(19) United States
(12) Patent Application Publication
(10) Pub. No.: US 2026/0000075 A1
(43) Pub. Date: Jan. 1, 2026

(54) HERBICIDAL MALONIC ACID MONOAMIDES AND MALONAMIDE ESTERS

(71) Applicant: BASF SE, Ludwigshafen am Rhein (DE)

(72) Inventors: Marc HEINRICH, Ludwigshafen (DE); Markus KORDES, Ludwigshafen (DE); Tobias SEISER, Ludwigshafen (DE); Gunther ZIMMERMANN, Ludwigshafen (DE); Trevor William NEWTON, Limburgerhof (DE); Gerd KRAEMER, Limburgerhof (DE)

(21) Appl. No.: 18/869,186

(22) PCT Filed: May 24, 2023
(86) PCT No.: PCT/EP2023/063952

§ 371 Date: Nov. 25, 2024

(30) Foreign Application Priority Data
May 25, 2022 (EP) 22175511.9

(51) Int. Cl. A01N 37/30; A01P 13/00

(52) U.S. Cl. CPC A01N 37/30; A01P 13/00

(57) ABSTRACT

The present invention relates to the use of malonic acid monoamides and malonamide esters of the formula (I)

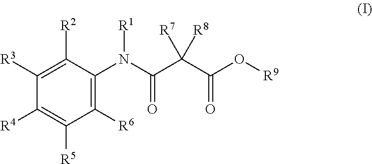

wherein the variables are as defined in the claims and the description, for controlling unwanted vegetation, to a method for combatting unwanted vegetation by using such compounds, to compositions comprising such compounds and to certain malonic acid monoamides and malonamide esters of the formula (I).

The present invention relates to the use of malonic acid monoamides and malonamide esters of the formula (1) as defined below for controlling unwanted vegetation, to a method for combatting unwanted vegetation by using such compounds, to compositions comprising such compounds and to certain malonic acid monoamides and malonamide esters of the formula (1).

### TECHNICAL BACKGROUND

For the purpose of controlling unwanted vegetation, especially in crops, there is an ongoing need for new herbicides that have high activity and selectivity together with a substantial lack of toxicity for humans and animals.

WO 2012/130798, WO 2014/04882, WO 2014/048882, WO 2018/228985, WO 2018/228986, WO 2019/034602, WO 2019/145245, WO 2020/114932, WO 2020/114934 and WO 2020/182723 describe 3-phenylisoxazoline-5-carboxamides and their use as herbicides.

WO 87/05898 describes the use of malonic acid derivatives for retarding plant growth.

Malonic acid derivatives are also described in U.S. Pat. No. 3,072,473 as plant growth regulants.

WO 01/12183 describes the use of malonic acid derivatives, characterized by a monocyclic saturated heterocyclic ring having up to two heteroatoms, for the treatment of cell-adhesion mediated pathologies.

WO2022/112351 relates to malonic acid diamides and their use as herbicides. Certain malonic acid monoamides and malonamide esters are used as intermediates in the synthesis of the targeted malonic acid diamides; they are however not used for any other purpose, and especially not as herbicides.

The compounds of the prior art often suffer from insufficient herbicidal activity, in particular at low application rates, and/or unsatisfactory selectivity resulting in a low compatibility with crop plants.

WO 2013/032797 relates to oxetane 3,3-dicarboxamides which modulate protein kinase signal transduction pathways, thereby making them useful as anti-cancer agents and for the treatment of other diseases associated with said pathways. In the synthesis of one of said diamides, in example 1 B, 3-[(4-fluorophenyl)carbamoyl]-oxetane-3-carboxylic acid is prepared as intermediate compound and converted further.

U.S. Pat. No. 5,123,951 relates to plant growth regulator compositions containing an ethylene (-type) response inducing agent and a malonic acid derivative compound. In table 3, among many others, ethyl 2-[(4-bromo-2-methyl-phenyl)carbamoyl]-1,3-dithiolane-2-carboxylate is listed as a representative for such malonic acid derivatives. However, neither the synthesis of this compound nor its use or any combination with an ethylene (-type) response inducing agent is disclosed.

Accordingly, it is an object of the present invention to provide further malonamide compounds having a strong herbicidal activity, in particular even at low application rates, a sufficiently low toxicity for humans and animals and/or a high compatibility with crop plants. The malonamide compounds should also show a broad activity spectrum against a large number of different unwanted plants.

These and further objectives are achieved by the compounds of formula (I) defined below, including their agriculturally acceptable salts, stereoisomers and tautomers.

### SUMMARY OF THE INVENTION

Accordingly, the present invention relates to the use of a compound of the formula (I), of an agriculturally acceptable salt, a stereoisomer or a tautomer thereof

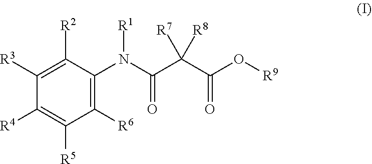

wherein
R¹ is hydrogen, (C₁-C₃)-alkyl, (C₁-C₃)-haloalkyl, (C₃-C₄)-cycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy-(C₁-C₃)-alkyl, (C₁-C₃)-alkoxy or (C₁-C₃)-haloalkoxy;
R² is hydrogen, halogen, hydroxyl, cyano, (C₁-C₃)-alkyl, (C₁-C₃)-haloalkyl, (C₁-C₃)-alkoxy or (C₁-C₃)-haloalkoxy;
R³ is hydrogen, halogen, nitro, hydroxyl, cyano, (C₁-C₃)-alkyl, (C₁-C₃)-haloalkyl, hyd-roxy-(C₁-C₃)-alkyl, (C₃-C₅)-cycloalkyl, (C₃-C₅)-halocycloalkyl, hydroxy-(C₃-C₅)-cycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy, (C₁-C₃)-haloalkoxy, (C₁-C₃)-alkoxycarbonyl, (C₁-C₃)-alkylthio, (C₁-C₃)-alkylsulfinyl or (C₁-C₃)-alkylsulfonyl;
R⁴ is hydrogen, halogen, hydroxyl, cyano, (C₁-C₃)-alkyl, (C₁-C₃)-haloalkyl, (C₃-C₄)-cycloalkyl, (C₃-C₄)-halocycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy or (C₁-C₃)-haloalkoxy;
R⁵ is hydrogen, halogen, nitro, hydroxyl, cyano, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy, (C₁-C₃)-haloalkoxy, (C₁-C₃)-alkoxycarbonyl, (C₁-C₃)-alkylthio, (C₁-C₃)-alkylsulfinyl or (C₁-C₃)-alkylsulfonyl;
R⁶ is hydrogen, halogen, hydroxyl, cyano, (C₁-C₃)-alkyl, (C₁-C₃)-haloalkyl, (C₁-C₃)-alkoxy or (C₁-C₃)-haloalkoxy;
R⁷ and R⁸ form, together with the carbon atom to which they are bound, a saturated or partially unsaturated 4-, 5-, 6-, 7- or 8-membered monocyclic or bicyclic hetero-cyclic ring W, containing, in addition to this carbon atom, q carbon atoms, u oxy-gen atoms, v nitrogen atoms, and w sulfur atoms as ring members, where one carbon ring atom bears p oxo groups, and where the ring is substituted by n radi-cals R^{b};
R⁹ is hydrogen, (C₁-C₆)-alkyl, (C₂-C₄)-alkenyl, (C₂-C₄)-alkynyl, (C₃-C₆)-cycloalkyl, (C₃-C₆)-cycloalkyl-(C₁-C₃)-alkyl or phenyl-(C₁-C₃)-alkyl, where the six last-mentioned radicals are each substituted by m radicals selected from the group consisting of fluorine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members;
R^{a} is (C₁-C₆)-alkyl, (C₂-C₄)-alkynyl or (C₃-C₆)-cycloalkyl, each of which is substituted by m radicals selected from the group consisting of fluorine, chlorine, bromine, iodine, cyano, hydroxyl, and (C₁-C₃)-alkoxy;
each R^{b} is independently halogen, nitro, hydroxyl, cyano, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₁-C₃)-alkoxy, (C₁-C₃)-haloalkoxy, (C₁-C₃)-alkoxycarbonyl, (C₂-C₃)-alkenyl, (C₂-C₃)-haloalkenyl, (C₂-C₃)-alkynyl, (C₂-C₃)-haloalkynyl, (C₁-C₃)-alkylthio, (C₁-C₃)-alkylsulfinyl or (C₁-C₃)-alkylsulfonyl; or two R^{b}, bound on the same carbon atom, form together a methylene group (═CH₂);
each m is independently 0, 1, 2, 3, 4 or 5;
each n is independently 0, 1 or 2;
p is0or1;
q is 1, 2, 3, 4, 5 or 6;
u is 0, 1 or 2;
v is 0, 1, 2, or 3;
w is 0, 1 or 2;
with the proviso that at least one of u, v and w is not 0;
for combatting undesired vegetation.

In a specific embodiment, the use according to the invention does not encompass the use of ethyl 2-[(4-bromo-2-methyl-phenyl)carbamoyl]-1,3-dithiolane-2-carboxylate.

The invention relates moreover to a herbicidal composition comprising at least one compound of the formula (I) as defined above, an agriculturally acceptable salt thereof, a stereoisomer thereof or a tautomer thereof, and at least one auxiliary which is cus-tomary for formulating crop protection compounds. In a particular embodiment, the composition according to the invention does not encompass compositions comprising simultaneously 3-[(4-fluorophenyl)carbamoyl]oxetane-3-carboxylic acid as compound of the formula (I) and one or more of the following solvents: acetonitrile, ethyl acetate, water, methanol, tetrahydrofuran. More particularly, the composition according to the invention does not encompass compositions comprising 3-[(4-fluorophenyl)carbamoyl]-oxetane-3-carboxylic acid (as compound (I)), and does not encompass compositions comprising ethyl 2-[(4-bromo-2-methyl-phenyl)carbamoyl]-1,3-dithiolane-2-carboxylate (as compound (I)).

In another particular embodiment, the composition according to the invention does not encompass compositions comprising simultaneously one of the following compounds: compounds (I), wherein
R¹, R², R⁴ and R⁶ are hydrogen, R³ and R⁵ are C₁, R⁷ and R⁸ form together with the carbon atom they are bound to oxetan-2,2-diyl (i.e. R⁷ and R⁸ form together a bridg-ing group —CH₂—CH₂—O—), 2,5-dihydrofuran-2,2-diyl (i.e. R⁷ and R⁸ form together a bridging group —CH═CH—CH₂—O—), 3,5-dimethyl-2,5-dihydrofuran-2,2-diyl (i.e. R⁷ and R⁸ form together a bridging group —C(CH₃)═CH—CH(CH₃)—O—), oxathiolan-2,2-diyl (i.e. R⁷ and R⁸ form together a bridging group —S—CH₂—CH₂—O—), 1,3-dioxolan-5,5-diyl (i.e. R⁷ and R⁸ form together a bridging group —CH₂—O—CH₂—O—), 3-methyl-4,5-dihydroisoxazol-5,5-diyl (i.e. R⁷ and R⁸ form together a bridging group —CH₂—C(CH₃)=N—O—), or

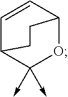

and R⁹ is hydrogen or ethyl;
R¹, R², R⁴ and R⁶ are hydrogen, R³ and R⁵ are C₁, R⁷ and R⁸ form together with the carbon atom they are bound to tetrahydrofuran-2,2-diyl (i.e. R⁷ and R⁸ form together a bridging group —CH₂—CH₂—CH₂—O—) or 2,5-dihydrothiophen-2,2-diyl (i.e. R⁷ and R⁸ form together a bridging group —CH═CH—CH₂—S—), and R⁹ is hydrogen or methyl;
R¹, R², R⁴ and R⁶ are hydrogen, R³ and R⁵ are F, R⁷ and R⁸ form together with the carbon atom they are bound to oxetan-2,2-diyl (i.e. R⁷ and R⁸ form together a bridg-ing group —CH₂—CH₂—O—), and R⁹ is hydrogen or ethyl; and one or more of the following solvents: N,N-dimethylformamide, acetonitrile, ethyl acetate, water, methanol, ethanol, tetrahydrofuran, methyl-tert-butyl-ether, toluene, pentane, dichloromethane.

The invention relates furthermore to a composition comprising at least one compound of formula (1) (component A) as defined above, an agriculturally acceptable salt thereof, a stereoisomer thereof or a tautomer thereof, and at least one further compound se-lected from the herbicidal compounds B different from compounds (1) (component B) and safeners C (component C), preferably from herbicidal compounds B.

The invention relates also to a method for controlling undesired vegetation, which method comprises allowing a herbicidally effective amount of at least one compound of formula (1), an agriculturally acceptable salt thereof, a stereoisomer thereof or a tauto-mer thereof or of said compositions to act on plants, their seeds and/or their habitat.

Furthermore, the invention relates to compounds (1), agriculturally acceptable salts thereof, stereoisomers thereof and tautomers thereof, except for compounds (1), wherein:
R¹, R², R⁴ and R⁶ are hydrogen, R³ and R⁵ are C₁, R⁷ and R⁸ form together with the carbon atom they are bound to oxetan-2,2-diyl (i.e. R⁷ and R⁸ form together a bridg-ing group —CH₂—CH₂—O—), 2,5-dihydrofuran-2,2-diyl (i.e. R⁷ and R⁸ form together a bridging group —CH═CH—CH₂—O—), 3,5-dimethyl-2,5-dihydrofuran-2,2-diyl (i.e. R⁷ and R⁸ form together a bridging group —C(CH₃)═CH—CH(CH₃)—O—), oxathiolan-2,2-diyl (i.e. R⁷ and R⁸ form together a bridging group —S—CH₂—CH₂—O—), 1,3-dioxolan-5,5-diyl (i.e. R⁷ and R⁸ form together a bridging group —CH₂—O—CH₂—O—), 3-methyl-4,5-dihydroisoxazol-5,5-diyl (i.e. R⁷ and R⁸ form together a bridging group —CH₂—C(CH₃)=N—O—), or

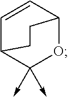

and R⁹ is hydrogen or ethyl;
R¹, R², R⁴ and R⁶ are hydrogen, R³ and R⁵ are C₁, R⁷ and R⁸ form together with the carbon atom they are bound to 1-tert-butoxycarbonyl-pyrrolidin-2,2-diyl (i.e. R⁷ and R⁸ form together a bridging group —CH₂—CH₂—CH₂—N(—C(O)—O—C(CH₃)₃)—), and R⁹ is ethyl;
R¹, R², R⁴ and R⁶ are hydrogen, R³ and R⁵ are C₁ or F, R⁷ and R⁸ form together with the carbon atom they are bound to tetrahydrofuran-2,2-diyl (i.e. R⁷ and R⁸ form to-gether a bridging group —CH₂—CH₂—CH₂—O—) or 2,5-dihydrothiophen-2,2-diyl (i.e. R⁷ and R⁸ form together a bridging group —CH═CH—CH₂—S—), and R⁹ is hydrogen or me-thyl;
R¹, R², R⁴ and R⁶ are hydrogen, R³ and R⁵ are F, R⁷ and R⁸ form together with the carbon atom they are bound to oxetan-2,2-diyl (i.e. R⁷ and R⁸ form together a bridg-ing group —CH₂—CH₂—O—), and R⁹ is hydrogen or ethyl; 15 - R⁷ and R⁸ form together with the carbon atom they are bound to tetrahydrofuran-2,2-diyl (i.e. R⁷ and R⁸ form together a bridging group —CH₂—CH₂—CH₂—O—), and R⁹ is tert-butyl;
R¹ is hydrogen or methyl, R⁷ and R⁸ form together with the carbon atom they are bound to oxetan-3,3-diyl (i.e. R⁷ and R⁸ form together a bridging group —CH₂—O—CH₂—), and R⁹ is hydrogen or methyl; and
R⁷ and R⁸ form together with the carbon atom they are bound to tetrahydropyran-4,4-diyl (i.e. R⁷ and R⁸ form together a bridging group —CH₂—CH₂—O—CH₂—CH₂), and R⁹ is hydrogen or ethyl; and except for following compounds (1):
2-[(3-fluoro-5-methylphenyl)carbamoyl]oxolane-2-carboxylic acid;
2-[(3-bromophenyl)carbamoyl]oxolane-2-carboxylic acid;
2-[(4-tert-butylphenyl)carbamoyl]oxolane-2-carboxylic acid;
2-[(2,3-dimethylphenyl)carbamoyl]oxolane-2-carboxylic acid;
2-[(3-bromo-2-methylphenyl)carbamoyl]oxolane-2-carboxylic acid;
2-[(5-chloro-2-methylphenyl)carbamoyl]oxolane-2-carboxylic acid;
2-[(4-difluoromethoxylphenyl)carbamoyl]oxolane-2-carboxylic acid;
2-[(4-ethyl-3-fluorophenyl)carbamoyl]oxolane-2-carboxylic acid;
2-[(3,5-difluoro-4-methoxyphenyl)carbamoyl]oxolane-2-carboxylic acid;
2-[(3-chloro-4-(2-methylpropoxy)phenyl)carbamoyl]oxolane-2-carboxylic acid;
2-[(4-hydroxy-2-methyl-5-(1-methylethyl)phenyl)carbamoyl]oxolane-2-carboxylic acid;
2-[(4-hydroxy-2,3,5-trimethylphenyl)carbamoyl]oxolane-2-carboxylic acid;
2-[(3-hydroxy-2,4-dimethylphenyl)carbamoyl]oxolane-2-carboxylic acid;
2-[(5-ethyl-2-hydroxyphenyl)carbamoyl]oxolane-2-carboxylic acid;
3-[(4-fluorophenyl)carbamoyl]oxetane-3-carboxylic acid as compound of the formula (1); and
ethyl 2-[(4-bromo-2-methyl-phenyl)carbamoyl]-1,3-dithiolane-2-carboxylate.

### DETAILED DESCRIPTION OF THE INVENTION

### Definitions

Depending on the kind of substituents, the compounds of formula (1) may have one or more stereogenic centers, in which case they may be present as mixtures of enantio-mers or diastereomers but also in the form of the pure enantiomers or pure diastere-omers. The invention provides both the pure enantiomers or pure diastereomers of the compounds of formula I, and their mixtures and the use according to the invention of the pure enantiomers or pure diastereomers of the compound of formula I or its mix-tures. Suitable compounds of formula I also include all possible geometrical stereoiso-mers (cis/trans or Z/E isomers) as a specific form of diastereomers and mixtures thereof. Cis/trans (Z/E) isomers may be present with respect to an alkene, carbon-nitrogen double-bond, nitrogen-sulfur double bond, amide group or a cyclic, non-aromatic moie-ty. The term “stereoisomer(s)” encompasses both optical isomers, such as enantio-mers or diastereomers, the latter existing due to more than one stereogenic center in the molecule, as well as geometrical isomers (cis/trans (Z/E) isomers). Just by way of example, a stereogenic center in compounds (1) is the C atom carrying R⁷ and R⁸, pro-vided the ring formed by these radicals and the carbon atom to which they are bound has not rotary mirror axis.

If the above-mentioned herbicidal compounds B and/or the safeners C have one or stereogenic centers or can be present as different geometrical stereoisomers (cis/trans or E/Z isomers), they may also be present as enantiomers or diastereomers or geometrical stereoisomers, and it is possible to use both the pure enantiomers or diastereomers or geometrical stereoisomers or mixtures of different enantiomers, diastereomers and/or geometrical stereoisomers.

If the compounds of formula (1), the herbicidal compounds B and/or the safeners C as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds. Just by way of example, a ionizable functional group is —C(O)OH which can be present in compounds (1) if R⁹ is hydrogen or if the compounds contain a substituent —CO₂Ra, wherein R^{a} is hydrogen. Compounds (1) containing such —C(O)OH groups can be used in form of their salts, i.e. in form of compounds containing one or more groups —C(O)O—M⁺, where M⁺ is a cation equivalent. Examples for agriculturally suitable cations are given below.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diethylammonium, diisopropylammonium, trimethylammonium, triethylammonium, tris(isopropyl)ammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy)eth-1-ylammonium (diglycolamine salt), di(2-hydroxyeth-1-yl)ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

The compounds (1) may be present in form of different tautomers. For instance, an am-ide moiety —N(H)—C(═O)— can be in equilibrium with its tautomeric form —N═C(OH)—.

If for example R¹ is hydrogen, the malonamide moiety can be present as —N(H)—C(═O)—C(R⁷)(R⁸)—C(═O)—OR⁹— or as —N═C(OH)—C(R⁷)(R⁸)—C(═O)—OR⁹—.

The same applies if ring W is a lactam, i.e. if it contains an amide group as ring mem-ber (=unsubstituted, secondary nitrogen ring atom neighboured to a carbon ring atom carrying an oxo group); in this case, this ring moiety —N(H)—C(═O)— can be in equilibrium with its tautomeric form —N═C(OH)—.

The amount in which the one or other tautomeric form is present depends on the com-plete molecular structure and even stronger on the surrounding conditions (presence or absence of solvent, type of solvent, pH, temperature etc.).

The term “undesired vegetation” (“weeds”) is understood to include any vegetation growing in non-crop-areas or at a crop plant site or locus of seeded and otherwise de-sired crop, where the vegetation is any plant species, including their germinant seeds, emerging seedlings and established vegetation, other than the seeded or desired crop (if any). Weeds, in the broadest sense, are plants considered undesirable in a particu-lar location.

The terms used for organic groups in the definition of the variables are, like the expres-sion “halogen”, collective terms which represent the individual members of these groups of organic units.

The prefix C_{X}-C_{y} denotes the number of possible carbon atoms in the particular case. All hydrocarbon chains can be straight-chain or branched.

The term “halogen” denotes in each case fluorine, chlorine, bromine, or iodine, in particular fluorine, chlorine or bromine.

The term “partially or completely halogenated” will be taken to mean that 1 or more, e.g. 1, 2, 3, 4 or 5 or all of the hydrogen atoms of a given radical have been re-placed by a halogen atom, in particular by fluorine or chlorine. A partially or completely halogenated radical is termed below also “halo-radical”. For example, partially or com-pletely halogenated alkyl is also termed haloalkyl.

The term “alkyl” as used herein (and in the alkyl moieties of other groups com-prising an alkyl group, e.g. alkoxy, alkoxycarbonyl, alkylthio, alkylsulfinyl, alkylsulfonyl, hydroxyalkyl and alkoxyalkyl) denotes in each case a straight-chain or branched alkyl group having usually from 1 to 6 carbon atoms (=C₁-C₆-alkyl), in particular 1 to 4 car-bon atoms (=C₁-C₄-alkyl) and especially from 1 to 3 carbon atoms (=C₁-C₃-alkyl) or 1 or 2 carbon atoms (=C₁-C₂-alkyl). C₁-C₂-Alkyl is methyl or ethyl. C₁-C₃-Alkyl is methyl, ethyl, n-propyl or iso-propyl. Examples of C₁-C₄-alkyl are methyl, ethyl, n-propyl, iso-propyl, n-butyl, 2-butyl (=sec-butyl), isobutyl and tert-butyl. Examples for C₁-C₆-alkyl are, in addition to those mentioned for C₁-C₄-alkyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

The term “haloalkyl” as used herein (and in the haloalkyl moieties of other groups comprising a haloalkyl group, e.g. haloalkoxy), which is also expressed as “alkyl which is partially or fully halogenated”, denotes in each case a straight-chain or branched alkyl group having usually from 1 to 3 carbon atoms (=C₁-C₃-haloalkyl), e.g. 1 or 2 car-bon atoms (=C₁-C₂-haloalkyl), as defined above, wherein the hydrogen atoms of this group are partially or totally replaced with halogen atoms. Preferred haloalkyl moieties are fluorinated alkyl, e.g. fluorinated C₁-C₂-alkyl or fluorinated C₁-C₃-alkyl. Examples for C₁-C₂-haloalkyl are fluoromethyl, difluoromethyl, trifluoromethyl, chloromethyl, di-chloromethyl, trichloromethyl, chlorofluoromethyl, dichlorofluoromethyl, chlorodifluoro-methyl, bromomethyl, 1-fluoroethyl, 2-fluoroethyl, 2,2-difluoroethyl, 2,2,2-trifluoroethyl, pentafluoroethyl, 1-chloroethyl, 2-chloroethyl, 2,2,-dichloroethyl, 2,2,2-trichloroethyl, 2-chloro-2-fluoroethyl, 2-chloro-2,2-difluoroethyl, 2,2-dichloro-2-fluoroethyl, 1-bromoethyl, and the like. Examples for C₁-C₃-haloalkyl are, in addition to those mentioned for C₁-C₂-haloalkyl, 1-fluoropropyl, 2-fluoropropyl, 3-fluoropropyl, 3,3-difluoropropyl, 3,3,3-trifluoropropyl, heptafluoropropyl, 1,1,1-trifluoroprop-2-yl, 3-chloropropyl, and the like.

The term “hydroxyalkyl” denotes in each case a straight-chain or branched alkyl group having usually from 1 to 3 carbon atoms (=C₁-C₃-hydroxyalkyl), as defined above, wherein one hydrogen atom of this group is replaced with a hydroxyl group.

Examples are hydroxymethyl, 1-hydroxyethyl, 2-hydroxyethyl, 1-hydroxypropyl, 2-hydroxypropyl, 3-hydroxypropyl, 1-hydroxy-2-propyl and the like.

The term “alkenyl” as used herein denotes in each case a monounsaturated 20 straight-chain or branched hydrocarbon radical having usually 2 to 4 carbon atoms (=C₂-C₄-alkenyl) or 2 or 3 carbon atoms (=C₂-C₃-alkenyl), and a double bond in any posi-tion, for example C₂-C₃-alkenyl, such as ethenyl, 1-propenyl, 2-propenyl or 1-methylethenyl; C₂-C₄-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl or 2-methyl-2-propenyl.

The term “haloalkenyl” as used herein, which may also be expressed as “alkenyl which is substituted by halogen”, and the haloalkenyl moieties in haloalkenyloxy and the like refers to unsaturated straight-chain or branched hydrocarbon radicals having 2 to 4 (=C₂-C₄-haloalkenyl) or 2 to 3 (=C₂-C₃-haloalkenyl) carbon atoms and a double bond in any position, where some or all of the hydrogen atoms in these groups are re-placed by halogen atoms as mentioned above, in particular fluorine, chlorine and bro-mine, for example chlorovinyl, chloroallyl and the like.

The term “alkynyl” as used herein denotes unsaturated straight-chain or branched hydrocarbon radicals having usually 2 to 4 carbon atoms (=C₂-C₄-alkynyl) or 2 to 3 carbon atoms (=C₂-C₃-alkynyl) and a triple bond in any position, for example C₂-C₃-alkynyl, such as ethynyl, 1-propynyl or 2-propynyl; C₂-C₄-alkynyl, such as ethynyl, 1-propynyl or 2-propynyl, 1-butynyl, 2-butynyl, 3-butynyl, 1-methyl-2-propynyl and the like.

The term “haloalkynyl” as used herein, which is also expressed as “alkynyl which is substituted by halogen”, refers to unsaturated straight-chain or branched hydrocar-bon radicals having usually 2 to 4 carbon atoms (=C₂-C₄-haloalkynyl) or 2 or 3 carbon atoms (=C₂-C₃-haloalkynyl), and a triple bond in any position (as mentioned above), where some or all of the hydrogen atoms in these groups are replaced by halogen at-oms as mentioned above, in particular fluorine, chlorine and bromine.

The term “cycloalkyl” as used herein denotes in each case a mono- or bicyclic, saturated cycloaliphatic radical having usually from 3 to 6 carbon atoms (=C₃-C₆-cycloalkyl), 3 to 5 carbon atoms (=C₃-C₅-cycloalkyl) or 3 to 4 carbon atoms (=C₃-C₄-cycloalkyl) as (only) ring members. Examples of monocyclic saturated cycloaliphatic radicals having 3 or 4 carbon atoms comprise cyclopropyl and cyclobutyl. Examples of monocyclic saturated cycloaliphatic radicals having 3 to 5 carbon atoms comprise cy-clopropyl, cyclobutyl and cyclopentyl. Examples of monocyclic saturated cycloaliphatic radicals having 3 to 6 carbon atoms comprise cyclopropyl, cyclobutyl, cyclopentyl and cyclohexyl. Examples of bicyclic radicals having 5 or 6 carbon atoms comprise bicy-clo[1.1.1]pentyl and bicyclo[2.1.1]hexyl. Preferably, cycloalkyl is monocyclic.

The term “halocycloalkyl” as used herein (and in the halocycloalkyl moieties of other groups comprising an halocycloalkyl group) denotes in each case a mono- or bicyclic cycloaliphatic radical having usually from 3 to 6 carbon atoms (“C₃-C₆-halocycloalkyl”), preferably 3 to 5 carbon atoms (“C₃-C₅-halocycloalkyl”) or 3 to 4 car-bon atoms (“C₃-C₄-halocycloalkyl”), wherein at least one, e.g. 1, 2, 3, 4 or 5 of the hy-drogen atoms are replaced by halogen, in particular by fluorine or chlorine. Examples are 1- and 2-fluorocyclopropyl, 1,2-, 2,2- and 2,3-difluorocyclopropyl, 1,2,2-trifluorocyclopropyl, 2,2,3,3-tetrafluorocyclpropyl, 1- and 2-chlorocyclopropyl, 1,2-, 2,2-and 2,3-dichlorocyclopropyl, 1,2,2-trichlorocyclopropyl, 2,2,3,3-tetrachlorocyclpropyl, 1-, 2- and 3-fluorocyclobutyl, 1,2-, 1,3-, 2,2-, 2,3-, 2,4-, 3,3-difluorocyclobutyl, 1-, 2- and 3-chlorocyclobutyl, 1,2-, 1,3-, 2,2-, 2,3-, 2,4-, 3,3-dichlorocyclobutyl, 1-, 2- and 3-fluorocyclopentyl, 1,2-, 2,2-, 2,3-, 3,3-, 3,4-, 2,5-difluorocyclopentyl, 1-, 2- and 3-chlorocyclopentyl, 1,2-, 2,2-, 2,3-, 3,3-, 3,4-, 2,5-dichlorocyclopentyl and the like.

The term “hydroxycycloalkyl” denotes in each case a mono- or bicyclic cycloali-phatic radical having usually from 3 to 6 carbon atoms (“hydroxy-(C₃-C₆)-cycloalkyl”), preferably 3 to 5 carbon atoms (“hydroxy-(C₃-C₅)-cycloalkyl”) or 3 to 4 carbon atoms (“hydroxy-(C₃-C₄)-cycloalkyl”), wherein at least one, e.g. 1, 2, 3, 4 or 5 of the hydrogen atoms are replaced by a hydroxyl group. Examples are 1-hydroxycyclopropyl, 2-hydroxycyclopropyl, 1,2-dihydroxycyclopropyl, 2,3-dihydroxycyclopropyl, 1-hydroxycyclobutyl, 2-hydroxycyclobutyl, 3-hydroxycyclobutyl, 1,2-dihydroxycyclobutyl, 1,3-dihydroxycyclobutyl, 2,3-dihydroxycyclobutyl, 1-hydroxycyclopentyl, 2-hydroxycyclopentyl, 3-hydroxycyclopentyl, 1,2-dihydroxycyclopentyl, 1,3-dihydroxycyclopentyl, 2,3-dihydroxycyclopentyl and the like.

The term “alkoxy” as used herein denotes in each case a straight-chain or branched alkyl group usually having from 1 to 3 carbon atoms (=C₁-C₃-alkoxy), in par-ticular 1 or 2 carbon atoms (=C₁-C₂-alkoxy), which is bound to the remainder of the molecule via an oxygen atom. C₁-C₂-Alkoxy is methoxy or ethoxy. C₁-C₃-Alkoxy is addi-tionally, for example, n-propoxy or 1-methylethoxy (isopropoxy).

The term “haloalkoxy” as used herein denotes in each case a straight-chain or branched alkoxy group, as defined above, having usually from 1 to 3 carbon atoms (=C₁-C₃-haloalkoxy), in particular 1 or 2 carbon atoms (=C₁-C₂-haloalkoxy), wherein the hydrogen atoms of this group are partially or totally replaced with halogen atoms, in particular fluorine atoms (in this case, the radical is also termed fluorinated alkoxy). C₁-C₂-Haloalkoxy is, for example, OCH₂F, OCHF₂, OCF₃, OCH₂C₁, OCHCl₂, OCCl₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy or OC₂F₅. C₁-C₃-Haloalkoxy is additionally, for example, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, OCH₂—C₂F₅, OCF₂—C₂F₅, 1—(CH₂F)-2-fluoroethoxy, 1-(CH₂Cl)-2-chloroethoxy or 1—(CH₂Br)-2-bromoethoxy.

The term “alkylthio” (also alkylsulfanylor “alkyl-S”) as used herein denotes in each case a straight-chain or branched saturated alkyl group as defined above, usually comprising 1 to 3 carbon atoms (=C₁-C₃-alkylthio) or 1 to 2 carbon atoms (=C₁-C₂-alkylthio), which is attached via a sulfur atom at any position in the alkyl group. C₁-C₂-Alkylthio is methylthio or ethylthio. C₁-C₃-Alkylthio is additionally, for example, n-propylthio or 1-methylethylthio (isopropylthio).

The term “alkylsulfinyl” denotes an alkyl group, as defined above, attached via a sulfinyl [S(O)] group. For example, the term “C₁-C₂-alkylsulfinyl” refers to a C₁-C₂-alkyl group, as defined above, attached via a sulfinyl [S(O)] group. The term “C₁-C₃-alkylsulfinyl” refers to a C₁-C₃-alkyl group, as defined above, attached via a sulfinyl [S(O)] group. C₁-C₂-alkylsulfinyl is methylsulfinyl or ethylsulfinyl. C₁-C₃-alkylsulfinyl is additionally, for example, n-propylsulfinyl or 1-methylethylsulfinyl (isopropylsulfinyl).

The term “alkylsulfonyl” denotes an alkyl group, as defined above, attached via a sulfonyl [S(O)₂] group. The term “C₁-C₂-alkylsulfonyl” refers to a C₁-C₂-alkyl group, as defined above, attached via a sulfonyl [S(O)₂] group. The term “C₁-C₃-alkylsulfonyl” refers to a C₁-C₃-alkyl group, as defined above, attached via a sulfonyl [S(O)₂] group. C₁-C₂-alkylsulfonyl is methylsulfonyl or ethylsulfonyl. C₁-C₃-alkylsulfonyl is additionally, for example, n-propylsulfonyl or 1-methylethylsulfonyl (isopropylsulfonyl).

The substituent “oxo” replaces a CH₂ group by a C(═O) group.

The suffix “-carbonyl” in a group denotes in each case that the group is bound to the remainder of the molecule via a carbonyl C═O group. This is the case e.g. in alkoxycarbonyl.

The term “alkoxycarbonyl” denotes an alkoxy group, as defined above, attached via a carbonyl [C(═O)] group to the remainder of the molecule. C₁-C₃-Alkoxycarbonyl is a C₁-C₃-alkoxy group, as defined above, attached via a carbonyl [C(═O)] group to the remainder of the molecule. Examples for C₁-C₃-alkoxycarbonyl are methoxycarbonyl, ethoxycarbonyl, propoxycarbonyl and isopropoxycarbonyl.

Phenylthio is a phenyl ring attached via an S atom to the remainder of the mole-cule.

Phenylsulfinyl is a phenyl ring attached via a S(O) group to the remainder of the molecule.

Phenylsulfonyl is a phenyl ring attached via a S(O)₂ group to the remainder of the molecule.

Phenyl-C₁-C₂-alkyl is a C₁-C₂-alkyl group, as defined above, in which one hydro-gen atom is replaced by a phenyl ring (i.e. the attachment to the remainder of the mol-ecule is via the alkyl group). Examples are benzyl, 1-phenylethyl and 2-phenylethyl.

Phenyl-C₁-C₃-alkyl is a C₁-C₃-alkyl group, as defined above, in which one hydrogen atom is replaced by a phenyl ring (i.e. the attachment to the remainder of the molecule is via the alkyl group). Examples are benzyl, 1-phenylethyl, 2-phenylethyl, 1-phenylpropyl, 2-phenylpropyl, 3-phenylpropyl or 2-phenyl-2-propyl.

If two R^{b}, bound on the same carbon atom, form together a methylene group (═CH₂), this means that a carbon atom as ring member of ring W (—CH₂—) is replaced by a carbon atom carrying an exocyclic methylene group (—C(═CH₂)—). 5- or 6-membered heteroaromatic rings containing 1, 2 or 3 heteroatoms selected from N, O and S as ring members contain 1 O, S or N as ring member or 2 or 3 N atoms as ring members or 1 O and 1 or 2 N atoms as ring members or 1 S and 1 or 2 N as ring members. Examples are are 2-furyl, 3-furyl, 2-thienyl, 3-thienyl, 1-pyrrolyl, 2-pyrrolyl, 3-pyrrolyl, 1-pyrazolyl, 3-pyrazolyl, 4-pyrazolyl, 5-pyrazolyl, 2-oxazolyl, 4-oxazolyl, 5-oxazolyl, 3-isoxazolyl, 4-isoxazolyl, 5-isoxazolyl, 2-thiazolyl, 4-thiazolyl, 5-thiazolyl, 3-isothiazolyl, 4-isothiazolyl, 5-isothiazolyl, 1-imidazolyl, 2-imidazolyl, 4-imidazolyl, 5-imidazolyl, 1,3,4-triazol-1-yl, 1,3,4-triazol-2-yl, 1,3,4-triazol-3-yl, 1,2,3-triazol-1-yl, 1,2,3-triazol-2-yl, 1,2,3-triazol-4-yl, 1,2,5-oxadiazol-3-yl, 1,2,3-oxadiazol-4-yl, 1,2,3-oxadiazol-5-yl, 1,3,4-oxadiazol-2-yl, 1,2,5-thiadiazol-3-yl, 1,2,3-thiadiazol-4-yl, 1,2,3-thiadiazol-5-yl, 1,3,4-thiadiazol-2-yl, 2-pyridinyl, 3-pyridinyl, 4-pyridinyl, 3-pyridazinyl, 4-pyridazinyl, 2-pyrimidinyl, 4-pyrimidinyl, 5-pyrimidinyl and 2-pyrazinyl.

R⁷ and R⁸ form, together with the carbon atom to which they are bound, a satu-rated or partially unsaturated 4-, 5-, 6-, 7- or 8-membered monocyclic or bicyclic heter-ocyclic ring W, containing, in addition to this carbon atom, q carbon atoms, u oxygen atoms, v nitrogen atoms, and w sulfur atoms as ring members, where one carbon ring atom bears p oxo groups, and where the ring is substituted by n radicals R^{b}. The n rad-icals R^{b} may be bound both to carbon ring atoms and to nitrogen ring atoms (if present and if not part of a double bond in the ring).

Examples for saturated four- to eight-membered monocyclic heterocyclic rings W are azetidin-2,2-diyl, azetidin-3,3-diyl, oxetan-2,2-diyl, oxetan-3,3,-diyl, thietan-2,2-diyl, thietan-3,3-diyl, 1-oxo-thietan-2,2-diyl, 1-oxothietan-3,3-diyl, 1,1-dioxo-thietan-2,2-diyl, 1,1-di-oxothietan-3,3-diyl, pyrrolidin-2,2-diyl, pyrrolidin-3,3-diyl, tetrahydrofuran-2,2-diyl, tetrahydrofuran-3,3-diyl, tetra-hydrothiophen-2,2-diyl, tetrahydrothiophen-3,3-diyl, 1-oxo-tetrahydrothiophen-2,2-diyl, 1-oxotetrahydrothiophen-3,3-diyl, 1,1-dioxo-tetrahydrothiophen-2,2-diyl, 1,1-dioxotetrahydrothiophen-3,3-diyl, pyrazolidin-3,3-diyl, pyrazolidin-4,4-diyl, imidazolidin-2,2-diyl, imidazolidin-4,4-diyl, 1,3-dioxolan-2,2-diyl, 1,3-dioxolan-4,4-diyl, 1,3-dithiolan-2,2-diyl, 1,3-dithiolan-4,4-diyl, 1,3-oxathiolan-2,2-diyl, 1,3-oxathiolan-4,4-diyl, 1,3-oxathiolan-5,5-diyl, oxazoli-din-2,2-diyl, oxazolidin-4,4-diyl, oxazolidin-5,5-diyl, isoxazolidin-3,3-diyl, isoxazolidin-4,4-diyl, isoxazolidin-5,5-diyl, thiazolidin-2,2-diyl, thiazolidin-4,4-diyl, thiazolidin-5,5-diyl, isothiazolidin-3,3-diyl, isothi-azolidin-4,4-diyl, isothiazolidin-5,5-diyl, 1,2,4-oxadiazolidin-3,3-diyl, 1,2,4-oxadiazolidin-5,5-diyl, 1,2,4-thiadiazolidin-3,3-diyl, 1,2,4-thiadiazolidin-5,5-diyl, 1,3,4-oxadiazolidin-2,2-diyl, 1,3,4 thiadiazolidin-2,2-diyl, 1,2,4-triazolidin-3,3-diyl, 1,2,4-triazolidin-5,5-diyl, tetrahydropyran-2,2-diyl, tetrahydropyran-3,3-diyl, tetrahydropyran-4,4-diyl, tetrahy-drothiopyran-2,2-diyl, tetrahydrothiopyran-3,3-diyl, tetrahydrothiopyran-4,4-diyl, 1-oxotetrahydrothiopyran-2,2-diyl, 1-oxotetrahydrothiopyran-3,3-diyl, 1-oxotetrahydrothiopyran-4,4-diyl, 1,1-dioxotetrahydrothiopyran-2,2-diyl, 1,1-dioxotetrahydrothiopyran-3,3-diyl, 1,1-dioxotetrahydrothiopyran-4,4-diyl, piperidin-2,2-diyl, piperidin-3,3-diyl, piperidin-4,4-diyl, 1,3-dioxan-2,2-diyl, 1,3-dioxan-4,4-diyl, 1,3-dioxan-5,5-diyl, 1,4-dioxan-2,2-diyl, piperazin-2,2-diyl, hexahydropyridazin-3,3-diyl, hexahydropyridazin-4,4-diyl, hexahydropyrimidin-2,2-diyl, hexahydropyrimidin-4,4-diyl, hexahydropyrimidin-5,5-diyl, mor-pholin-2,2-diyl, morpholin-3,3-diyl, thiomorpholin-2,2-diyl, thiomorpholin-3,3-diyl, 1-oxo-thiomorpholin-2,2-diyl, 1-oxo-thiomorpholin-3,3-diyl, 1,1-dioxo-thiomorpholin-2,2-diyl, 1,1-dioxo-thiomorpholin-3,3-diyl, azepan-2,2-, -3,3- or -4,4-diyl, oxepan-2,2-, -3,3- or -4,4-diyl, hexahydro-1,3-diazepin-2,2-, -4,4- or -5,5-diyl, hexahydro-1,4-diazepin-2,2- or -5,5-diyl, hexahydro-1,3-oxazepin-2,2-, -4,4-, -5,5-, 6,6-or -7,7-diyl, hexahydro-1,4-oxazepin-2,2-, -3,3-, -4,4-, -5,5-, -6,6- or -7,7-diyl, hexahy-dro-1,3-dioxepin-2,2-, -4,4- or -5,5-diyl, hexahydro-1,4-dioxepin-2,2-, -5,5- or -6,6-diyl, oxocan-2,2-, 3,3- or -4,4-diyl, thiocan-2,2-, 3,3- or -4,4-diyl, azocan-2,2-, 3,3- or -4,4-diyl, and the like.

Examples for partly unsaturated four- to eight-membered monocyclic heterocyclic rings W are 2,3-dihydrofuran-2,2-diyl, 2,3-dihydrofuran-3,3-diyl, 2,5-dihydrofuran-2,2-diyl, 2,3-dihydrothien-2,2-diyl, 2,3-dihydrothien-3,3-diyl, 2,5-dihydrothien-2,2-diyl, 1-oxo-2,3-dihydrothien-2,2-diyl, 1-oxo-2,3-dihydrothien-3,3-diyl, 1-oxo-2,5-dihydrothien-2,2-diyl, 1,1-di-oxo-2,3-dihydrothien-2,2-diyl, 1,1-dioxo-2,3-dihydrothien-3,3-diyl, 1,1-dioxo-2,5-dihydrothien-2,2-diyl, 2,3-dihydro-1 H-pyrrol-2,2-diyl, 2,3-dihydro-1 H-pyrrol-3,3-diyl, 2,5-dihydro-1 H-pyrrol-2,2-diyl, 1,3-dioxol-2,2-diyl, 1,3-dioxol-4,4-diyl, 1,3-dithiol-2,2-diyl, 1,3-dithiol-4,4-diyl, 1,3-oxathiol-2,2-diyl, 1,3-oxathiol-4,4-diyl, 1,3-oxathiol-5,5-diyl, 2,3-dihydro-1 H-pyrazol-3,3-diyl, 2,5-dihydro-1 H-imidazol-2,2-diyl, 2,5-dihydro-1 H-imidazol-5,5-diyl, 2,3-dihydrooxazol-2,2-diyl, 2,5-dihydrooxazol-2,2-diyl, 2,5-dihydrooxazol-5,5-diyl, 4,5-dihydrooxazol-4,4-diyl, 4,5-dihydrooxazol-5,5-diyl, 2,3-dihydroisoxazol-3,3-diyl, 2,5-dihydroisoxazol-2,2-diyl, 4,5-dihydroisoxazol-4,4-diyl, 4,5-dihydroisoxazol-5,5-diyl, 2,3-dihydrothiazol-2,2-diyl, 2,5-dihydrothiazol-2,2-diyl, 2,5-dihydrothiazol-5,5-diyl, 4,5-dihydrothiazol-4,4-diyl, 4,5-dihydrothiazol-5,5-diyl, 2,3-dihydroisothiazol-3,3-diyl, 2,5-dihydroisothiazol-2,2-diyl, 4,5-dihydroisothiazol-4,4-diyl, 4,5-dihydroisothiazol-5,5-diyl, 3,6-dihydro-2H-pyran-2,2-diyl, 3,6-dihydro-2H-pyran-3,3-diyl, 3,6-dihydro-2H-pyran-6,6-diyl, 3,4-dihydro-2H-pyran-4,4-diyl, 3,4-dihydro-2H-pyran-5,5-diyl, 3,4-dihydro-2H-pyran-6,6-diyl, 3,6-dihydro-2H-thiopyran-2,2-diyl, 3,6-dihydro-2H-thiopyran-3,3-diyl, 3,6-dihydro-2H-thiopyran-6,6-diyl, 3,4-dihydro-2H-thiopyran-4,4-diyl, 3,4-dihydro-2H-thiopyran-5,5-diyl, 3,4-dihydro-2H-thiopyran-6,6-diyl, 1,2,3,4-tetrahydropyridin-2,2-diyl, 1,2,3,4-tetrahydropyridin-3,3-diyl, 1,2,3,4-tetrahydropyridin-4,4-diyl, 1,2,3,6-tetrahydropyridin-2,2-diyl, 1,2,3,6-tetrahydropyridin-3,3-diyl, 1,2,3,6-tetrahydropyridin-6,6-diyl, 1,2-dihydropyridin-2,2-diyl, 1,4-dihydropyridin-4,4-diyl and the like.

Bicyclic rings W contain two rings which have at least one ring atom in common. The term comprises condensed (fused) ring systems, in which the two rings have two neighboring ring atoms in common, as well as spiro systems, in which the rings have only one ring atom in common, and bridged systems with at least three ring atoms in common. The bicyclic rings are heterocyclic, containing at least one heteroatom or heteroatom group selected from N, O and S as ring member(s). The bicyclic rings W have generally 5 to 8 ring members.

Examples for saturated 5- to 8-membered bicyclic condensed heterocyclic rings are:

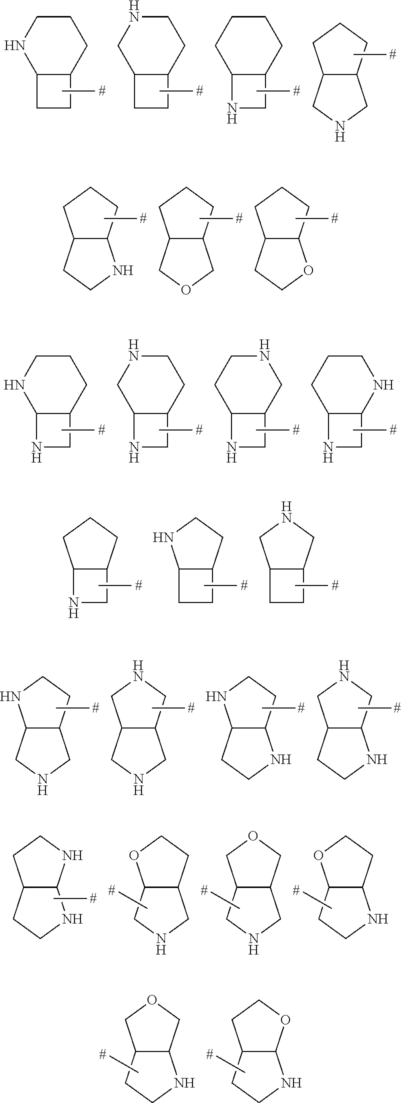

Examples for saturated 5- to 8-membered bicyclic spirocyclic heterocyclic rings are:

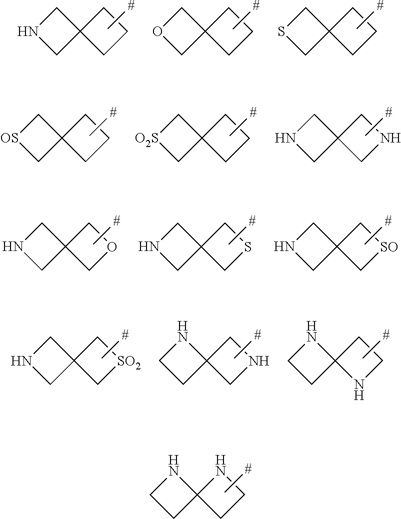

Examples for saturated 5- to 8-membered bicyclic bridged heterocyclic rings are:

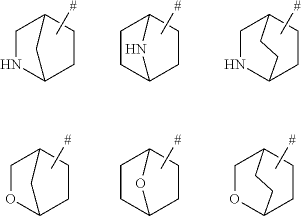

Examples for partly unsaturated 5- to 8-membered bicyclic bridged heterocyclic rings are:

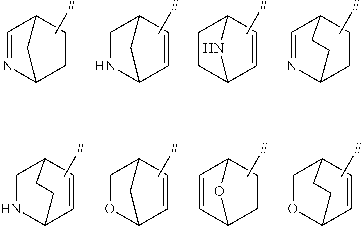

In the above structures #denotes the attachment point of ring W to the two C(O) groups. The attachment point is not restricted to the ring on which this is shown, but can be on either of the two rings. Since W is attached to two carbon atoms, the at-tachment point is on a carbon atom shown as CH₂ in the above structures. If the rings carry one or more substituents, these may be bound to carbon and/or to nitrogen ring atoms.

The preferred embodiments of the invention mentioned herein below have to be under-stood as being preferred either independently from each other or in combination with one another. The remarks made to the variables of compounds (I) apply both in context with their use, with the method of using them, with compositions containing them as well as to compounds (I) as such, unless these are defined more specifically (especial-ly with respect to R⁹ or R^{b}).
R¹ is preferably hydrogen or (C₁-C₃)-alkyl, and is more preferably hydrogen.
R² is preferably hydrogen, halogen or (C₁-C₃)-alkyl, and is more preferably hydrogen.
R⁶ is preferably hydrogen, halogen or (C₁-C₃)-alkyl, and is more preferably hydrogen.

### Preferably,

R² is hydrogen, halogen, or (C₁-C₃)-alkyl; and
R⁶ is hydrogen, halogen, or (C₁-C₃)-alkyl.
   More preferably,
R² is hydrogen; and
R⁶ is hydrogen.

Preferably, R³ is hydrogen, halogen, cyano, (C₁-C₃)-alkyl, (C₁-C₃)-haloalkyl, (C₁-C₃)-alkoxy or (C₁-C₃)-haloalkoxy, more preferably halogen or (C₁-C₃)-haloalkoxy, and in particular halogen.

Preferably, R⁵ is hydrogen, halogen, cyano, (C₁-C₃)-alkyl, (C₁-C₃)-haloalkyl, (C₁-C₃)-alkoxy or (C₁-C₃)-haloalkoxy, more preferably hydrogen or halogen, and in particular halogen.

### Preferably,

R³ is hydrogen, halogen, cyano, (C₁-C₃)-alkyl, (C₁-C₃)-haloalkyl, (C₁-C₃)-alkoxy or (C₁-C₃)-haloalkoxy; and
R⁵ is hydrogen, halogen, cyano, (C₁-C₃)-alkyl, (C₁-C₃)-haloalkyl, (C₁-C₃)-alkoxy or (C₁-C₃)-haloalkoxy.

### More Preferably,

R³ is halogen or (C₁-C₃)-haloalkoxy; and
R⁵ is hydrogen or halogen.

### In Particular,

R³ is halogen; and
R⁵ is halogen.

### Specifically,

R³ is F or C₁; and
R⁵ is F or C₁.

Preferably, R⁴ is hydrogen or halogen, and is more preferably hydrogen.

In particular, R², R⁴ and R⁶ are hydrogen, and R³ and R⁵ are halogen.

Preferably, R⁷ and R⁸ form, together with the carbon atom to which they are bound, a saturated or partially unsaturated 4-, 5- or 6-membered monocyclic heterocyclic ring W or a saturated or partially unsaturated 7- or 8-membered bicyclic heterocyclic ring W, where ring W contains, in addition to this carbon atom, q carbon atoms, u oxygen at-oms, v nitrogen atoms, and w sulfur atoms as ring members, where the sum of u, v and w is 1 or 2, and where ring W is substituted by n radicals R^{b}.

Examples for such rings W are

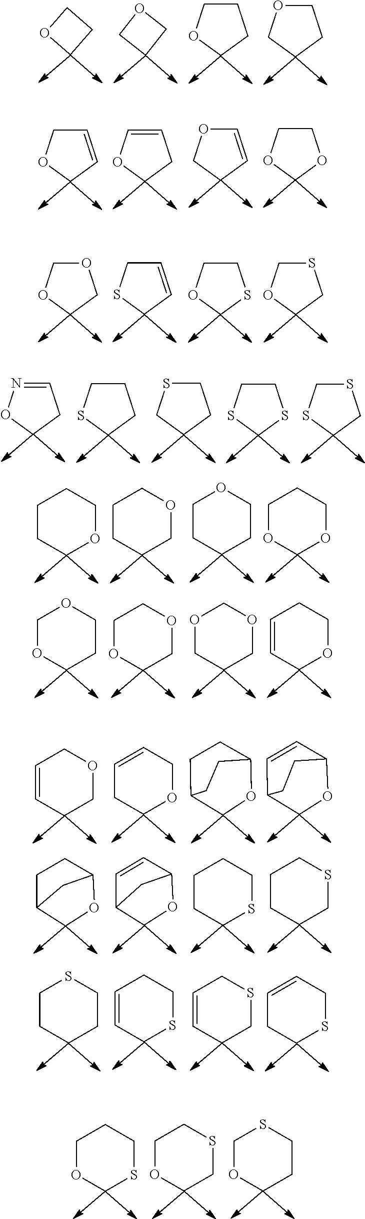

The arrows denote the bonds to the two C(O) groups. Possible substituents R^{b} are not shown. They can be bound to a carbon ring atom or to a secondary nitrogen ring atom (the latter not exemplified in the above ring structures).

### Preferably,

u is 1 or 2, v is 0 and w is 0; or
u is 1, v is 1 and w is 0; or
u is 1, v is 0 and w is 1; or
u is, v is and w is.

More preferably, R⁷ and R⁸ form, together with the carbon atom to which they are bound, a saturated or partially unsaturated 4-, 5- or 6-membered monocyclic heterocy-clic ring W containing 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or ^{R} and R⁸ form, together with the carbon atom to which they are bound, a saturated or oartially unsaturated 7- or 8-membered bicyclic heterocyclic ring W containing 1 oxy-gen atom as ring members, the remaining ring members being carbon atoms, and where the ring is substituted by n radicals R^{b}, where n is 0, 1 or 2.

In particular, R⁷ and R⁸ form, together with the carbon atom to which they are bound, a saturated or partially unsaturated 4- or 5-membered monocyclic heterocyclic ring W containing 1 oxygen atom as ring member, the remaining ring members being carbon atoms, and where the ring is substituted by n radicals R^{b}, where n is 0 or 1.

Preferably, each R^{b} is independently (C₁-C₃)-alkyl or (C₁-C₃)-haloalkyl; or two R^{b}, bound on the same carbon atom, form a methylene group (═CH₂). More preferably, each R^{b} is independently (C₁-C₂)-alkyl or (C₁-C₂)-haloalkyl; or two R^{b}, bound on the same carbon atom, form a methylene group (═CH₂). In particular, each R^{b} is independently (C₁-C₂)-alkyl or (C₁-C₂)-haloalkyl.

Preferably, R⁹ is hydrogen, (C₁-C₆)-alkyl, (C₃-C₆)-cycloalkyl, (C₃-C₆)-cycloalkyl-(C₁-C₃)-alkyl, phenyl-(C₁-C₃)-alkyl or (C₁-C₄)-alkyl substituted by m radicals selected from the group consisting of fluorine, chlorine, bromine, cyano, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5- or 6-membered heteroaromatic ring containing 1, 2 or 3 heteroatoms selected from N, O and S as ring members; where m is 1, 2 or 3.

More preferably, R⁹ is hydrogen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members. The 5-membered heteroaromatic ring is preferably furanyl.

In particular, R⁹ is hydrogen, (C₁-C₃)-alkyl, (C₃-C₄)-cycloalkyl, (C₃-C₄)-cycloalkyl-(C₁-C₂)-alkyl, phenyl-(C₁-C₂)-alkyl or (C₁-C₃)-alkyl substituted by 1, 2 or 3 fluorine or chlo-rine atoms or by 1 radical selected from the group consisting of (C₁-C₃)-alkoxy, (C₁-C₃)-alkylthio, (C₁-C₃)-alkylsulfonyl, phenylthio and furanyl.

Examples for rings W wherein R⁷ and R⁸ form, together with the carbon atom to which they are bound, a saturated or partially unsaturated 4-, 5- or 6-membered monocyclic heterocyclic ring W containing 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or R⁷ and R⁸ form, together with the carbon atom to which they are bound, a saturated or partially unsaturated 7- or 8-membered bicyclic heterocyclic ring W containing 1 oxygen atom as ring members, the remaining ring members being carbon atoms, and where the ring is substituted by n radicals R^{b}, where n is 0, 1 or 2, and where each R^{b} is independently (C₁-C₂)-alkyl or (C₁-C₂)-haloalkyl or two R^{b}, bound on the same carbon atom, form a methylene group (═CH₂); are:

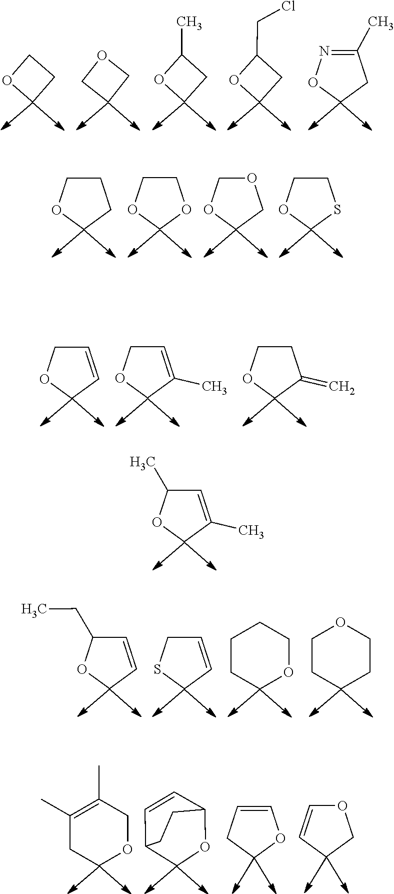

The compounds of formula (1) of the present invention may comprise a stereogenic center (*) depending on the structure of the ring W (the ring must not contain a mirror axis for the carbon atom carrying R⁷ and R⁸ to be a stereogenic center), as exemplified below:

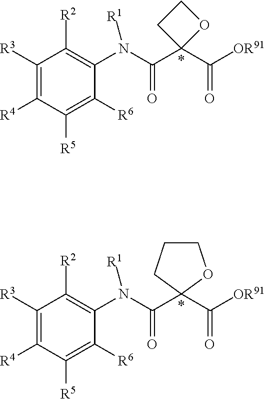

Accordingly, if the carbon atom to which R⁷ and R⁸ are bound to form a ring W is a ste-reogenic center, the compounds of formula (1) exist in two stereoisomeric forms (if no further stereogenic center is present; otherwise, the compounds of formula (1) exist in more than two stereoisomeric forms, of course; to be more precise in 2ⁿ stereoisomeric forms, n being the number of stereogenic centers in the molecule - provided no meso form is present). All stereoisomers as well as mixtures thereof are also part of the pre-sent invention.

In a particular embodiment, the substituents have the following meaning:
R¹ is hydrogen or (C₁-C₃)-alkyl; preferably hydrogen;
R² is hydrogen, halogen or (C₁-C₃)-alkyl;
R³ is hydrogen, halogen, cyano, (C₁-C₃)-alkyl, (C₁-C₃)-haloalkyl, (C₁-C₃)-alkoxy or (C₁-C₃)-haloalkoxy;
R⁴ is hydrogen or halogen; preferably hydrogen;
R⁵ is hydrogen, halogen, cyano, (C₁-C₃)-alkyl, (C₁-C₃)-haloalkyl, (C₁-C₃)-alkoxy or (C₁-C₃)-haloalkoxy;
R⁶ is hydrogen, halogen or (C₁-C₃)-alkyl;
R⁷ and R⁸ form, together with the carbon atom to which they are bound, a saturated or partially unsaturated 4-, 5- or 6-membered monocyclic heterocyclic ring W or a saturated or partially unsaturated 7- or 8-membered bicyclic heterocyclic ring W, where ring W contains, in addition to this carbon atom, q carbon atoms, u oxygen atoms, v nitrogen atoms, and w sulfur atoms as ring members, where the sum of u, v and w is 1 or 2, and where ring W is substituted by n radicals R^{b};
R⁹ is hydrogen, (C₁-C₆)-alkyl, (C₃-C₆)-cycloalkyl, (C₃-C₆)-cycloalkyl-(C₁-C₃)-alkyl, phenyl-(C₁-C₃)-alkyl or (C₁-C₄)-alkyl substituted by m radicals selected from the group consisting of fluorine, chlorine, bromine, cyano, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5- or 6-membered heteroaromatic ring containing 1, 2 or 3 heteroatoms selected from N, O and S as ring members; where m is 1, 2 or 3.
   More Particularly, the Substituents have the Following Meaning:
R¹ is hydrogen;
R² is hydrogen;
R³ is halogen or (C₁-C₃)-haloalkoxy;
R⁴ is hydrogen;
R⁵ is hydrogen or halogen;
R⁶ is hydrogen;
R⁷ and R⁸ form, together with the carbon atom to which they are bound, a saturated or partially unsaturated 4-, 5- or 6-membered monocyclic heterocyclic ring W con-taining 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or R⁷ and R⁸ form, together with the carbon atom to which they are bound, a satu-rated or partially unsaturated 7- or 8-membered bicyclic heterocyclic ring W con-taining 1 oxygen atom as ring member, the remaining ring members being carbon atoms, and where the ring is substituted by n radicals R^{b}, where n is 0, 1 or 2; where
each R^{b} is independently (C₁-C₃)-alkyl or (C₁-C₃)-haloalkyl; or two R^{b}, bound on the same carbon atom, form a methylene group (═CH₂); and R⁹ is hydrogen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members (where the 5-membered heteroaromatic ring is preferably furanyl);
where R⁹ is preferably hydrogen, (C₁-C₃)-alkyl, (C₃-C₄)-cycloalkyl, (C₃-C₄)-cycloalkyl-(C₁-C₂)-alkyl, phenyl-(C₁-C₂)-alkyl or (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl.
   Specifically, the Substituents have the Following Meaning:
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated or partially unsaturated 4- or 5-membered monocyclic heterocyclic ring W containing 1 oxygen atom as ring member, the remaining ring members being carbon at-oms, and where the ring is substituted by n radicals R^{b}, where n is 0 or 1; where
each R^{b} is independently (C₁-C₃)-alkyl or (C₁-C₃)-haloalkyl; and
R⁹ is hydrogen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members (where the 5-membered heteroaromatic ring is preferably furanyl;
where R⁹ is preferably hydrogen, (C₁-C₃)-alkyl, (C₃-C₄)-cycloalkyl, (C₃-C₄)-cycloalkyl-(C₁-C₂)-alkyl, phenyl-(C₁-C₂)-alkyl or (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl.
   More Specifically, the Substituents have the Following Meaning:
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated 4-membered monocyclic heterocyclic ring W containing 1 oxygen atom as ring member, the remaining ring members being carbon atoms, or a partially unsatu-rated 5-membered monocyclic heterocyclic ring W containing 1 oxygen atom as ring member, the remaining ring members being carbon atoms, and where the ring W is substituted by n radicals R^{b}, where n is 0 or 1; where
each R^{b} is independently (C₁-C₃)-alkyl or (C₁-C₃)-haloalkyl; and
R⁹ is hydrogen, (C₁-C₃)-alkyl, (C₃-C₄)-cycloalkyl, (C₃-C₄)-cycloalkyl-(C₁-C₂)-alkyl, phenyl-(C₁-C₂)-alkyl or (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl.

In the context of the present invention, compounds of the formula (1), wherein R¹, R² and R⁶ are hydrogen and R³, R⁴, R⁵ and W (W is formed by R⁷ and R⁸ together with the carbon atom to which they are bound) have the meanings as defined lines in 1 to 3696 of Table 1 below, are particularly preferred. In case the carbon atom to which R⁷ and R⁸ are bound to form W is a center of chirality, both enantiomers are subject of this invention as well as mixtures thereof.

TABLE 1

| Cpd. | R³ | R⁴ | R | W ^{*)} |
|---|---|---|---|---|
| 1. | H | H | H | A.1 |
| 2. | F | H | H | A.1 |
| 3. | Cl | H | H | A.1 |
| 4. | Br | H | H | A.1 |
| 5. | I | H | H | A.1 |
| 6. | CN | H | H | A.1 |
| 7. | CH₃ | H | H | A.1 |
| 8. | CF₃ | H | H | A.1 |
| 9. | OCH₃ | H | H | A.1 |
| 10. | OCF₃ | H | H | A.1 |
| 11. | CH₂CH₃ | H | H | A.1 |
| 12. | H | F | H | A.1 |
| 13. | F | F | H | A.1 |
| 14. | Cl | F | H | A.1 |
| 15. | Br | F | H | A.1 |
| 16. | I | F | H | A.1 |
| 17. | CN | F | H | A.1 |
| 18. | CH₃ | F | H | A.1 |
| 19. | CF₃ | F | H | A.1 |
| 20. | OCH₃ | F | H | A.1 |
| 21. | OCF₃ | F | H | A.1 |
| 22. | CH₂CH₃ | F | H | A.1 |
| 23. | H | Cl | H | A.1 |
| 24. | F | Cl | H | A.1 |
| 25. | Cl | Cl | H | A.1 |
| 26. | Br | Cl | H | A.1 |
| 27. | I | Cl | H | A.1 |
| 28. | CN | Cl | H | A.1 |
| 29. | CH₃ | Cl | H | A.1 |
| 30. | CF₃ | Cl | H | A.1 |
| 31. | OCH₃ | Cl | H | A.1 |
| 32. | OCF₃ | Cl | H | A.1 |
| 33. | CH₂CH₃ | Cl | H | A.1 |
| 34. | H | H | F | A.1 |
| 35. | F | H | F | A.1 |
| 36. | Cl | H | F | A.1 |
| 37. | Br | H | F | A.1 |
| 38. | I | H | F | A.1 |
| 39. | CN | H | F | A.1 |
| 40. | CH₃ | H | F | A.1 |
| 41. | CF₃ | H | F | A.1 |
| 42. | OCH₃ | H | F | A.1 |
| 43. | OCF₃ | H | F | A.1 |
| 44. | CH₂CH₃ | H | F | A.1 |
| 45. | H | F | F | A.1 |
| 46. | F | F | F | A.1 |
| 47. | Cl | F | F | A.1 |
| 48. | Br | F | F | A.1 |
| 49. | I | F | F | A.1 |
| 50. | CN | F | F | A.1 |
| 51. | CH₃ | F | F | A.1 |
| 52. | CF₃ | F | F | A.1 |
| 53. | OCH₃ | F | F | A.1 |
| 54 | OCF₃ | F | F | A.1 |
| 55. | CH₂CH₃ | F | F | A.1 |
| 56. | H | Cl | F | A.1 |
| 57. | F | Cl | F | A.1 |
| 58. | Cl | Cl | F | A.1 |
| 59. | Br | Cl | F | A.1 |
| 60. | I | Cl | F | A.1 |
| 61. | CN | Cl | F | A.1 |
| 62. | CH₃ | Cl | F | A.1 |
| 63. | CF₃ | Cl | F | A.1 |
| 64. | OCH₃ | Cl | F | A.1 |
| 65. | OCF₃ | Cl | F | A.1 |
| 66. | CH₂CH₃ | Cl | F | A.1 |
| 67. | H | H | Cl | A.1 |
| 68. | F | H | Cl | A.1 |
| 69. | Cl | H | Cl | A.1 |
| 70. | Br | H | Cl | A.1 |
| 71. | I | H | Cl | A.1 |
| 72. | CN | H | Cl | A.1 |
| 73. | CH₃ | H | Cl | A.1 |
| 74. | CF₃ | H | Cl | A.1 |
| 75. | OCH₃ | H | Cl | A.1 |
| 76 | OCF₃ | H | Cl | A.1 |
| 77 | CH₂CH₃ | H | Cl | A.1 |
| 78. | H | F | Cl | A.1 |
| 79. | F | F | Cl | A.1 |
| 80 | Cl | F | Cl | A.1 |
| 81. | Br | F | Cl | A.1 |
| 82. | I | F | Cl | A.1 |
| 83. | CN | F | Cl | A.1 |
| 84. | CH₃ | F | Cl | A.1 |
| 85 | CF₃ | F | Cl | A.1 |
| 86. | OCH₃ | F | Cl | A.1 |
| 87. | OCF₃ | F | Cl | A.1 |
| 88. | CH₂CH₃ | F | Cl | A.1 |
| 89. | H | Cl | Cl | A.1 |
| 90. | F | Cl | Cl | A.1 |
| 91. | Cl | Cl | Cl | A.1 |
| 92 | Br | Cl | Cl | A.1 |
| 93. | I | Cl | Cl | A.1 |
| 94. | CN | Cl | Cl | A.1 |
| 95. | CH₃ | Cl | Cl | A.1 |
| 96. | CF₃ | Cl | Cl | A.1 |
| 97. | OCH₃ | Cl | Cl | A.1 |
| 98. | OCF₃ | Cl | Cl | A.1 |
| 99. | CH₂CH₃ | Cl | Cl | A.1 |
| 100. | H | H | Br | A.1 |
| 101. | F | H | Br | A.1 |
| 102. | Cl | H | Br | A.1 |
| 103. | Br | H | Br | A.1 |
| 104. | I | H | Br | A.1 |
| 105. | CN | H | Br | A.1 |
| 106. | CH₃ | H | Br | A.1 |
| 107. | CF₃ | H | Br | A.1 |
| 108. | OCH₃ | H | Br | A.1 |
| 109. | OCF₃ | H | Br | A.1 |
| 110. | CH₂CH₃ | H | Br | A.1 |
| 111. | H | F | Br | A.1 |
| 112. | F | F | Br | A.1 |
| 113. | Cl | F | Br | A.1 |
| 114. | Br | F | Br | A.1 |
| 115. | I | F | Br | A.1 |
| 116. | CN | F | Br | A.1 |
| 117. | CH₃ | F | Br | A.1 |
| 118. | CF₃ | F | Br | A.1 |
| 119. | OCH₃ | F | Br | A.1 |
| 120. | OCF₃ | F | Br | A.1 |
| 121. | CH₂CH₃ | F | Br | A.1 |
| 122. | H | Cl | Br | A.1 |
| 123. | F | Cl | Br | A.1 |
| 124. | Cl | Cl | Br | A.1 |
| 125. | Br | Cl | Br | A.1 |
| 126. | I | Cl | Br | A.1 |
| 127. | CN | Cl | Br | A.1 |
| 128. | CH₃ | Cl | Br | A.1 |
| 129. | CF₃ | Cl | Br | A.1 |
| 130. | OCH₃ | Cl | Br | A.1 |
| 131. | OCF₃ | Cl | Br | A.1 |
| 132. | CH₂CH₃ | Cl | Br | A.1 |
| 133. | H | H | I | A.1 |
| 134. | F | H | I | A.1 |
| 135. | Cl | H | I | A.1 |
| 136. | Br | H | I | A.1 |
| 137. | I | H | I | A.1 |
| 138. | CN | H | I | A.1 |
| 139. | CH₃ | H | I | A.1 |
| 140. | CF₃ | H | I | A.1 |
| 141. | OCH₃ | H | I | A.1 |
| 142. | OCF₃ | H | I | A.1 |
| 143. | CH₂CH₃ | H | I | A.1 |
| 144. | H | F | I | A.1 |
| 145. | F | F | I | A.1 |
| 146. | Cl | F | I | A.1 |
| 147. | Br | F | I | A.1 |
| 148. | I | F | I | A.1 |
| 149. | CN | F | I | A.1 |
| 150. | CH₃ | F | I | A.1 |
| 151. | CF₃ | F | I | A.1 |
| 152. | OCH₃ | F | I | A.1 |
| 153. | OCF₃ | F | I | A.1 |
| 154. | CH₂CH₃ | F | I | A.1 |
| 155. | H | Cl | I | A.1 |
| 156. | F | Cl | I | A.1 |
| 157. | Cl | Cl | I | A.1 |
| 158. | Br | Cl | I | A.1 |
| 159. | I | Cl | I | A.1 |
| 160. | CN | Cl | I | A.1 |
| 161. | CH₃ | Cl | I | A.1 |
| 162. | CF₃ | Cl | I | A.1 |
| 163. | OCH₃ | Cl | I | A.1 |
| 164. | OCF₃ | Cl | I | A.1 |
| 165. | CH₂CH₃ | Cl | I | A.1 |
| 166. | H | H | CN | A.1 |
| 167. | F | H | CN | A.1 |
| 168. | Cl | H | CN | A.1 |
| 169. | Br | H | CN | A.1 |
| 170. | I | H | CN | A.1 |
| 171. | CN | H | CN | A.1 |
| 172. | CH₃ | H | CN | A.1 |
| 173. | CF₃ | H | CN | A.1 |
| 174. | OCH₃ | H | CN | A.1 |
| 175. | OCF₃ | H | CN | A.1 |
| 176. | CH₂CH₃ | H | CN | A.1 |
| 177. | H | F | CN | A.1 |
| 178. | F | F | CN | A.1 |
| 179. | Cl | F | CN | A.1 |
| 180. | Br | F | CN | A.1 |
| 181. | I | F | CN | A.1 |
| 182. | CN | F | CN | A.1 |
| 183. | CH₃ | F | CN | A.1 |
| 184. | CF₃ | F | CN | A.1 |
| 185. | OCH₃ | F | CN | A.1 |
| 186. | OCF₃ | F | CN | A.1 |
| 187. | CH₂CH₃ | F | CN | A.1 |
| 188. | H | Cl | CN | A.1 |
| 189. | F | Cl | CN | A.1 |
| 190. | Cl | Cl | CN | A.1 |
| 191. | Br | Cl | CN | A.1 |
| 192. | I | Cl | CN | A.1 |
| 193. | CN | Cl | CN | A.1 |
| 194. | CH₃ | Cl | CN | A.1 |
| 195. | CF₃ | Cl | CN | A.1 |
| 196. | OCH₃ | Cl | CN | A.1 |
| 197. | OCF₃ | Cl | CN | A.1 |
| 198. | CH₂CH₃ | Cl | CN | A.1 |
| 199. | H | H | CH₃ | A.1 |
| 200. | F | H | CH₃ | A.1 |
| 201. | Cl | H | CH₃ | A.1 |
| 202. | Br | H | CH₃ | A.1 |
| 203. | I | H | CH₃ | A.1 |
| 204. | CN | H | CH₃ | A.1 |
| 205. | CH₃ | H | CH₃ | A.1 |
| 206. | CF₃ | H | CH₃ | A.1 |
| 207. | OCH₃ | H | CH₃ | A.1 |
| 208. | OCF₃ | H | CH₃ | A.1 |
| 209. | CH₂CH₃ | H | CH₃ | A.1 |
| 210. | H | F | CH₃ | A.1 |
| 211. | F | F | CH₃ | A.1 |
| 212. | Cl | F | CH₃ | A.1 |
| 213. | Br | F | CH₃ | A.1 |
| 214. | I | F | CH₃ | A.1 |
| 215. | CN | F | CH₃ | A.1 |
| 216. | CH₃ | F | CH₃ | A.1 |
| 217. | CF₃ | F | CH₃ | A.1 |
| 218. | OCH₃ | F | CH₃ | A.1 |
| 219. | OCF₃ | F | CH₃ | A.1 |
| 220. | CH₂CH₃ | F | CH₃ | A.1 |
| 221. | H | Cl | CH₃ | A.1 |
| 222. | F | Cl | CH₃ | A.1 |
| 223. | Cl | Cl | CH₃ | A.1 |
| 224. | Br | Cl | CH₃ | A.1 |
| 225. | I | Cl | CH₃ | A.1 |
| 226. | CN | Cl | CH₃ | A.1 |
| 227. | CH₃ | Cl | CH₃ | A.1 |
| 228. | CF₃ | Cl | CH₃ | A.1 |
| 229. | OCH₃ | Cl | CH₃ | A.1 |
| 230. | OCF₃ | Cl | CH₃ | A.1 |
| 231. | CH₂CH₃ | Cl | CH₃ | A.1 |
| 232. | H | H | H | A.2 |
| 233. | F | H | H | A.2 |
| 234. | Cl | H | H | A.2 |
| 235. | Br | H | H | A.2 |
| 236. | I | H | H | A.2 |
| 237. | CN | H | H | A.2 |
| 238. | CH₃ | H | H | A.2 |
| 239. | CF₃ | H | H | A.2 |
| 240. | OCH₃ | H | H | A.2 |
| 241. | OCF₃ | H | H | A.2 |
| 242. | CH₂CH₃ | H | H | A.2 |
| 243. | H | F | H | A.2 |
| 244. | F | F | H | A.2 |
| 245. | Cl | F | H | A.2 |
| 246. | Br | F | H | A.2 |
| 247. | I | F | H | A.2 |
| 248. | CN | F | H | A.2 |
| 249. | CH₃ | F | H | A.2 |
| 250. | CF₃ | F | H | A.2 |
| 251. | OCH₃ | F | H | A.2 |
| 252. | OCF₃ | F | H | A.2 |
| 253. | CH₂CH₃ | F | H | A.2 |
| 254. | H | Cl | H | A.2 |
| 255. | F | Cl | H | A.2 |
| 256. | Cl | Cl | H | A.2 |
| 257. | Br | Cl | H | A.2 |
| 258. | I | Cl | H | A.2 |
| 259. | CN | Cl | H | A.2 |
| 260. | CH₃ | Cl | H | A.2 |
| 261. | CF₃ | Cl | H | A.2 |
| 262. | OCH₃ | Cl | H | A.2 |
| 263. | OCF₃ | Cl | H | A.2 |
| 264. | CH₂CH₃ | Cl | H | A.2 |
| 265. | H | H | F | A.2 |
| 266. | F | H | F | A.2 |
| 267. | Cl | H | F | A.2 |
| 268. | Br | H | F | A.2 |
| 269. | I | H | F | A.2 |
| 270. | CN | H | F | A.2 |
| 271. | CH₃ | H | F | A.2 |
| 272. | CF₃ | H | F | A.2 |
| 273. | OCH₃ | H | F | A.2 |
| 274. | OCF₃ | H | F | A.2 |
| 275. | CH₂CH₃ | H | F | A.2 |
| 276. | H | F | F | A.2 |
| 277. | F | F | F | A.2 |
| 278. | Cl | F | F | A.2 |
| 279. | Br | F | F | A.2 |
| 280. | I | F | F | A.2 |
| 281. | CN | F | F | A.2 |
| 282. | CH₃ | F | F | A.2 |
| 283. | CF₃ | F | F | A.2 |
| 284. | OCH₃ | F | F | A.2 |
| 285. | OCF₃ | F | F | A.2 |
| 286. | CH₂CH₃ | F | F | A.2 |
| 287. | H | Cl | F | A.2 |
| 288. | F | Cl | F | A.2 |
| 289. | Cl | Cl | F | A.2 |
| 290. | Br | Cl | F | A.2 |
| 291. | I | Cl | F | A.2 |
| 292. | CN | Cl | F | A.2 |
| 293. | CH₃ | Cl | F | A.2 |
| 294. | CF₃ | Cl | F | A.2 |
| 295. | OCH₃ | Cl | F | A.2 |
| 296. | OCF₃ | Cl | F | A.2 |
| 297. | CH₂CH₃ | Cl | F | A.2 |
| 298. | H | H | Cl | A.2 |
| 299. | F | H | Cl | A.2 |
| 300. | Cl | H | Cl | A.2 |
| 301. | Br | H | Cl | A.2 |
| 302. | I | H | Cl | A.2 |
| 303. | CN | H | Cl | A.2 |
| 304. | CH₃ | H | Cl | A.2 |
| 305. | CF₃ | H | Cl | A.2 |
| 306. | OCH₃ | H | Cl | A.2 |
| 307. | OCF₃ | H | Cl | A.2 |
| 308. | CH₂CH₃ | H | Cl | A.2 |
| 309. | H | F | Cl | A.2 |
| 310. | F | F | Cl | A.2 |
| 311. | Cl | F | Cl | A.2 |
| 312. | Br | F | Cl | A.2 |
| 313. | I | F | Cl | A.2 |
| 314. | CN | F | Cl | A.2 |
| 315. | CH₃ | F | Cl | A.2 |
| 316. | CF₃ | F | Cl | A.2 |
| 317. | OCH₃ | F | Cl | A.2 |
| 318. | OCF₃ | F | Cl | A.2 |
| 319. | CH₂CH₃ | F | Cl | A.2 |
| 320. | H | Cl | Cl | A.2 |
| 321. | F | Cl | Cl | A.2 |
| 322. | Cl | Cl | Cl | A.2 |
| 323. | Br | Cl | Cl | A.2 |
| 324. | I | Cl | Cl | A.2 |
| 325. | CN | Cl | Cl | A.2 |
| 326. | CH₃ | Cl | Cl | A.2 |
| 327. | CF₃ | Cl | Cl | A.2 |
| 328. | OCH₃ | Cl | Cl | A.2 |
| 329. | OCF₃ | Cl | Cl | A.2 |
| 330. | CH₂CH₃ | Cl | Cl | A.2 |
| 331. | H | H | Br | A.2 |
| 332. | F | H | Br | A.2 |
| 333. | Cl | H | Br | A.2 |
| 334. | Br | H | Br | A.2 |
| 335. | I | H | Br | A.2 |
| 336. | CN | H | Br | A.2 |
| 337. | CH₃ | H | Br | A.2 |
| 338. | CF₃ | H | Br | A.2 |
| 339. | OCH | H | Br | A.2 |
| 340. | OCF₃ | H | Br | A.2 |
| 341. | CH₂CH₃ | H | Br | A.2 |
| 342. | H | F | Br | A.2 |
| 343. | F | F | Br | A.2 |
| 344. | Cl | F | Br | A.2 |
| 345. | Br | F | Br | A.2 |
| 346. | I | F | Br | A.2 |
| 347. | CN | F | Br | A.2 |
| 348. | CH₃ | F | Br | A.2 |
| 349. | CF₃ | F | Br | A.2 |
| 350. | OCH₃ | F | Br | A.2 |
| 351. | OCF₃ | F | Br | A.2 |
| 352. | CH₂CH₃ | F | Br | A.2 |
| 353. | H | Cl | Br | A.2 |
| 354. | F | Cl | Br | A.2 |
| 355. | Cl | Cl | Br | A.2 |
| 356. | Br | Cl | Br | A.2 |
| 357. | I | Cl | Br | A.2 |
| 358. | CN | Cl | Br | A.2 |
| 359. | CH₃ | Cl | Br | A.2 |
| 360. | CF₃ | Cl | Br | A.2 |
| 361. | OCH₃ | Cl | Br | A.2 |
| 362. | OCF₃ | Cl | Br | A.2 |
| 363. | CH₂CH₃ | Cl | Br | A.2 |
| 364. | H | H | I | A.2 |
| 365. | F | H | I | A.2 |
| 366. | Cl | H | I | A.2 |
| 367. | Br | H | I | A.2 |
| 368. | I | H | I | A.2 |
| 369. | CN | H | I | A.2 |
| 370. | CH₃ | H | I | A.2 |
| 371. | CF₃ | H | I | A.2 |
| 372. | OCH₃ | H | I | A.2 |
| 373. | OCF₃ | H | I | A.2 |
| 374. | CH₂CH₃ | H | I | A.2 |
| 375. | H | F | I | A.2 |
| 376. | F | F | I | A.2 |
| 377. | Cl | F | I | A.2 |
| 378. | Br | F | I | A.2 |
| 379. | I | F | I | A.2 |
| 380. | CN | F | I | A.2 |
| 381. | CH₃ | F | I | A.2 |
| 382. | CF₃ | F | I | A.2 |
| 383. | OCH₃ | F | I | A.2 |
| 384. | OCF₃ | F | I | A.2 |
| 385. | CH₂CH₃ | F | I | A.2 |
| 386. | H | Cl | I | A.2 |
| 387. | F | Cl | I | A.2 |
| 388. | Cl | Cl | I | A.2 |
| 389. | Br | Cl | I | A.2 |
| 390. | 1 | Cl | I | A.2 |
| 391. | CN | Cl | I | A.2 |
| 392. | CH₃ | Cl | I | A.2 |
| 393. | CF₃ | Cl | I | A.2 |
| 394. | OCH₃ | Cl | I | A.2 |
| 395. | OCF₃ | Cl | I | A.2 |
| 396. | CH₂CH₃ | Cl | I | A.2 |
| 397. | H | H | CN | A.2 |
| 398. | F | H | CN | A.2 |
| 399. | Cl | H | CN | A.2 |
| 400. | Br | H | CN | A.2 |
| 401. | I | H | CN | A.2 |
| 402. | CN | H | CN | A.2 |
| 403. | CH₃ | H | CN | A.2 |
| 404. | CF₃ | H | CN | A.2 |
| 405. | OCH₃ | H | CN | A.2 |
| 406. | OCF₃ | H | CN | A.2 |
| 407. | CH₂CH₃ | H | CN | A.2 |
| 408. | H | F | CN | A.2 |
| 409. | F | F | CN | A.2 |
| 410. | Cl | F | CN | A.2 |
| 411. | Br | F | CN | A.2 |
| 412. | I | F | CN | A.2 |
| 413. | CN | F | CN | A.2 |
| 414. | CH | F | CN | A.2 |
| 415. | CF₃ | F | CN | A.2 |
| 416. | OCH₃ | F | CN | A.2 |
| 417. | OCF₃ | F | CN | A.2 |
| 418. | CH₂CH₃ | F | CN | A.2 |
| 419. | H | Cl | CN | A.2 |
| 420. | F | Cl | CN | A.2 |
| 421. | Cl | Cl | CN | A.2 |
| 422. | Br | Cl | CN | A.2 |
| 423. | I | Cl | CN | A.2 |
| 424. | CN | Cl | CN | A.2 |
| 425. | CH₃ | Cl | CN | A.2 |
| 426. | CF₃ | Cl | CN | A.2 |
| 427. | OCH₃ | Cl | CN | A.2 |
| 428. | OCF₃ | Cl | CN | A.2 |
| 429. | CH₂CH₃ | Cl | CN | A.2 |
| 430. | H | H | CH₃ | A.2 |
| 431. | F | H | CH₃ | A.2 |
| 432. | Cl | H | CH₃ | A.2 |
| 433. | Br | H | CH₃ | A.2 |
| 434. | I | H | CH₃ | A.2 |
| 435. | CN | H | CH₃ | A.2 |
| 436. | CH₃ | H | CH₃ | A.2 |
| 437. | CF₃ | H | CH₃ | A.2 |
| 438. | OCH₃ | H | CH₃ | A.2 |
| 439. | OCF₃ | H | CH₃ | A.2 |
| 440. | CH₂CH₃ | H | CH₃ | A.2 |
| 441. | H | F | CH₃ | A.2 |
| 442. | F | F | CH₃ | A.2 |
| 443. | Cl | F | CH₃ | A.2 |
| 444. | Br | F | CH₃ | A.2 |
| 445. | I | F | CH₃ | A.2 |
| 446. | CN | F | CH₃ | A.2 |
| 447. | CH₃ | F | CH₃ | A.2 |
| 448. | CF₃ | F | CH₃ | A.2 |
| 449. | OCH₃ | F | CH₃ | A.2 |
| 450. | OCF₃ | F | CH₃ | A.2 |
| 451. | CH₂CH₃ | F | CH₃ | A.2 |
| 452. | H | Cl | CH₃ | A.2 |
| 453. | F | Cl | CH₃ | A.2 |
| 454. | Cl | Cl | CH₃ | A.2 |
| 455. | Br | Cl | CH₃ | A.2 |
| 456. | I | Cl | CH₃ | A.2 |
| 457. | CN | Cl | CH₃ | A.2 |
| 458. | CH₃ | Cl | CH₃ | A.2 |
| 459. | CF₃ | Cl | CH₃ | A.2 |
| 460. | OCH₃ | Cl | CH₃ | A.2 |
| 461. | OCF₃ | Cl | CH₃ | A.2 |
| 462. | CH₂CH₃ | Cl | CH₃ | A.2 |
| 463. | H | H | H | A.3 |
| 464. | F | H | H | A.3 |
| 465. | Cl | H | H | A.3 |
| 466. | Br | H | H | A.3 |
| 467. | I | H | H | A.3 |
| 468. | CN | H | H | A.3 |
| 469. | CH₃ | H | H | A.3 |
| 470. | CF₃ | H | H | A.3 |
| 471. | OCH₃ | H | H | A.3 |
| 472. | OCF₃ | H | H | A.3 |
| 473. | CH₂CH₃ | H | H | A.3 |
| 474. | H | F | H | A.3 |
| 475. | F | F | H | A.3 |
| 476. | Cl | F | H | A.3 |
| 477. | Br | F | H | A.3 |
| 478. | I | F | H | A.3 |
| 479. | CN | F | H | A.3 |
| 480. | CH₃ | F | H | A.3 |
| 481. | CF | F | H | A.3 |
| 482. | OCH₃ | F | H | A.3 |
| 483. | OCF₃ | F | H | A.3 |
| 484. | CH₂CH₃ | F | H | A.3 |
| 485. | H | Cl | H | A.3 |
| 486. | F | Cl | H | A.3 |
| 487. | Cl | Cl | H | A.3 |
| 488. | Br | Cl | H | A.3 |
| 489. | I | Cl | H | A.3 |
| 490. | CN | Cl | H | A.3 |
| 491. | CH₃ | Cl | H | A.3 |
| 492. | CF₃ | Cl | H | A.3 |
| 493. | OCH₃ | Cl | H | A.3 |
| 494. | OCF₃ | Cl | H | A.3 |
| 495. | CH₂CH₃ | Cl | H | A.3 |
| 496. | H | H | F | A.3 |
| 497. | F | H | F | A.3 |
| 498. | Cl | H | F | A.3 |
| 499. | Br | H | F | A.3 |
| 500. | I | H | F | A.3 |
| 501. | CN | H | F | A.3 |
| 502. | CH₃ | H | F | A.3 |
| 503. | CF₃ | H | F | A.3 |
| 504. | OCH₃ | H | F | A.3 |
| 505. | OCF₃ | H | F | A.3 |
| 506. | CH₂CH₃ | H | F | A.3 |
| 507. | H | F | F | A.3 |
| 508. | F | F | F | A.3 |
| 509. | Cl | F | F | A.3 |
| 510. | Br | F | F | A.3 |
| 511. | I | F | F | A.3 |
| 512. | CN | F | F | A.3 |
| 513. | CH₃ | F | F | A.3 |
| 514. | CF₃ | F | F | A.3 |
| 515. | OCH₃ | F | F | A.3 |
| 516. | OCF₃ | F | F | A.3 |
| 517. | CH₂CH₃ | F | F | A.3 |
| 518. | H | Cl | F | A.3 |
| 519. | F | Cl | F | A.3 |
| 520. | Cl | Cl | F | A.3 |
| 521. | Br | Cl | F | A.3 |
| 522. | I | Cl | F | A.3 |
| 523. | CN | Cl | F | A.3 |
| 524. | CH₃ | Cl | F | A.3 |
| 525. | CF₃ | Cl | F | A.3 |
| 526. | OCH₃ | Cl | F | A.3 |
| 527. | OCF₃ | Cl | F | A.3 |
| 528. | CH₂CH₃ | Cl | F | A.3 |
| 529. | H | H | Cl | A.3 |
| 530. | F | H | Cl | A.3 |
| 531. | Cl | H | Cl | A.3 |
| 532. | Br | H | Cl | A.3 |
| 533. | I | H | Cl | A.3 |
| 534. | CN | H | Cl | A.3 |
| 535. | CH₃ | H | Cl | A.3 |
| 536. | CF₃ | H | Cl | A.3 |
| 537. | OCH₃ | H | Cl | A.3 |
| 538. | OCF₃ | H | Cl | A.3 |
| 539. | CH₂CH₃ | H | Cl | A.3 |
| 540. | H | F | Cl | A.3 |
| 541. | F | F | Cl | A.3 |
| 542. | Cl | F | Cl | A.3 |
| 543. | Br | F | Cl | A.3 |
| 544. | I | F | Cl | A.3 |
| 545. | CN | F | Cl | A.3 |
| 546. | CH₃ | F | Cl | A.3 |
| 547. | CF₃ | F | Cl | A.3 |
| 548. | OCH₃ | F | Cl | A.3 |
| 549. | OCF₃ | F | Cl | A.3 |
| 550. | CH₂CH₃ | F | Cl | A.3 |
| 551. | H | Cl | Cl | A.3 |
| 552. | F | Cl | Cl | A.3 |
| 553. | Cl | Cl | Cl | A.3 |
| 554. | Br | Cl | Cl | A.3 |
| 555. | I | Cl | Cl | A.3 |
| 556. | CN | Cl | Cl | A.3 |
| 557. | CH₃ | Cl | Cl | A.3 |
| 558. | CF₃ | Cl | Cl | A.3 |
| 559. | OCH₃ | Cl | Cl | A.3 |
| 560. | OCF₃ | Cl | Cl | A.3 |
| 561. | CH₂CH₃ | Cl | Cl | A.3 |
| 562. | H | H | Br | A.3 |
| 563. | F | H | Br | A.3 |
| 564. | Cl | H | Br | A.3 |
| 565. | Br | H | Br | A.3 |
| 566. | I | H | Br | A.3 |
| 567. | CN | H | Br | A.3 |
| 568. | CH₃ | H | Br | A.3 |
| 569. | CF₃ | H | Br | A.3 |
| 570. | OCH₃ | H | Br | A.3 |
| 571. | OCF₃ | H | Br | A.3 |
| 572. | CH₂CH₃ | H | Br | A.3 |
| 573. | H | F | Br | A.3 |
| 574. | F | F | Br | A.3 |
| 575. | Cl | F | Br | A.3 |
| 576. | Br | F | Br | A.3 |
| 577. | I | F | Br | A.3 |
| 578. | CN | F | Br | A.3 |
| 579. | CH₃ | F | Br | A.3 |
| 580. | CF₃ | F | Br | A.3 |
| 581. | OCH₃ | F | Br | A.3 |
| 582. | OCF₃ | F | Br | A.3 |
| 583. | CH₂CH₃ | F | Br | A.3 |
| 584. | H | Cl | Br | A.3 |
| 585. | F | Cl | Br | A.3 |
| 586. | Cl | Cl | Br | A.3 |
| 587. | Br | Cl | Br | A.3 |
| 588. | I | Cl | Br | A.3 |
| 589. | CN | Cl | Br | A.3 |
| 590. | CH₃ | Cl | Br | A.3 |
| 591. | CF₃ | Cl | Br | A.3 |
| 592. | OCH₃ | Cl | Br | A.3 |
| 593. | OCF₃ | Cl | Br | A.3 |
| 594. | CH₂CH₃ | Cl | Br | A.3 |
| 595. | H | H | I | A.3 |
| 596. | F | H | I | A.3 |
| 597. | Cl | H | I | A.3 |
| 598. | Br | H | I | A.3 |
| 599. | I | H | I | A.3 |
| 600. | CN | H | I | A.3 |
| 601. | CH₃ | H | I | A.3 |
| 602. | CF₃ | H | I | A.3 |
| 603. | OCH₃ | H | I | A.3 |
| 604. | OCF₃ | H | I | A.3 |
| 605. | CH₂CH₃ | H | I | A.3 |
| 606. | H | F | I | A.3 |
| 607. | F | F | I | A.3 |
| 608. | Cl | F | I | A.3 |
| 609. | Br | F | I | A.3 |
| 610. | I | F | I | A.3 |
| 611. | CN | F | I | A.3 |
| 612. | CH₃ | F | I | A.3 |
| 613. | CF₃ | F | I | A.3 |
| 614. | OCH₃ | F | I | A.3 |
| 615. | OCF₃ | F | I | A.3 |
| 616. | CH₂CH₃ | F | I | A.3 |
| 617. | H | Cl | I | A.3 |
| 618. | F | Cl | I | A.3 |
| 619. | Cl | Cl | I | A.3 |
| 620. | Br | Cl | I | A.3 |
| 621. | I | Cl | I | A.3 |
| 622. | CN | Cl | I | A.3 |
| 623. | CH₃ | Cl | I | A.3 |
| 624. | CF₃ | Cl | I | A.3 |
| 625. | OCH₃ | Cl | I | A.3 |
| 626. | OCF₃ | Cl | I | A.3 |
| 627. | CH₂CH₃ | Cl | I | A.3 |
| 628. | H | H | CN | A.3 |
| 629. | F | H | CN | A.3 |
| 630. | Cl | H | CN | A.3 |
| 631. | Br | H | CN | A.3 |
| 632. | I | H | CN | A.3 |
| 633. | CN | H | CN | A.3 |
| 634. | CH₃ | H | CN | A.3 |
| 635. | CF₃ | H | CN | A.3 |
| 636. | OCH₃ | H | CN | A.3 |
| 637. | OCF₃ | H | CN | A.3 |
| 638. | CH₂CH₃ | H | CN | A.3 |
| 639. | H | F | CN | A.3 |
| 640. | F | F | CN | A.3 |
| 641. | Cl | F | CN | A.3 |
| 642. | Br | F | CN | A.3 |
| 643. | I | F | CN | A.3 |
| 644. | CN | F | CN | A.3 |
| 645. | CH₃ | F | CN | A.3 |
| 646. | CF₃ | F | CN | A.3 |
| 647. | OCH₃ | F | CN | A.3 |
| 648. | OCF₃ | F | CN | A.3 |
| 649. | CH₂CH₃ | F | CN | A.3 |
| 650. | H | Cl | CN | A.3 |
| 651. | F | Cl | CN | A.3 |
| 652. | Cl | Cl | CN | A.3 |
| 653. | Br | Cl | CN | A.3 |
| 654. | I | Cl | CN | A.3 |
| 655. | CN | Cl | CN | A.3 |
| 656. | CH₃ | Cl | CN | A.3 |
| 657. | CF₃ | Cl | CN | A.3 |
| 658. | OCH₃ | Cl | CN | A.3 |
| 659. | OCF₃ | Cl | CN | A.3 |
| 660. | CH₂CH₃ | Cl | CN | A.3 |
| 661. | H | H | CH₃ | A.3 |
| 662. | F | H | CH₃ | A.3 |
| 663. | Cl | H | CH₃ | A.3 |
| 664. | Br | H | CH₃ | A.3 |
| 665. | I | H | CH₃ | A.3 |
| 666. | CN | H | CH₃ | A.3 |
| 667. | CH₃ | H | CH₃ | A.3 |
| 668. | CF₃ | H | CH₃ | A.3 |
| 669. | OCH₃ | H | CH₃ | A.3 |
| 670. | OCF₃ | H | CH₃ | A.3 |
| 671. | CH₂CH₃ | H | CH₃ | A.3 |
| 672. | H | F | CH₃ | A.3 |
| 673. | F | F | CH₃ | A.3 |
| 674. | Cl | F | CH₃ | A.3 |
| 675. | Br | F | CH₃ | A.3 |
| 676. | I | F | CH₃ | A.3 |
| 677. | CN | F | CH₃ | A.3 |
| 678. | CH₃ | F | CH₃ | A.3 |
| 679. | CF₃ | F | CH₃ | A.3 |
| 680. | OCH₃ | F | CH₃ | A.3 |
| 681. | OCF₃ | F | CH₃ | A.3 |
| 682. | CH₂CH₃ | F | CH₃ | A.3 |
| 683. | H | Cl | CH₃ | A.3 |
| 684. | F | Cl | CH₃ | A.3 |
| 685. | Cl | Cl | CH₃ | A.3 |
| 686. | Br | Cl | CH₃ | A.3 |
| 687. | I | Cl | CH₃ | A.3 |
| 688. | CN | Cl | CH₃ | A.3 |
| 689. | CH₃ | Cl | CH₃ | A.3 |
| 690. | CF₃ | Cl | CH₃ | A.3 |
| 691. | OCH₃ | Cl | CH₃ | A.3 |
| 692. | OCF₃ | Cl | CH₃ | A.3 |
| 693. | CH₂CH₃ | Cl | CH₃ | A.3 |
| 694. | H | H | H | A.4 |
| 695. | F | H | H | A.4 |
| 696. | Cl | H | H | A.4 |
| 697. | Br | H | H | A.4 |
| 698. | I | H | H | A.4 |
| 699. | CN | H | H | A.4 |
| 700. | CH₃ | H | H | A.4 |
| 701. | CF₃ | H | H | A.4 |
| 702. | OCH₃ | H | H | A.4 |
| 703. | OCF₃ | H | H | A.4 |
| 704. | CH₂CH₃ | H | H | A.4 |
| 705. | H | F | H | A.4 |
| 706. | F | F | H | A.4 |
| 707. | Cl | F | H | A.4 |
| 708. | Br | F | H | A.4 |
| 709. | I | F | H | A.4 |
| 710. | CN | F | H | A.4 |
| 711. | CH₃ | F | H | A.4 |
| 712. | CF₃ | F | H | A.4 |
| 713. | OCH₃ | F | H | A.4 |
| 714. | OCF₃ | F | H | A.4 |
| 715. | CH₂CH₃ | F | H | A.4 |
| 716. | H | Cl | H | A.4 |
| 717. | F | Cl | H | A.4 |
| 718. | Cl | Cl | H | A.4 |
| 719. | Br | Cl | H | A.4 |
| 720. | I | Cl | H | A.4 |
| 721. | CN | Cl | H | A.4 |
| 722. | CH₃ | Cl | H | A.4 |
| 723. | CF₃ | Cl | H | A.4 |
| 724. | OCH₃ | Cl | H | A.4 |
| 725. | OCF₃ | Cl | H | A.4 |
| 726. | CH₂CH₃ | Cl | H | A.4 |
| 727. | H | H | F | A.4 |
| 728. | F | H | F | A.4 |
| 729. | Cl | H | F | A.4 |
| 730. | Br | H | F | A.4 |
| 731. | I | H | F | A.4 |
| 732. | CN | H | F | A.4 |
| 733. | CH₃ | H | F | A.4 |
| 734. | CF₃ | H | F | A.4 |
| 735. | OCH₃ | H | F | A.4 |
| 736. | OCF₃ | H | F | A.4 |
| 737. | CH₂CH₃ | H | F | A.4 |
| 738. | H | F | F | A.4 |
| 739. | F | F | F | A.4 |
| 740. | Cl | F | F | A.4 |
| 741. | Br | F | F | A.4 |
| 742. | I | F | F | A.4 |
| 743. | CN | F | F | A.4 |
| 744. | CH₃ | F | F | A.4 |
| 745. | CF₃ | F | F | A.4 |
| 746. | OCH₃ | F | F | A.4 |
| 747. | OCF₃ | Cl | F | A.4 |
| 748. | CH₂CH₃ | Cl | F | A.4 |
| 749. | H | Cl | F | A.4 |
| 750. | F | Cl | F | A.4 |
| 751. | Cl | Cl | F | A.4 |
| 752. | Br | Cl | F | A.4 |
| 753. | I | Cl | F | A.4 |
| 754. | CN | Cl | F | A.4 |
| 755. | CH₃ | Cl | F | A.4 |
| 756. | CF₃ | Cl | F | A.4 |
| 757. | OCH₃ | Cl | F | A.4 |
| 758. | OCF₃ | Cl | F | A.4 |
| 759. | CH₂CH₃ | Cl | F | A.4 |
| 760. | H | H | Cl | A.4 |
| 761. | F | H | Cl | A.4 |
| 762. | Cl | H | Cl | A.4 |
| 763. | Br | H | Cl | A.4 |
| 764. | I | H | Cl | A.4 |
| 765. | CN | H | Cl | A.4 |
| 766. | CH₃ | H | Cl | A.4 |
| 767. | CF₃ | H | Cl | A.4 |
| 768. | OCH₃ | H | Cl | A.4 |
| 769. | OCF₃ | H | Cl | A.4 |
| 770. | CH₂CH₃ | H | Cl | A.4 |
| 771. | H | F | Cl | A.4 |
| 772. | F | F | Cl | A.4 |
| 773. | Cl | F | Cl | A.4 |
| 774. | Br | F | Cl | A.4 |
| 775. | I | F | Cl | A.4 |
| 776. | CN | F | Cl | A.4 |
| 777. | CH₃ | F | Cl | A.4 |
| 778. | CF₃ | F | Cl | A.4 |
| 779. | OCH₃ | F | Cl | A.4 |
| 780. | OCF₃ | F | Cl | A.4 |
| 781. | CH₂CH₃ | F | Cl | A.4 |
| 782. | H | Cl | Cl | A.4 |
| 783. | F | Cl | Cl | A.4 |
| 784. | Cl | Cl | Cl | A.4 |
| 785. | Br | Cl | Cl | A.4 |
| 786. | I | Cl | Cl | A.4 |
| 787. | CN | Cl | Cl | A.4 |
| 788. | CH₃ | Cl | Cl | A.4 |
| 789. | CF₃ | Cl | Cl | A.4 |
| 790. | OCH₃ | Cl | Cl | A.4 |
| 791. | OCF₃ | Cl | Cl | A.4 |
| 792. | CH₂CH₃ | Cl | Cl | A.4 |
| 793. | H | H | Br | A.4 |
| 794. | F | H | Br | A.4 |
| 795. | Cl | H | Br | A.4 |
| 796. | Br | H | Br | A.4 |
| 797. | I | H | Br | A.4 |
| 798. | CN | H | Br | A.4 |
| 799. | CH₃ | H | Br | A.4 |
| 800. | CF₃ | H | Br | A.4 |
| 801. | OCH₃ | H | Br | A.4 |
| 802. | OCF₃ | H | Br | A.4 |
| 803. | CH₂CH₃ | H | Br | A.4 |
| 804. | H | F | Br | A.4 |
| 805. | F | F | Br | A.4 |
| 806. | Cl | F | Br | A.4 |
| 807. | Br | F | Br | A.4 |
| 808. | I | F | Br | A.4 |
| 809. | CN | F | Br | A.4 |
| 810. | CH₃ | F | Br | A.4 |
| 811. | CF₃ | F | Br | A.4 |
| 812. | OCH₃ | F | Br | A.4 |
| 813. | OCF₃ | F | Br | A.4 |
| 814. | CH₂CH₃ | F | Br | A.4 |
| 815. | H | Cl | Br | A.4 |
| 816. | F | Cl | Br | A.4 |
| 817. | Cl | Cl | Br | A.4 |
| 818. | Br | Cl | Br | A.4 |
| 819. | I | Cl | Br | A.4 |
| 820. | CN | Cl | Br | A.4 |
| 821. | CH₃ | Cl | Br | A.4 |
| 822. | CF₃ | Cl | Br | A.4 |
| 823. | OCH₃ | Cl | Br | A.4 |
| 824. | OCF₃ | Cl | Br | A.4 |
| 825. | CH₂CH₃ | Cl | Br | A.4 |
| 826. | H | H | I | A.4 |
| 827. | F | H | I | A.4 |
| 828. | Cl | H | I | A.4 |
| 829. | Br | H | I | A.4 |
| 830. | I | H | I | A.4 |
| 831. | CN | H | I | A.4 |
| 832. | CH₃ | H | I | A.4 |
| 833. | CF₃ | H | I | A.4 |
| 834. | OCH₃ | H | I | A.4 |
| 835. | OCF₃ | H | I | A.4 |
| 836. | CH₂CH₃ | H | I | A.4 |
| 837. | H | F | I | A.4 |
| 838. | F | F | I | A.4 |
| 839. | Cl | F | I | A.4 |
| 840. | Br | F | I | A.4 |
| 841. | I | F | I | A.4 |
| 842. | CN | F | I | A.4 |
| 843. | CH₃ | F | I | A.4 |
| 844. | CF₃ | F | I | A.4 |
| 845. | OCH₃ | F | I | A.4 |
| 846. | OCF₃ | F | I | A.4 |
| 847. | CH₂CH₃ | F | I | A.4 |
| 848. | H | Cl | I | A.4 |
| 849. | F | Cl | I | A.4 |
| 850. | Cl | Cl | I | A.4 |
| 851. | Br | Cl | I | A.4 |
| 852. | I | Cl | I | A.4 |
| 853. | CN | Cl | I | A.4 |
| 854. | CH₃ | Cl | I | A.4 |
| 855. | CF₃ | Cl | I | A.4 |
| 856. | OCH₃ | Cl | I | A.4 |
| 857. | OCF₃ | Cl | I | A.4 |
| 858. | CH₂CH₃ | Cl | I | A.4 |
| 859. | H | H | CN | A.4 |
| 860. | F | H | CN | A.4 |
| 861. | Cl | H | CN | A.4 |
| 862. | Br | H | CN | A.4 |
| 863. | I | H | CN | A.4 |
| 864. | CN | H | CN | A.4 |
| 865. | CH₃ | H | CN | A.4 |
| 866. | CF₃ | H | CN | A.4 |
| 867. | OCH₃ | H | CN | A.4 |
| 868. | OCF₃ | H | CN | A.4 |
| 869. | CH₂CH₃ | H | CN | A.4 |
| 870. | H | F | CN | A.4 |
| 871. | F | F | CN | A.4 |
| 872. | Cl | F | CN | A.4 |
| 873. | Br | F | CN | A.4 |
| 874. | I | F | CN | A.4 |
| 875. | CN | F | CN | A.4 |
| 876. | CH₃ | F | CN | A.4 |
| 877. | CF₃ | F | CN | A.4 |
| 878. | OCH₃ | F | CN | A.4 |
| 879. | OCF₃ | F | CN | A.4 |
| 880. | CH₂CH₃ | F | CN | A.4 |
| 881. | H | Cl | CN | A.4 |
| 882. | F | Cl | CN | A.4 |
| 883. | Cl | Cl | CN | A.4 |
| 884. | Br | Cl | CN | A.4 |
| 885. | I | Cl | CN | A.4 |
| 886. | CN | Cl | CN | A.4 |
| 887. | CH₃ | Cl | CN | A.4 |
| 888. | CF | Cl | CN | A.4 |
| 889. | OCH₃ | Cl | CN | A.4 |
| 890. | OCF₃ | Cl | CN | A.4 |
| 891. | CH₂CH₃ | Cl | CN | A.4 |
| 892. | H | H | CH₃ | A.4 |
| 893. | F | H | CH₃ | A.4 |
| 894. | Cl | H | CH₃ | A.4 |
| 895. | Br | H | CH₃ | A.4 |
| 896. | I | H | CH₃ | A.4 |
| 897. | CN | H | CH₃ | A.4 |
| 898. | CH₃ | H | CH₃ | A.4 |
| 899. | CF₃ | H | CH₃ | A.4 |
| 900. | OCH₃ | H | CH₃ | A.4 |
| 901. | OCF₃ | H | CH₃ | A.4 |
| 902. | CH₂CH₃ | H | CH₃ | A.4 |
| 903. | H | F | CH₃ | A.4 |
| 904. | F | F | CH₃ | A.4 |
| 905. | Cl | F | CH₃ | A.4 |
| 906. | Br | F | CH₃ | A.4 |
| 907. | I | F | CH₃ | A.4 |
| 908. | CN | F | CH₃ | A.4 |
| 909. | CH₃ | F | CH₃ | A.4 |
| 910. | CF₃ | F | CH₃ | A.4 |
| 911. | OCH₃ | F | CH₃ | A.4 |
| 912. | OCF₃ | F | CH₃ | A.4 |
| 913. | CH₂CH₃ | F | CH₃ | A.4 |
| 914. | H | Cl | CH₃ | A.4 |
| 915. | F | Cl | CH₃ | A.4 |
| 916. | Cl | Cl | CH₃ | A.4 |
| 917. | Br | Cl | CH₃ | A.4 |
| 918. | I | Cl | CH₃ | A.4 |
| 919. | CN | Cl | CH₃ | A.4 |
| 920. | CH₃ | Cl | CH₃ | A.4 |
| 921. | CF₃ | Cl | CH₃ | A.4 |
| 922. | OCH₃ | Cl | CH₃ | A.4 |
| 923. | OCF₃ | Cl | CH₃ | A.4 |
| 924. | CH₂CH₃ | Cl | CH₃ | A.4 |
| 925. | H | H | H | A.5 |
| 926. | F | H | H | A.5 |
| 927. | Cl | H | H | A.5 |
| 928. | Br | H | H | A.5 |
| 929. | I | H | H | A.5 |
| 930. | CN | H | H | A.5 |
| 931. | CH₃ | H | H | A.5 |
| 932. | CF₃ | H | H | A.5 |
| 933. | OCH₃ | H | H | A.5 |
| 934. | OCF₃ | H | H | A.5 |
| 935. | CH₂CH₃ | H | H | A.5 |
| 936. | H | F | H | A.5 |
| 937. | F | F | H | A.5 |
| 938. | Cl | F | H | A.5 |
| 939. | Br | F | H | A.5 |
| 940. | I | F | H | A.5 |
| 941. | CN | F | H | A.5 |
| 942. | CH₃ | F | H | A.5 |
| 943. | CF₃ | F | H | A.5 |
| 944. | OCH₃ | F | H | A.5 |
| 945. | OCF₃ | F | H | A.5 |
| 946. | CH₂CH₃ | F | H | A.5 |
| 947. | H | Cl | H | A.5 |
| 948. | F | Cl | H | A.5 |
| 949. | Cl | Cl | H | A.5 |
| 950. | Br | Cl | H | A.5 |
| 951. | I | Cl | H | A.5 |
| 952. | CN | Cl | H | A.5 |
| 953. | CH₃ | Cl | H | A.5 |
| 954. | CF₃ | Cl | H | A.5 |
| 955. | OCH₃ | Cl | H | A.5 |
| 956. | OCF₃ | Cl | H | A.5 |
| 957. | CH₂CH₃ | Cl | H | A.5 |
| 958. | H | H | F | A.5 |
| 959. | F | H | F | A.5 |
| 960. | Cl | H | F | A.5 |
| 961. | Br | H | F | A.5 |
| 962. | I | H | F | A.5 |
| 963. | CN | H | F | A.5 |
| 964. | CH₃ | H | F | A.5 |
| 965. | CF₃ | H | F | A.5 |
| 966. | OCH₃ | H | F | A.5 |
| 967. | OCF₃ | H | F | A.5 |
| 968. | CH₂CH₃ | H | F | A.5 |
| 969. | H | F | F | A.5 |
| 970. | F | F | F | A.5 |
| 971. | Cl | F | F | A.5 |
| 972. | Br | F | F | A.5 |
| 973. | I | F | F | A.5 |
| 974. | CN | F | F | A.5 |
| 975. | CH₃ | F | F | A.5 |
| 976. | CF₃ | F | F | A.5 |
| 977. | OCH₃ | F | F | A.5 |
| 978. | OCF₃ | Cl | F | A.5 |
| 979. | CH₂CH₃ | Cl | F | A.5 |
| 980. | H | Cl | F | A.5 |
| 981. | F | Cl | F | A.5 |
| 982. | Cl | Cl | F | A.5 |
| 983. | Br | Cl | F | A.5 |
| 984. | I | Cl | F | A.5 |
| 985. | CN | Cl | F | A.5 |
| 986. | CH₃ | Cl | F | A.5 |
| 987. | CF₃ | Cl | F | A.5 |
| 988. | OCH₃ | Cl | F | A.5 |
| 989. | OCF₃ | Cl | F | A.5 |
| 990. | CH₂CH₃ | Cl | F | A.5 |
| 991. | H | H | Cl | A.5 |
| 992. | F | H | Cl | A.5 |
| 993. | Cl | H | Cl | A.5 |
| 994. | Br | H | Cl | A.5 |
| 995. | I | H | Cl | A.5 |
| 996. | CN | H | Cl | A.5 |
| 997. | CH₃ | H | Cl | A.5 |
| 998. | CF₃ | H | Cl | A.5 |
| 999. | OCH₃ | H | Cl | A.5 |
| 1000. | OCF₃ | H | Cl | A.5 |
| 1001. | CH₂CH₃ | H | Cl | A.5 |
| 1002. | H | F | Cl | A.5 |
| 1003. | F | F | Cl | A.5 |
| 1004. | Cl | F | Cl | A.5 |
| 1005. | Br | F | Cl | A.5 |
| 1006. | I | F | Cl | A.5 |
| 1007. | CN | F | Cl | A.5 |
| 1008. | CH₃ | F | Cl | A.5 |
| 1009. | CF₃ | F | Cl | A.5 |
| 1010. | OCH₃ | F | Cl | A.5 |
| 1011. | OCF₃ | F | Cl | A.5 |
| 1012. | CH₂CH₃ | F | Cl | A.5 |
| 1013. | H | Cl | Cl | A.5 |
| 1014. | F | Cl | Cl | A.5 |
| 1015. | Cl | Cl | Cl | A.5 |
| 1016. | Br | Cl | Cl | A.5 |
| 1017. | I | Cl | Cl | A.5 |
| 1018. | CN | Cl | Cl | A.5 |
| 1019. | CH₃ | Cl | Cl | A.5 |
| 1020. | CF₃ | Cl | Cl | A.5 |
| 1021. | OCH₃ | Cl | Cl | A.5 |
| 1022. | OCF₃ | Cl | Cl | A.5 |
| 1023. | CH₂CH₃ | Cl | Cl | A.5 |
| 1024. | H | H | Br | A.5 |
| 1025. | F | H | Br | A.5 |
| 1026. | Cl | H | Br | A.5 |
| 1027. | Br | H | Br | A.5 |
| 1028. | I | H | Br | A.5 |
| 1029. | CN | H | Br | A.5 |
| 1030. | CH₃ | H | Br | A.5 |
| 1031. | CF₃ | H | Br | A.5 |
| 1032. | OCH₃ | H | Br | A.5 |
| 1033. | OCF₃ | H | Br | A.5 |
| 1034. | CH₂CH₃ | H | Br | A.5 |
| 1035. | H | F | Br | A.5 |
| 1036. | F | F | Br | A.5 |
| 1037. | Cl | F | Br | A.5 |
| 1038. | Br | F | Br | A.5 |
| 1039. | I | F | Br | A.5 |
| 1040. | CN | F | Br | A.5 |
| 1041. | CH₃ | F | Br | A.5 |
| 1042. | CF₃ | F | Br | A.5 |
| 1043. | OCH₃ | F | Br | A.5 |
| 1044. | OCF₃ | F | Br | A.5 |
| 1045. | CH₂CH₃ | F | Br | A.5 |
| 1046. | H | Cl | Br | A.5 |
| 1047. | F | Cl | Br | A.5 |
| 1048. | Cl | Cl | Br | A.5 |
| 1049. | Br | Cl | Br | A.5 |
| 1050. | I | Cl | Br | A.5 |
| 1051. | CN | Cl | Br | A.5 |
| 1052. | CH₃ | Cl | Br | A.5 |
| 1053. | CF₃ | Cl | Br | A.5 |
| 1054. | OCH₃ | Cl | Br | A.5 |
| 1055. | OCF₃ | Cl | Br | A.5 |
| 1056. | CH₂CH₃ | Cl | Br | A.5 |
| 1057. | H | H | I | A.5 |
| 1058. | F | H | I | A.5 |
| 1059. | Cl | H | I | A.5 |
| 1060. | Br | H | I | A.5 |
| 1061. | I | H | I | A.5 |
| 1062. | CN | H | I | A.5 |
| 1063. | CH | H | I | A.5 |
| 1064. | CF₃ | H | I | A.5 |
| 1065. | OCH₃ | H | I | A.5 |
| 1066. | OCF₃ | H | I | A.5 |
| 1067. | CH₂CH₃ | H | I | A.5 |
| 1068. | H | F | I | A.5 |
| 1069. | F | F | I | A.5 |
| 1070. | Cl | F | I | A.5 |
| 1071. | Br | F | I | A.5 |
| 1072. | I | F | I | A.5 |
| 1073. | CN | F | I | A.5 |
| 1074. | CH₃ | F | I | A.5 |
| 1075. | CF₃ | F | I | A.5 |
| 1076. | OCH₃ | F | I | A.5 |
| 1077. | OCF₃ | F | I | A.5 |
| 1078. | CH₂CH₃ | F | I | A.5 |
| 1079. | H | Cl | I | A.5 |
| 1080. | F | Cl | I | A.5 |
| 1081. | Cl | Cl | I | A.5 |
| 1082. | Br | Cl | I | A.5 |
| 1083. | I | Cl | I | A.5 |
| 1084. | CN | Cl | I | A.5 |
| 1085. | CH₃ | Cl | I | A.5 |
| 1086. | CF₃ | Cl | I | A.5 |
| 1087. | OCH₃ | Cl | I | A.5 |
| 1088. | OCF₃ | Cl | I | A.5 |
| 1089. | CH₂CH₃ | Cl | I | A.5 |
| 1090. | H | H | CN | A.5 |
| 1091. | F | H | CN | A.5 |
| 1092. | Cl | H | CN | A.5 |
| 1093. | Br | H | CN | A.5 |
| 1094. | I | H | CN | A.5 |
| 1095. | CN | H | CN | A.5 |
| 1096. | CH₃ | H | CN | A.5 |
| 1097. | CF₃ | H | CN | A.5 |
| 1098. | OCH₃ | H | CN | A.5 |
| 1099. | OCF₃ | H | CN | A.5 |
| 1100. | CH₂CH₃ | H | CN | A.5 |
| 1101. | H | F | CN | A.5 |
| 1102. | F | F | CN | A.5 |
| 1103. | Cl | F | CN | A.5 |
| 1104. | Br | F | CN | A.5 |
| 1105. | I | F | CN | A.5 |
| 1106. | CN | F | CN | A.5 |
| 1107. | CH₃ | F | CN | A.5 |
| 1108. | CF₃ | F | CN | A.5 |
| 1109. | OCH₃ | F | CN | A.5 |
| 1110. | OCF₃ | F | CN | A.5 |
| 1111. | CH₂CH₃ | F | CN | A.5 |
| 1112. | H | Cl | CN | A.5 |
| 1113. | F | Cl | CN | A.5 |
| 1114. | Cl | Cl | CN | A.5 |
| 1115. | Br | Cl | CN | A.5 |
| 1116. | I | Cl | CN | A.5 |
| 1117. | CN | Cl | CN | A.5 |
| 1118. | CH₃ | Cl | CN | A.5 |
| 1119. | CF₃ | Cl | CN | A.5 |
| 1120. | OCH₃ | Cl | CN | A.5 |
| 1121. | OCF₃ | Cl | CN | A.5 |
| 1122. | CH₂CH₃ | Cl | CN | A.5 |
| 1123. | H | H | CH₃ | A.5 |
| 1124. | F | H | CH₃ | A.5 |
| 1125. | Cl | H | CH₃ | A.5 |
| 1126. | Br | H | CH₃ | A.5 |
| 1127. | I | H | CH₃ | A.5 |
| 1128. | CN | H | CH₃ | A.5 |
| 1129. | CH₃ | H | CH₃ | A.5 |
| 1130. | CF₃ | H | CH₃ | A.5 |
| 1131. | OCH₃ | H | CH₃ | A.5 |
| 1132. | OCF₃ | H | CH₃ | A.5 |
| 1133. | CH₂CH₃ | H | CH₃ | A.5 |
| 1134. | H | F | CH₃ | A.5 |
| 1135. | F | F | CH₃ | A.5 |
| 1136. | Cl | F | CH₃ | A.5 |
| 1137. | Br | F | CH₃ | A.5 |
| 1138. | I | F | CH₃ | A.5 |
| 1139. | CN | F | CH₃ | A.5 |
| 1140. | CH₃ | F | CH₃ | A.5 |
| 1141. | CF₃ | F | CH₃ | A.5 |
| 1142. | OCH₃ | F | CH₃ | A.5 |
| 1143. | OCF₃ | F | CH₃ | A.5 |
| 1144. | CH₂CH₃ | F | CH₃ | A.5 |
| 1145. | H | Cl | CH₃ | A.5 |
| 1146. | F | Cl | CH₃ | A.5 |
| 1147. | Cl | Cl | CH₃ | A.5 |
| 1148. | Br | Cl | CH₃ | A.5 |
| 1149. | I | Cl | CH₃ | A.5 |
| 1150. | CN | Cl | CH₃ | A.5 |
| 1151. | CH₃ | Cl | CH₃ | A.5 |
| 1152. | CF₃ | Cl | CH₃ | A.5 |
| 1153. | OCH₃ | Cl | CH₃ | A.5 |
| 1154. | OCF₃ | Cl | CH₃ | A.5 |
| 1155. | CH₂CH₃ | Cl | CH₃ | A.5 |
| 1156. | H | H | H | A.6 |
| 1157. | F | H | H | A.6 |
| 1158. | Cl | H | H | A.6 |
| 1159. | Br | H | H | A.6 |
| 1160. | I | H | H | A.6 |
| 1161. | CN | H | H | A.6 |
| 1162. | CH₃ | H | H | A.6 |
| 1163. | CF₃ | H | H | A.6 |
| 1164. | OCH₃ | H | H | A.6 |
| 1165. | OCF₃ | H | H | A.6 |
| 1166. | CH₂CH₃ | H | H | A.6 |
| 1167. | H | F | H | A.6 |
| 1168. | F | F | H | A.6 |
| 1169. | Cl | F | H | A.6 |
| 1170. | Br | F | H | A.6 |
| 1171. | I | F | H | A.6 |
| 1172. | CN | F | H | A.6 |
| 1173. | CH₃ | F | H | A.6 |
| 1174. | CF₃ | F | H | A.6 |
| 1175. | OCH₃ | F | H | A.6 |
| 1176. | OCF₃ | F | H | A.6 |
| 1177. | CH₂CH₃ | F | H | A.6 |
| 1178. | H | Cl | H | A.6 |
| 1179. | F | Cl | H | A.6 |
| 1180. | Cl | Cl | H | A.6 |
| 1181. | Br | Cl | H | A.6 |
| 1182. | I | Cl | H | A.6 |
| 1183. | CN | Cl | H | A.6 |
| 1184. | CH₃ | Cl | H | A.6 |
| 1185. | CF₃ | Cl | H | A.6 |
| 1186. | OCH₃ | Cl | H | A.6 |
| 1187. | OCF₃ | Cl | H | A.6 |
| 1188. | CH₂CH₃ | Cl | H | A.6 |
| 1189. | H | H | F | A.6 |
| 1190. | F | H | F | A.6 |
| 1191. | Cl | H | F | A.6 |
| 1192. | Br | H | F | A.6 |
| 1193. | I | H | F | A.6 |
| 1194. | CN | H | F | A.6 |
| 1195. | CH₃ | H | F | A.6 |
| 1196. | CF₃ | H | F | A.6 |
| 1197. | OCH₃ | H | F | A.6 |
| 1198. | OCF₃ | H | F | A.6 |
| 1199. | CH₂CH₃ | H | F | A.6 |
| 1200. | H | F | F | A.6 |
| 1201. | F | F | F | A.6 |
| 1202. | Cl | F | F | A.6 |
| 1203. | Br | F | F | A.6 |
| 1204. | I | F | F | A.6 |
| 1205. | CN | F | F | A.6 |
| 1206. | CH₃ | F | F | A.6 |
| 1207. | CF₃ | F | F | A.6 |
| 1208. | OCH₃ | F | F | A.6 |
| 1209. | OCF₃ | F | F | A.6 |
| 1210. | CH₂CH₃ | F | F | A.6 |
| 1211. | H | Cl | F | A.6 |
| 1212. | F | Cl | F | A.6 |
| 1213. | Cl | Cl | F | A.6 |
| 1214. | Br | Cl | F | A.6 |
| 1215. | I | Cl | F | A.6 |
| 1216. | CN | Cl | F | A.6 |
| 1217. | CH₃ | Cl | F | A.6 |
| 1218. | CF₃ | Cl | F | A.6 |
| 1219. | OCH₃ | Cl | F | A.6 |
| 1220. | OCF₃ | Cl | F | A.6 |
| 1221. | CH₂CH₃ | Cl | F | A.6 |
| 1222. | H | H | Cl | A.6 |
| 1223. | F | H | Cl | A.6 |
| 1224. | Cl | H | Cl | A.6 |
| 1225. | Br | H | Cl | A.6 |
| 1226. | I | H | Cl | A.6 |
| 1227. | CN | H | Cl | A.6 |
| 1228. | CH₃ | H | Cl | A.6 |
| 1229. | CF₃ | H | Cl | A.6 |
| 1230. | OCH₃ | H | Cl | A.6 |
| 1231. | OCF₃ | H | Cl | A.6 |
| 1232. | CH₂CH₃ | H | Cl | A.6 |
| 1233. | H | F | Cl | A.6 |
| 1234. | F | F | Cl | A.6 |
| 1235. | Cl | F | Cl | A.6 |
| 1236. | Br | F | Cl | A.6 |
| 1237. | I | F | Cl | A.6 |
| 1238. | CN | F | Cl | A.6 |
| 1239. | CH₃ | F | Cl | A.6 |
| 1240. | CF₃ | F | Cl | A.6 |
| 1241. | OCH₃ | F | Cl | A.6 |
| 1242. | OCF₃ | F | Cl | A.6 |
| 1243. | CH₂CH₃ | F | Cl | A.6 |
| 1244. | H | Cl | Cl | A.6 |
| 1245. | F | Cl | Cl | A.6 |
| 1246. | Cl | Cl | Cl | A.6 |
| 1247. | Br | Cl | Cl | A.6 |
| 1248. | I | Cl | Cl | A.6 |
| 1249. | CN | Cl | Cl | A.6 |
| 1250. | CH₃ | Cl | Cl | A.6 |
| 1251. | CF₃ | Cl | Cl | A.6 |
| 1252. | OCH₃ | Cl | Cl | A.6 |
| 1253. | OCF₃ | Cl | Cl | A.6 |
| 1254. | CH₂CH₃ | Cl | Cl | A.6 |
| 1255. | H | H | Br | A.6 |
| 1256. | F | H | Br | A.6 |
| 1257. | Cl | H | Br | A.6 |
| 1258. | Br | H | Br | A.6 |
| 1259. | I | H | Br | A.6 |
| 1260. | CN | H | Br | A.6 |
| 1261. | CH₃ | H | Br | A.6 |
| 1262. | CF₃ | H | Br | A.6 |
| 1263. | OCH₃ | H | Br | A.6 |
| 1264. | OCF₃ | H | Br | A.6 |
| 1265. | CH₂CH₃ | H | Br | A.6 |
| 1266. | H | F | Br | A.6 |
| 1267. | F | F | Br | A.6 |
| 1268. | Cl | F | Br | A.6 |
| 1269. | Br | F | Br | A.6 |
| 1270. | I | F | Br | A.6 |
| 1271. | CN | F | Br | A.6 |
| 1272. | CH₃ | F | Br | A.6 |
| 1273. | CF₃ | F | Br | A.6 |
| 1274. | OCH₃ | F | Br | A.6 |
| 1275. | OCF₃ | F | Br | A.6 |
| 1276. | CH₂CH₃ | F | Br | A.6 |
| 1277. | H | Cl | Br | A.6 |
| 1278. | F | Cl | Br | A.6 |
| 1279. | Cl | Cl | Br | A.6 |
| 1280. | Br | Cl | Br | A.6 |
| 1281. | I | Cl | Br | A.6 |
| 1282. | CN | Cl | Br | A.6 |
| 1283. | CH₃ | Cl | Br | A.6 |
| 1284. | CF₃ | Cl | Br | A.6 |
| 1285. | OCH₃ | Cl | Br | A.6 |
| 1286. | OCF₃ | Cl | Br | A.6 |
| 1287. | CH₂CH₃ | Cl | Br | A.6 |
| 1288. | H | H | I | A.6 |
| 1289. | F | H | I | A.6 |
| 1290. | Cl | H | I | A.6 |
| 1291. | Br | H | I | A.6 |
| 1292. | I | H | I | A.6 |
| 1293. | CN | H | I | A.6 |
| 1294. | CH₃ | H | I | A.6 |
| 1295. | CF₃ | H | I | A.6 |
| 1296. | OCH₃ | H | I | A.6 |
| 1297. | OCF₃ | H | I | A.6 |
| 1298. | CH₂CH₃ | H | I | A.6 |
| 1299. | H | F | I | A.6 |
| 1300. | F | F | I | A.6 |
| 1301. | Cl | F | I | A.6 |
| 1302. | Br | F | I | A.6 |
| 1303. | I | F | I | A.6 |
| 1304. | CN | F | I | A.6 |
| 1305. | CH₃ | F | I | A.6 |
| 1306. | CF₃ | F | I | A.6 |
| 1307. | OCH₃ | F | I | A.6 |
| 1308. | OCF₃ | F | I | A.6 |
| 1309. | CH₂CH₃ | F | I | A.6 |
| 1310. | H | Cl | I | A.6 |
| 1311. | F | Cl | I | A.6 |
| 1312. | Cl | Cl | I | A.6 |
| 1313. | Br | Cl | I | A.6 |
| 1314. | I | Cl | I | A.6 |
| 1315. | CN | Cl | I | A.6 |
| 1316. | CH₃ | Cl | I | A.6 |
| 1317. | CF₃ | Cl | I | A.6 |
| 1318. | OCH₃ | Cl | I | A.6 |
| 1319. | OCF₃ | Cl | I | A.6 |
| 1320. | CH₂CH₃ | Cl | I | A.6 |
| 1321. | H | H | CN | A.6 |
| 1322. | F | H | CN | A.6 |
| 1323. | Cl | H | CN | A.6 |
| 1324. | Br | H | CN | A.6 |
| 1325. | I | H | CN | A.6 |
| 1326. | CN | H | CN | A.6 |
| 1327. | CH₃ | H | CN | A.6 |
| 1328. | CF | H | CN | A.6 |
| 1329. | OCH₃ | H | CN | A.6 |
| 1330. | OCF₃ | H | CN | A.6 |
| 1331. | CH₂CH₃ | H | CN | A.6 |
| 1332. | H | F | CN | A.6 |
| 1333. | F | F | CN | A.6 |
| 1334. | Cl | F | CN | A.6 |
| 1335. | Br | F | CN | A.6 |
| 1336. | I | F | CN | A.6 |
| 1337. | CN | F | CN | A.6 |
| 1338. | CH₃ | F | CN | A.6 |
| 1339. | CF₃ | F | CN | A.6 |
| 1340. | OCH₃ | F | CN | A.6 |
| 1341. | OCF₃ | F | CN | A.6 |
| 1342. | CH₂CH₃ | F | CN | A.6 |
| 1343. | H | Cl | CN | A.6 |
| 1344. | F | Cl | CN | A.6 |
| 1345. | Cl | Cl | CN | A.6 |
| 1346. | Br | Cl | CN | A.6 |
| 1347. | I | Cl | CN | A.6 |
| 1348. | CN | Cl | CN | A.6 |
| 1349. | CH₃ | Cl | CN | A.6 |
| 1350. | CF₃ | Cl | CN | A.6 |
| 1351. | OCH₃ | Cl | CN | A.6 |
| 1352. | OCF₃ | Cl | CN | A.6 |
| 1353. | CH₂CH₃ | Cl | CN | A.6 |
| 1354. | H | H | CH₃ | A.6 |
| 1355. | F | H | CH₃ | A.6 |
| 1356. | Cl | H | CH₃ | A.6 |
| 1357. | Br | H | CH₃ | A.6 |
| 1358. | I | H | CH₃ | A.6 |
| 1359. | CN | H | CH₃ | A.6 |
| 1360. | CH₃ | H | CH₃ | A.6 |
| 1361. | CF | H | CH₃ | A.6 |
| 1362. | OCH₃ | H | CH₃ | A.6 |
| 1363. | OCF₃ | H | CH₃ | A.6 |
| 1364. | CH₂CH₃ | H | CH₃ | A.6 |
| 1365. | H | F | CH₃ | A.6 |
| 1366. | F | F | CH₃ | A.6 |
| 1367. | Cl | F | CH₃ | A.6 |
| 1368. | Br | F | CH₃ | A.6 |
| 1369. | I | F | CH₃ | A.6 |
| 1370. | CN | F | CH₃ | A.6 |
| 1371. | CH₃ | F | CH₃ | A.6 |
| 1372. | CF | F | CH₃ | A.6 |
| 1373. | OCH₃ | F | CH₃ | A.6 |
| 1374. | OCF₃ | F | CH₃ | A.6 |
| 1375. | CH₂CH₃ | F | CH₃ | A.6 |
| 1376. | H | Cl | CH₃ | A.6 |
| 1377. | F | Cl | CH₃ | A.6 |
| 1378. | Cl | Cl | CH₃ | A.6 |
| 1379. | Br | Cl | CH₃ | A.6 |
| 1380. | I | Cl | CH₃ | A.6 |
| 1381. | CN | Cl | CH₃ | A.6 |
| 1382. | CH₃ | Cl | CH₃ | A.6 |
| 1383. | CF₃ | Cl | CH₃ | A.6 |
| 1384. | OCH₃ | Cl | CH₃ | A.6 |
| 1385. | OCF₃ | Cl | CH₃ | A.6 |
| 1386. | CH₂CH₃ | Cl | CH₃ | A.6 |
| 1387. | H | H | H | A.7 |
| 1388. | F | H | H | A.7 |
| 1389. | Cl | H | H | A.7 |
| 1390. | Br | H | H | A.7 |
| 1391. | I | H | H | A.7 |
| 1392. | CN | H | H | A.7 |
| 1393. | CH₃ | H | H | A.7 |
| 1394. | CF₃ | H | H | A.7 |
| 1395. | OCH₃ | H | H | A.7 |
| 1396. | OCF₃ | H | H | A.7 |
| 1397. | CH₂CH₃ | H | H | A.7 |
| 1398. | H | F | H | A.7 |
| 1399. | F | F | H | A.7 |
| 1400. | Cl | F | H | A.7 |
| 1401. | Br | F | H | A.7 |
| 1402. | I | F | H | A.7 |
| 1403. | CN | F | H | A.7 |
| 1404. | CH₃ | F | H | A.7 |
| 1405. | CF₃ | F | H | A.7 |
| 1406. | OCH₃ | F | H | A.7 |
| 1407. | OCF₃ | F | H | A.7 |
| 1408. | CH₂CH₃ | F | H | A.7 |
| 1409. | H | Cl | H | A.7 |
| 1410. | F | Cl | H | A.7 |
| 1411. | Cl | Cl | H | A.7 |
| 1412. | Br | Cl | H | A.7 |
| 1413. | I | Cl | H | A.7 |
| 1414. | CN | Cl | H | A.7 |
| 1415. | CH₃ | Cl | H | A.7 |
| 1416. | CF₃ | Cl | H | A.7 |
| 1417. | OCH₃ | Cl | H | A.7 |
| 1418. | OCF₃ | Cl | H | A.7 |
| 1419. | CH₂CH₃ | Cl | H | A.7 |
| 1420. | H | H | F | A.7 |
| 1421. | F | H | F | A.7 |
| 1422. | Cl | H | F | A.7 |
| 1423. | Br | H | F | A.7 |
| 1424. | I | H | F | A.7 |
| 1425. | CN | H | F | A.7 |
| 1426. | CH₃ | H | F | A.7 |
| 1427. | CF₃ | H | F | A.7 |
| 1428. | OCH₃ | H | F | A.7 |
| 1429. | OCF₃ | H | F | A.7 |
| 1430. | CH₂CH₃ | H | F | A.7 |
| 1431. | H | F | F | A.7 |
| 1432. | F | F | F | A.7 |
| 1433. | Cl | F | F | A.7 |
| 1434. | Br | F | F | A.7 |
| 1435. | I | F | F | A.7 |
| 1436. | CN | F | F | A.7 |
| 1437. | CH₃ | F | F | A.7 |
| 1438. | CF₃ | F | F | A.7 |
| 1439. | OCH₃ | F | F | A.7 |
| 1440. | OCF₃ | F | F | A.7 |
| 1441. | CH₂CH₃ | F | F | A.7 |
| 1442. | H | Cl | F | A.7 |
| 1443. | F | Cl | F | A.7 |
| 1444. | Cl | Cl | F | A.7 |
| 1445. | Br | Cl | F | A.7 |
| 1446. | I | Cl | F | A.7 |
| 1447. | CN | Cl | F | A.7 |
| 1448. | CH₃ | Cl | F | A.7 |
| 1449. | CF₃ | Cl | F | A.7 |
| 1450. | OCH₃ | Cl | F | A.7 |
| 1451. | OCF₃ | Cl | F | A.7 |
| 1452. | CH₂CH₃ | Cl | F | A.7 |
| 1453. | H | H | Cl | A.7 |
| 1454. | F | H | Cl | A.7 |
| 1455. | Cl | H | Cl | A.7 |
| 1456. | Br | H | Cl | A.7 |
| 1457. | I | H | Cl | A.7 |
| 1458. | CN | H | Cl | A.7 |
| 1459. | CH₃ | H | Cl | A.7 |
| 1460. | CF₃ | H | Cl | A.7 |
| 1461. | OCH₃ | H | Cl | A.7 |
| 1462. | OCF₃ | H | Cl | A.7 |
| 1463. | CH₂CH₃ | H | Cl | A.7 |
| 1464. | H | F | Cl | A.7 |
| 1465. | F | F | Cl | A.7 |
| 1466. | Cl | F | Cl | A.7 |
| 1467. | Br | F | Cl | A.7 |
| 1468. | I | F | Cl | A.7 |
| 1469. | CN | F | Cl | A.7 |
| 1470. | CH₃ | F | Cl | A.7 |
| 1471. | CF₃ | F | Cl | A.7 |
| 1472. | OCH₃ | F | Cl | A.7 |
| 1473. | OCF₃ | F | Cl | A.7 |
| 1474. | CH₂CH₃ | F | Cl | A.7 |
| 1475. | H | Cl | Cl | A.7 |
| 1476. | F | Cl | Cl | A.7 |
| 1477. | Cl | Cl | Cl | A.7 |
| 1478. | Br | Cl | Cl | A.7 |
| 1479. | I | Cl | Cl | A.7 |
| 1480. | CN | Cl | Cl | A.7 |
| 1481. | CH₃ | Cl | Cl | A.7 |
| 1482. | CF₃ | Cl | Cl | A.7 |
| 1483. | OCH₃ | Cl | Cl | A.7 |
| 1484. | OCF₃ | Cl | Cl | A.7 |
| 1485. | CH₂CH₃ | Cl | Cl | A.7 |
| 1486. | H | H | Br | A.7 |
| 1487. | F | H | Br | A.7 |
| 1488. | Cl | H | Br | A.7 |
| 1489. | Br | H | Br | A.7 |
| 1490. | I | H | Br | A.7 |
| 1491. | CN | H | Br | A.7 |
| 1492. | CH₃ | H | Br | A.7 |
| 1493. | CF₃ | H | Br | A.7 |
| 1494. | OCH₃ | H | Br | A.7 |
| 1495. | OCF₃ | H | Br | A.7 |
| 1496. | CH₂CH₃ | H | Br | A.7 |
| 1497. | H | F | Br | A.7 |
| 1498. | F | F | Br | A.7 |
| 1499. | Cl | F | Br | A.7 |
| 1500. | Br | F | Br | A.7 |
| 1501. | I | F | Br | A.7 |
| 1502. | CN | F | Br | A.7 |
| 1503. | CH₃ | F | Br | A.7 |
| 1504. | CF₃ | F | Br | A.7 |
| 1505. | OCH₃ | F | Br | A.7 |
| 1506. | OCF₃ | F | Br | A.7 |
| 1507. | CH₂CH₃ | F | Br | A.7 |
| 1508. | H | Cl | Br | A.7 |
| 1509. | F | Cl | Br | A.7 |
| 1510. | Cl | Cl | Br | A.7 |
| 1511. | Br | Cl | Br | A.7 |
| 1512. | I | Cl | Br | A.7 |
| 1513. | CN | Cl | Br | A.7 |
| 1514. | CH₃ | Cl | Br | A.7 |
| 1515. | CF₃ | Cl | Br | A.7 |
| 1516. | OCH₃ | Cl | Br | A.7 |
| 1517. | OCF₃ | Cl | Br | A.7 |
| 1518. | CH₂CH₃ | Cl | Br | A.7 |
| 1519. | H | H | I | A.7 |
| 1520. | F | H | I | A.7 |
| 1521. | Cl | H | I | A.7 |
| 1522. | Br | H | I | A.7 |
| 1523. | I | H | I | A.7 |
| 1524. | CN | H | I | A.7 |
| 1525. | CH₃ | H | I | A.7 |
| 1526. | CF₃ | H | I | A.7 |
| 1527. | OCH₃ | H | I | A.7 |
| 1528. | OCF₃ | H | I | A.7 |
| 1529. | CH₂CH₃ | H | I | A.7 |
| 1530. | H | F | I | A.7 |
| 1531. | F | F | I | A.7 |
| 1532. | Cl | F | I | A.7 |
| 1533. | Br | F | I | A.7 |
| 1534. | I | F | I | A.7 |
| 1535. | CN | F | I | A.7 |
| 1536. | CH₃ | F | I | A.7 |
| 1537. | CF₃ | F | I | A.7 |
| 1538. | OCH₃ | F | I | A.7 |
| 1539. | OCF₃ | F | I | A.7 |
| 1540. | CH₂CH₃ | F | I | A.7 |
| 1541. | H | Cl | I | A.7 |
| 1542. | F | Cl | I | A.7 |
| 1543. | Cl | Cl | I | A.7 |
| 1544. | Br | Cl | I | A.7 |
| 1545. | I | Cl | I | A.7 |
| 1546. | CN | Cl | I | A.7 |
| 1547. | CH₃ | Cl | I | A.7 |
| 1548. | CF₃ | Cl | I | A.7 |
| 1549. | OCH₃ | Cl | I | A.7 |
| 1550. | OCF₃ | Cl | I | A.7 |
| 1551. | CH₂CH₃ | Cl | I | A.7 |
| 1552. | H | H | CN | A.7 |
| 1553. | F | H | CN | A.7 |
| 1554. | Cl | H | CN | A.7 |
| 1555. | Br | H | CN | A.7 |
| 1556. | I | H | CN | A.7 |
| 1557. | CN | H | CN | A.7 |
| 1558. | CH₃ | H | CN | A.7 |
| 1559. | CF₃ | H | CN | A.7 |
| 1560. | OCH₃ | H | CN | A.7 |
| 1561. | OCF₃ | H | CN | A.7 |
| 1562. | CH₂CH₃ | H | CN | A.7 |
| 1563. | H | F | CN | A.7 |
| 1564. | F | F | CN | A.7 |
| 1565. | Cl | F | CN | A.7 |
| 1566. | Br | F | CN | A.7 |
| 1567. | I | F | CN | A.7 |
| 1568. | CN | F | CN | A.7 |
| 1569. | CH₃ | F | CN | A.7 |
| 1570. | CF₃ | F | CN | A.7 |
| 1571. | OCH₃ | F | CN | A.7 |
| 1572. | OCF₃ | F | CN | A.7 |
| 1573. | CH₂CH₃ | F | CN | A.7 |
| 1574. | H | Cl | CN | A.7 |
| 1575. | F | Cl | CN | A.7 |
| 1576. | Cl | Cl | CN | A.7 |
| 1577. | Br | Cl | CN | A.7 |
| 1578. | I | Cl | CN | A.7 |
| 1579. | CN | Cl | CN | A.7 |
| 1580. | CH₃ | Cl | CN | A.7 |
| 1581 | CF₃ | Cl | CN | A.7 |
| 1582. | OCH₃ | Cl | CN | A.7 |
| 1583. | OCF₃ | Cl | CN | A.7 |
| 1584. | CH₂CH₃ | Cl | CN | A.7 |
| 1585. | H | H | CH₃ | A.7 |
| 1586. | F | H | CH₃ | A.7 |
| 1587. | Cl | H | CH₃ | A.7 |
| 1588. | Br | H | CH₃ | A.7 |
| 1589. | I | H | CH₃ | A.7 |
| 1590. | CN | H | CH₃ | A.7 |
| 1591. | CH₃ | H | CH₃ | A.7 |
| 1592. | CF₃ | H | CH₃ | A.7 |
| 1593. | OCH₃ | H | CH₃ | A.7 |
| 1594. | OCF₃ | H | CH₃ | A.7 |
| 1595. | CH₂CH₃ | H | CH₃ | A.7 |
| 1596. | H | F | CH₃ | A.7 |
| 1597. | F | F | CH₃ | A.7 |
| 1598. | Cl | F | CH₃ | A.7 |
| 1599. | Br | F | CH₃ | A.7 |
| 1600. | I | F | CH₃ | A.7 |
| 1601. | CN | F | CH₃ | A.7 |
| 1602. | CH₃ | F | CH₃ | A.7 |
| 1603. | CF₃ | F | CH₃ | A.7 |
| 1604. | OCH₃ | F | CH₃ | A.7 |
| 1605. | OCF₃ | F | CH₃ | A.7 |
| 1606. | CH₂CH₃ | F | CH₃ | A.7 |
| 1607. | H | Cl | CH₃ | A.7 |
| 1608. | F | Cl | CH₃ | A.7 |
| 1609. | Cl | Cl | CH₃ | A.7 |
| 1610. | Br | Cl | CH₃ | A.7 |
| 1611. | I | Cl | CH₃ | A.7 |
| 1612. | CN | Cl | CH₃ | A.7 |
| 1613. | CH₃ | Cl | CH₃ | A.7 |
| 1614. | CF₃ | Cl | CH₃ | A.7 |
| 1615. | OCH₃ | Cl | CH₃ | A.7 |
| 1616. | OCF₃ | Cl | CH₃ | A.7 |
| 1617. | CH₂CH₃ | Cl | CH₃ | A.7 |
| 1618. | H | H | H | A.8 |
| 1619. | F | H | H | A.8 |
| 1620. | Cl | H | H | A.8 |
| 1621. | Br | H | H | A.8 |
| 1622. | I | H | H | A.8 |
| 1623. | CN | H | H | A.8 |
| 1624. | CH₃ | H | H | A.8 |
| 1625. | CF₃ | H | H | A.8 |
| 1626. | OCH₃ | H | H | A.8 |
| 1627. | OCF₃ | H | H | A.8 |
| 1628. | CH₂CH₃ | H | H | A.8 |
| 1629. | H | F | H | A.8 |
| 1630. | F | F | H | A.8 |
| 1631. | Cl | F | H | A.8 |
| 1632. | Br | F | H | A.8 |
| 1633. | I | F | H | A.8 |
| 1634. | CN | F | H | A.8 |
| 1635. | CH₃ | F | H | A.8 |
| 1636. | CF₃ | F | H | A.8 |
| 1637. | OCH₃ | F | H | A.8 |
| 1638. | OCF₃ | F | H | A.8 |
| 1639. | CH₂CH₃ | F | H | A.8 |
| 1640. | H | Cl | H | A.8 |
| 1641. | F | Cl | H | A.8 |
| 1642 | Cl | Cl | H | A.8 |
| 1643. | Br | Cl | H | A.8 |
| 1644. | I | Cl | H | A.8 |
| 1645. | CN | Cl | H | A.8 |
| 1646. | CH₃ | Cl | H | A.8 |
| 1647. | CF₃ | Cl | H | A.8 |
| 1648. | OCH₃ | Cl | H | A.8 |
| 1649. | OCF₃ | Cl | H | A.8 |
| 1650. | CH₂CH₃ | Cl | H | A.8 |
| 1651. | H | H | F | A.8 |
| 1652. | F | H | F | A.8 |
| 1653. | Cl | H | F | A.8 |
| 1654. | Br | H | F | A.8 |
| 1655. | I | H | F | A.8 |
| 1656. | CN | H | F | A.8 |
| 1657. | CH₃ | H | F | A.8 |
| 1658. | CF₃ | H | F | A.8 |
| 1659. | OCH₃ | H | F | A.8 |
| 1660. | OCF₃ | H | F | A.8 |
| 1661. | CH₂CH₃ | H | F | A.8 |
| 1662. | H | F | F | A.8 |
| 1663. | F | F | F | A.8 |
| 1664. | Cl | F | F | A.8 |
| 1665. | Br | F | F | A.8 |
| 1666. | I | F | F | A.8 |
| 1667. | CN | F | F | A.8 |
| 1668. | CH₃ | F | F | A.8 |
| 1669. | CF₃ | F | F | A.8 |
| 1670. | OCH₃ | F | F | A.8 |
| 1671. | OCF₃ | F | F | A.8 |
| 1672. | CH₂CH₃ | F | F | A.8 |
| 1673. | H | Cl | F | A.8 |
| 1674. | F | Cl | F | A.8 |
| 1675. | Cl | Cl | F | A.8 |
| 1676. | Br | Cl | F | A.8 |
| 1677. | I | Cl | F | A.8 |
| 1678. | CN | Cl | F | A.8 |
| 1679. | CH₃ | Cl | F | A.8 |
| 1680. | CF₃ | Cl | F | A.8 |
| 1681. | OCH₃ | Cl | F | A.8 |
| 1682. | OCF₃ | Cl | F | A.8 |
| 1683. | CH₂CH₃ | Cl | F | A.8 |
| 1684. | H | H | Cl | A.8 |
| 1685. | F | H | Cl | A.8 |
| 1686. | Cl | H | Cl | A.8 |
| 1687. | Br | H | Cl | A.8 |
| 1688. | I | H | Cl | A.8 |
| 1689. | CN | H | Cl | A.8 |
| 1690. | CH₃ | H | Cl | A.8 |
| 1691. | CF₃ | H | Cl | A.8 |
| 1692. | OCH₃ | H | Cl | A.8 |
| 1693. | OCF₃ | H | Cl | A.8 |
| 1694. | CH₂CH₃ | H | Cl | A.8 |
| 1695. | H | F | Cl | A.8 |
| 1696. | F | F | Cl | A.8 |
| 1697. | Cl | F | Cl | A.8 |
| 1698. | Br | F | Cl | A.8 |
| 1699. | I | F | Cl | A.8 |
| 1700. | CN | F | Cl | A.8 |
| 1701. | CH₃ | F | Cl | A.8 |
| 1702. | CF₃ | F | Cl | A.8 |
| 1703. | OCH₃ | F | Cl | A.8 |
| 1704. | OCF₃ | F | Cl | A.8 |
| 1705. | CH₂CH₃ | F | Cl | A.8 |
| 1706. | H | Cl | Cl | A.8 |
| 1707. | F | Cl | Cl | A.8 |
| 1708. | Cl | Cl | Cl | A.8 |
| 1709. | Br | Cl | Cl | A.8 |
| 1710. | I | Cl | Cl | A.8 |
| 1711. | CN | Cl | Cl | A.8 |
| 1712. | CH₃ | Cl | Cl | A.8 |
| 1713. | CF₃ | Cl | Cl | A.8 |
| 1714. | OCH₃ | Cl | Cl | A.8 |
| 1715. | OCF₃ | Cl | Cl | A.8 |
| 1716. | CH₂CH₃ | Cl | Cl | A.8 |
| 1717. | H | H | Br | A.8 |
| 1718. | F | H | Br | A.8 |
| 1719. | Cl | H | Br | A.8 |
| 1720. | Br | H | Br | A.8 |
| 1721. | I | H | Br | A.8 |
| 1722. | CN | H | Br | A.8 |
| 1723. | CH₃ | H | Br | A.8 |
| 1724. | CF₃ | H | Br | A.8 |
| 1725. | OCH₃ | H | Br | A.8 |
| 1726. | OCF₃ | H | Br | A.8 |
| 1727. | CH₂CH₃ | H | Br | A.8 |
| 1728. | H | F | Br | A.8 |
| 1729. | F | F | Br | A.8 |
| 1730. | Cl | F | Br | A.8 |
| 1731. | Br | F | Br | A.8 |
| 1732. | I | F | Br | A.8 |
| 1733. | CN | F | Br | A.8 |
| 1734. | CH₃ | F | Br | A.8 |
| 1735. | CF₃ | F | Br | A.8 |
| 1736. | OCH₃ | F | Br | A.8 |
| 1737. | OCF₃ | F | Br | A.8 |
| 1738. | CH₂CH₃ | F | Br | A.8 |
| 1739. | H | Cl | Br | A.8 |
| 1740. | F | Cl | Br | A.8 |
| 1741. | Cl | Cl | Br | A.8 |
| 1742. | Br | Cl | Br | A.8 |
| 1743. | I | Cl | Br | A.8 |
| 1744. | CN | Cl | Br | A.8 |
| 1745. | CH₃ | Cl | Br | A.8 |
| 1746. | CF₃ | Cl | Br | A.8 |
| 1747. | OCH₃ | Cl | Br | A.8 |
| 1748. | OCF₃ | Cl | Br | A.8 |
| 1749. | CH₂CH₃ | Cl | Br | A.8 |
| 1750. | H | H | I | A.8 |
| 1751. | F | H | I | A.8 |
| 1752. | Cl | H | I | A.8 |
| 1753. | Br | H | I | A.8 |
| 1754. | I | H | I | A.8 |
| 1755. | CN | H | I | A.8 |
| 1756. | CH₃ | H | I | A.8 |
| 1757. | CF₃ | H | I | A.8 |
| 1758. | OCH₃ | H | I | A.8 |
| 1759. | OCF₃ | H | I | A.8 |
| 1760. | CH₂CH₃ | H | I | A.8 |
| 1761. | H | F | I | A.8 |
| 1762. | F | F | I | A.8 |
| 1763. | Cl | F | I | A.8 |
| 1764. | Br | F | I | A.8 |
| 1765. | I | F | I | A.8 |
| 1766. | CN | F | I | A.8 |
| 1767. | CH₃ | F | I | A.8 |
| 1768. | CF₃ | F | I | A.8 |
| 1769. | OCH₃ | F | I | A.8 |
| 1770. | OCF₃ | F | I | A.8 |
| 1771. | CH₂CH₃ | F | I | A.8 |
| 1772. | H | Cl | I | A.8 |
| 1773. | F | Cl | I | A.8 |
| 1774. | Cl | Cl | I | A.8 |
| 1775. | Br | Cl | I | A.8 |
| 1776. | I | Cl | I | A.8 |
| 1777. | CN | Cl | I | A.8 |
| 1778. | CH₃ | Cl | I | A.8 |
| 1779. | CF₃ | Cl | I | A.8 |
| 1780. | OCH₃ | Cl | I | A.8 |
| 1781. | OCF₃ | Cl | I | A.8 |
| 1782. | CH₂CH₃ | Cl | I | A.8 |
| 1783. | H | H | CN | A.8 |
| 1784. | F | H | CN | A.8 |
| 1785. | Cl | H | CN | A.8 |
| 1786. | Br | H | CN | A.8 |
| 1787. | I | H | CN | A.8 |
| 1788. | CN | H | CN | A.8 |
| 1789. | CH₃ | H | CN | A.8 |
| 1790. | CF₃ | H | CN | A.8 |
| 1791. | OCH₃ | H | CN | A.8 |
| 1792. | OCF₃ | H | CN | A.8 |
| 1793. | CH₂CH₃ | H | CN | A.8 |
| 1794. | H | F | CN | A.8 |
| 1795. | F | F | CN | A.8 |
| 1796. | Cl | F | CN | A.8 |
| 1797. | Br | F | CN | A.8 |
| 1798. | I | F | CN | A.8 |
| 1799. | CN | F | CN | A.8 |
| 1800. | CH₃ | F | CN | A.8 |
| 1801. | CF₃ | F | CN | A.8 |
| 1802. | OCH₃ | F | CN | A.8 |
| 1803. | OCF₃ | F | CN | A.8 |
| 1804. | CH₂CH₃ | F | CN | A.8 |
| 1805. | H | Cl | CN | A.8 |
| 1806. | F | Cl | CN | A.8 |
| 1807. | Cl | Cl | CN | A.8 |
| 1808. | Br | Cl | CN | A.8 |
| 1809. | I | Cl | CN | A.8 |
| 1810. | CN | Cl | CN | A.8 |
| 1811. | CH₃ | Cl | CN | A.8 |
| 1812. | CF₃ | Cl | CN | A.8 |
| 1813. | OCH₃ | Cl | CN | A.8 |
| 1814. | OCF₃ | Cl | CN | A.8 |
| 1815. | CH₂CH₃ | Cl | CN | A.8 |
| 1816. | H | H | CH₃ | A.8 |
| 1817. | F | H | CH₃ | A.8 |
| 1818. | Cl | H | CH₃ | A.8 |
| 1819. | Br | H | CH₃ | A.8 |
| 1820. | I | H | CH₃ | A.8 |
| 1821. | CN | H | CH₃ | A.8 |
| 1822. | CH₃ | H | CH₃ | A.8 |
| 1823. | CF₃ | H | CH₃ | A.8 |
| 1824. | OCH₃ | H | CH₃ | A.8 |
| 1825. | OCF₃ | H | CH₃ | A.8 |
| 1826. | CH₂CH₃ | H | CH₃ | A.8 |
| 1827. | H | F | CH₃ | A.8 |
| 1828. | F | F | CH₃ | A.8 |
| 1829. | Cl | F | CH₃ | A.8 |
| 1830. | Br | F | CH₃ | A.8 |
| 1831. | I | F | CH₃ | A.8 |
| 1832. | CN | F | CH₃ | A.8 |
| 1833. | CH₃ | F | CH₃ | A.8 |
| 1834. | CF₃ | F | CH₃ | A.8 |
| 1835. | OCH₃ | F | CH₃ | A.8 |
| 1836. | OCF₃ | F | CH₃ | A.8 |
| 1837. | CH₂CH₃ | F | CH₃ | A.8 |
| 1838. | H | Cl | CH₃ | A.8 |
| 1839. | F | Cl | CH₃ | A.8 |
| 1840. | Cl | Cl | CH₃ | A.8 |
| 1841. | Br | Cl | CH₃ | A.8 |
| 1842. | I | Cl | CH₃ | A.8 |
| 1843. | CN | Cl | CH₃ | A.8 |
| 1844. | CH₃ | Cl | CH₃ | A.8 |
| 1845. | CF₃ | Cl | CH₃ | A.8 |
| 1846. | OCH₃ | Cl | CH₃ | A.8 |
| 1847. | OCF₃ | Cl | CH₃ | A.8 |
| 1848. | CH₂CH₃ | Cl | CH₃ | A.8 |
| 1849. | H | H | H | A.9 |
| 1850. | F | H | H | A.9 |
| 1851. | Cl | H | H | A.9 |
| 1852. | Br | H | H | A.9 |
| 1853. | I | H | H | A.9 |
| 1854. | CN | H | H | A.9 |
| 1855. | CH₃ | H | H | A.9 |
| 1856. | CF₃ | H | H | A.9 |
| 1857. | OCH₃ | H | H | A.9 |
| 1858. | OCF₃ | H | H | A.9 |
| 1859. | CH₂CH₃ | H | H | A.9 |
| 1860. | H | F | H | A.9 |
| 1861. | F | F | H | A.9 |
| 1862. | Cl | F | H | A.9 |
| 1863. | Br | F | H | A.9 |
| 1864. | I | F | H | A.9 |
| 1865. | CN | F | H | A.9 |
| 1866. | CH₃ | F | H | A.9 |
| 1867. | CF₃ | F | H | A.9 |
| 1868. | OCH₃ | F | H | A.9 |
| 1869. | OCF₃ | F | H | A.9 |
| 1870. | CH₂CH₃ | F | H | A.9 |
| 1871. | H | Cl | H | A.9 |
| 1872. | F | Cl | H | A.9 |
| 1873. | Cl | Cl | H | A.9 |
| 1874. | Br | Cl | H | A.9 |
| 1875. | I | Cl | H | A.9 |
| 1876. | CN | Cl | H | A.9 |
| 1877. | CH₃ | Cl | H | A.9 |
| 1878. | CF₃ | Cl | H | A.9 |
| 1879. | OCH₃ | Cl | H | A.9 |
| 1880. | OCF₃ | Cl | H | A.9 |
| 1881. | CH₂CH₃ | Cl | H | A.9 |
| 1882. | H | H | F | A.9 |
| 1883. | F | H | F | A.9 |
| 1884. | Cl | H | F | A.9 |
| 1885. | Br | H | F | A.9 |
| 1886. | I | H | F | A.9 |
| 1887. | CN | H | F | A.9 |
| 1888. | CH₃ | H | F | A.9 |
| 1889. | CF₃ | H | F | A.9 |
| 1890. | OCH₃ | H | F | A.9 |
| 1891. | OCF₃ | H | F | A.9 |
| 1892. | CH₂CH₃ | H | F | A.9 |
| 1893. | H | F | F | A.9 |
| 1894. | F | F | F | A.9 |
| 1895. | Cl | F | F | A.9 |
| 1896. | Br | F | F | A.9 |
| 1897. | I | F | F | A.9 |
| 1898. | CN | F | F | A.9 |
| 1899. | CH₃ | F | F | A.9 |
| 1900. | CF | F | F | A.9 |
| 1901. | OCH₃ | F | F | A.9 |
| 1902. | OCF₃ | F | F | A.9 |
| 1903. | CH₂CH₃ | F | F | A.9 |
| 1904. | H | Cl | F | A.9 |
| 1905. | F | Cl | F | A.9 |
| 1906. | Cl | Cl | F | A.9 |
| 1907. | Br | Cl | F | A.9 |
| 1908. | I | Cl | F | A.9 |
| 1909. | CN | Cl | F | A.9 |
| 1910. | CH₃ | Cl | F | A.9 |
| 1911. | CF₃ | Cl | F | A.9 |
| 1912. | OCH₃ | Cl | F | A.9 |
| 1913. | OCF₃ | Cl | F | A.9 |
| 1914. | CH₂CH₃ | Cl | F | A.9 |
| 1915. | H | H | Cl | A.9 |
| 1916. | F | H | Cl | A.9 |
| 1917. | Cl | H | Cl | A.9 |
| 1918. | Br | H | Cl | A.9 |
| 1919. | I | H | Cl | A.9 |
| 1920. | CN | H | Cl | A.9 |
| 1921. | CH₃ | H | Cl | A.9 |
| 1922. | CF₃ | H | Cl | A.9 |
| 1923. | OCH₃ | H | Cl | A.9 |
| 1924. | OCF₃ | H | Cl | A.9 |
| 1925. | CH₂CH₃ | H | Cl | A.9 |
| 1926. | H | F | Cl | A.9 |
| 1927. | F | F | Cl | A.9 |
| 1928. | Cl | F | Cl | A.9 |
| 1929. | Br | F | Cl | A.9 |
| 1930. | I | F | Cl | A.9 |
| 1931. | CN | F | Cl | A.9 |
| 1932. | CH₃ | F | Cl | A.9 |
| 1933. | CF₃ | F | Cl | A.9 |
| 1934. | OCH₃ | F | Cl | A.9 |
| 1935. | OCF₃ | F | Cl | A.9 |
| 1936. | CH₂CH₃ | F | Cl | A.9 |
| 1937. | H | Cl | Cl | A.9 |
| 1938. | F | Cl | Cl | A.9 |
| 1939. | Cl | Cl | Cl | A.9 |
| 1940. | Br | Cl | Cl | A.9 |
| 1941. | I | Cl | Cl | A.9 |
| 1942. | CN | Cl | Cl | A.9 |
| 1943. | CH₃ | Cl | Cl | A.9 |
| 1944. | CF₃ | Cl | Cl | A.9 |
| 1945. | OCH₃ | Cl | Cl | A.9 |
| 1946. | OCF₃ | Cl | Cl | A.9 |
| 1947. | CH₂CH₃ | Cl | Cl | A.9 |
| 1948. | H | H | Br | A.9 |
| 1949. | F | H | Br | A.9 |
| 1950. | Cl | H | Br | A.9 |
| 1951. | Br | H | Br | A.9 |
| 1952. | I | H | Br | A.9 |
| 1953. | CN | H | Br | A.9 |
| 1954. | CH₃ | H | Br | A.9 |
| 1955. | CF₃ | H | Br | A.9 |
| 1956. | OCH₃ | H | Br | A.9 |
| 1957. | OCF₃ | H | Br | A.9 |
| 1958. | CH₂CH₃ | H | Br | A.9 |
| 1959. | H | F | Br | A.9 |
| 1960. | F | F | Br | A.9 |
| 1961. | Cl | F | Br | A.9 |
| 1962. | Br | F | Br | A.9 |
| 1963. | I | F | Br | A.9 |
| 1964. | CN | F | Br | A.9 |
| 1965. | CH₃ | F | Br | A.9 |
| 1966. | CF₃ | F | Br | A.9 |
| 1967. | OCH₃ | F | Br | A.9 |
| 1968. | OCF₃ | F | Br | A.9 |
| 1969. | CH₂CH₃ | F | Br | A.9 |
| 1970. | H | Cl | Br | A.9 |
| 1971. | F | Cl | Br | A.9 |
| 1972. | Cl | Cl | Br | A.9 |
| 1973. | Br | Cl | Br | A.9 |
| 1974. | I | Cl | Br | A.9 |
| 1975. | CN | Cl | Br | A.9 |
| 1976. | CH₃ | Cl | Br | A.9 |
| 1977. | CF₃ | Cl | Br | A.9 |
| 1978. | OCH₃ | Cl | Br | A.9 |
| 1979. | OCF₃ | Cl | Br | A.9 |
| 1980. | CH₂CH₃ | Cl | Br | A.9 |
| 1981. | H | H | I | A.9 |
| 1982. | F | H | I | A.9 |
| 1983. | Cl | H | I | A.9 |
| 1984. | Br | H | I | A.9 |
| 1985. | I | H | I | A.9 |
| 1986. | CN | H | I | A.9 |
| 1987. | CH₃ | H | I | A.9 |
| 1988. | CF₃ | H | I | A.9 |
| 1989. | OCH₃ | H | I | A.9 |
| 1990. | OCF₃ | H | I | A.9 |
| 1991. | CH₂CH₃ | H | I | A.9 |
| 1992. | H | F | I | A.9 |
| 1993. | F | F | I | A.9 |
| 1994. | Cl | F | I | A.9 |
| 1995. | Br | F | I | A.9 |
| 1996. | I | F | I | A.9 |
| 1997. | CN | F | I | A.9 |
| 1998. | CH₃ | F | I | A.9 |
| 1999. | CF₃ | F | I | A.9 |
| 2000. | OCH₃ | F | I | A.9 |
| 2001. | OCF₃ | F | I | A.9 |
| 2002. | CH₂CH₃ | F | I | A.9 |
| 2003. | H | Cl | I | A.9 |
| 2004. | F | Cl | I | A.9 |
| 2005. | Cl | Cl | I | A.9 |
| 2006. | Br | Cl | I | A.9 |
| 2007. | I | Cl | I | A.9 |
| 2008. | CN | Cl | I | A.9 |
| 2009. | CH₃ | Cl | I | A.9 |
| 2010. | CF₃ | Cl | I | A.9 |
| 2011. | OCH₃ | Cl | I | A.9 |
| 2012. | OCF₃ | Cl | I | A.9 |
| 2013. | CH₂CH₃ | Cl | I | A.9 |
| 2014. | H | H | CN | A.9 |
| 2015. | F | H | CN | A.9 |
| 2016. | Cl | H | CN | A.9 |
| 2017. | Br | H | CN | A.9 |
| 2018. | I | H | CN | A.9 |
| 2019. | CN | H | CN | A.9 |
| 2020. | CH₃ | H | CN | A.9 |
| 2021. | CF₃ | H | CN | A.9 |
| 2022. | OCH₃ | H | CN | A.9 |
| 2023. | OCF₃ | H | CN | A.9 |
| 2024. | CH₂CH₃ | H | CN | A.9 |
| 2025. | H | F | CN | A.9 |
| 2026. | F | F | CN | A.9 |
| 2027. | Cl | F | CN | A.9 |
| 2028. | Br | F | CN | A.9 |
| 2029. | I | F | CN | A.9 |
| 2030. | CN | F | CN | A.9 |
| 2031. | CH₃ | F | CN | A.9 |
| 2032. | CF₃ | F | CN | A.9 |
| 2033. | OCH₃ | F | CN | A.9 |
| 2034. | OCF₃ | F | CN | A.9 |
| 2035. | CH₂CH₃ | F | CN | A.9 |
| 2036. | H | Cl | CN | A.9 |
| 2037. | F | Cl | CN | A.9 |
| 2038. | Cl | Cl | CN | A.9 |
| 2039. | Br | Cl | CN | A.9 |
| 2040. | I | Cl | CN | A.9 |
| 2041. | CN | Cl | CN | A.9 |
| 2042. | CH₃ | Cl | CN | A.9 |
| 2043. | CF₃ | Cl | CN | A.9 |
| 2044. | OCH₃ | Cl | CN | A.9 |
| 2045. | OCF₃ | Cl | CN | A.9 |
| 2046. | CH₂CH₃ | Cl | CN | A.9 |
| 2047. | H | H | CH₃ | A.9 |
| 2048. | F | H | CH₃ | A.9 |
| 2049. | Cl | H | CH₃ | A.9 |
| 2050. | Br | H | CH₃ | A.9 |
| 2051. | I | H | CH₃ | A.9 |
| 2052. | CN | H | CH₃ | A.9 |
| 2053. | CH₃ | H | CH₃ | A.9 |
| 2054. | CF₃ | H | CH₃ | A.9 |
| 2055. | OCH₃ | H | CH₃ | A.9 |
| 2056. | OCF₃ | H | CH₃ | A.9 |
| 2057. | CH₂CH₃ | H | CH₃ | A.9 |
| 2058. | H | F | CH₃ | A.9 |
| 2059. | F | F | CH₃ | A.9 |
| 2060. | Cl | F | CH₃ | A.9 |
| 2061. | Br | F | CH₃ | A.9 |
| 2062. | I | F | CH₃ | A.9 |
| 2063. | CN | F | CH₃ | A.9 |
| 2064. | CH₃ | F | CH₃ | A.9 |
| 2065. | CF₃ | F | CH₃ | A.9 |
| 2066. | OCH₃ | F | CH₃ | A.9 |
| 2067. | OCF₃ | F | CH₃ | A.9 |
| 2068. | CH₂CH₃ | F | CH₃ | A.9 |
| 2069. | H | Cl | CH₃ | A.9 |
| 2070. | F | Cl | CH₃ | A.9 |
| 2071. | Cl | Cl | CH₃ | A.9 |
| 2072. | Br | Cl | CH₃ | A.9 |
| 2073. | I | Cl | CH₃ | A.9 |
| 2074. | CN | Cl | CH₃ | A.9 |
| 2075. | CH₃ | Cl | CH₃ | A.9 |
| 2076. | CF₃ | Cl | CH₃ | A.9 |
| 2077. | OCH₃ | Cl | CH₃ | A.9 |
| 2078. | OCF₃ | Cl | CH₃ | A.9 |
| 2079. | CH₂CH₃ | Cl | CH₃ | A.9 |
| 2080. | H | H | H | A.10 |
| 2081. | F | H | H | A.10 |
| 2082. | Cl | H | H | A.10 |
| 2083. | Br | H | H | A.10 |
| 2084. | I | H | H | A.10 |
| 2085. | CN | H | H | A.10 |
| 2086. | CH₃ | H | H | A.10 |
| 2087. | CF₃ | H | H | A.10 |
| 2088. | OCH₃ | H | H | A.10 |
| 2089. | OCF₃ | H | H | A.10 |
| 2090. | CH₂CH₃ | H | H | A.10 |
| 2091. | H | F | H | A.10 |
| 2092. | F | F | H | A.10 |
| 2093. | Cl | F | H | A.10 |
| 2094. | Br | F | H | A.10 |
| 2095. | I | F | H | A.10 |
| 2096. | CN | F | H | A.10 |
| 2097. | CH₃ | F | H | A.10 |
| 2098. | CF₃ | F | H | A.10 |
| 2099. | OCH₃ | F | H | A.10 |
| 2100. | OCF₃ | F | H | A.10 |
| 2101. | CH₂CH₃ | F | H | A.10 |
| 2102. | H | Cl | H | A.10 |
| 2103. | F | Cl | H | A.10 |
| 2104. | Cl | Cl | H | A.10 |
| 2105. | Br | Cl | H | A.10 |
| 2106. | I | Cl | H | A.10 |
| 2107. | CN | Cl | H | A.10 |
| 2108. | CH₃ | Cl | H | A.10 |
| 2109. | CF₃ | Cl | H | A.10 |
| 2110. | OCH₃ | Cl | H | A.10 |
| 2111. | OCF₃ | Cl | H | A.10 |
| 2112. | CH₂CH₃ | Cl | H | A.10 |
| 2113. | H | H | F | A.10 |
| 2114. | F | H | F | A.10 |
| 2115. | Cl | H | F | A.10 |
| 2116. | Br | H | F | A.10 |
| 2117. | I | H | F | A.10 |
| 2118. | CN | H | F | A.10 |
| 2119. | CH₃ | H | F | A.10 |
| 2120. | CF₃ | H | F | A.10 |
| 2121. | OCH₃ | H | F | A.10 |
| 2122. | OCF₃ | H | F | A.10 |
| 2123. | CH₂CH₃ | H | F | A.10 |
| 2124. | H | F | F | A.10 |
| 2125. | F | F | F | A.10 |
| 2126. | Cl | F | F | A.10 |
| 2127. | Br | F | F | A.10 |
| 2128. | I | F | F | A.10 |
| 2129. | CN | F | F | A.10 |
| 2130. | CH | F | F | A.10 |
| 2131. | CF | F | F | A.10 |
| 2132. | OCH₃ | F | F | A.10 |
| 2133. | OCF₃ | F | F | A.10 |
| 2134. | CH₂CH₃ | F | F | A.10 |
| 2135. | H | Cl | F | A.10 |
| 2136. | F | Cl | F | A.10 |
| 2137. | Cl | Cl | F | A.10 |
| 2138. | Br | Cl | F | A.10 |
| 2139. | I | Cl | F | A.10 |
| 2140. | CN | Cl | F | A.10 |
| 2141. | CH₃ | Cl | F | A.10 |
| 2142. | CF₃ | Cl | F | A.10 |
| 2143. | OCH₃ | Cl | F | A.10 |
| 2144. | OCF₃ | Cl | F | A.10 |
| 2145. | CH₂CH₃ | Cl | F | A.10 |
| 2146. | H | H | Cl | A.10 |
| 2147. | F | H | Cl | A.10 |
| 2148. | Cl | H | Cl | A.10 |
| 2149. | Br | H | Cl | A.10 |
| 2150. | I | H | Cl | A.10 |
| 2151. | CN | H | Cl | A.10 |
| 2152. | CH₃ | H | Cl | A.10 |
| 2153. | CF₃ | H | Cl | A.10 |
| 2154. | OCH₃ | H | Cl | A.10 |
| 2155. | OCF₃ | H | Cl | A.10 |
| 2156. | CH₂CH₃ | H | Cl | A.10 |
| 2157. | H | F | Cl | A.10 |
| 2158. | F | F | Cl | A.10 |
| 2159. | Cl | F | Cl | A.10 |
| 2160. | Br | F | Cl | A.10 |
| 2161. | I | F | Cl | A.10 |
| 2162. | CN | F | Cl | A.10 |
| 2163. | CH₃ | F | Cl | A.10 |
| 2164. | CF₃ | F | Cl | A.10 |
| 2165. | OCH₃ | F | Cl | A.10 |
| 2166. | OCF₃ | F | Cl | A.10 |
| 2167. | CH₂CH₃ | F | Cl | A.10 |
| 2168. | H | Cl | Cl | A.10 |
| 2169. | F | Cl | Cl | A.10 |
| 2170. | Cl | Cl | Cl | A.10 |
| 2171. | Br | Cl | Cl | A.10 |
| 2172. | I | Cl | Cl | A.10 |
| 2173. | CN | Cl | Cl | A.10 |
| 2174. | CH₃ | Cl | Cl | A.10 |
| 2175. | CF₃ | Cl | Cl | A.10 |
| 2176. | OCH₃ | Cl | Cl | A.10 |
| 2177. | OCF₃ | Cl | Cl | A.10 |
| 2178. | CH₂CH₃ | Cl | Cl | A.10 |
| 2179. | H | H | Br | A.10 |
| 2180. | F | H | Br | A.10 |
| 2181. | Cl | H | Br | A.10 |
| 2182. | Br | H | Br | A.10 |
| 2183. | I | H | Br | A.10 |
| 2184. | CN | H | Br | A.10 |
| 2185. | CH₃ | H | Br | A.10 |
| 2186. | CF₃ | H | Br | A.10 |
| 2187. | OCH₃ | H | Br | A.10 |
| 2188. | OCF₃ | H | Br | A.10 |
| 2189. | CH₂CH₃ | H | Br | A.10 |
| 2190. | H | F | Br | A.10 |
| 2191. | F | F | Br | A.10 |
| 2192. | Cl | F | Br | A.10 |
| 2193. | Br | F | Br | A.10 |
| 2194. | I | F | Br | A.10 |
| 2195. | CN | F | Br | A.10 |
| 2196. | CH₃ | F | Br | A.10 |
| 2197. | CF₃ | F | Br | A.10 |
| 2198. | OCH₃ | F | Br | A.10 |
| 2199. | OCF₃ | F | Br | A.10 |
| 2200. | CH₂CH₃ | F | Br | A.10 |
| 2201. | H | Cl | Br | A.10 |
| 2202. | F | Cl | Br | A.10 |
| 2203. | Cl | Cl | Br | A.10 |
| 2204. | Br | Cl | Br | A.10 |
| 2205. | I | Cl | Br | A.10 |
| 2206. | CN | Cl | Br | A.10 |
| 2207. | CH₃ | Cl | Br | A.10 |
| 2208. | CF₃ | Cl | Br | A.10 |
| 2209. | OCH₃ | Cl | Br | A.10 |
| 2210. | OCF₃ | Cl | Br | A.10 |
| 2211. | CH₂CH₃ | Cl | Br | A.10 |
| 2212. | H | H | I | A.10 |
| 2213. | F | H | I | A.10 |
| 2214. | Cl | H | I | A.10 |
| 2215. | Br | H | I | A.10 |
| 2216. | I | H | I | A.10 |
| 2217. | CN | H | I | A.10 |
| 2218. | CH₃ | H | I | A.10 |
| 2219. | CF₃ | H | I | A.10 |
| 2220. | OCH₃ | H | I | A.10 |
| 2221 | OCF₃ | H | I | A.10 |
| 2222. | CH₂CH₃ | H | I | A.10 |
| 2223. | H | F | I | A.10 |
| 2224. | F | F | I | A.10 |
| 2225. | Cl | F | I | A.10 |
| 2226. | Br | F | I | A.10 |
| 2227. | I | F | I | A.10 |
| 2228. | CN | F | I | A.10 |
| 2229. | CH₃ | F | I | A.10 |
| 2230. | CF₃ | F | I | A.10 |
| 2231. | OCH₃ | F | I | A.10 |
| 2232. | OCF₃ | F | I | A.10 |
| 2233. | CH₂CH₃ | F | I | A.10 |
| 2234. | H | Cl | I | A.10 |
| 2235. | F | Cl | I | A.10 |
| 2236. | Cl | Cl | I | A.10 |
| 2237. | Br | Cl | I | A.10 |
| 2238. | I | Cl | I | A.10 |
| 2239. | CN | Cl | I | A.10 |
| 2240. | CH₃ | Cl | I | A.10 |
| 2241. | CF₃ | Cl | I | A.10 |
| 2242. | OCH₃ | Cl | I | A.10 |
| 2243. | OCF₃ | Cl | I | A.10 |
| 2244. | CH₂CH₃ | Cl | I | A.10 |
| 2245. | H | H | CN | A.10 |
| 2246. | F | H | CN | A.10 |
| 2247. | Cl | H | CN | A.10 |
| 2248. | Br | H | CN | A.10 |
| 2249. | I | H | CN | A.10 |
| 2250. | CN | H | CN | A.10 |
| 2251. | CH₃ | H | CN | A.10 |
| 2252. | CF₃ | H | CN | A.10 |
| 2253. | OCH₃ | H | CN | A.10 |
| 2254. | OCF₃ | H | CN | A.10 |
| 2255. | CH₂CH₃ | H | CN | A.10 |
| 2256. | H | F | CN | A.10 |
| 2257. | F | F | CN | A.10 |
| 2258. | Cl | F | CN | A.10 |
| 2259. | Br | F | CN | A.10 |
| 2260. | I | F | CN | A.10 |
| 2261. | CN | F | CN | A.10 |
| 2262. | CH₃ | F | CN | A.10 |
| 2263. | CF₃ | F | CN | A.10 |
| 2264. | OCH₃ | F | CN | A.10 |
| 2265. | OCF₃ | F | CN | A.10 |
| 2266. | CH₂CH₃ | F | CN | A.10 |
| 2267. | H | Cl | CN | A.10 |
| 2268. | F | Cl | CN | A.10 |
| 2269. | Cl | Cl | CN | A.10 |
| 2270. | Br | Cl | CN | A.10 |
| 2271. | I | Cl | CN | A.10 |
| 2272. | CN | Cl | CN | A.10 |
| 2273. | CH₃ | Cl | CN | A.10 |
| 2274. | CF₃ | Cl | CN | A.10 |
| 2275. | OCH₃ | Cl | CN | A.10 |
| 2276. | OCF₃ | Cl | CN | A.10 |
| 2277. | CH₂CH₃ | Cl | CN | A.10 |
| 2278. | H | H | CH₃ | A.10 |
| 2279. | F | H | CH₃ | A.10 |
| 2280. | Cl | H | CH₃ | A.10 |
| 2281. | Br | H | CH₃ | A.10 |
| 2282. | I | H | CH₃ | A.10 |
| 2283. | CN | H | CH₃ | A.10 |
| 2284. | CH₃ | H | CH₃ | A.10 |
| 2285. | CF₃ | H | CH₃ | A.10 |
| 2286. | OCH₃ | H | CH₃ | A.10 |
| 2287. | OCF₃ | H | CH₃ | A.10 |
| 2288. | CH₂CH₃ | H | CH₃ | A.10 |
| 2289. | H | F | CH₃ | A.10 |
| 2290. | F | F | CH₃ | A.10 |
| 2291. | Cl | F | CH₃ | A.10 |
| 2292. | Br | F | CH₃ | A.10 |
| 2293. | I | F | CH₃ | A.10 |
| 2294. | CN | F | CH₃ | A.10 |
| 2295. | CH₃ | F | CH₃ | A.10 |
| 2296. | CF₃ | F | CH₃ | A.10 |
| 2297. | OCH₃ | F | CH₃ | A.10 |
| 2298. | OCF₃ | F | CH₃ | A.10 |
| 2299. | CH₂CH₃ | F | CH₃ | A.10 |
| 2300. | H | Cl | CH₃ | A.10 |
| 2301. | F | Cl | CH₃ | A.10 |
| 2302. | Cl | Cl | CH₃ | A.10 |
| 2303. | Br | Cl | CH₃ | A.10 |
| 2304. | I | Cl | CH₃ | A.10 |
| 2305. | CN | Cl | CH₃ | A.10 |
| 2306. | CH₃ | Cl | CH₃ | A.10 |
| 2307. | CF₃ | Cl | CH₃ | A.10 |
| 2308. | OCH₃ | Cl | CH₃ | A.10 |
| 2309. | OCF₃ | Cl | CH₃ | A.10 |
| 2310. | CH₂CH₃ | Cl | CH₃ | A.10 |
| 2311. | H | H | H | A.11 |
| 2312. | F | H | H | A.11 |
| 2313. | Cl | H | H | A.11 |
| 2314. | Br | H | H | A.11 |
| 2315. | I | H | H | A.11 |
| 2316. | CN | H | H | A.11 |
| 2317. | CH₃ | H | H | A.11 |
| 2318. | CF₃ | H | H | A.11 |
| 2319. | OCH₃ | H | H | A.11 |
| 2320. | OCF₃ | H | H | A.11 |
| 2321. | CH₂CH₃ | H | H | A.11 |
| 2322. | H | F | H | A.11 |
| 2323. | F | F | H | A.11 |
| 2324. | Cl | F | H | A.11 |
| 2325. | Br | F | H | A.11 |
| 2326. | I | F | H | A.11 |
| 2327. | CN | F | H | A.11 |
| 2328. | CH₃ | F | H | A.11 |
| 2329. | CF₃ | F | H | A.11 |
| 2330. | OCH₃ | F | H | A.11 |
| 2331. | OCF₃ | F | H | A.11 |
| 2332. | CH₂CH₃ | F | H | A.11 |
| 2333. | H | Cl | H | A.11 |
| 2334. | F | Cl | H | A.11 |
| 2335. | Cl | Cl | H | A.11 |
| 2336. | Br | Cl | H | A.11 |
| 2337. | I | Cl | H | A.11 |
| 2338. | CN | Cl | H | A.11 |
| 2339. | CH₃ | Cl | H | A.11 |
| 2340. | CF₃ | Cl | H | A.11 |
| 2341. | OCH₃ | Cl | H | A.11 |
| 2342. | OCF₃ | Cl | H | A.11 |
| 2343. | CH₂CH₃ | Cl | H | A.11 |
| 2344. | H | H | F | A.11 |
| 2345. | F | H | F | A.11 |
| 2346. | Cl | H | F | A.11 |
| 2347. | Br | H | F | A.11 |
| 2348. | I | H | F | A.11 |
| 2349. | CN | H | F | A.11 |
| 2350. | CH₃ | H | F | A.11 |
| 2351. | CF₃ | H | F | A.11 |
| 2352. | OCH₃ | H | F | A.11 |
| 2353. | OCF₃ | H | F | A.11 |
| 2354. | CH₂CH₃ | H | F | A.11 |
| 2355. | H | F | F | A.11 |
| 2356. | F | F | F | A.11 |
| 2357. | Cl | F | F | A.11 |
| 2358. | Br | F | F | A.11 |
| 2359. | I | F | F | A.11 |
| 2360. | CN | F | F | A.11 |
| 2361. | CH₃ | F | F | A.11 |
| 2362. | CF₃ | F | F | A.11 |
| 2363. | OCH₃ | F | F | A.11 |
| 2364. | OCF₃ | F | F | A.11 |
| 2365. | CH₂CH₃ | F | F | A.11 |
| 2366. | H | Cl | F | A.11 |
| 2367. | F | Cl | F | A.11 |
| 2368. | Cl | Cl | F | A.11 |
| 2369. | Br | Cl | F | A.11 |
| 2370. | I | Cl | F | A.11 |
| 2371. | CN | Cl | F | A.11 |
| 2372. | CH₃ | Cl | F | A.11 |
| 2373. | CF₃ | Cl | F | A.11 |
| 2374. | OCH₃ | Cl | F | A.11 |
| 2375. | OCF₃ | Cl | F | A.11 |
| 2376. | CH₂CH₃ | Cl | F | A.11 |
| 2377. | H | H | Cl | A.11 |
| 2378. | F | H | Cl | A.11 |
| 2379. | Cl | H | Cl | A.11 |
| 2380. | Br | H | Cl | A.11 |
| 2381. | I | H | Cl | A.11 |
| 2382. | CN | H | Cl | A.11 |
| 2383. | CH₃ | H | Cl | A.11 |
| 2384. | CF₃ | H | Cl | A.11 |
| 2385. | OCH₃ | H | Cl | A.11 |
| 2386. | OCF₃ | H | Cl | A.11 |
| 2387. | CH₂CH₃ | H | Cl | A.11 |
| 2388. | H | F | Cl | A.11 |
| 2389. | F | F | Cl | A.11 |
| 2390. | Cl | F | Cl | A.11 |
| 2391. | Br | F | Cl | A.11 |
| 2392. | I | F | Cl | A.11 |
| 2393. | CN | F | Cl | A.11 |
| 2394. | CH₃ | F | Cl | A.11 |
| 2395. | CF₃ | F | Cl | A.11 |
| 2396. | OCH₃ | F | Cl | A.11 |
| 2397. | OCF₃ | F | Cl | A.11 |
| 2398. | CH₂CH₃ | F | Cl | A.11 |
| 2399. | H | Cl | Cl | A.11 |
| 2400. | F | Cl | Cl | A.11 |
| 2401. | Cl | Cl | Cl | A.11 |
| 2402. | Br | Cl | Cl | A.11 |
| 2403. | I | Cl | Cl | A.11 |
| 2404. | CN | Cl | Cl | A.11 |
| 2405. | CH₃ | Cl | Cl | A.11 |
| 2406. | CF₃ | Cl | Cl | A.11 |
| 2407. | OCH₃ | Cl | Cl | A.11 |
| 2408. | OCF₃ | Cl | Cl | A.11 |
| 2409. | CH₂CH₃ | Cl | Cl | A.11 |
| 2410. | H | H | Br | A.11 |
| 2411. | F | H | Br | A.11 |
| 2412. | Cl | H | Br | A.11 |
| 2413. | Br | H | Br | A.11 |
| 2414. | I | H | Br | A.11 |
| 2415. | CN | H | Br | A.11 |
| 2416. | CH₃ | H | Br | A.11 |
| 2417. | CF₃ | H | Br | A.11 |
| 2418. | OCH₃ | H | Br | A.11 |
| 2419. | OCF₃ | H | Br | A.11 |
| 2420. | CH₂CH₃ | H | Br | A.11 |
| 2421. | H | F | Br | A.11 |
| 2422. | F | F | Br | A.11 |
| 2423. | Cl | F | Br | A.11 |
| 2424. | Br | F | Br | A.11 |
| 2425. | I | F | Br | A.11 |
| 2426. | CN | F | Br | A.11 |
| 2427. | CH₃ | F | Br | A.11 |
| 2428. | CF₃ | F | Br | A.11 |
| 2429. | OCH₃ | F | Br | A.11 |
| 2430. | OCF₃ | F | Br | A.11 |
| 2431. | CH₂CH₃ | F | Br | A.11 |
| 2432. | H | Cl | Br | A.11 |
| 2433. | F | Cl | Br | A.11 |
| 2434. | Cl | Cl | Br | A.11 |
| 2435. | Br | Cl | Br | A.11 |
| 2436. | I | Cl | Br | A.11 |
| 2437. | CN | Cl | Br | A.11 |
| 2438. | CH₃ | Cl | Br | A.11 |
| 2439. | CF₃ | Cl | Br | A.11 |
| 2440. | OCH₃ | Cl | Br | A.11 |
| 2441. | OCF₃ | Cl | Br | A.11 |
| 2442. | CH₂CH₃ | Cl | Br | A.11 |
| 2443. | H | H | I | A.11 |
| 2444. | F | H | I | A.11 |
| 2445. | Cl | H | I | A.11 |
| 2446. | Br | H | I | A.11 |
| 2447. | I | H | I | A.11 |
| 2448. | CN | H | I | A.11 |
| 2449. | CH | H | I | A.11 |
| 2450. | CF₃ | H | I | A.11 |
| 2451. | OCH₃ | H | I | A.11 |
| 2452. | OCF₃ | H | I | A.11 |
| 2453. | CH₂CH₃ | H | I | A.11 |
| 2454. | H | F | I | A.11 |
| 2455. | F | F | I | A.11 |
| 2456. | Cl | F | I | A.11 |
| 2457. | Br | F | I | A.11 |
| 2458. | I | F | I | A.11 |
| 2459. | CN | F | I | A.11 |
| 2460. | CH₃ | F | I | A.11 |
| 2461. | CF₃ | F | I | A.11 |
| 2462. | OCH₃ | F | I | A.11 |
| 2463. | OCF₃ | F | I | A.11 |
| 2464. | CH₂CH₃ | F | I | A.11 |
| 2465. | H | Cl | I | A.11 |
| 2466. | F | Cl | I | A.11 |
| 2467. | Cl | Cl | I | A.11 |
| 2468. | Br | Cl | I | A.11 |
| 2469. | I | Cl | I | A.11 |
| 2470. | CN | Cl | I | A.11 |
| 2471. | CH₃ | Cl | I | A.11 |
| 2472. | CF₃ | Cl | I | A.11 |
| 2473. | OCH₃ | Cl | I | A.11 |
| 2474. | OCF₃ | Cl | I | A.11 |
| 2475. | CH₂CH₃ | Cl | I | A.11 |
| 2476. | H | H | CN | A.11 |
| 2477. | F | H | CN | A.11 |
| 2478. | Cl | H | CN | A.11 |
| 2479. | Br | H | CN | A.11 |
| 2480. | I | H | CN | A.11 |
| 2481. | CN | H | CN | A.11 |
| 2482. | CH₃ | H | CN | A.11 |
| 2483. | CF₃ | H | CN | A.11 |
| 2484. | OCH₃ | H | CN | A.11 |
| 2485. | OCF₃ | H | CN | A.11 |
| 2486. | CH₂CH₃ | H | CN | A.11 |
| 2487. | H | F | CN | A.11 |
| 2488. | F | F | CN | A.11 |
| 2489. | Cl | F | CN | A.11 |
| 2490. | Br | F | CN | A.11 |
| 2491. | I | F | CN | A.11 |
| 2492. | CN | F | CN | A.11 |
| 2493. | CH₃ | F | CN | A.11 |
| 2494. | CF₃ | F | CN | A.11 |
| 2495. | OCH₃ | F | CN | A.11 |
| 2496. | OCF₃ | F | CN | A.11 |
| 2497. | CH₂CH₃ | F | CN | A.11 |
| 2498. | H | Cl | CN | A.11 |
| 2499. | F | Cl | CN | A.11 |
| 2500. | Cl | Cl | CN | A.11 |
| 2501. | Br | Cl | CN | A.11 |
| 2502. | I | Cl | CN | A.11 |
| 2503. | CN | Cl | CN | A.11 |
| 2504. | CH₃ | Cl | CN | A.11 |
| 2505. | CF₃ | Cl | CN | A.11 |
| 2506. | OCH₃ | Cl | CN | A.11 |
| 2507. | OCF₃ | Cl | CN | A.11 |
| 2508. | CH₂CH₃ | Cl | CN | A.11 |
| 2509. | H | H | CH₃ | A.11 |
| 2510. | F | H | CH₃ | A.11 |
| 2511. | Cl | H | CH₃ | A.11 |
| 2512. | Br | H | CH₃ | A.11 |
| 2513. | I | H | CH₃ | A.11 |
| 2514. | CN | H | CH₃ | A.11 |
| 2515. | CH₃ | H | CH₃ | A.11 |
| 2516. | CF₃ | H | CH₃ | A.11 |
| 2517. | OCH₃ | H | CH₃ | A.11 |
| 2518. | OCF₃ | H | CH₃ | A.11 |
| 2519. | CH₂CH₃ | H | CH₃ | A.11 |
| 2520. | H | F | CH₃ | A.11 |
| 2521. | F | F | CH₃ | A.11 |
| 2522. | Cl | F | CH₃ | A.11 |
| 2523. | Br | F | CH₃ | A.11 |
| 2524. | I | F | CH₃ | A.11 |
| 2525. | CN | F | CH₃ | A.11 |
| 2526. | CH₃ | F | CH₃ | A.11 |
| 2527. | CF₃ | F | CH₃ | A.11 |
| 2528. | OCH₃ | F | CH₃ | A.11 |
| 2529. | OCF₃ | F | CH₃ | A.11 |
| 2530. | CH₂CH₃ | F | CH₃ | A.11 |
| 2531. | H | Cl | CH₃ | A.11 |
| 2532. | F | Cl | CH₃ | A.11 |
| 2533. | Cl | Cl | CH₃ | A.11 |
| 2534. | Br | Cl | CH₃ | A.11 |
| 2535. | I | Cl | CH₃ | A.11 |
| 2536. | CN | Cl | CH₃ | A.11 |
| 2537. | CH₃ | Cl | CH₃ | A.11 |
| 2538. | CF₃ | Cl | CH₃ | A.11 |
| 2539. | OCH₃ | Cl | CH₃ | A.11 |
| 2540. | OCF₃ | Cl | CH₃ | A.11 |
| 2541. | CH₂CH₃ | Cl | CH₃ | A.11 |
| 2542. | H | H | H | A.12 |
| 2543. | F | H | H | A.12 |
| 2544. | Cl | H | H | A.12 |
| 2545. | Br | H | H | A.12 |
| 2546. | I | H | H | A.12 |
| 2547. | CN | H | H | A.12 |
| 2548. | CH₃ | H | H | A.12 |
| 2549. | CF₃ | H | H | A.12 |
| 2550. | OCH₃ | H | H | A.12 |
| 2551. | OCF₃ | H | H | A.12 |
| 2552. | CH₂CH₃ | H | H | A.12 |
| 2553. | H | F | H | A.12 |
| 2554. | F | F | H | A.12 |
| 2555. | Cl | F | H | A.12 |
| 2556. | Br | F | H | A.12 |
| 2557. | I | F | H | A.12 |
| 2558. | CN | F | H | A.12 |
| 2559. | CH₃ | F | H | A.12 |
| 2560. | CF₃ | F | H | A.12 |
| 2561. | OCH₃ | F | H | A.12 |
| 2562. | OCF₃ | F | H | A.12 |
| 2563. | CH₂CH₃ | F | H | A.12 |
| 2564. | H | Cl | H | A.12 |
| 2565. | F | Cl | H | A.12 |
| 2566. | Cl | Cl | H | A.12 |
| 2567. | Br | Cl | H | A.12 |
| 2568. | I | Cl | H | A.12 |
| 2569. | CN | Cl | H | A.12 |
| 2570. | CH₃ | Cl | H | A.12 |
| 2571. | CF₃ | Cl | H | A.12 |
| 2572. | OCH₃ | Cl | H | A.12 |
| 2573. | OCF₃ | Cl | H | A.12 |
| 2574. | CH₂CH₃ | Cl | H | A.12 |
| 2575. | H | H | F | A.12 |
| 2576. | F | H | F | A.12 |
| 2577. | Cl | H | F | A.12 |
| 2578. | Br | H | F | A.12 |
| 2579. | I | H | F | A.12 |
| 2580. | CN | H | F | A.12 |
| 2581. | CH₃ | H | F | A.12 |
| 2582. | CF₃ | H | F | A.12 |
| 2583. | OCH₃ | H | F | A.12 |
| 2584. | OCF₃ | H | F | A.12 |
| 2585. | CH₂CH₃ | H | F | A.12 |
| 2586. | H | F | F | A.12 |
| 2587. | F | F | F | A.12 |
| 2588. | Cl | F | F | A.12 |
| 2589. | Br | F | F | A.12 |
| 2590. | I | F | F | A.12 |
| 2591. | CN | F | F | A.12 |
| 2592. | CH₃ | F | F | A.12 |
| 2593. | CF₃ | F | F | A.12 |
| 2594. | OCH₃ | F | F | A.12 |
| 2595. | OCF₃ | F | F | A.12 |
| 2596. | CH₂CH₃ | F | F | A.12 |
| 2597. | H | Cl | F | A.12 |
| 2598. | F | Cl | F | A.12 |
| 2599. | Cl | Cl | F | A.12 |
| 2600. | Br | Cl | F | A.12 |
| 2601. | I | Cl | F | A.12 |
| 2602. | CN | Cl | F | A.12 |
| 2603. | CH₃ | Cl | F | A.12 |
| 2604. | CF₃ | Cl | F | A.12 |
| 2605. | OCH₃ | Cl | F | A.12 |
| 2606. | OCF₃ | Cl | F | A.12 |
| 2607. | CH₂CH₃ | Cl | F | A.12 |
| 2608. | H | H | Cl | A.12 |
| 2609. | F | H | Cl | A.12 |
| 2610. | Cl | H | Cl | A.12 |
| 2611. | Br | H | Cl | A.12 |
| 2612. | I | H | Cl | A.12 |
| 2613. | CN | H | Cl | A.12 |
| 2614. | CH₃ | H | Cl | A.12 |
| 2615. | CF₃ | H | Cl | A.12 |
| 2616 | OCH₃ | H | Cl | A.12 |
| 2617. | OCF₃ | H | Cl | A.12 |
| 2618. | CH₂CH₃ | H | Cl | A.12 |
| 2619. | H | F | Cl | A.12 |
| 2620. | F | F | Cl | A.12 |
| 2621. | Cl | F | Cl | A.12 |
| 2622. | Br | F | Cl | A.12 |
| 2623. | I | F | Cl | A.12 |
| 2624. | CN | F | Cl | A.12 |
| 2625. | CH₃ | F | Cl | A.12 |
| 2626. | CF₃ | F | Cl | A.12 |
| 2627. | OCH₃ | F | Cl | A.12 |
| 2628. | OCF₃ | F | Cl | A.12 |
| 2629. | CH₂CH₃ | F | Cl | A.12 |
| 2630. | H | Cl | Cl | A.12 |
| 2631. | F | Cl | Cl | A.12 |
| 2632. | Cl | Cl | Cl | A.12 |
| 2633. | Br | Cl | Cl | A.12 |
| 2634. | I | Cl | Cl | A.12 |
| 2635. | CN | Cl | Cl | A.12 |
| 2636. | CH₃ | Cl | Cl | A.12 |
| 2637. | CF₃ | Cl | Cl | A.12 |
| 2638. | OCH₃ | Cl | Cl | A.12 |
| 2639. | OCF₃ | Cl | Cl | A.12 |
| 2640. | CH₂CH₃ | Cl | Cl | A.12 |
| 2641. | H | H | Br | A.12 |
| 2642. | F | H | Br | A.12 |
| 2643. | Cl | H | Br | A.12 |
| 2644. | Br | H | Br | A.12 |
| 2645. | I | H | Br | A.12 |
| 2646. | CN | H | Br | A.12 |
| 2647. | CH₃ | H | Br | A.12 |
| 2648. | CF₃ | H | Br | A.12 |
| 2649. | OCH₃ | H | Br | A.12 |
| 2650. | OCF₃ | H | Br | A.12 |
| 2651. | CH₂CH₃ | H | Br | A.12 |
| 2652. | H | F | Br | A.12 |
| 2653. | F | F | Br | A.12 |
| 2654. | Cl | F | Br | A.12 |
| 2655. | Br | F | Br | A.12 |
| 2656. | I | F | Br | A.12 |
| 2657. | CN | F | Br | A.12 |
| 2658. | CH₃ | F | Br | A.12 |
| 2659. | CF₃ | F | Br | A.12 |
| 2660. | OCH₃ | F | Br | A.12 |
| 2661. | OCF₃ | F | Br | A.12 |
| 2662. | CH₂CH₃ | F | Br | A.12 |
| 2663. | H | Cl | Br | A.12 |
| 2664. | F | Cl | Br | A.12 |
| 2665. | Cl | Cl | Br | A.12 |
| 2666. | Br | Cl | Br | A.12 |
| 2667. | I | Cl | Br | A.12 |
| 2668. | CN | Cl | Br | A.12 |
| 2669. | CH₃ | Cl | Br | A.12 |
| 2670. | CF₃ | Cl | Br | A.12 |
| 2671. | OCH₃ | Cl | Br | A.12 |
| 2672. | OCF₃ | Cl | Br | A.12 |
| 2673. | CH₂CH₃ | Cl | Br | A.12 |
| 2674. | H | H | I | A.12 |
| 2675. | F | H | I | A.12 |
| 2676. | Cl | H | I | A.12 |
| 2677. | Br | H | I | A.12 |
| 2678. | I | H | I | A.12 |
| 2679. | CN | H | I | A.12 |
| 2680. | CH₃ | H | I | A.12 |
| 2681 | CF₃ | H | I | A.12 |
| 2682. | OCH₃ | H | I | A.12 |
| 2683. | OCF₃ | H | I | A.12 |
| 2684. | CH₂CH₃ | H | I | A.12 |
| 2685. | H | F | I | A.12 |
| 2686. | F | F | I | A.12 |
| 2687. | Cl | F | I | A.12 |
| 2688. | Br | F | I | A.12 |
| 2689. | I | F | I | A.12 |
| 2690. | CN | F | I | A.12 |
| 2691. | CH₃ | F | I | A.12 |
| 2692. | CF₃ | F | I | A.12 |
| 2693. | OCH₃ | F | I | A.12 |
| 2694. | OCF₃ | F | I | A.12 |
| 2695. | CH₂CH₃ | F | I | A.12 |
| 2696. | H | Cl | I | A.12 |
| 2697. | F | Cl | I | A.12 |
| 2698. | Cl | Cl | I | A.12 |
| 2699. | Br | Cl | I | A.12 |
| 2700. | I | Cl | I | A.12 |
| 2701. | CN | Cl | I | A.12 |
| 2702. | CH₃ | Cl | I | A.12 |
| 2703. | CF₃ | Cl | I | A.12 |
| 2704. | OCH₃ | Cl | I | A.12 |
| 2705. | OCF₃ | Cl | I | A.12 |
| 2706. | CH₂CH₃ | Cl | I | A.12 |
| 2707. | H | H | CN | A.12 |
| 2708. | F | H | CN | A.12 |
| 2709. | Cl | H | CN | A.12 |
| 2710. | Br | H | CN | A.12 |
| 2711. | I | H | CN | A.12 |
| 2712. | CN | H | CN | A.12 |
| 2713. | CH₃ | H | CN | A.12 |
| 2714. | CF₃ | H | CN | A.12 |
| 2715. | OCH₃ | H | CN | A.12 |
| 2716. | OCF₃ | H | CN | A.12 |
| 2717. | CH₂CH₃ | H | CN | A.12 |
| 2718. | H | F | CN | A.12 |
| 2719. | F | F | CN | A.12 |
| 2720. | Cl | F | CN | A.12 |
| 2721. | Br | F | CN | A.12 |
| 2722. | I | F | CN | A.12 |
| 2723. | CN | F | CN | A.12 |
| 2724. | CH₃ | F | CN | A.12 |
| 2725. | CF₃ | F | CN | A.12 |
| 2726. | OCH₃ | F | CN | A.12 |
| 2727. | OCF₃ | F | CN | A.12 |
| 2728. | CH₂CH₃ | F | CN | A.12 |
| 2729. | H | Cl | CN | A.12 |
| 2730. | F | Cl | CN | A.12 |
| 2731. | Cl | Cl | CN | A.12 |
| 2732. | Br | Cl | CN | A.12 |
| 2733. | I | Cl | CN | A.12 |
| 2734. | CA | Cl | CN | A.12 |
| 2735. | CH₃ | Cl | CN | A.12 |
| 2736. | CF₃ | Cl | CN | A.12 |
| 2737. | OCH₃ | Cl | CN | A.12 |
| 2738. | OCF₃ | Cl | CN | A.12 |
| 2739. | CH₂CH₃ | Cl | CN | A.12 |
| 2740. | H | H | CH₃ | A.12 |
| 2741. | F | H | CH₃ | A.12 |
| 2742. | Cl | H | CH₃ | A.12 |
| 2743. | Br | H | CH₃ | A.12 |
| 2744. | I | H | CH₃ | A.12 |
| 2745. | CN | H | CH₃ | A.12 |
| 2746. | CH₃ | H | CH₃ | A.12 |
| 2747. | CF₃ | H | CH₃ | A.12 |
| 2748. | OCH₃ | H | CH₃ | A.12 |
| 2749 | OCF₃ | H | CH₃ | A.12 |
| 2750. | CH₂CH₃ | H | CH₃ | A.12 |
| 2751. | H | F | CH₃ | A.12 |
| 2752. | F | F | CH₃ | A.12 |
| 2753. | Cl | F | CH₃ | A.12 |
| 2754. | Br | F | CH₃ | A.12 |
| 2755. | I | F | CH₃ | A.12 |
| 2756. | CN | F | CH₃ | A.12 |
| 2757. | CH₃ | F | CH₃ | A.12 |
| 2758. | CF₃ | F | CH₃ | A.12 |
| 2759. | OCH₃ | F | CH₃ | A.12 |
| 2760. | OCF₃ | F | CH₃ | A.12 |
| 2761. | CH₂CH₃ | F | CH₃ | A.12 |
| 2762. | H | Cl | CH₃ | A.12 |
| 2763. | F | Cl | CH₃ | A.12 |
| 2764. | Cl | Cl | CH₃ | A.12 |
| 2765. | Br | Cl | CH₃ | A.12 |
| 2766. | I | Cl | CH₃ | A.12 |
| 2767. | CN | Cl | CH₃ | A.12 |
| 2768. | CH₃ | Cl | CH₃ | A.12 |
| 2769. | CF₃ | Cl | CH₃ | A.12 |
| 2770. | OCH₃ | Cl | CH₃ | A.12 |
| 2771. | OCF₃ | Cl | CH₃ | A.12 |
| 2772. | CH₂CH₃ | Cl | CH₃ | A.12 |
| 2773. | H | H | H | A.13 |
| 2774. | F | H | H | A.13 |
| 2775. | Cl | H | H | A.13 |
| 2776. | Br | H | H | A.13 |
| 2777. | I | H | H | A.13 |
| 2778. | CN | H | H | A.13 |
| 2779. | CH₃ | H | H | A.13 |
| 2780. | CF₃ | H | H | A.13 |
| 2781. | OCH₃ | H | H | A.13 |
| 2782. | OCF₃ | H | H | A.13 |
| 2783. | CH₂CH₃ | H | H | A.13 |
| 2784. | H | F | H | A.13 |
| 2785. | F | F | H | A.13 |
| 2786. | Cl | F | H | A.13 |
| 2787. | Br | F | H | A.13 |
| 2788. | I | F | H | A.13 |
| 2789. | CN | F | H | A.13 |
| 2790. | CH₃ | F | H | A.13 |
| 2791. | CF₃ | F | H | A.13 |
| 2792. | OCH₃ | F | H | A.13 |
| 2793. | OCF₃ | F | H | A.13 |
| 2794. | CH₂CH₃ | F | H | A.13 |
| 2795. | H | Cl | H | A.13 |
| 2796. | F | Cl | H | A.13 |
| 2797. | Cl | Cl | H | A.13 |
| 2798. | Br | Cl | H | A.13 |
| 2799. | I | Cl | H | A.13 |
| 2800. | CN | Cl | H | A.13 |
| 2801. | CH₃ | Cl | H | A.13 |
| 2802. | CF₃ | Cl | H | A.13 |
| 2803. | OCH₃ | Cl | H | A.13 |
| 2804. | OCF₃ | Cl | H | A.13 |
| 2805. | CH₂CH₃ | Cl | H | A.13 |
| 2806. | H | H | F | A.13 |
| 2807. | F | H | F | A.13 |
| 2808. | Cl | H | F | A.13 |
| 2809. | Br | H | F | A.13 |
| 2810. | I | H | F | A.13 |
| 2811. | CN | H | F | A.13 |
| 2812. | CH₃ | H | F | A.13 |
| 2813. | CF₃ | H | F | A.13 |
| 2814. | OCH₃ | H | F | A.13 |
| 2815. | OCF₃ | H | F | A.13 |
| 2816. | CH₂CH₃ | H | F | A.13 |
| 2817. | H | F | F | A.13 |
| 2818. | F | F | F | A.13 |
| 2819. | Cl | F | F | A.13 |
| 2820. | Br | F | F | A.13 |
| 2821. | I | F | F | A.13 |
| 2822. | CN | F | F | A.13 |
| 2823. | CH₃ | F | F | A.13 |
| 2824. | CF₃ | F | F | A.13 |
| 2825. | OCH₃ | F | F | A.13 |
| 2826. | OCF₃ | F | F | A.13 |
| 2827. | CH₂CH₃ | F | F | A.13 |
| 2828. | H | Cl | F | A.13 |
| 2829. | F | Cl | F | A.13 |
| 2830. | Cl | Cl | F | A.13 |
| 2831. | Br | Cl | F | A.13 |
| 2832. | I | Cl | F | A.13 |
| 2833. | CN | Cl | F | A.13 |
| 2834. | CH₃ | Cl | F | A.13 |
| 2835. | CF₃ | Cl | F | A.13 |
| 2836. | OCH₃ | Cl | F | A.13 |
| 2837. | OCF₃ | Cl | F | A.13 |
| 2838. | CH₂CH₃ | Cl | F | A.13 |
| 2839. | H | H | Cl | A.13 |
| 2840. | F | H | Cl | A.13 |
| 2841. | Cl | H | Cl | A.13 |
| 2842. | Br | H | Cl | A.13 |
| 2843. | I | H | Cl | A.13 |
| 2844. | CN | H | Cl | A.13 |
| 2845. | CH₃ | H | Cl | A.13 |
| 2846. | CF₃ | H | Cl | A.13 |
| 2847. | OCH₃ | H | Cl | A.13 |
| 2848. | OCF₃ | H | Cl | A.13 |
| 2849. | CH₂CH₃ | H | Cl | A.13 |
| 2850. | H | F | Cl | A.13 |
| 2851. | F | F | Cl | A.13 |
| 2852. | Cl | F | Cl | A.13 |
| 2853. | Br | F | Cl | A.13 |
| 2854. | I | F | Cl | A.13 |
| 2855. | CN | F | Cl | A.13 |
| 2856. | CH₃ | F | Cl | A.13 |
| 2857. | CF₃ | F | Cl | A.13 |
| 2858. | OCH₃ | F | Cl | A.13 |
| 2859. | OCF₃ | F | Cl | A.13 |
| 2860. | CH₂CH₃ | F | Cl | A.13 |
| 2861. | H | Cl | Cl | A.13 |
| 2862. | F | Cl | Cl | A.13 |
| 2863. | Cl | Cl | Cl | A.13 |
| 2864. | Br | Cl | Cl | A.13 |
| 2865. | I | Cl | Cl | A.13 |
| 2866. | CN | Cl | Cl | A.13 |
| 2867. | CH₃ | Cl | Cl | A.13 |
| 2868. | CF₃ | Cl | Cl | A.13 |
| 2869. | OCH₃ | Cl | Cl | A.13 |
| 2870. | OCF₃ | Cl | Cl | A.13 |
| 2871. | CH₂CH₃ | Cl | Cl | A.13 |
| 2872. | H | H | Br | A.13 |
| 2873. | F | H | Br | A.13 |
| 2874. | Cl | H | Br | A.13 |
| 2875. | Br | H | Br | A.13 |
| 2876. | I | H | Br | A.13 |
| 2877. | CN | H | Br | A.13 |
| 2878. | CH₃ | H | Br | A.13 |
| 2879. | CF₃ | H | Br | A.13 |
| 2880. | OCH₃ | H | Br | A.13 |
| 2881. | OCF₃ | H | Br | A.13 |
| 2882. | CH₂CH₃ | H | Br | A.13 |
| 2883. | H | F | Br | A.13 |
| 2884. | F | F | Br | A.13 |
| 2885. | Cl | F | Br | A.13 |
| 2886. | Br | F | Br | A.13 |
| 2887. | I | F | Br | A.13 |
| 2888. | CN | F | Br | A.13 |
| 2889. | CH₃ | F | Br | A.13 |
| 2890. | CF₃ | F | Br | A.13 |
| 2891. | OCH₃ | F | Br | A.13 |
| 2892. | OCF₃ | F | Br | A.13 |
| 2893. | CH₂CH₃ | F | Br | A.13 |
| 2894. | H | Cl | Br | A.13 |
| 2895. | F | Cl | Br | A.13 |
| 2896. | Cl | Cl | Br | A.13 |
| 2897. | Br | Cl | Br | A.13 |
| 2898. | I | Cl | Br | A.13 |
| 2899. | CN | Cl | Br | A.13 |
| 2900. | CH₃ | Cl | Br | A.13 |
| 2901. | CF | Cl | Br | A.13 |
| 2902. | OCH₃ | Cl | Br | A.13 |
| 2903. | OCF₃ | Cl | Br | A.13 |
| 2904. | CH₂CH₃ | Cl | Br | A.13 |
| 2905. | H | H | I | A.13 |
| 2906. | F | H | I | A.13 |
| 2907. | Cl | H | I | A.13 |
| 2908. | Br | H | I | A.13 |
| 2909. | I | H | I | A.13 |
| 2910. | CN | H | I | A.13 |
| 2911. | CH₃ | H | I | A.13 |
| 2912. | CF₃ | H | I | A.13 |
| 2913. | OCH₃ | H | I | A.13 |
| 2914. | OCF₃ | H | I | A.13 |
| 2915. | CH₂CH₃ | H | I | A.13 |
| 2916. | H | F | I | A.13 |
| 2917. | F | F | I | A.13 |
| 2918. | Cl | F | I | A.13 |
| 2919. | Br | F | I | A.13 |
| 2920. | I | F | I | A.13 |
| 2921. | CN | F | I | A.13 |
| 2922. | CH₃ | F | I | A.13 |
| 2923. | CF₃ | F | I | A.13 |
| 2924. | OCH₃ | F | I | A.13 |
| 2925. | OCF₃ | F | I | A.13 |
| 2926. | CH₂CH₃ | F | I | A.13 |
| 2927. | H | Cl | I | A.13 |
| 2928. | F | Cl | I | A.13 |
| 2929. | Cl | Cl | I | A.13 |
| 2930. | Br | Cl | I | A.13 |
| 2931. | I | Cl | I | A.13 |
| 2932. | CN | Cl | I | A.13 |
| 2933. | CH₃ | Cl | I | A.13 |
| 2934. | CF₃ | Cl | I | A.13 |
| 2935. | OCH₃ | Cl | I | A.13 |
| 2936. | OCF₃ | Cl | I | A.13 |
| 2937. | CH₂CH₃ | Cl | I | A.13 |
| 2938. | H | H | CN | A.13 |
| 2939. | F | H | CN | A.13 |
| 2940. | Cl | H | CN | A.13 |
| 2941. | Br | H | CN | A.13 |
| 2942. | I | H | CN | A.13 |
| 2943. | CN | H | CN | A.13 |
| 2944. | CH₃ | H | CN | A.13 |
| 2945. | CF₃ | H | CN | A.13 |
| 2946. | OCH₃ | H | CN | A.13 |
| 2947. | OCF₃ | H | CN | A.13 |
| 2948. | CH₂CH₃ | H | CN | A.13 |
| 2949. | H | F | CN | A.13 |
| 2950. | F | F | CN | A.13 |
| 2951. | Cl | F | CN | A.13 |
| 2952. | Br | F | CN | A.13 |
| 2953. | I | F | CN | A.13 |
| 2954. | CN | F | CN | A.13 |
| 2955. | CH₃ | F | CN | A.13 |
| 2956. | CF₃ | F | CN | A.13 |
| 2957. | OCH₃ | F | CN | A.13 |
| 2958. | OCF₃ | F | CN | A.13 |
| 2959. | CH₂CH₃ | F | CN | A.13 |
| 2960. | H | Cl | CN | A.13 |
| 2961. | F | Cl | CN | A.13 |
| 2962. | Cl | Cl | CN | A.13 |
| 2963. | Br | Cl | CN | A.13 |
| 2964. | I | Cl | CN | A.13 |
| 2965. | CN | Cl | CN | A.13 |
| 2966. | CH₃ | Cl | CN | A.13 |
| 2967. | CF₃ | Cl | CN | A.13 |
| 2968. | OCH₃ | Cl | CN | A.13 |
| 2969. | OCF₃ | Cl | CN | A.13 |
| 2970. | CH₂CH₃ | Cl | CN | A.13 |
| 2971. | H | H | CH₃ | A.13 |
| 2972. | F | H | CH₃ | A.13 |
| 2973. | Cl | H | CH₃ | A.13 |
| 2974. | Br | H | CH₃ | A.13 |
| 2975. | I | H | CH₃ | A.13 |
| 2976. | CN | H | CH₃ | A.13 |
| 2977. | CH₃ | H | CH₃ | A.13 |
| 2978. | CF₃ | H | CH₃ | A.13 |
| 2979. | OCH₃ | H | CH₃ | A.13 |
| 2980. | OCF₃ | H | CH₃ | A.13 |
| 2981. | CH₂CH₃ | H | CH₃ | A.13 |
| 2982. | H | F | CH₃ | A.13 |
| 2983. | F | F | CH₃ | A.13 |
| 2984. | Cl | F | CH₃ | A.13 |
| 2985. | Br | F | CH₃ | A.13 |
| 2986. | I | F | CH₃ | A.13 |
| 2987. | CN | F | CH₃ | A.13 |
| 2988. | CH₃ | F | CH₃ | A.13 |
| 2989. | CF₃ | F | CH₃ | A.13 |
| 2990. | OCH₃ | F | CH₃ | A.13 |
| 2991. | OCF₃ | F | CH₃ | A.13 |
| 2992. | CH₂CH₃ | F | CH₃ | A.13 |
| 2993. | H | Cl | CH₃ | A.13 |
| 2994. | F | Cl | CH₃ | A.13 |
| 2995. | Cl | Cl | CH₃ | A.13 |
| 2996. | Br | Cl | CH₃ | A.13 |
| 2997. | I | Cl | CH₃ | A.13 |
| 2998. | CN | Cl | CH₃ | A.13 |
| 2999. | CH₃ | Cl | CH₃ | A.13 |
| 3000. | CF₃ | Cl | CH₃ | A.13 |
| 3001. | OCH₃ | Cl | CH₃ | A.13 |
| 3002. | OCF₃ | Cl | CH₃ | A.13 |
| 3003. | CH₂CH₃ | Cl | CH₃ | A.13 |
| 3004. | H | H | H | A.14 |
| 3005. | F | H | H | A.14 |
| 3006. | Cl | H | H | A.14 |
| 3007. | Br | H | H | A.14 |
| 3008. | I | H | H | A.14 |
| 3009. | CN | H | H | A.14 |
| 3010. | CH₃ | H | H | A.14 |
| 3011. | CF₃ | H | H | A.14 |
| 3012. | OCH₃ | H | H | A.14 |
| 3013. | OCF₃ | H | H | A.14 |
| 3014. | CH₂CH₃ | H | H | A.14 |
| 3015. | H | F | H | A.14 |
| 3016. | F | F | H | A.14 |
| 3017. | Cl | F | H | A.14 |
| 3018. | Br | F | H | A.14 |
| 3019. | I | F | H | A.14 |
| 3020. | CN | F | H | A.14 |
| 3021. | CH₃ | F | H | A.14 |
| 3022 | CF₃ | F | H | A.14 |
| 3023. | OCH₃ | F | H | A.14 |
| 3024. | OCF₃ | F | H | A.14 |
| 3025. | CH₂CH₃ | F | H | A.14 |
| 3026. | H | Cl | H | A.14 |
| 3027. | F | Cl | H | A.14 |
| 3028. | Cl | Cl | H | A.14 |
| 3029. | Br | Cl | H | A.14 |
| 3030. | I | Cl | H | A.14 |
| 3031. | CN | Cl | H | A.14 |
| 3032. | CH₃ | Cl | H | A.14 |
| 3033. | CF₃ | Cl | H | A.14 |
| 3034. | OCH₃ | Cl | H | A.14 |
| 3035. | OCF₃ | Cl | H | A.14 |
| 3036. | CH₂CH₃ | Cl | H | A.14 |
| 3037. | H | H | F | A.14 |
| 3038. | F | H | F | A.14 |
| 3039. | Cl | H | F | A.14 |
| 3040. | Br | H | F | A.14 |
| 3041. | I | H | F | A.14 |
| 3042. | CN | H | F | A.14 |
| 3043. | CH₃ | H | F | A.14 |
| 3044. | CF₃ | H | F | A.14 |
| 3045. | OCH₃ | H | F | A.14 |
| 3046. | OCF₃ | H | F | A.14 |
| 3047. | CH₂CH₃ | H | F | A.14 |
| 3048. | H | F | F | A.14 |
| 3049. | F | F | F | A.14 |
| 3050. | Cl | F | F | A.14 |
| 3051. | Br | F | F | A.14 |
| 3052. | I | F | F | A.14 |
| 3053. | CN | F | F | A.14 |
| 3054. | CH₃ | F | F | A.14 |
| 3055. | CF₃ | F | F | A.14 |
| 3056. | OCH₃ | F | F | A.14 |
| 3057. | OCF₃ | F | F | A.14 |
| 3058. | CH₂CH₃ | F | F | A.14 |
| 3059. | H | Cl | F | A.14 |
| 3060. | F | Cl | F | A.14 |
| 3061. | Cl | Cl | F | A.14 |
| 3062. | Br | Cl | F | A.14 |
| 3063. | I | Cl | F | A.14 |
| 3064. | CN | Cl | F | A.14 |
| 3065. | CH₃ | Cl | F | A.14 |
| 3066. | CF₃ | Cl | F | A.14 |
| 3067. | OCH₃ | Cl | F | A.14 |
| 3068. | OCF₃ | Cl | F | A.14 |
| 3069. | CH₂CH₃ | Cl | F | A.14 |
| 3070. | H | H | Cl | A.14 |
| 3071. | F | H | Cl | A.14 |
| 3072. | Cl | H | Cl | A.14 |
| 3073. | Br | H | Cl | A.14 |
| 3074. | I | H | Cl | A.14 |
| 3075. | CN | H | Cl | A.14 |
| 3076. | CH₃ | H | Cl | A.14 |
| 3077. | CF₃ | H | Cl | A.14 |
| 3078. | OCH₃ | H | Cl | A.14 |
| 3079. | OCF₃ | H | Cl | A.14 |
| 3080. | CH₂CH₃ | H | Cl | A.14 |
| 3081. | H | F | Cl | A.14 |
| 3082. | F | F | Cl | A.14 |
| 3083. | Cl | F | Cl | A.14 |
| 3084. | Br | F | Cl | A.14 |
| 3085. | I | F | Cl | A.14 |
| 3086. | CN | F | Cl | A.14 |
| 3087. | CH₃ | F | Cl | A.14 |
| 3088. | CF₃ | F | Cl | A.14 |
| 3089. | OCH₃ | F | Cl | A.14 |
| 3090. | OCF₃ | F | Cl | A.14 |
| 3091. | CH₂CH₃ | F | Cl | A.14 |
| 3092. | H | Cl | Cl | A.14 |
| 3093. | F | Cl | Cl | A.14 |
| 3094. | Cl | Cl | Cl | A.14 |
| 3095. | Br | Cl | Cl | A.14 |
| 3096. | I | Cl | Cl | A.14 |
| 3097. | CN | Cl | Cl | A.14 |
| 3098. | CH₃ | Cl | Cl | A.14 |
| 3099. | CF₃ | Cl | Cl | A.14 |
| 3100. | OCH₃ | Cl | Cl | A.14 |
| 3101. | OCF₃ | Cl | Cl | A.14 |
| 3102. | CH₂CH₃ | Cl | Cl | A.14 |
| 3103. | H | H | Br | A.14 |
| 3104. | F | H | Br | A.14 |
| 3105. | Cl | H | Br | A.14 |
| 3106. | Br | H | Br | A.14 |
| 3107. | I | H | Br | A.14 |
| 3108. | CN | H | Br | A.14 |
| 3109. | CH₃ | H | Br | A.14 |
| 3110. | CF₃ | H | Br | A.14 |
| 3111. | OCH₃ | H | Br | A.14 |
| 3112. | OCF₃ | H | Br | A.14 |
| 3113. | CH₂CH₃ | H | Br | A.14 |
| 3114. | H | F | Br | A.14 |
| 3115. | F | F | Br | A.14 |
| 3116. | Cl | F | Br | A.14 |
| 3117. | Br | F | Br | A.14 |
| 3118. | I | F | Br | A.14 |
| 3119. | CN | F | Br | A.14 |
| 3120. | CH₃ | F | Br | A.14 |
| 3121. | CF₃ | F | Br | A.14 |
| 3122. | OCH₃ | F | Br | A.14 |
| 3123. | OCF₃ | F | Br | A.14 |
| 3124. | CH₂CH₃ | F | Br | A.14 |
| 3125. | H | Cl | Br | A.14 |
| 3126. | F | Cl | Br | A.14 |
| 3127. | Cl | Cl | Br | A.14 |
| 3128. | Br | Cl | Br | A.14 |
| 3129. | I | Cl | Br | A.14 |
| 3130. | CN | Cl | Br | A.14 |
| 3131. | CH₃ | Cl | Br | A.14 |
| 3132. | CF₃ | Cl | Br | A.14 |
| 3133. | OCH₃ | Cl | Br | A.14 |
| 3134. | OCF₃ | Cl | Br | A.14 |
| 3135. | CH₂CH₃ | Cl | Br | A.14 |
| 3136. | H | H | I | A.14 |
| 3137. | F | H | I | A.14 |
| 3138. | Cl | H | I | A.14 |
| 3139. | Br | H | I | A.14 |
| 3140. | I | H | I | A.14 |
| 3141. | CN | H | I | A.14 |
| 3142. | CH₃ | H | I | A.14 |
| 3143. | CF₃ | H | I | A.14 |
| 3144. | OCH₃ | H | I | A.14 |
| 3145. | OCF₃ | H | I | A.14 |
| 3146. | CH₂CH₃ | H | I | A.14 |
| 3147. | H | F | I | A.14 |
| 3148. | F | F | I | A.14 |
| 3149. | Cl | F | I | A.14 |
| 3150. | Br | F | I | A.14 |
| 3151. | I | F | I | A.14 |
| 3152. | CN | F | I | A.14 |
| 3153. | CH₃ | F | I | A.14 |
| 3154. | CF₃ | F | I | A.14 |
| 3155. | OCH₃ | F | I | A.14 |
| 3156. | OCF₃ | F | I | A.14 |
| 3157. | CH₂CH₃ | F | I | A.14 |
| 3158. | H | Cl | I | A.14 |
| 3159. | F | Cl | I | A.14 |
| 3160. | Cl | Cl | I | A.14 |
| 3161. | Br | Cl | I | A.14 |
| 3162. | I | Cl | I | A.14 |
| 3163. | CN | Cl | I | A.14 |
| 3164. | CH₃ | Cl | I | A.14 |
| 3165. | CF₃ | Cl | I | A.14 |
| 3166. | OCH₃ | Cl | I | A.14 |
| 3167. | OCF₃ | Cl | I | A.14 |
| 3168. | CH₂CH₃ | Cl | I | A.14 |
| 3169. | H | H | CN | A.14 |
| 3170. | F | H | CN | A.14 |
| 3171. | Cl | H | CN | A.14 |
| 3172. | Br | H | CN | A.14 |
| 3173. | I | H | CN | A.14 |
| 3174. | CN | H | CN | A.14 |
| 3175. | CH₃ | H | CN | A.14 |
| 3176. | CF₃ | H | CN | A.14 |
| 3177. | OCH₃ | H | CN | A.14 |
| 3178. | OCF₃ | H | CN | A.14 |
| 3179. | CH₂CH₃ | H | CN | A.14 |
| 3180. | H | F | CN | A.14 |
| 3181. | F | F | CN | A.14 |
| 3182. | Cl | F | CN | A.14 |
| 3183. | Br | F | CN | A.14 |
| 3184. | I | F | CN | A.14 |
| 3185. | CN | F | CN | A.14 |
| 3186. | CH₃ | F | CN | A.14 |
| 3187. | CF₃ | F | CN | A.14 |
| 3188. | OCH₃ | F | CN | A.14 |
| 3189. | OCF₃ | F | CN | A.14 |
| 3190. | CH₂CH₃ | F | CN | A.14 |
| 3191. | H | Cl | CN | A.14 |
| 3192. | F | Cl | CN | A.14 |
| 3193. | Cl | Cl | CN | A.14 |
| 3194. | Br | Cl | CN | A.14 |
| 3195. | I | Cl | CN | A.14 |
| 3196. | CN | Cl | CN | A.14 |
| 3197. | CH₃ | Cl | CN | A.14 |
| 3198. | CF₃ | Cl | CN | A.14 |
| 3199. | OCH₃ | Cl | CN | A.14 |
| 3200. | OCF₃ | Cl | CN | A.14 |
| 3201. | CH₂CH₃ | Cl | CN | A.14 |
| 3202. | H | H | CH₃ | A.14 |
| 3203. | F | H | CH₃ | A.14 |
| 3204. | Cl | H | CH₃ | A.14 |
| 3205. | Br | H | CH₃ | A.14 |
| 3206. | I | H | CH₃ | A.14 |
| 3207. | CN | H | CH₃ | A.14 |
| 3208. | CH₃ | H | CH₃ | A.14 |
| 3209. | CF₃ | H | CH₃ | A.14 |
| 3210. | OCH₃ | H | CH₃ | A.14 |
| 3211. | OCF₃ | H | CH₃ | A.14 |
| 3212. | CH₂CH₃ | H | CH₃ | A.14 |
| 3213. | H | F | CH₃ | A.14 |
| 3214. | F | F | CH₃ | A.14 |
| 3215. | Cl | F | CH₃ | A.14 |
| 3216. | Br | F | CH₃ | A.14 |
| 3217. | I | F | CH₃ | A.14 |
| 3218. | CN | F | CH₃ | A.14 |
| 3219. | CH₃ | F | CH₃ | A.14 |
| 3220. | CF₃ | F | CH₃ | A.14 |
| 3221. | OCH₃ | F | CH₃ | A.14 |
| 3222. | OCF₃ | F | CH₃ | A.14 |
| 3223. | CH₂CH₃ | F | CH₃ | A.14 |
| 3224. | H | Cl | CH₃ | A.14 |
| 3225. | F | Cl | CH₃ | A.14 |
| 3226. | Cl | Cl | CH₃ | A.14 |
| 3227. | Br | Cl | CH₃ | A.14 |
| 3228. | I | Cl | CH₃ | A.14 |
| 3229. | CN | Cl | CH₃ | A.14 |
| 3230. | CH₃ | Cl | CH₃ | A.14 |
| 3231. | CF₃ | Cl | CH₃ | A.14 |
| 3232. | OCH₃ | Cl | CH₃ | A.14 |
| 3233. | OCF₃ | Cl | CH₃ | A.14 |
| 3234. | CH₂CH₃ | Cl | CH₃ | A.14 |
| 3235. | H | H | H | A.15 |
| 3236. | F | H | H | A.15 |
| 3237. | Cl | H | H | A.15 |
| 3238. | Br | H | H | A.15 |
| 3239. | I | H | H | A.15 |
| 3240. | CN | H | H | A.15 |
| 3241. | CH₃ | H | H | A.15 |
| 3242. | CF₃ | H | H | A.15 |
| 3243. | OCH₃ | H | H | A.15 |
| 3244. | OCF₃ | H | H | A.15 |
| 3245. | CH₂CH₃ | H | H | A.15 |
| 3246. | H | F | H | A.15 |
| 3247. | F | F | H | A.15 |
| 3248. | Cl | F | H | A.15 |
| 3249. | Br | F | H | A.15 |
| 3250. | I | F | H | A.15 |
| 3251. | CN | F | H | A.15 |
| 3252. | CH₃ | F | H | A.15 |
| 3253. | CF₃ | F | H | A.15 |
| 3254. | OCH₃ | F | H | A.15 |
| 3255. | OCF₃ | F | H | A.15 |
| 3256. | CH₂CH₃ | F | H | A.15 |
| 3257. | H | Cl | H | A.15 |
| 3258. | F | Cl | H | A.15 |
| 3259. | Cl | Cl | H | A.15 |
| 3260. | Br | Cl | H | A.15 |
| 3261. | I | Cl | H | A.15 |
| 3262. | CN | Cl | H | A.15 |
| 3263. | CH₃ | Cl | H | A.15 |
| 3264. | CF₃ | Cl | H | A.15 |
| 3265. | OCH₃ | Cl | H | A.15 |
| 3266. | OCF₃ | Cl | H | A.15 |
| 3267. | CH₂CH₃ | Cl | H | A.15 |
| 3268. | H | H | F | A.15 |
| 3269. | F | H | F | A.15 |
| 3270. | Cl | H | F | A.15 |
| 3271. | Br | H | F | A.15 |
| 3272. | I | H | F | A.15 |
| 3273. | CN | H | F | A.15 |
| 3274. | CH₃ | H | F | A.15 |
| 3275. | CF₃ | H | F | A.15 |
| 3276. | OCH₃ | H | F | A.15 |
| 3277. | OCF₃ | H | F | A.15 |
| 3278. | CH₂CH₃ | H | F | A.15 |
| 3279. | H | F | F | A.15 |
| 3280. | F | F | F | A.15 |
| 3281. | Cl | F | F | A.15 |
| 3282. | Br | F | F | A.15 |
| 3283. | I | F | F | A.15 |
| 3284. | CN | F | F | A.15 |
| 3285. | CH₃ | F | F | A.15 |
| 3286. | CF₃ | F | F | A.15 |
| 3287. | OCH₃ | F | F | A.15 |
| 3288. | OCF₃ | F | F | A.15 |
| 3289. | CH₂CH₃ | F | F | A.15 |
| 3290. | H | Cl | F | A.15 |
| 3291. | F | Cl | F | A.15 |
| 3292. | Cl | Cl | F | A.15 |
| 3293. | Br | Cl | F | A.15 |
| 3294. | I | Cl | F | A.15 |
| 3295. | CN | Cl | F | A.15 |
| 3296. | CH₃ | Cl | F | A.15 |
| 3297. | CF₃ | Cl | F | A.15 |
| 3298. | OCH₃ | Cl | F | A.15 |
| 3299. | OCF₃ | Cl | F | A.15 |
| 3300. | CH₂CH₃ | Cl | F | A.15 |
| 3301. | H | H | Cl | A.15 |
| 3302. | F | H | Cl | A.15 |
| 3303. | Cl | H | Cl | A.15 |
| 3304. | Br | H | Cl | A.15 |
| 3305. | I | H | Cl | A.15 |
| 3306. | CN | H | Cl | A.15 |
| 3307. | CH₃ | H | Cl | A.15 |
| 3308. | CF₃ | H | Cl | A.15 |
| 3309. | OCH₃ | H | Cl | A.15 |
| 3310. | OCF₃ | H | Cl | A.15 |
| 3311. | CH₂CH₃ | H | Cl | A.15 |
| 3312. | H | F | Cl | A.15 |
| 3313. | F | F | Cl | A.15 |
| 3314. | Cl | F | Cl | A.15 |
| 3315. | Br | F | Cl | A.15 |
| 3316. | I | F | Cl | A.15 |
| 3317. | CN | F | Cl | A.15 |
| 3318. | CH₃ | F | Cl | A.15 |
| 3319. | CF₃ | F | Cl | A.15 |
| 3320. | OCH₃ | F | Cl | A.15 |
| 3321. | OCF₃ | F | Cl | A.15 |
| 3322. | CH₂CH₃ | F | Cl | A.15 |
| 3323. | H | Cl | Cl | A.15 |
| 3324. | F | Cl | Cl | A.15 |
| 3325. | Cl | Cl | Cl | A.15 |
| 3326. | Br | Cl | Cl | A.15 |
| 3327. | I | Cl | Cl | A.15 |
| 3328. | CN | Cl | Cl | A.15 |
| 3329. | CH₃ | Cl | Cl | A.15 |
| 3330. | CF₃ | Cl | Cl | A.15 |
| 3331. | OCH₃ | Cl | Cl | A.15 |
| 3332. | OCF₃ | Cl | Cl | A.15 |
| 3333. | CH₂CH₃ | Cl | Cl | A.15 |
| 3334. | H | H | Br | A.15 |
| 3335. | F | H | Br | A.15 |
| 3336. | Cl | H | Br | A.15 |
| 3337. | Br | H | Br | A.15 |
| 3338. | I | H | Br | A.15 |
| 3339. | CN | H | Br | A.15 |
| 3340. | CH₃ | H | Br | A.15 |
| 3341. | CF₃ | H | Br | A.15 |
| 3342 | OCH₃ | H | Br | A.15 |
| 3343. | OCF₃ | H | Br | A.15 |
| 3344 | CH₂CH₃ | H | Br | A.15 |
| 3345. | H | F | Br | A.15 |
| 3346. | F | F | Br | A.15 |
| 3347. | Cl | F | Br | A.15 |
| 3348. | Br | F | Br | A.15 |
| 3349. | I | F | Br | A.15 |
| 3350. | CN | F | Br | A.15 |
| 3351. | CH₃ | F | Br | A.15 |
| 3352. | CF₃ | F | Br | A.15 |
| 3353. | OCH₃ | F | Br | A.15 |
| 3354. | OCF₃ | F | Br | A.15 |
| 3355. | CH₂CH₃ | F | Br | A.15 |
| 3356. | H | Cl | Br | A.15 |
| 3357. | F | Cl | Br | A.15 |
| 3358. | Cl | Cl | Br | A.15 |
| 3359. | Br | Cl | Br | A.15 |
| 3360. | I | Cl | Br | A.15 |
| 3361. | CN | Cl | Br | A.15 |
| 3362. | CH₃ | Cl | Br | A.15 |
| 3363. | CF₃ | Cl | Br | A.15 |
| 3364 | OCH₃ | Cl | Br | A.15 |
| 3365. | OCF₃ | Cl | Br | A.15 |
| 3366. | CH₂CH₃ | Cl | Br | A.15 |
| 3367. | H | H | I | A.15 |
| 3368. | F | H | I | A.15 |
| 3369. | Cl | H | I | A.15 |
| 3370. | Br | H | I | A.15 |
| 3371. | I | H | I | A.15 |
| 3372. | CN | H | I | A.15 |
| 3373. | CH₃ | H | I | A.15 |
| 3374. | CF₃ | H | I | A.15 |
| 3375. | OCH₃ | H | I | A.15 |
| 3376. | OCF₃ | H | I | A.15 |
| 3377. | CH₂CH₃ | H | I | A.15 |
| 3378. | H | F | I | A.15 |
| 3379. | F | F | I | A.15 |
| 3380. | Cl | F | I | A.15 |
| 3381. | Br | F | I | A.15 |
| 3382. | I | F | I | A.15 |
| 3383. | CN | F | I | A.15 |
| 3384. | CH₃ | F | I | A.15 |
| 3385. | CF₃ | F | I | A.15 |
| 3386. | OCH₃ | F | I | A.15 |
| 3387. | OCF₃ | F | I | A.15 |
| 3388. | CH₂CH₃ | F | I | A.15 |
| 3389. | H | Cl | I | A.15 |
| 3390. | F | Cl | I | A.15 |
| 3391. | Cl | Cl | I | A.15 |
| 3392. | Br | Cl | I | A.15 |
| 3393. | I | Cl | I | A.15 |
| 3394. | CN | Cl | I | A.15 |
| 3395. | CH₃ | Cl | I | A.15 |
| 3396. | CF₃ | Cl | I | A.15 |
| 3397. | OCH₃ | Cl | I | A.15 |
| 3398. | OCF₃ | Cl | I | A.15 |
| 3399. | CH₂CH₃ | Cl | I | A.15 |
| 3400. | H | H | CN | A.15 |
| 3401. | F | H | CN | A.15 |
| 3402. | Cl | H | CN | A.15 |
| 3403. | Br | H | CN | A.15 |
| 3404. | I | H | CN | A.15 |
| 3405. | CN | H | CN | A.15 |
| 3406. | CH₃ | H | CN | A.15 |
| 3407. | CF₃ | H | CN | A.15 |
| 3408. | OCH₃ | H | CN | A.15 |
| 3409. | OCF₃ | H | CN | A.15 |
| 3410. | CH₂CH₃ | H | CN | A.15 |
| 3411. | H | F | CN | A.15 |
| 3412. | F | F | CN | A.15 |
| 3413. | Cl | F | CN | A.15 |
| 3414. | Br | F | CN | A.15 |
| 3415. | I | F | CN | A.15 |
| 3416. | CN | F | CN | A.15 |
| 3417. | CH₃ | F | CN | A.15 |
| 3418. | CF₃ | F | CN | A.15 |
| 3419. | OCH₃ | F | CN | A.15 |
| 3420. | OCF₃ | F | CN | A.15 |
| 3421. | CH₂CH₃ | F | CN | A.15 |
| 3422. | H | Cl | CN | A.15 |
| 3423. | F | Cl | CN | A.15 |
| 3424. | Cl | Cl | CN | A.15 |
| 3425. | Br | Cl | CN | A.15 |
| 3426. | I | Cl | CN | A.15 |
| 3427. | CN | Cl | CN | A.15 |
| 3428. | CH₃ | Cl | CN | A.15 |
| 3429. | CF₃ | Cl | CN | A.15 |
| 3430. | OCH₃ | Cl | CN | A.15 |
| 3431. | OCF₃ | Cl | CN | A.15 |
| 3432. | CH₂CH₃ | Cl | CN | A.15 |
| 3433. | H | H | CH₃ | A.15 |
| 3434. | F | H | CH₃ | A.15 |
| 3435. | Cl | H | CH₃ | A.15 |
| 3436. | Br | H | CH₃ | A.15 |
| 3437. | I | H | CH₃ | A.15 |
| 3438. | CN | H | CH₃ | A.15 |
| 3439. | CH₃ | H | CH₃ | A.15 |
| 3440. | CF₃ | H | CH₃ | A.15 |
| 3441. | OCH₃ | H | CH₃ | A.15 |
| 3442. | OCF₃ | H | CH₃ | A.15 |
| 3443. | CH₂CH₃ | H | CH₃ | A.15 |
| 3444. | H | F | CH₃ | A.15 |
| 3445. | F | F | CH₃ | A.15 |
| 3446. | Cl | F | CH₃ | A.15 |
| 3447. | Br | F | CH₃ | A.15 |
| 3448. | I | F | CH₃ | A.15 |
| 3449. | CN | F | CH₃ | A.15 |
| 3450. | CH₃ | F | CH₃ | A.15 |
| 3451. | CF₃ | F | CH₃ | A.15 |
| 3452. | OCH₃ | F | CH₃ | A.15 |
| 3453. | OCF₃ | F | CH₃ | A.15 |
| 3454. | CH₂CH₃ | F | CH₃ | A.15 |
| 3455. | H | Cl | CH₃ | A.15 |
| 3456. | F | Cl | CH₃ | A.15 |
| 3457. | Cl | Cl | CH₃ | A.15 |
| 3458. | Br | Cl | CH₃ | A.15 |
| 3459. | I | Cl | CH₃ | A.15 |
| 3460. | CN | Cl | CH₃ | A.15 |
| 3461. | CH₃ | Cl | CH₃ | A.15 |
| 3462. | CF₃ | Cl | CH₃ | A.15 |
| 3463. | OCH₃ | Cl | CH₃ | A.15 |
| 3464. | OCF₃ | Cl | CH₃ | A.15 |
| 3465. | CH₂CH₃ | Cl | CH₃ | A.15 |
| 3466. | H | H | H | A.16 |
| 3467. | F | H | H | A.16 |
| 3468. | Cl | H | H | A.16 |
| 3469. | Br | H | H | A.16 |
| 3470. | I | H | H | A.16 |
| 3471. | CN | H | H | A.16 |
| 3472. | CH₃ | H | H | A.16 |
| 3473. | CF₃ | H | H | A.16 |
| 3474 | OCH₃ | H | H | A.16 |
| 3475 | OCF₃ | H | H | A.16 |
| 3476. | CH₂CH₃ | H | H | A.16 |
| 3477. | H | F | H | A.16 |
| 3478. | F | F | H | A.16 |
| 3479. | Cl | F | H | A.16 |
| 3480. | Br | F | H | A.16 |
| 3481. | I | F | H | A.16 |
| 3482. | CN | F | H | A.16 |
| 3483. | CH₃ | F | H | A.16 |
| 3484. | CF₃ | F | H | A.16 |
| 3485. | OCH₃ | F | H | A.16 |
| 3486. | OCF₃ | F | H | A.16 |
| 3487. | CH₂CH₃ | F | H | A.16 |
| 3488. | H | Cl | H | A.16 |
| 3489. | F | Cl | H | A.16 |
| 3490. | Cl | Cl | H | A.16 |
| 3491. | Br | Cl | H | A.16 |
| 3492. | I | Cl | H | A.16 |
| 3493. | CN | Cl | H | A.16 |
| 3494. | CH₃ | Cl | H | A.16 |
| 3495. | CF₃ | Cl | H | A.16 |
| 3496 | OCH₃ | Cl | H | A.16 |
| 3497 | OCF₃ | Cl | H | A.16 |
| 3498. | CH₂CH₃ | Cl | H | A.16 |
| 3499. | H | H | F | A.16 |
| 3500. | F | H | F | A.16 |
| 3501. | Cl | H | F | A.16 |
| 3502. | Br | H | F | A.16 |
| 3503. | I | H | F | A.16 |
| 3504. | CN | H | F | A.16 |
| 3505. | CH₃ | H | F | A.16 |
| 3506. | CF₃ | H | F | A.16 |
| 3507. | OCH₃ | H | F | A.16 |
| 3508. | OCF₃ | H | F | A.16 |
| 3509. | CH₂CH₃ | H | F | A.16 |
| 3510. | H | F | F | A.16 |
| 3511. | F | F | F | A.16 |
| 3512. | Cl | F | F | A.16 |
| 3513. | Br | F | F | A.16 |
| 3514. | I | F | F | A.16 |
| 3515. | CN | F | F | A.16 |
| 3516. | CH₃ | F | F | A.16 |
| 3517. | CF₃ | F | F | A.16 |
| 3518. | OCH₃ | F | F | A.16 |
| 3519. | OCF₃ | F | F | A.16 |
| 3520. | CH₂CH₃ | F | F | A.16 |
| 3521. | H | Cl | F | A.16 |
| 3522. | F | Cl | F | A.16 |
| 3523. | Cl | Cl | F | A.16 |
| 3524. | Br | Cl | F | A.16 |
| 3525. | I | Cl | F | A.16 |
| 3526. | CN | Cl | F | A.16 |
| 3527. | CH₃ | Cl | F | A.16 |
| 3528. | CF₃ | Cl | F | A.16 |
| 3529. | OCH₃ | Cl | F | A.16 |
| 3530. | OCF₃ | Cl | F | A.16 |
| 3531. | CH₂CH₃ | Cl | F | A.16 |
| 3532. | H | H | Cl | A.16 |
| 3533. | F | H | Cl | A.16 |
| 3534. | Cl | H | Cl | A.16 |
| 3535. | Br | H | Cl | A.16 |
| 3536. | I | H | Cl | A.16 |
| 3537. | CN | H | Cl | A.16 |
| 3538 | CH₃ | H | Cl | A.16 |
| 3539. | CF₃ | H | Cl | A.16 |
| 3540. | OCH₃ | H | Cl | A.16 |
| 3541. | OCF₃ | H | Cl | A.16 |
| 3542. | CH₂CH₃ | H | Cl | A.16 |
| 3543. | H | F | Cl | A.16 |
| 3544. | F | F | Cl | A.16 |
| 3545. | Cl | F | Cl | A.16 |
| 3546. | Br | F | Cl | A.16 |
| 3547. | I | F | Cl | A.16 |
| 3548. | CN | F | Cl | A.16 |
| 3549. | CH₃ | F | Cl | A.16 |
| 3550. | CF₃ | F | Cl | A.16 |
| 3551. | OCH₃ | F | Cl | A.16 |
| 3552. | OCF₃ | F | Cl | A.16 |
| 3553. | CH₂CH₃ | F | Cl | A.16 |
| 3554. | H | Cl | Cl | A.16 |
| 3555. | F | Cl | Cl | A.16 |
| 3556. | Cl | Cl | Cl | A.16 |
| 3557. | Br | Cl | Cl | A.16 |
| 3558. | I | Cl | Cl | A.16 |
| 3559. | CN | Cl | Cl | A.16 |
| 3560. | CH₃ | Cl | Cl | A.16 |
| 3561. | CF₃ | Cl | Cl | A.16 |
| 3562. | OCH₃ | Cl | Cl | A.16 |
| 3563. | OCF₃ | Cl | Cl | A.16 |
| 3564. | CH₂CH₃ | Cl | Cl | A.16 |
| 3565. | H | H | Br | A.16 |
| 3566. | F | H | Br | A.16 |
| 3567. | Cl | H | Br | A.16 |
| 3568. | Br | H | Br | A.16 |
| 3569. | I | H | Br | A.16 |
| 3570. | CN | H | Br | A.16 |
| 3571. | CH₃ | H | Br | A.16 |
| 3572. | CF₃ | H | Br | A.16 |
| 3573. | OCH₃ | H | Br | A.16 |
| 3574. | OCF₃ | H | Br | A.16 |
| 3575. | CH₂CH₃ | H | Br | A.16 |
| 3576. | H | F | Br | A.16 |
| 3577. | F | F | Br | A.16 |
| 3578. | Cl | F | Br | A.16 |
| 3579. | Br | F | Br | A.16 |
| 3580. | I | F | Br | A.16 |
| 3581. | CN | F | Br | A.16 |
| 3582. | CH₃ | F | Br | A.16 |
| 3583. | CF₃ | F | Br | A.16 |
| 3584. | OCH₃ | F | Br | A.16 |
| 3585. | OCF₃ | F | Br | A.16 |
| 3586. | CH₂CH₃ | F | Br | A.16 |
| 3587. | H | Cl | Br | A.16 |
| 3588. | F | Cl | Br | A.16 |
| 3589. | Cl | Cl | Br | A.16 |
| 3590. | Br | Cl | Br | A.16 |
| 3591. | I | Cl | Br | A.16 |
| 3592. | CN | Cl | Br | A.16 |
| 3593. | CH₃ | Cl | Br | A.16 |
| 3594. | CF₃ | Cl | Br | A.16 |
| 3595. | OCH₃ | Cl | Br | A.16 |
| 3596. | OCF₃ | Cl | Br | A.16 |
| 3597. | CH₂CH₃ | Cl | Br | A.16 |
| 3598. | H | H | I | A.16 |
| 3599. | F | H | I | A.16 |
| 3600. | Cl | H | I | A.16 |
| 3601. | Br | H | I | A.16 |
| 3602. | I | H | I | A.16 |
| 3603. | CN | H | I | A.16 |
| 3604. | CH₃ | H | I | A.16 |
| 3605. | CF₃ | H | I | A.16 |
| 3606. | OCH₃ | H | I | A.16 |
| 3607. | OCF₃ | H | I | A.16 |
| 3608. | CH₂CH₃ | H | I | A.16 |
| 3609. | H | F | I | A.16 |
| 3610. | F | F | I | A.16 |
| 3611. | Cl | F | I | A.16 |
| 3612. | Br | F | I | A.16 |
| 3613. | I | F | I | A.16 |
| 3614. | CN | F | I | A.16 |
| 3615. | CH₃ | F | I | A.16 |
| 3616. | CF₃ | F | I | A.16 |
| 3617. | OCH₃ | F | I | A.16 |
| 3618. | OCF₃ | F | I | A.16 |
| 3619. | CH₂CH₃ | F | I | A.16 |
| 3620. | H | Cl | I | A.16 |
| 3621. | F | Cl | I | A.16 |
| 3622. | Cl | Cl | I | A.16 |
| 3623. | Br | Cl | I | A.16 |
| 3624. | I | Cl | I | A.16 |
| 3625. | CN | Cl | I | A.16 |
| 3626. | CH₃ | Cl | I | A.16 |
| 3627. | CF₃ | Cl | I | A.16 |
| 3628. | OCH₃ | Cl | I | A.16 |
| 3629. | OCF₃ | Cl | I | A.16 |
| 3630. | CH₂CH₃ | Cl | I | A.16 |
| 3631. | H | H | CN | A.16 |
| 3632. | F | H | CN | A.16 |
| 3633. | Cl | H | CN | A.16 |
| 3634. | Br | H | CN | A.16 |
| 3635. | I | H | CN | A.16 |
| 3636. | CN | H | CN | A.16 |
| 3637. | CH₃ | H | CN | A.16 |
| 3638. | CF₃ | H | CN | A.16 |
| 3639. | OCH₃ | H | CN | A.16 |
| 3640. | OCF₃ | H | CN | A.16 |
| 3641. | CH₂CH₃ | H | CN | A.16 |
| 3642. | H | F | CN | A.16 |
| 3643. | F | F | CN | A.16 |
| 3644. | Cl | F | CN | A.16 |
| 3645. | Br | F | CN | A.16 |
| 3646. | I | F | CN | A.16 |
| 3647. | CN | F | CN | A.16 |
| 3648. | CH₃ | F | CN | A.16 |
| 3649. | CF₃ | F | CN | A.16 |
| 3650. | OCH₃ | F | CN | A.16 |
| 3651. | OCF₃ | F | CN | A.16 |
| 3652. | CH₂CH₃ | F | CN | A.16 |
| 3653. | H | Cl | CN | A.16 |
| 3654. | F | Cl | CN | A.16 |
| 3655. | Cl | Cl | CN | A.16 |
| 3656. | Br | Cl | CN | A.16 |
| 3657. | I | Cl | CN | A.16 |
| 3658. | CN | Cl | CN | A.16 |
| 3659. | CH₃ | Cl | CN | A.16 |
| 3660. | CF₃ | Cl | CN | A.16 |
| 3661. | OCH₃ | Cl | CN | A.16 |
| 3662. | OCF₃ | Cl | CN | A.16 |
| 3663. | CH₂CH₃ | Cl | CN | A.16 |
| 3664. | H | H | CH₃ | A.16 |
| 3665. | F | H | CH₃ | A.16 |
| 3666. | Cl | H | CH₃ | A.16 |
| 3667. | Br | H | CH₃ | A.16 |
| 3668. | I | H | CH₃ | A.16 |
| 3669. | CN | H | CH₃ | A.16 |
| 3670. | CH₃ | H | CH₃ | A.16 |
| 3671. | CF₃ | H | CH₃ | A.16 |
| 3672. | OCH₃ | H | CH₃ | A.16 |
| 3673. | OCF₃ | H | CH₃ | A.16 |
| 3674. | CH₂CH₃ | H | CH₃ | A.16 |
| 3675. | H | F | CH₃ | A.16 |
| 3676. | F | F | CH₃ | A.16 |
| 3677. | Cl | F | CH₃ | A.16 |
| 3678. | Br | F | CH₃ | A.16 |
| 3679. | I | F | CH₃ | A.16 |
| 3680. | CN | F | CH₃ | A.16 |
| 3681. | CH₃ | F | CH₃ | A.16 |
| 3682. | CF₃ | F | CH₃ | A.16 |
| 3683. | OCH₃ | F | CH₃ | A.16 |
| 3684. | OCF₃ | F | CH₃ | A.16 |
| 3685. | CH₂CH₃ | F | CH₃ | A.16 |
| 3686. | H | Cl | CH₃ | A.16 |
| 3687. | F | Cl | CH₃ | A.16 |
| 3688. | Cl | Cl | CH₃ | A.16 |
| 3689. | Br | Cl | CH₃ | A.16 |
| 3690. | I | Cl | CH₃ | A.16 |
| 3691. | CN | Cl | CH₃ | A.16 |
| 3692. | CH₃ | Cl | CH₃ | A.16 |
| 3693. | CF₃ | Cl | CH₃ | A.16 |
| 3694. | OCH₃ | Cl | CH₃ | A.16 |
| 3695. | OCF₃ | Cl | CH₃ | A.16 |
| 3696. | CH₂CH₃ | Cl | CH₃ | A.16 |

^{*)} the variables A.1 to A.16 representing W in
Table 1 above have the following meanings:

| | |
|---|---|
| A.1 | 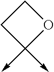 |
| A.2 | 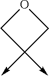 |
| A.3 | 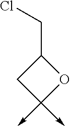 |
| A.4 | 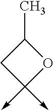 |
| A.5 | 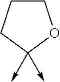 |
| A.6 | 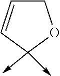 |
| A.7 | 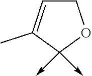 |
| A.8 | 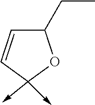 |
| A.9 | 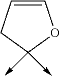 |
| A.10 | 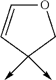 |
| A.11 | 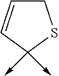 |
| A.12 | 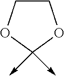 |
| A.13 | 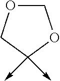 |
| A.14 | 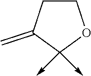 |
| A.15 | 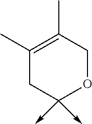 |
| A.16 | 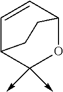 |

Compounds (I), wherein R, R² and R⁶ are hydrogen, R⁹ is hydrogen and R³, R⁴, R⁵ and R⁷, R^{s}(forming W together with the carbon atom to which they are bound) have the meanings as defined lines in 1 to 3696 of Table 1 above (also termed compounds 5 (1.2), i.e. individual compounds 1.2.1-1.1.3696, are particularly preferred.

Compounds (1), wherein R¹, R² and R⁶ are hydrogen, R⁹ is methyl and R³, R⁴, R⁵ and R⁷, R^{s}(forming W together with the carbon atom to which they are bound) have the meanings as defined lines in 1 to 3696 of Table 1 above (also termed compounds (1.3), i.e. individual compounds 1.3.1-1.3.3696, are particularly preferred.

Compounds (1), wherein R¹, R² and R⁶ are hydrogen, R⁹ is 2-methoxyethyl and R³, R⁴, R⁵ and R⁷, R⁸ (forming W together with the carbon atom to which they are bound) have the meanings as defined lines in 1 to 3696 of Table 1 above (also termed compounds (1.4), i.e. individual compounds 1.4.1-1.4.3696, are particularly preferred.

Compounds (1), wherein R¹, R² and R⁶ are hydrogen, R⁹ is 2-(methylsulfanyl)-ethyl (=2-(methylthio)-ethyl) and R³, R⁴, R⁵ and R⁷, R⁸ (forming W together with the carbon atom to which they are bound) have the meanings as defined lines in 1 to 3696 of Table 1 above (also termed compounds (1.5), i.e. individual compounds 1.5.1 -1.5.3696, are particularly preferred.

Compounds (1), wherein R¹, R² and R⁶ are hydrogen, R⁹ is 2-(methylsulfonyl)-ethyl and R³, R⁴, R⁵ and R⁷, R⁸ (forming W together with the carbon atom to which they are bound) have the meanings as defined lines in 1 to 3696 of Table 1 above (also termed compounds (1.6), i.e. individual compounds 1.6.1-1.6.3696, are particularly preferred.

Compounds (1), wherein R¹, R² and R⁶ are hydrogen, R⁹ is 2-(phenylsulfanyl)-ethyl and R³, R⁴, R⁵ and R⁷, R⁸ (forming W together with the carbon atom to which they are bound) have the meanings as defined lines in 1 to 3696 of Table 1 above (also termed compounds (1.7), i.e. individual compounds 1.7.1-1.7.3696, are particularly preferred.

Compounds (1), wherein R¹, R² and R⁶ are hydrogen, R⁹ is 2-chloroethyl and R³, R⁴, R⁵ and R⁷, R⁸ (forming W together with the carbon atom to which they are bound) have the meanings as defined lines in 1 to 3696 of Table 1 above (also termed com-pounds (1.8), i.e. individual compounds 1.8.1-1.8.3696, are particularly preferred.

Compounds (1), wherein R¹, R² and R⁶ are hydrogen, R⁹ is 2-fluoroethyl and R³, R⁴, R⁵ and R⁷, R⁸ (forming W together with the carbon atom to which they are bound) have the meanings as defined lines in 1 to 3696 of Table 1 above (also termed com-pounds (1.9), i.e. individual compounds 1.9.1-1.9.3696, are particularly preferred.

Compounds (1), wherein R¹, R² and R⁶ are hydrogen, R⁹ is 2,2-difluoroethyl and R³, R⁴, R⁵ and R⁷, R⁸ (forming W together with the carbon atom to which they are bound) have the meanings as defined lines in 1 to 3696 of Table 1 above (also termed compounds (1.10), i.e. individual compounds 1.10.1-1.10.3696, are particularly pre-ferred.

Compounds (1), wherein R¹, R² and R⁶ are hydrogen, R⁹ is 2,2,2-trifluoroethyl and R³, R⁴, R⁵ and R⁷, R⁸ (forming W together with the carbon atom to which they are bound) have the meanings as defined lines in 1 to 3696 of Table 1 above (also termed compounds (1.11), i.e. individual compounds 1.11.1-1.11.3696, are particularly pre-ferred.

Compounds (1), wherein R¹, R² and R⁶ are hydrogen, R⁹ is furan-2-yl-methyl and R³, R⁴, R⁵ and R⁷, R⁸ (forming W together with the carbon atom to which they are bound) have the meanings as defined lines in 1 to 3696 of Table 1 above (also termed compounds (1.12), i.e. individual compounds 1.12.1-1.12.3696, are particularly pre-ferred.

Compounds (1), wherein R¹, R² and R⁶ are hydrogen, R⁹ is benzyl and R³, R⁴, R⁵ and R⁷, R⁸ (forming W together with the carbon atom to which they are bound) have the meanings as defined lines in 1 to 3696 of Table 1 above (also termed compounds (1.13), i.e. individual compounds 1.13.1-1.13.3696, are particularly preferred.

Compounds (1), wherein R¹, R² and R⁶ are hydrogen, R⁹ is cyclopropylmethyl and R³, R⁴, R⁵ and R⁷, R⁸ (forming W together with the carbon atom to which they are bound) have the meanings as defined lines in 1 to 3696 of Table 1 above (also termed compounds (1.14), i.e. individual compounds 1.14.1-1.14.3696, are particularly pre-ferred.

Compounds (1), wherein R¹, R² and R⁶ are hydrogen, R⁹ is cyclopropyl and R³, R⁴, R⁵ and R⁷, R⁸ (forming W together with the carbon atom to which they are bound) have the meanings as defined lines in 1 to 3696 of Table 1 above (also termed com-pounds (1.15), i.e. individual compounds 1.15.1-1.15.3696, are particularly preferred.

Compounds (1), wherein R¹, R² and R⁶ are hydrogen, R⁹ is cyclobutyl and R³, R⁴, R⁵ and R⁷, R⁸ (forming W together with the carbon atom to which they are bound) have the meanings as defined lines in 1 to 3696 of Table 1 above (also termed compounds (1.16), i.e. individual compounds 1.16.1-1.16.3696, are particularly preferred.

Compounds (1) wherein R⁹ is hydrogen (carboxylic acids) are commercially available or can be prepared from the corresponding esters (1); i.e. from compounds (1) in which R⁹ is not hydrogen (in the following, such ester compounds (1) are termed compounds (I′), and R⁹ which is not hydrogen is termed R⁹¹). If R⁹¹ is alkyl, esters (I′) may be cleaved using aqueous alkali metal hydroxides. Preferably lithium hydroxide, sodium hydroxide or potassium hydroxide (1-2 eq.) are employed. The reaction is typically carried out in mixtures of water and an organic solvent. Preferably the organic solvent is THF, meth-anol or acetonitrile. The reaction is carried out at temperatures between 0° C. and 100° C. Preferably the reaction is carried at room temperature. If R⁹¹ is benzyl in (I′), then the ester may be cleaved using palladium on charcoal (0.001-1 eq.) as catalyst and hydrogen gas at temperatures between 0° C. and reflux. Preferably the reaction is carried out at room temperature. Typically, an organic solvent is employed. Preferably THF, methanol or ethanol are employed.

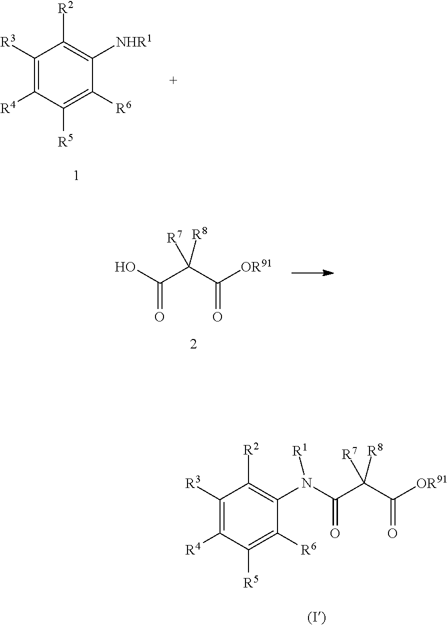

Cyclic compounds of the formula (I′) can be prepared from cyclic carboxylic acids 2 and commercially available amines 1 using a base and a coupling reagent. Thus, com-pounds of formula (I′) can be synthesized from the corresponding carboxylic acids (1eq.) using a coupling reagent (1-2 eq.), for example T₃P (propanephosphonic acid anhydride) or HATU (O—(7-azabenzotriazole-1- yl)-N,N,N′,N′-tetramethyluronium-hexafluorphosphate), an organic base (1-3 eq.) and the amines 1 (1-3 eq.). The reac-tion is typically carried out in an organic solvent. Preferably an aprotic organic solvent is used. Most preferably tetrahydrofuran (THF), N,N-dimethylformamide (DMF) or ace-tonitrile (ACN) are used. The reaction is carried out at temperatures between 0° C. to refluxing temperatures. Preferably the reaction is carried out at room temperature.

Preferably the organic base is triethylamine or N,N-diisopropylethylamine.

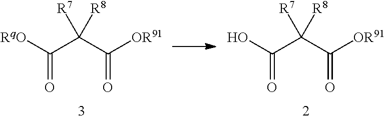

Cyclic carboxylic acids 2 may be prepared from the corresponding diester 3 by selec-tive cleavage of one ester group. If Rq is an alkyl ester, selective ester cleavage may be achieved using an aqueous base. Preferably an alkali metal hydroxide is used. Most preferably lithium hydroxide, sodium hydroxide or potassium hydroxide are used. The reaction is typically carried out in mixtures of water and an organic solvent. Preferably THF, methanol or acetonitrile are employed. The reaction is carried out at temperatures between 0° C. and 100° C., preferably at room temperature.

Alternatively, trimethyltin hydroxide (e.g. 1 eq.) in 1,2 dichlorethane at room tempera-ture to reflux may be used (as described in Angew. Chem. Int. Ed, 2005, 44: 1378-1382), preferably at reflux. If Rq is benzyl in 3, then the ester may be cleaved using palladium on charcoal (0.001-1eq.) as catalyst and hydrogen gas at temperatures be-tween 0° C. and reflux. Preferably the reaction is carried out at room temperature. Typi-cally, an organic solvent is employed. Preferably THF, methanol or ethanol are em-ployed.

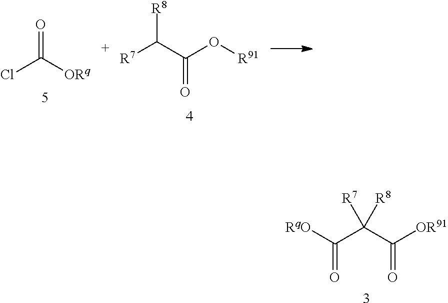

The cyclic diesters 3 may be synthesized from a commercially available cyclic monoes-ter4, a base and a chloroformate 5 (1-3 eq.) as described in Bioorganic & Medicinal Chemistry Letters, 12 (11), 1501-1505; 2002. The reaction is typically carried out in an organic solvent, preferably in tetrahydrofuran. Suitable temperatures range between -78° C. and 25° C. Preferably the reaction is allowed to warm up from −78° C. to 25° C. over a period of 16 h. Preferably lithiumdiisopropylamide (1eq.) is used as a base.

Alternatively, specific cyclic diesters can be prepared according to the following pro-cesses:

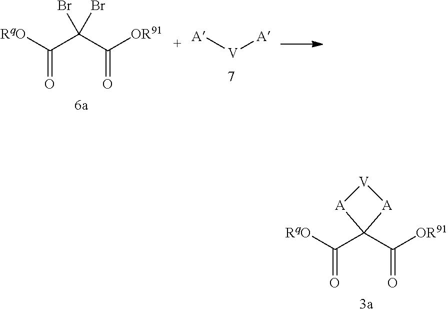

Alternatively, cyclic diester 3a may be prepared from commercially available diethyl dibromomalonates 6a, a base and an alcohol or thiol of the formula 7 (V is —CH₂CH₂— or —CH₂CH₂CH₂—, optionally substituted with R^{b}; each A is independently selected from O, S, NH and NR^{b1}, A′ is independently selected from OH, SH, NHR^{b1}, and R^{b1} is hydro-gen, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₁-C₃)-alkoxy, (C₁-C₃)-haloalkoxy, (C₁-C₃)-alkoxycarbonyl, (C₂-C₃)-alkenyl, (C₂-C₃)-haloalkenyl, (C₂-C₃)-alkynyl, (C₂-C₃)-haloalkynyl or (C₁-C₃)-alkylsulfonyl). The reaction is typically carried out in an organic solvent, preferably in tetrahydrofuran. Suitable temperatures range between 0° C. and 25° C. Preferably sodium hydride (2eq.) is used as a base.

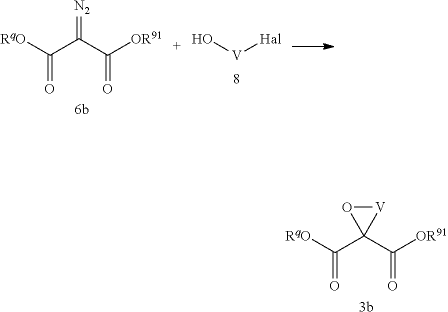

The cyclic diester of the formula 3b containing oxy-heterocycles are either commercial-ly available or may be prepared from the corresponding diazo-compounds 6b using dirhodiumtetraacetate ([Rh(OAc)₂]2) (0.001-0.1 eq.) and commercially available halo-genated (Hal=C₁, Br) alcohols of the formula 8 (V is —CH₂CH₂—, —CH₂CH₂CH₂—, —CH₂CH₂CH₂CH₂—, optionally substituted with R^{b}), followed by cyclization using sodium hydride (1.2 eq.) in N,N-dimethylformamide (DMF) as described in Angew. Chem. Int. Ed. 2014, 53, 14230-14234.

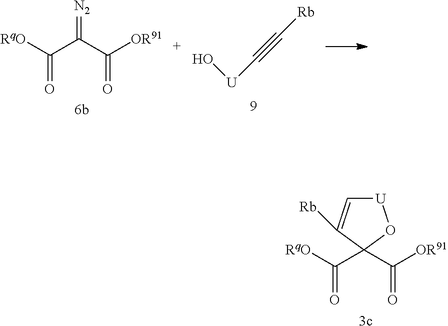

Alternatively, the cyclic unsaturated diester of the formula 3c containing oxy-heterocycles may be prepared from the corresponding diazo-compounds 6b using dir-hodiumtetraacetate ([Rh(OAc)₂]2) (0.001-0.1 eq.) and alcohols of the formula 9 (U is —CH₂— or —CH₂CH₂—, optionally substituted with R^{b}) followed by cyclization using cesium carbonate (2.0 eq.) in acetonitrile. Suitable temperatures range from room temperature to 60° C.

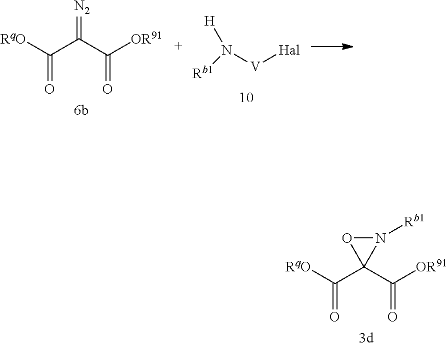

The cyclic diesters containing N-heterocycles 3d may be prepared from the corre-sponding diazo-compounds 6b using bis[rhodium(α,α,α′,α′-tetramethyl-1,3-benzenedipropionic acid)]([Rh(esp)]₂, CAS [819050-89-0](0.001-0.1 eq.) and amines containing halogens (Hal=Br, C₁) of the formula 10 (V is —CH₂CH₂—, —CH₂CH₂CH₂—, or —CH₂CH₂CH₂CH₂—, optionally substituted with R^{b}) in toluene at 60° C. followed by addition of cesium hydroxid monohydrate (2 eq.) and tetrabutylammonium bromide (0.1 eq.) as described in Angew. Chem. Int. Ed. 2019, 58, 1458-1462. R^{b1} is hydrogen, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₁-C₃)-alkoxy, (C₁-C₃)-haloalkoxy, (C₁-C₃)-alkoxycarbonyl, (C₂-C₃)-alkenyl, (C₂-C₃)-haloalkenyl, (C₂-C₃)-alkynyl, (C₂-C₃)-haloalkynyl or (C₁-C₃)-alkylsulfonyl.

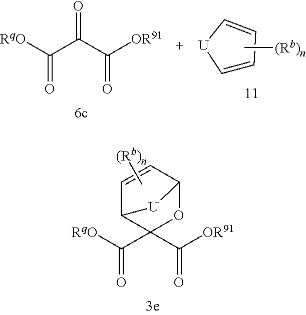

The unsaturated diesters containing O-heterocycles of the formula 3e (U is —CH₂— or —CH₂CH₂—) may be prepared from the commercially available keto malonate (CAS 609-09-6) 6c using cyclic or acyclic dienes of the formula 11 in acetonitrile at 130° C. as described in J. Org. Chem. 1977, 42, 4095-4103. Alternatively, heating at 130° C. for 4 h is performed by irradiating the reaction mixture with a microwave (300 W).

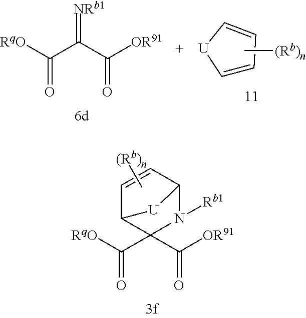

The corresponding N-heterocyclic unsaturated diesters of the formula 3f (U is —CH₂— or —CH₂CH₂—) may be prepared analogously from the corresponding imido malonate 6d using cyclic or acyclic dienes of the formula 11 in tetrahydrofuran at 100° C. as de-scribed in Tetrahedron Lett. 1981, 22, 4607, Synth. Commun. 1972, 2, 211 and J. Med.

Chem. 1973, 16, 853 or by irradiating the reaction mixture with a microwave (100° C., 4 h, 300 W). R^{b1} is hydrogen, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₁-C₃)-alkoxy, (C₁-C₃)-haloalkoxy, (C₁-C₃)-alkoxycarbonyl, (C₂-C₃)-alkenyl, (C₂-C₃)-haloalkenyl, (C₂-C₃)-alkynyl, (C₂-C₃)-haloalkynyl or (C₁-C₃)-alkylsulfonyl.

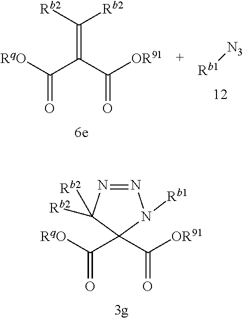

The corresponding triazolines of the formula 3g may be prepared from the commercial-ly available alkenes of the formula 6e using azides of the formula 12 using catalytic amounts of N,N-dimethylurea in toluene at 60° C. as described in Org. Lett. 2015, 17, 4568-4571. R^{b1} is hydrogen, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₁-C₃)-alkoxy, (C₁-C₃)-haloalkoxy, (C₁-C₃)-alkoxycarbonyl, (C₂-C₃)-alkenyl, (C₂-C₃)-haloalkenyl, (C₂-C₃)-alkynyl, (C₂-C₃)-haloalkynyl or (C₁-C₃)-alkylsulfonyl. Each R^{b2} is independently hydro-gen or has one of the meanings given for R^{b}.

The compounds of formula (1) of the present invention may comprise a stereogenic center (*) depending on the structure of the ring W (the ring must not contain a mirror axis for the carbon atom carrying R⁷ and R⁸ to be a stereogenic center), as exemplified below:

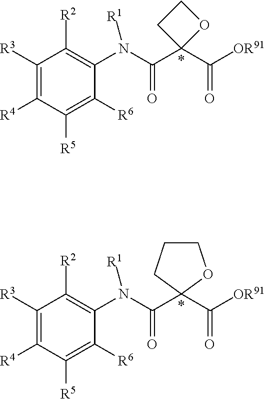

Accordingly, if the carbon atom to which R⁷ and R⁸ are bound to form a ring W is a ste-reogenic center, the compounds of formula (1) exist in two stereoisomeric forms (if no further stereogenic center is present; otherwise, the compounds of formula (1) exist in more than two stereoisomeric forms, of course; to be more precise in 2ⁿ stereoisomeric forms, n being the number of stereogenic centers in the molecule - provided no meso form is present). All stereoisomers as well as mixtures thereof are also part of the pre-sent invention.

To widen the spectrum of action, the compounds of formula (1) may be mixed with many representatives of other herbicidal or growth-regulating active ingredient groups and then applied concomitantly. Suitable components for combinations are, for example, herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

It may furthermore be beneficial to apply the compounds of formula (1) alone or in combination with other herbicides, or else in the form of a mixture with other crop protection agents, for example together with agents for controlling pests or phytopathogenic fungi or bacteria. Also of interest is the miscibility with mineral salt solutions, which are employed for treating nutritional and trace element deficiencies.

Other additives such as non-phytotoxic oils and oil concentrates may also be added.

In one embodiment of the present invention the combinations according to the present invention comprise at least one compound of formula (I) (compound A or component A) and at least one further active compound selected from herbicides B (compound B), preferably herbicides B of class b1) to b15), and safeners C (compound C).

In another embodiment of the present invention the combinations according to the pre-sent invention comprise at least one compound of formula (I) and at least one further active compound B (herbicide B).

Examples of herbicides B which can be used in combination with the compoundsA of formula (I) according to the present invention are:

b1) from the Group of the Lipid Biosynthesis Inhibitors:

ACC-herbicides such as alloxydim, alloxydim-sodium, butroxydim, clethodim, clodinafop, clodinafop-propargyl, cycloxydim, cyhalofop, cyhalofop-butyl, diclofop, di-clofop-methyl, fenoxaprop, fenoxaprop-ethyl, fenoxaprop-P, fenoxaprop-P-ethyl, fluazi-fop, fluazifop-butyl, fluazifop-P, fluazifop-P-butyl, haloxyfop, haloxyfop-methyl, halox-yfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl- [1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro -4-cyclopropyl- [1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); and non ACC herbicides such as benfuresate, butylate, cycloate, dalapon, dimepiperate, EPTC, esprocarb, ethofumesate, flupro-panate, molinate, orbencarb, pebulate, prosulfocarb, TCA, thiobencarb, tiocarbazil, triallate and vernolate;

b2) from the Group of the ALS Inhibitors:

sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron, imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam, pyrimidinylbenzoates such as bispyribac, bispyribac-sodium, pyribenzoxim, pyriftalid, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5), N-(4-bromophenyl)-2-[(4,6-dimethoxy-2-pyrimidinyl)oxy]benzenemethanamine (CAS 420138-01-8), sulfonylaminocarbonyl-triazolinone herbicides such as flucarbazone, flucarbazone-sodium, propoxycarbazone, propoxycarbazone-sodium, thiencarbazone and thiencarbazone-methyl; and triafamone;

among these, a preferred embodiment of the invention relates to those compositions comprising at least one imidazolinone herbicide;

b3) from the Group of the Photosynthesis Inhibitors:

amicarbazone, inhibitors of the photosystem II, e.g. 1-(6-tert-butylpyrimidin-4-yl)-2-hydroxy-4-methoxy-3-methyl-2H-pyrrol-5-one (CAS 1654744-66-7), 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butyl-1-methyl-pyrazol-3-yl)-4-chloro-2-hydroxy-3-methyl-2H-pyrrol-5-one (CAS 1654057-29-0), 1-(5-tert-butyl-1-methyl-pyrazol-3-yl)-3-chloro-2-hydroxy-4-methyl-2H-pyrrol-5-one (CAS 1654747-80-4), 4-hydroxy-1-methoxy-5-methyl-3-[4-(trifluoromethyl)-2-pyridyl]imidazolidin-2-one; (CAS 2023785-78-4), 4-hydroxy-1,5-dimethyl-3-[4-(trifluoromethyl)-2-pyridyl]imidazolidin-2-one (CAS 2023785-79-5), 5-ethoxy-4-hydroxy-1-methyl-3-[4-(trifluoromethyl)-2-pyridyl]imidazolidin-2-one (CAS 1701416-69-4), 4-hydroxy-1-methyl-3-[4-(trifluoromethyl)-2-pyridyl]imidazolidin-2-one (CAS 1708087-22-2), 4-hydroxy-1,5-dimethyl-3-[1-methyl-5-(trifluoromethyl)pyrazol-3-yl]imidazolidin-2-one (CAS 2023785-80-8), 1-(5-tert-butylisoxazol-3-yl)-4-ethoxy-5-hydroxy-3-methyl-imidazolidin-2-one (CAS 1844836-64-1), triazine herbicides, including of chlorotriazine, triazinones, triazindiones, methylthiotriazines and pyridazinones such as ametryn, atrazine, chloridazone, cyanazine, desmetryn, dimethametryn,hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate. Among these, a preferred embodiment of the invention relates to those compositions comprising at least one aryl urea herbicide. Among these, likewise a preferred embodiment of the invention relates to those compositions comprising at least one triazine herbicide. Among these, likewise a preferred embodiment of the invention relates to those compositions comprising at least one nitrile herbicide;

b4) from the Group of the Protoporphyrinogen-IX Oxidase Inhibitors:

acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1 H-pyrazole-1-carboxamide (CAS 452098-92-9), N-tetrahydrofurfuryl-3-(2,6-dichloro-4-trifluoromethylphenoxy)-5-methyl-1 H-pyrazole-1-carboxamide (CAS 915396-43-9), N-ethyl-3-(2-chloro-6-fluoro-4-trifluoromethylphenoxy)-5-methyl-1 H-pyrazole-1-carboxamide (CAS 452099-05-7), N-tetrahydrofurfuryl-3-(2-chloro-6-fluoro-4-trifluoro-methylphenoxy)-5-methyl-1 H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2H-benzo[1,4]oxazin-6-yl)-1 H-pyrimidine-2,4-dione (CAS 1304113-05-0), methyl (E)-4-[2-chloro-5-[4-chloro-5-(difluoromethoxy)-1 H-methyl-pyrazol-3-yl]-4-fluoro-phenoxy]-3-methoxy-but-2-enoate (CAS 948893-00-3), and 3-[7-chloro-5-fluoro-2-(trifluoromethyl)-1 H-benzimidazol-4-yl]-1-methyl-6-(trifluoromethyl)-1 H-pyrimidine-2,4-dione (CAS 212754-02-4), 2-[2-chloro-5-[3-chloro-5-(trifluoromethyl)-2-pyridinyl]-4-fluorophenoxy]-2-methoxy-acetic acid methyl ester (CAS 1970221-16-9), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-acetic acid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1);

b5) from the Group of the Bleacher Herbicides:

PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)-pyrimidine (CAS 180608-33-7), HPPD inhibitors: benzobicyclon, benzofenap, bicyclopyrone, clomazone, fenquinotrione, isoxaflutole, mesotrione, oxotrione (CAS 1486617-21-3), pyrasulfotole, pyrazolynate, pyrazoxyfen, sulcotrione, tefuryltrione, tembotrione, tolpyralate, topramezone, bleacher, unknown target: aclonifen, amitrole flumeturon 2-chloro-3-methylsulfanyl-N-(1-methyltetrazol-5-yl)-4-(trifluoromethyl)benzamide (CAS 1361139-71-0), bixlozone and 2-(2,5-dichlorophenyl)methyl-4,4-dimethyl-3-isoxazolidinone (CAS 81778-66-7);

b6) from the Group of the EPSP Synthase Inhibitors:

glyphosate, glyphosate-isopropylammonium, glyposate-potassium and glyphosate-trimesium (sulfosate);

b7) from the Group of the Glutamine Synthase Inhibitors:

bilanaphos (bialaphos), bilanaphos-sodium, glufosinate, glufosinate-P and glufosinate-ammonium;

b8) from the Group of the DHP Synthase Inhibitors:

asulam;

b9) from the Group of the Mitosis Inhibitors:

compounds of group K1: dinitroanilines such as benfluralin, butralin, dinitramine, ethalfluralin, fluchloralin, oryzalin, pendimethalin, prodiamine and trifluralin, phosphoramidates such as amiprophos, amiprophos-methyl, and butamiphos, benzoic acid herbicides such as chlorthal, chlorthal-dimethyl, pyridines such as dithiopyr and thiazopyr, benzamides such as propyzamide and tebutam; compounds of group K2: carbetamide, chlorpropham, flamprop, flamprop-isopropyl, flamprop-methyl, flamprop-M-isopropyl, flamprop-M-methyl and propham; among these, compounds of group K1, in particular dinitroanilines are preferred;

b10) from the Group of the VLCFA Inhibitors:

chloroacetamides such as acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides such as flufe-nacet and mefenacet, acetanilides such as diphenamid, naproanilide, napropamide and napropamide-M, tetrazolinones such fentrazamide, and other herbicides such as anilofos, cafenstrole, fenoxasulfone, ipfencarbazone, piperophos, pyroxasulfone and isoxazoline compounds of the formulae 11.1, 11.2, 11.3, 11.4, 11.5, 11.6, 11.7, 11.8 and 11.9

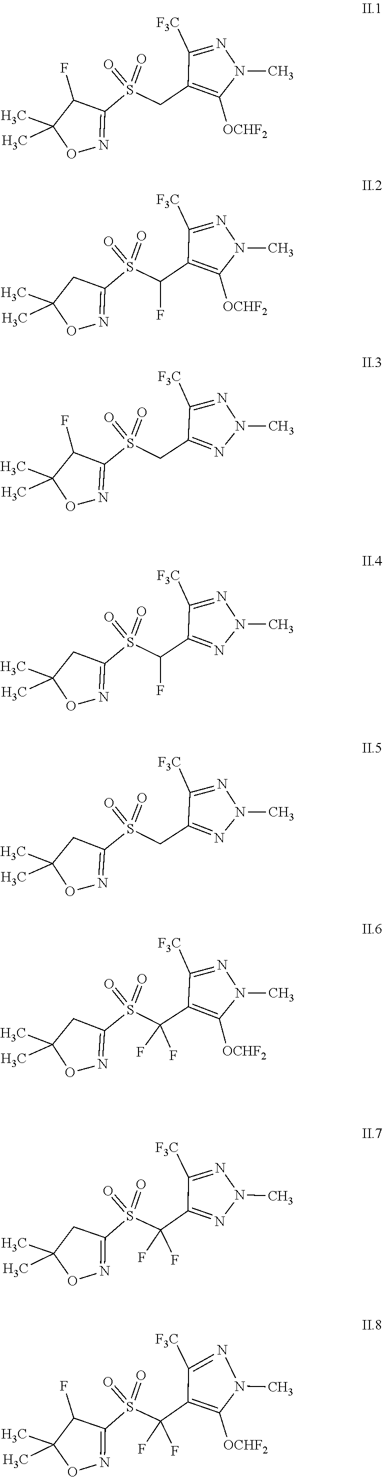

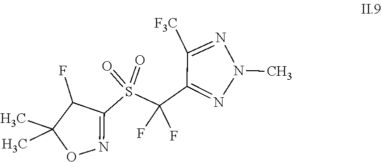

the isoxazoline compounds of the formula (II) are known in the art, e.g. from WO 2006/024820, WO 2006/037945, WO 2007/071900 and WO 2007/096576;
among the VLCFA inhibitors, preference is given to chloroacetamides and oxyacetamides;
   b11) from the Group of the Cellulose Biosynthesis Inhibitors:

chlorthiamid, dichlobenil, flupoxam, indaziflam, isoxaben, triaziflam and 1-cyclohexyl-5-pentafluorphenyloxy-14-[1,2,4,6]thiatriazin-3-ylamine (CAS 175899-01-1);

b12) from the Group of the Decoupler Herbicides:

dinoseb, dinoterb and DNOC and its salts;

b13) from the Group of the Auxinic Herbicides: 2,4-D and its salts and esters such as clacyfos, 2,4-DB and its salts and esters, aminocyclopyrachlor and its salts and esters, aminopyralid and its salts such as aminopyralid-dimethylammonium, aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, flopyrauxifen, fluroxypyr, fluroxypyr-butometyl, fluroxypyr-meptyl, halauxifen and its salts and esters (CAS 943832-60-8); MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen, florpyrauxifen-benzyl (CAS 1390661-72-9) and 4-amino-3-chloro-5-fluoro-6-(7-fluoro-1 H-indol-6-yl)picolinic acid (CAS 1629965-65-6);

b14) from the group of the auxin transport inhibitors: diflufenzopyr, diflufenzopyr-sodium, naptalam and naptalam-sodium;

b15) from the group of the other herbicides: bromobutide, chlorflurenol, chlorflurenol-methyl, cinmethylin, cumyluron, cyclopyrimorate (CAS 499223-49-3) and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine tetflupyrolimet, and tridiphane.

Moreover, it may be useful to apply the compounds of formula (1) in combination with safeners. Safeners are chemical compounds which prevent or reduce damage on useful plants without having a major impact on the herbicidal action of the compounds of the formula (1) towards undesired vegetation. They can be applied either before sowings (e.g. on seed treatments, shoots or seedlings) or in the pre-emergence application or post-emergence application of the useful plant. The safeners and the compounds of formula (1) and optionally the herbicides B can be applied simultaneously or in succession.

In another embodiment of the present invention the combinations according to the present invention comprise at least one compound of formula (1) and at least one safener C (component C).

Examples of safeners are e.g. (quinolin-8-oxy)acetic acids, 1-phenyl-5-haloalkyl-1H-1,2,4-triazol-3-carboxylic acids, 1-phenyl-4,5-dihydro-5-alkyl-1 H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of safener compounds C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4), metcamifen and BPCMS (CAS 54091-06-4).

The active compounds B of groups b1) to b15) and the active compounds C are known herbicides and safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660.

The assignment of the active compounds to the respective mechanisms of action is based on current knowledge. If several mechanisms of action apply to one active compound, this substance was only assigned to one mechanism of action.

The invention relates moreover to a herbicidal composition comprising at least one compound of the formula (I) as defined above, an agriculturally acceptable salt thereof, a stereoisomer thereof or a tautomer thereof, and at least one auxiliary which is cus-tomary for formulating crop protection compounds. Auxiliaries customary for formulat-ing crop protection compounds are defined below.

The invention relates also to moreover to a herbicidal composition comprising at least one compound of the formula (1) as defined above and a herbicide which is different from the compounds of the formula (1). Suitable herbicides are defined above. In a par-ticular embodiment, the composition according to the invention does not encompass compositions comprising simultaneously 3-[(4-fluorophenyl)carbamoyl]oxetane-3-carboxylic acid as compound of the formula (1) and one or more of the following sol-vents: acetonitrile, ethyl acetate, water, methanol, tetrahydrofuran. More particularly, the composition according to the invention does not encompass compositions compris-ing 3-[(4-fluorophenyl)carbamoyl]oxetane-3-carboxylic acid (irrespective of the nature of the further components present in the composition), and does not encompass com-positions comprising ethyl 2-[(4-bromo-2-methyl-phenyl)carbamoyl]-1,3-dithiolane-2-carboxylate.

In another particular embodiment, the composition according to the invention does not encompass compositions comprising simultaneously one of the following compounds: compounds (1), wherein
R¹, R², R⁴ and R⁶ are hydrogen, R³ and R⁵ are C₁, R⁷ and R⁸ form together with the carbon atom they are bound to oxetan-2,2-diyl (i.e. R⁷ and R⁸ form together a bridg-ing group —CH₂—CH₂—O—), 2,5-dihydrofuran-2,2-diyl (i.e. R⁷ and R⁸ form together a bridging group —CH═CH—CH₂—O—), 3,5-dimethyl-2,5-dihydrofuran-2,2-diyl (i.e. R⁷ and R⁸ form together a bridging group —C(CH₃)═CH—CH(CH₃)—O—), oxathiolan-2,2-diyl (i.e. R⁷ and R⁸ form together a bridging group —S—CH₂—CH₂—O—), 1,3-dioxolan-5,5-diyl (i.e. R⁷ and R⁸ form together a bridging group —CH₂—O—CH₂—O—), 3-methyl-4,5-dihydroisoxazol-5,5-diyl (i.e. R⁷ and R⁸ form together a bridging group —CH₂—C(CH₃)=N—O—), or

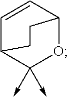

and R⁹ is hydrogen or ethyl;
R¹, R², R⁴ and R⁶ are hydrogen, R³ and R⁵ are C₁, R⁷ and R⁸ form together with the carbon atom they are bound to tetrahydrofuran-2,2-diyl (i.e. R⁷ and R⁸ form together a bridging group —CH₂—CH₂—CH₂—O—) or 2,5-dihydrothiophen-2,2-diyl (i.e. R⁷ and Rs form together a bridging group —CH═CH—CH₂—S—), and R⁹ is hydrogen or methyl;
R¹, R², R⁴ and R⁶ are hydrogen, R³ and R⁵ are F, R⁷ and R⁸ form together with the carbon atom they are bound to oxetan-2,2-diyl (i.e. R⁷ and R⁸ form together a bridg-ing group —CH₂—CH₂—O—), and R⁹ is hydrogen or ethyl;

and one or more of the following solvents: N,N-dimethylformamide, acetonitrile, ethyl acetate, water, methanol, ethanol, tetrahydrofuran, methyl-tert-butyl-ether, toluene, pentane, dichloromethane.

A formulation comprises a pesticidally effective amount of a compound of formula (1). The term “effective amount” denotes an amount of the combination or of the compound of formula (1), which is sufficient for controlling undesired vegetation, especially for con-trolling undesired vegetation in crops (i.e. cultivated plants) and which does not result in a substantial damage to the treated crop plants. Such an amount can vary in a broad range and is dependent on various factors, such as the undesired vegetation to be con-trolled, the treated crop plants or material, the climatic conditions and the specific com-pound of formula (1) used.

The compounds of formula (1) or their salts can be converted into customary types of formulations, e. g. solutions, emulsions, suspensions, dusts, powders, pastes, gran-ules, pressings, capsules, and mixtures thereof. Examples for formulation types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treat-ment of plant propagation materials such as seeds (e.g. GF). These and further formu-lation types are defined in the “Catalogue of pesticide formulation types and interna-tional coding system”, Technical Monograph No. 2, 6^{th} Ed. May 2008, CropLife Interna-tional.

The formulations are prepared in a known manner, such as described by Mollet and Grubemann, Formulation technology, Wiley VCH, Weinheim, 2001; or Knowles, New developments in crop protection product formulation, Agrow Reports DS243, T&F In-forma, London, 2005.

Suitable auxiliaries are solvents, liquid carriers, solid carriers or fillers, surfactants, dis-persants, emulsifiers, wetting agents, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetra-hydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phospho-nates; amines; amides, e.g. N-methylpyrrolidone, fatty acid dimethylamides; and mix-tures thereof.

Suitable solid carriers or fillers are mineral earths, e.g. silicates, silica gels, talc, kao-lins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof.

Such surfactants can be used as emulsifier, dispersant, solubilizer, wetter, penetration enhancer, protective colloid, or adjuvant. Examples of surfactants are listed in McCutcheon's, Vol.1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sul-fonates of fatty acids and oils, sulfonates of ethoxylated alkylphenols, sulfonates of alkoxylated arylphenols, sulfonates of condensed naphthalenes, sulfonates of dodecyl-and tridecylbenzenes, sulfonates of naphthalenes and alkylnaphthalenes, sulfosuccin-ates or sulfosuccinamates. Examples of sulfates are sulfates of fatty acids and oils, of ethoxylated alkylphenols, of alcohols, of ethoxylated alcohols, or of fatty acid esters.

Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof.

Examples of alkoxylates are compounds such as alcohols, alkylphenols, amines, am-ides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides.

Examples of polymeric surfactants are home- or copolymers of vinylpyrrolidone, vinyl-alcohols, or vinylacetate.

Suitable cationic surfactants are quaternary surfactants, for example quaternary am-monium compounds with one or two hydrophobic groups, or salts of long-chain primary amines. Suitable amphoteric surfactants are alkylbetains and imidazolines. Suitable block polymers are block polymers of the A-B or A-B-A type comprising blocks of poly-ethylene oxide and polypropylene oxide, or of the A-B—C type comprising alkanol, poly-ethylene oxide and polypropylene oxide. Suitable polyelectrolytes are polyacids or pol-ybases. Examples of polyacids are alkali salts of polyacrylic acid or polyacid comb pol-ymers. Examples of polybases are polyvinylamines or polyethyleneamines.

Suitable adjuvants are compounds, which have a neglectable or even no pesticidal activity themselves, and which improve the biological performance of the compounds of formula (1) on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothia-zolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine color-ants).

Suitable tackifiers or binders are polyvinylpyrrolidons, polyvinylacetates, polyvinyl alco-hols, polyacrylates, biological or synthetic waxes, and cellulose ethers.

Examples for formulation types and their preparation are:

### i) Water-Soluble Concentrates (SL, LS)

10-60 wt % of a compound of formula (1) or a combination comprising at least one com-pound of formula (1) (component A) and at least one further compound selected from the herbicidal compounds B (component B) and safeners C (component C) according to the invention and 5-15 wt % wetting agent (e.g. alcohol alkoxylates) are dissolved in water and/or in a water-soluble solvent (e.g. alcohols) ad 100 wt %. The active sub-stance dissolves upon dilution with water.

### ii) Dispersible Concentrates (DC)

5-25 wt % of a compound of formula (1) or a combination comprising at least one com-pound of formula (1) (component A) and at least one further compound selected from the herbicidal compounds B (component B) and safeners C (component C) according to the invention and 1-10 wt % dispersant (e. g. polyvinylpyrrolidone) are dissolved in organic solvent (e.g. cyclohexanone) ad 100 wt %. Dilution with water gives a disper-sion.

iii) Emulsifiable Concentrates (EC)

15-70 wt % of compound of formula (1) or a combination comprising at least one com-pound of formula (1) (component A) and at least one further compound selected from the herbicidal compounds B (component B) and safeners C (component C) according to the invention and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.

### iv) Emulsions (EW, EO, ES)

5-40 wt % of compound of formula (1) or a combination comprising at least one com-pound of formula (1) (component A) and at least one further compound selected from the herbicidal compounds B (component B) and safeners C (component C) according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of a compound of formula (1) or a combination com-prising at least one compound of formula (1) (component A) and at least one further compound selected from the herbicidal compounds B (component B) and safeners C (component C)according to the invention are comminuted with addition of 2-10 wt % dispersants and wetting agents (e.g. sodium lignosulfonate and alcohol ethoxylate), 0,1-2 wt % thickener (e.g. xanthan gum) and water ad 100 wt % to give a fine active substance suspension. Dilution with water gives a stable suspension of the active sub-stance. For FS type formulation up to 40 wt % binder (e.g. polyvinylalcohol) is added.

### vi) Water-Dispersible Granules and Water-Soluble Granules (WG, SG)

50-80 wt % of a compound of formula (1) or a combination comprising at least one com-pound of formula (1) (component A) and at least one further compound selected from the herbicidal compounds B (component B) and safeners C (component C)according to the invention are ground finely with addition of dispersants and wetting agents (e.g. sodium lignosulfonate and alcohol ethoxylate) ad 100 wt % and prepared as water-dispersible or water-soluble granules by means of technical appliances (e. g. extrusion, spray tower, fluidized bed). Dilution with water gives a stable dispersion or solution of the active substance.

vii) Water-Dispersible Powders and Water-Soluble Powders (WP, SP, WS)

50-80 wt % of a compound of formula (1) or a combination comprising at least one com-pound of formula (1) (component A) and at least one further compound selected from the herbicidal compounds B (component B) and safeners C (component C) according to the invention are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solu-tion of the active substance.

viii) Gel (GW, GF)

In an agitated ball mill, 5-25 wt % of a compound of formula (1) or a combination com-prising at least one compound of formula (1) (component A) and at least one further compound selected from the herbicidal compounds B (component B) and safeners C (component C) according to the invention are comminuted with addition of 3-10 wt % dispersants (e.g. sodium lignosulfonate), 1-5 wt % thickener (e.g. carboxymethylcellu-lose) and water ad 100 wt % to give a fine suspension of the active substance. Dilution with water gives a stable suspension of the active substance.

### iv) Microemulsion (ME)

5-20 wt % of a compound of formula (1) or a combination comprising at least one com-pound of formula (1) (component A) and at least one further compound selected from the herbicidal compounds B (component B) and safeners C (component C) according to the invention are added to 5-30 wt % organic solvent blend (e.g. fatty acid dimethyl-amide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.

### iv) Microcapsules (CS)

An oil phase comprising 5-50 wt % of a compound of formula (1) or a combination com-prising at least one compound of formula (1) (component A) and at least one further compound selected from the herbicidal compounds B (component B) and safeners C (component C) according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound of formula (1) according to the invention, 0-40 wt % water insoluble organic solvent (e.g. aromatic hydrocarbon), and an isocya-nate monomer (e.g. diphenylmethene-4,4′-diisocyanate) are dispersed into an aqueous solution of a protective colloid (e.g. polyvinyl alcohol). The addition of a polyamine (e.g. hexamethylenediamine) results in the formation of polyurea microcapsules. The mon-omers amount to 1-10 wt %. The wt % relate to the total CS formulation.

### ix) Dustable Powders (DP, DS)

1-10 wt % of a compound of formula (1) or a combination comprising at least one com-pound of formula (1) (component A) and at least one further compound selected from the herbicidal compounds B (component B) and safeners C (component C) according to the invention are ground finely and mixed intimately with solid carrier (e.g. finely di-vided kaolin) ad 100 wt %.

### x) Granules (GR, FG)

0.5-30 wt % of a compound of formula (1) or a combination comprising at least one compound of formula (1) (component A) and at least one further compound selected from the herbicidal compounds B (component B) and safeners C (component C) ac-cording to the invention is ground finely and associated with solid carrier (e.g. silicate) ad 100 wt %. Granulation is achieved by extrusion, spray-drying or the fluidized bed.

### xi) Ultra-Low Volume Liquids (UL)

1-50 wt % of a compound of formula (1) or a combination comprising at least one com-pound of formula (1) (component A) and at least one further compound selected from the herbicidal compounds B (component B) and safeners C (component C) according to the invention are dissolved in organic solvent (e.g. aromatic hydrocarbon) ad 100 wt %.

The formulation types i) to xi) may optionally comprise further auxiliaries, such as 0,1-1 wt % bactericides, 5-15 wt % anti-freezing agents, 0,1-1 wt % anti-foaming agents, and 0,1-1 wt % colorants.

The formulations and/or combinations generally comprise between 0.01 and 95%, preferably between 0.1 and 90%, and in particular between 0.5 and 75%, by weight of the compounds of formula (1).

The compounds of formula (1) are employed in a purity of from 90% to 100%, prefera-bly from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The formulations in question give, after two-to-tenfold dilution, active substance concentrations of from 0.01 to 60% by weight, preferably from 0.1 to 40% by weight, in the ready-to-use preparations. (nach unten verschoben) Methods for applying compounds of formula (1), formulations and/or combinations thereof, on to plant propagation material, especially seeds, include dressing, coating, pelleting, dusting, soaking and in-furrow application methods of the propagation mate-rial. Preferably, compounds of formula (1), formulations and/or combinations thereof, respectively, are applied on to the plant propagation material by a method such that germination is not induced, e. g. by seed dressing, pelleting, coating and dusting.

Various types of oils, wetting agents, adjuvants, fertilizer, or micronutrients, and further pesticides (e.g. herbicides, insecticides, fungicides, growth regulators, safeners) may be added to the compounds of formula (1), the formulations and/or the combinations comprising them as premix or, if appropriate not until immediately prior to use (tank mix). These agents can be admixed with the formulations according to the invention in a weight ratio of 1:100 to 100:1, preferably 1:10 to 10:1.

The user applies the compounds of formula (1) according to the invention, the formula-tions and/or the combinations comprising them usually from a pre-dosage device, a knapsack sprayer, a spray tank, a spray plane, or an irrigation system. Usually, the formulation is made up with water, buffer, and/or further auxiliaries to the desired appli-cation concentration and the ready-to-use spray liquor or the formulation according to the invention is thus obtained. Usually, 20 to 2000 liters, preferably 50 to 400 liters, of the ready-to-use spray liquor are applied per hectare of agricultural useful area.

According to one embodiment, either individual components of the formulation accord-ing to the invention or partially premixed components, e. g. components comprising compounds of formula (1) and optionally active substances from the groups B and/or C), may be mixed by the user in a spray tank and further auxiliaries and additives may be added, if appropriate.

In a further embodiment, individual components of the formulation according to the invention such as parts of a kit or parts of a binary or ternary mixture may be mixed by the user himself in a spray tank and further auxiliaries may be added, if appropriate.

In a further embodiment, either individual components of the formulation according to the invention or partially premixed components, e. g components comprising com-pounds of formula (1) and optionally active substances from the groups B and/or C), can be applied jointly (e.g. after tank mix) or consecutively.

In a preferred embodiment, the auxiliary comprises a liquid carrier and/or a solid carri-er, where the liquid carrier is selected from the group consisting of water, organic sol-vents and mixtures thereof, where the organic solvents are selected from the group consisting of mineral oil fractions, e.g. kerosene or diesel oil; oils of vegetable or animal origin; paraffin, tetrahydronaphthalene, alkylated naphthalenes; alcohols, e.g. ethanol, propanol, butanol, benzylalcohol, cyclohexanol or glycols; DMSO; ketones, e.g. cyclo-hexanone; esters different from ethyl acetate, e.g. lactates, carbonates, fatty acid es-ters, gamma-butyrolactone; fatty acids; phosphonates; amines; amides, e.g. N-methylpyrrolidone, fatty acid dimethylamides; and mixtures thereof; and where the solid carriers are preferably selected from the group consisting of silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof;

where in case that the auxiliary comprises water, the composition preferably also com-prises a surface-active compound, where the surface-active compound is preferably selected from the group consisting of anionic, cationic, nonionic and amphoteric surfac-tants, block polymers, polyelectrolytes, and mixtures thereof. More details to suitable surfactants are given above.

In another preferred embodiment, the auxiliary comprises water and a surface-active compound.

In another preferred embodiment, the composition comprises a herbicide which is dif-ferent from the compounds of the formula (I).

The invention relates moreover to a method for controlling unwanted vegetation which comprises allowing a herbicidally effective amount of at least one compound (I) as de-fined above or a composition as defined above to act on plants, their seed and/or their habitat.

The compounds of formula (I) are suitable as herbicides. They are suitable as such, as an appropriate formulation or in combination with at least one further compound select-ed from the herbicidal active compounds B (component B) and safeners C (component C).

The compounds of formula (1), or the formulations and/or combinations comprising the compounds of formula (1), control undesired vegetation on non-crop areas very efficiently, especially at high rates of application. They act against broad-leaved weeds and grass weeds in crops such as wheat, rice, maize, soya and cotton without causing any significant damage to the crop plants. This effect is mainly observed at low rates of application.

In particular, the compounds of formula (1), or the formulations and/or combinations comprising the compounds of formula (1) are useful for controlling at least one of the following undesired plant species: Abuti/on theophrasti(ABUTH), A/opercurus myosuroides (ALOMY), Amaranthus retroflexus (AM ARE), Apera spica-venti (APESV), Avena fatua (AVEFA), Echinocloa crus-galli (ECHCG), Lolium mul/tiforum (LOLMU), Fa//opia convolvulus (POLCO), Setaria viridis (SETVI), Setaria faberi(SETFA).

The compounds of formula (1), or the formulations and/or the combinations comprising them, are applied to the plants mainly by spraying the leaves. Here, the application can be carried out using, for example, water as carrier by customary spraying techniques using spray liquor amounts of from about 100 to 1000 I/ha (for example from 300 to 400 I/ha). The compounds of formula (1), or the formulations and/or the combinations comprising them, may also be applied by the low-volume or the ultra-low-volume method, or in the form of microgranules.

Application of the compounds of formula (1), or the formulations and/or the combinations comprising them, can be done before, during and/or after, preferably during and/or after, the emergence of the undesired vegetation.

Application of the compounds of formula (1), or the formulations and/or the combina-tions can be carried out before or during sowing.

The compounds of formula (1), or the formulations and/or the combinations comprising them, can be applied pre-, post-emergence or pre-plant, or together with the seed of a crop plant. It is also possible to apply the compounds of formula (1), or the formulations and/or the combinations comprising them, by applying seed, pretreated with the com-pounds of formula (1), or the formulations and/or the combinations comprising them, of a crop plant. If the active ingredients are less well tolerated by certain crop plants, ap-plication techniques may be used in which the combinations are sprayed, with the aid of the spraying equipment, in such a way that as far as possible they do not come into contact with the leaves of the sensitive crop plants, while the active ingredients reach the leaves of undesired vegetation growing underneath, or the bare soil surface (post-directed, lay-by).

In a further embodiment, the compounds of formula (1), or the formulations and/or the combinations comprising them, can be applied by treating seed. The treatment of seeds comprises essentially all procedures familiar to the person skilled in the art (seed dressing, seed coating, seed dusting, seed soaking, seed film coating, seed multilayer coating, seed encrusting, seed dripping and seed pelleting) based on the compounds of formula (1), or the formulations and/or the combinations prepared therefrom. Here, the combinations can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the crop plants mentioned above, but also the seed of transgenic plants or plants obtained by customary breeding methods.

When employed in plant protection, the amounts of active substances applied, i.e. the compounds of formula (1), component B and, if appropriate, component C without for-mulation auxiliaries, are, depending on the kind of effect desired, from 0.001 to 2 kg per ha, preferably from 0.005 to 2 kg per ha, more preferably from 0.05 to 0.9 kg per ha and in particular from 0.1 to 0.75 kg per ha.

In another embodiment of the invention, the application rate of the compounds of formula (1), component B and, if appropriate, component C, is from 0.001 to 3 kg/ha, preferably from 0.005 to 2.5 kg/ha and in particular from 0.01 to 2 kg/ha of active substance (a.s.).

In another preferred embodiment of the invention, the rates of application of the compounds of formula (1) according to the present invention (total amount of compounds of formula (1)) are from 0.1 g/ha to 3000 g/ha, preferably 10 g/ha to 1000 g/ha, depending on the control target, the season, the target plants and the growth stage.

In another preferred embodiment of the invention, the application rates of the com-pounds of formula (1) are in the range from 0.1 g/ha to 5000 g/ha and preferably in the range from 1 g/ha to 2500 g/ha or from 5 g/ha to 2000 g/ha.

In another preferred embodiment of the invention, the application rate of the com-pounds of formula (1) is 0.1 to 1000 g/ha, preferably1 to 750 g/ha, more preferably 5 to 500 g/ha.

The required application rates of herbicidal compounds B are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of safeners C are generally in the range of from 0.0005 kg/ha to 2.5 kg/ha and preferably in the range of from 0.005 kg/ha to 2 kg/ha or 0.01 kg/ha to 1.5 kg/h of a.s.

In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required.

In another embodiment of the invention, to treat the seed, the amounts of active substances applied, i.e. the compounds of formula (I), component B and, if appropriate, component C are generally employed in amounts of from 0.001 to 10 kg per 100 kg of seed.

When used in the protection of materials or stored products, the amount of active sub-stance applied depends on the kind of application area and on the desired effect.

Amounts customarily applied in the protection of materials are 0.001 g to 2 kg, prefera-bly 0.005 g to 1 kg, of active substance per cubic meter of treated material.

In case of combinations according to the present invention it is immaterial whether the compounds of formula (I), and the further component B and/or the component C are formulated and applied jointly or separately.

In the case of separate application, it is of minor importance, in which order the applica-tion takes place. It is only necessary, that the compounds of formula (I), and the further component B and/or the component C are applied in a time frame that allows simulta-neous action of the active ingredients on the plants, preferably within a time-frame of at most 14 days, in particular at most 7 days.

Depending on the application method in question, the compounds of formula (I), or the formulations and/or combinations comprising them, can additionally be employed in a further number of crop plants for eliminating undesired vegetation. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, lpomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, VIcia faba, V/tis vinifera and Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N.rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, VIcia faba, Vltis vinifera and Zea mays.

Especially preferred crops are crops of cereals, corn, soybeans, rice, oilseed rape, cotton, potatoes, peanuts or permanent crops.

The compounds of formula (1) according to the invention, or the formulations and/or combinations comprising them, can also be used in crops which have been modified by mutagenesis or genetic engineering in order to provide a new trait to a plant or to modi-fy an already present trait.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPRJCas, zinc-finger nucleases, TALENs or me-ganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transfor-mation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect re-sistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, ox-ynil herbicides, like bromoxynil and ioxynil, sulfonylurea herbicides, ALS inhibitor herbi-cides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO—01981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTOH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecti-cidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants. In particular genes coding for protease inhibitors, like CpTI and pinll. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, M0N809, MON810, M0N863, M0N87411, M0N88017, M0N89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419. Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-00410-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbi-cide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the muta-genized or integrated genes and the respective events are available from websites of the organizations “International Service for the Acquisition of Agri-biotech Applications (ISAAA)” (http://www.isaaa.org/gmapprovaldatabase) and the “Center for Environmen-tal Risk Assessment (CERA)” (http://cera-gmc.org/GMCropDatabase), as well as in patent applications, like EP3028573 and WO2017/011288.

The use of the compounds of formula (I) or formulations or combinations comprising them according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigor, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the compounds of formula (1) according to the invention, or the formulations and/or combinations comprising them, are also suitable for the defoliation and/or desiccation of plant parts of crops such as cotton, potato, oilseed rape, sunflower, soybean or field beans, in particular cotton. In this regard, formulations and/or combinations for the desiccation and/or defoliation of crops, processes for preparing these formulations and/or combinations and methods for desiccating and/or defoliating plants using the compounds of formula (1) have been found.

As desiccants, the compounds of formula (1) are particularly suitable for desiccating the above-ground parts of crop plants such as potato, oilseed rape, sunflower and soybean, but also cereals. This makes possible the fully mechanical harvesting of these important crop plants.

Also of economic interest is to facilitate harvesting, which is made possible by concentrating within a certain period of time the dehiscence, or reduction of adhesion to the tree, in citrus fruit, olives and other species and varieties of pernicious fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The present invention relates moreover to compounds (1) perse, as far as they are novel.

In one embodiment, the invention relates to a compound of the formula (1), an agricul-turally acceptable salt thereof, a stereoisomer thereof or a tautomer thereof

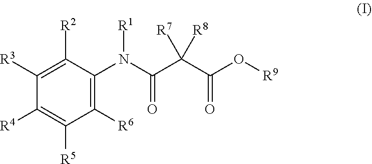

wherein R¹ to R⁹ have one of the above-given general or preferred meanings,

except for the following compounds (1), wherein:
R¹, R², R⁴ and R⁶ are hydrogen, R³ and R⁵ are C₁, R⁷ and R⁸ form together with the carbon atom they are bound to oxetan-2,2-diyl (i.e. R⁷ and R⁸ form together a bridg-ing group —CH₂—CH₂—O—), 2,5-dihydrofuran-2,2-diyl (i.e. R⁷ and R⁸ form together a bridging group —CH═CH—CH₂—O—), 3,5-dimethyl-2,5-dihydrofuran-2,2-diyl (i.e. R⁷ and R⁸ form together a bridging group —C(CH₃)═CH—CH(CH₃)—O—), oxathiolan-2,2-diyl (i.e. R⁷ and R⁸ form together a bridging group —S—CH₂—CH₂—O—), 1,3-dioxolan-5,5-diyl (i.e. R⁷ and R⁸ form together a bridging group —CH₂—O—CH₂—O—), 3-methyl-4,5-dihydroisoxazol-5,5-diyl (i.e. R⁷ and R⁸ form together a bridging group —CH₂—C(CH₃)=N—O—), or

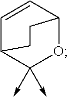

and R⁹ is hydrogen or ethyl;
R¹, R², R⁴ and R⁶ are hydrogen, R³ and R⁵ are C₁, R⁷ and R⁸ form together with the carbon atom they are bound to 1-tert-butoxycarbonyl-pyrrolidin-2,2-diyl (i.e. R⁷ and R⁸ form together a bridging group —CH₂—CH₂—CH₂—N(—C(O)—O—C(CH₃)₃)—), and R⁹ is ethyl;
R¹, R², R⁴ and R⁶ are hydrogen, R³ and R⁵ are F or C₁, R⁷ and R⁸ form together with the carbon atom they are bound to tetrahydrofuran-2,2-diyl (i.e. R⁷ and R⁸ form to-gether a bridging group —CH₂—CH₂—CH₂—O—) or 2,5-dihydrothiophen-2,2-diyl (i.e. R⁷ and R⁸ form together a bridging group —CH═CH—CH₂—S—), and R⁹ is hydrogen or me-thyl;
R¹, R², R⁴ and R⁶ are hydrogen, R³ and R⁵ are F, R⁷ and R⁸ form together with the carbon atom they are bound to oxetan-2,2-diyl (i.e. R⁷ and R⁸ form together a bridg-ing group —CH₂—CH₂—O—), and R⁹ is hydrogen or ethyl;
R⁷ and R⁸ form together with the carbon atom they are bound to tetrahydrofuran-2,2-diyl (i.e. R⁷ and R⁸ form together a bridging group —CH₂—CH₂—CH₂—O—), and R⁹ is tert-butyl;
R¹ is hydrogen or methyl, R⁷ and R⁸ form together with the carbon atom they are bound to oxetan-3,3-diyl (i.e. R⁷ and R⁸ form together a bridging group —CH₂—O—CH₂—), and R⁹ is hydrogen or methyl; and
R⁷ and R⁸ form together with the carbon atom they are bound to tetrahydropyran-4,4-diyl (i.e. R⁷ and R⁸ form together a bridging group —CH₂—CH₂—O—CH₂—CH₂), and R⁹ is hydrogen or ethyl; and except for following compounds (1):
2-[(3-fluoro-5-methylphenyl)carbamoyl]oxolane-2-carboxylic acid;
2-[(3-bromophenyl)carbamoyl]oxolane-2-carboxylic acid;
2-[(4-tert-butylphenyl)carbamoyl]oxolane-2-carboxylic acid;
2-[(2,3-dimethylphenyl)carbamoyl]oxolane-2-carboxylic acid;
2-[(3-bromo-2-methylphenyl)carbamoyl]oxolane-2-carboxylic acid;
2-[(5-chloro-2-methylphenyl)carbamoyl]oxolane-2-carboxylic acid;
2-[(4-difluoromethoxylphenyl)carbamoyl]oxolane-2-carboxylic acid;
2-[(4-ethyl-3-fluorophenyl)carbamoyl]oxolane-2-carboxylic acid;
2-[(3,5-difluoro-4-methoxyphenyl)carbamoyl]oxolane-2-carboxylic acid;
2-[(3-chloro-4-(2-methylpropoxy)phenyl)carbamoyl]oxolane-2-carboxylic acid;
2-[(4-hydroxy-2-methyl-5-(1-methylethyl)phenyl)carbamoyl]oxolane-2-carboxylic acid;
2-[(4-hydroxy-2,3,5-trimethylphenyl)carbamoyl]oxolane-2-carboxylic acid;
2-[(3-hydroxy-2,4-dimethylphenyl)carbamoyl]oxolane-2-carboxylic acid;
2-[(5-ethyl-2-hydroxyphenyl)carbamoyl]oxolane-2-carboxylic acid;
3-[(4-fluorophenyl)carbamoyl]oxetane-3-carboxylic acid as compound of the formula (1); and
ethyl 2-[(4-bromo-2-methyl-phenyl)carbamoyl]-1,3-dithiolane-2-carboxylate.

More preferably, in compounds (1) according to the invention, R¹ to R⁸ have one of the above-given general or preferred meanings, and R⁹ is n-propyl, isopropyl, n-butyl, sec-butyl (=2-butyl), isobutyl (=2-methylpropyl), (C₅-C₆)-alkyl, (C₂-C₄)-alkenyl, (C₂-C₄)-alkynyl, (C₃-C₆)-cycloalkyl, (C₃-C₆)-cycloalkyl-(C₁-C₃)-alkyl or phenyl-(C₁-C₃)-alkyl, where the six last-mentioned radi-cals are each substituted by m radicals selected from the group consisting of fluo-rine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members; or
R⁹ is (C₁-C₂)-alkyl substituted by m1 radicals selected from the group consisting of fluorine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members; where R^{a} is (C₁-C₆)-alkyl, (C₂-C₄)-alkynyl or (C₃-C₆)-cycloalkyl, each of which is sub-stituted by m radicals selected from the group consisting of fluorine, chlo-rine, bromine, iodine, cyano, hydroxy, and (C₁-C₃)-alkoxy; each m is independently 0, 1, 2, 3, 4 or 5; and m1 is 1, 2, 3, 4 or 5.

In particular, in compounds (1) according to the invention, R¹ to R⁸ have one of the above-given general or preferred meanings, and
R⁹ is (C₁-C₆)-alkyl substituted by m1 radicals R^{9a}; (C₂-C₄)-alkenyl, (C₂-C₄)-alkynyl, (C₃-C₆)-cycloalkyl or (C₃-C₆)-cycloalkyl-(C₁-C₃)-alkyl, where the four last-mentioned radicals are each substituted by m radicals R^{9a};
each R^{9a} is independently selected from the group consisting of fluorine, chlorine, bro-mine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members;
R^{a} is (C₁-C₆)-alkyl, (C₂-C₄)-alkynyl or (C₃-C₆)-cycloalkyl, each of which is substituted by m radicals selected from the group consisting of fluorine, chlorine, bromine, iodine, cyano, hydroxy, and (C₁-C₃)-alkoxy;
each m is independently 0, 1, 2, 3, 4 or 5; and
m1 is 1, 2, 3, 4 or 5.

More particularly, in compounds (1) according to the invention,
R⁹ is (C₁-C₄)-alkyl substituted by m1 radicals R^{9a}; (C₃-C₆)-cycloalkyl or (C₃-C₆)-cycloalkyl-(C₁-C₃)-alkyl; and
each R^{9a} is independently selected from the group consisting of fluorine, chlorine, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl and a 5-membered heteroaromatic ring containing 1, 2 or 3 heteroatoms selected from N, O and S as ring members (where the 5-membered heteroaromatic ring is preferably furanyl). Even more particularly, in compounds (1) according to the invention, R⁹ is (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl and a 5-membered heteroaromatic ring containing 1, 2 or 3 heteroatoms selected from N, O and S as ring members (where the 5-membered heteroaromatic ring is preferably furanyl); or R⁹ is (C₃-C₆)-cycloalkyl or (C₃-C₆)-cycloalkyl-(C₁-C₃)-alkyl.

Specifically, in compounds (1) according to the invention, R⁹ is (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio, and furanyl; or R⁹ is (C₃-C₄)-cycloalkyl or (C₃-C₄)-cycloalkyl-(C₁-C₂)-alkyl.

Specifically, the substituents in compounds (1) according to the invention have the fol-lowing meaning:
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated or partially unsaturated 4-, 5- or 6-membered monocyclic heterocyclic ring W con-taining 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or R⁷ and R⁸ form, together with the carbon atom to which they are bound, a satu-rated or partially unsaturated 7- or 8-membered bicyclic heterocyclic ring W con-taining 1 oxygen atom as ring members, the remaining ring members being car-bon atoms, and where the ring is substituted by n radicals R^{b}, where n is 0, 1 or 2; where
each R^{b} is independently (C₁-C₃)-alkyl or (C₁-C₃)-haloalkyl; or two R^{b}, bound on the same carbon atom, form a methylene group (═CH₂); and
R⁹ is as defined above; where in particular R⁹ is (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl and a 5-membered heteroaromatic ring containing 1, 2 or 3 heteroatoms selected from N, O and S as ring members (where the 5-membered heteroaromatic ring is preferably furanyl); or R⁹ is (C₃-C₆)-cycloalkyl or (C₃-C₆)-cycloalkyl-(C₁-C₃)-alkyl;
where specifically R⁹ is (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio, and furanyl; or R⁹ is (C₃-C₄)-cycloalkyl or (C₃-C₄)-cycloalkyl-(C₁-C₂)-alkyl.

In this context, preferably, R⁷ and R⁸ form, together with the carbon atom to which they are bound, a saturated or partially unsaturated 4-, 5-, 6-, 7- or 8-membered monocyclic or bicyclic heterocyclic ring W, containing, in addition to this carbon atom, q carbon atoms, u oxygen atoms, v nitrogen atoms, and w sulfur atoms as ring members, where one carbon ring atom bears p oxo groups, and where the ring is substituted by a methylene group (═CH₂); where q, u, v and w are as defined above. More preferably, where R⁷ and R⁸ form, together with the carbon atom to which they are bound, a satu-rated 5- or 6-membered, preferably 5-membered, monocyclic heterocyclic ring W, con-taining, in addition to this carbon atom, 3 or 4 carbon atoms and 1 oxygen atom as ring members, and where the ring is substituted by a methylene group (═CH₂).

In a more specific embodiment, the substituents in compounds (I) according to the in-vention have the following meaning:
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated 5-or 6-membered, preferably 5-membered, monocyclic heterocyclic ring W contain-ing, in addition to this carbon atom, 3 or 4 carbon atoms and 1 oxygen atom as ring members, and where the ring is substituted by a methylene group (═CH₂); and
R⁹ is hydrogen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members; and is preferably hydrogen.

In an even more specific embodiment, the substituents in compounds (1) according to the invention have the following meaning:
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated or partially unsaturated 4- or 5-membered monocyclic heterocyclic ring W containing 1 oxygen atom as ring member, the remaining ring members being carbon at-oms, and where the ring is substituted by n radicals R^{b}, where n is 0 or 1; where
each R^{b} is independently (C₁-C₃)-alkyl or (C₁-C₃)-haloalkyl; and
R⁹ is (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl; or R⁹ is (C₃-C₄)-cycloalkyl or (C₃-C₄)-cycloalkyl-(C₁-C₂)-alkyl.

In a very specific embodiment, the substituents in compounds (1) according to the in-vention have the following meaning:
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated 4-membered monocyclic heterocyclic ring W containing 1 oxygen atom as ring member, the remaining ring members being carbon atoms, or a partially unsatu-rated 5-membered monocyclic heterocyclic ring W containing 1 oxygen atom as ring member, the remaining ring members being carbon atoms, and where the ring is substituted by n radicals R^{b}, where n is 0 or 1; where
each R^{b} is independently (C₁-C₃)-alkyl or (C₁-C₃)-haloalkyl; and
R⁹ is (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl; or R⁹ is (C₃-C₄)-cycloalkyl or (C₃-C₄)-cycloalkyl-(C₁-C₂)-alkyl.

### EXAMPLES

### A Chemistry Examples

### Abbreviations

DMAP 4-(dimethylamino)-pyridine
EtOAc ethyl acetate
EtOH ethanol
LDA lithium diisopropylamide
MeCN acetonitrile
OAc acetate
PE petroleum ether
THF tetrahydrofuran Chemical bonds, drawn as bars in chemical formulae, indicate the relative stereochemistry on the ring system.

### Example 1

### Synthesis of ethyl 5-[(3,5-dichlorophenyl)carbamoyl]-2H-furan-5-carboxylate (Cpd 1.1)

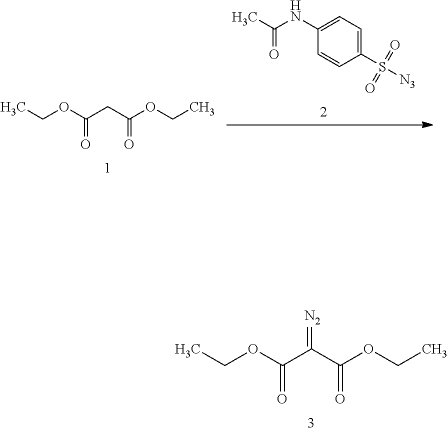

To a mixture of diethyl malonate (1) (50 g, 310 mmol) (CAS [53051-81-3]) and triethyl-amine (75 g, 744 mmol) in MeCN (500 ml) was added 4-acetamidobenzenesulfonyl azide (2) (p-ABSA, 12 g, 465 mmol) (CAS [2158-14-7]) at 20° C. The mixture was stirred at 20° C. for 16 h. The reaction was filtered and the filtrate was concentrated. Dichloromethane (100 mL) was added to the filtrate. The mixture was filtered and the filtrate was concentrated. The crude was purified by HPLC (EtOAc/PE=0%-100%) to give diethyl 2-diazopropanedioate (2) (62 g, quant.) as yellow oil. ¹H NMR (400 MHz, Chloroform-d) δ 4.31 (q, 4H), 1.32 (t, 6H).

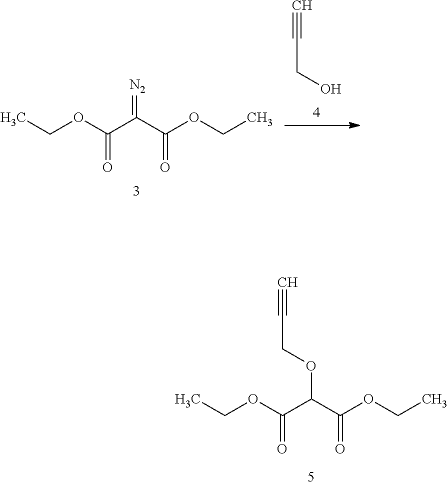

To a solution of diethyl 2-diazopropanedioate (3) (62 g, 330 mmol) and propargyl alco-hol (4) (18.5 g, 330 mmol) (CAS [107-19-7]) in toluene (600 ml) was added Rh₂(OAc)₄ (1.3 g, 2.9 mmol) (CAS [15956-28-2]) at 20° C. The mixture was stirred at 60° C. for 1 h.

The reaction was filtered and the filtrated was concentrated. The crude was purified by HPLC (EtOAc/PE=0%-100%) to give diethyl 2-prop-2-ynoxypropanedioate (5) (53 g, 80% over two steps) as yellow oil. ¹H NMR (400 MHz, Chloroform-d) δ 4.82-4.80 (s, 1H), 4.41 (d, 2H), 4.28 (m, 4H), 2.53 (t, 1H), 1.31 (t, 6H).

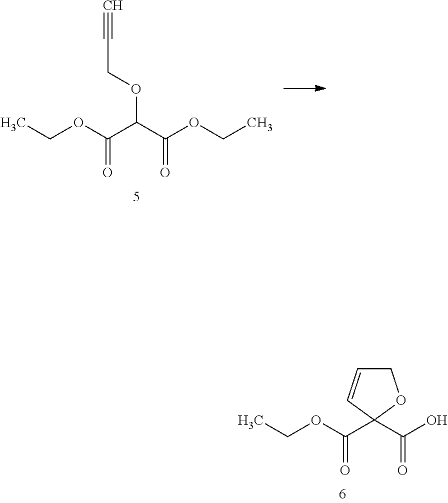

To a solution of diethyl 2-prop-2-ynoxypropanedioate (5) (30 g, 140 mmol) in EtOH/H₂O (200/200 mL) was added KOH (7.85 g, 140 mmol) at 20° C. in portions. The mixture was stirred at 20° C. for 16 h. The mixture was quenched with H₂O, adjusted to pH=3 with 6N HCl, and extracted with EtOAc. The combined organics were washed with brine, dried and concentrated to give 2-ethoxycarbonylhydrofuran-2-carboxylic acid (6) (20 g, 77%) as yellow oil. ¹H NMR (400 MHz, Chloroform-d) δ 6.23 (m, 1H), 6.02 (tdd, 1H), 4.93 (m, 1H), 4.87 (m, 1H), 4.29 (q, 2H), 1.32 (t, 3H).

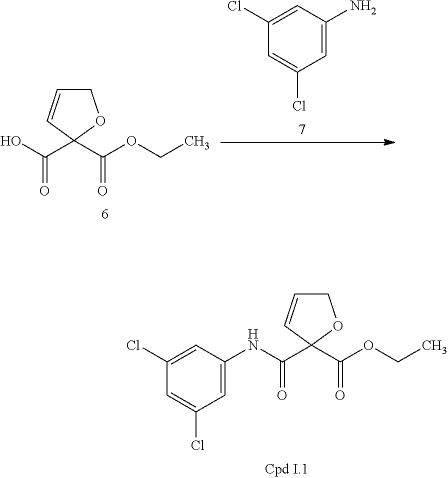 [SMILES: CCOC(=O)C1(C(=O)O)C=CCO1 ; Nc1cc(Cl)cc(Cl)c1 ; CCOC(=O)C1(C(=O)Nc2cc(Cl)cc(Cl)c2)C=CCO1]

To a solution of 2-ethoxycarbonylhydrofuran-2-carboxylic acid (12 g, 64 mmol) in dime-thylformamide (DMF) aniline 7 (50 mL, 1.2 M) was added. To the resulting solution HATU (2-(7-aza-1 H-benzotriazole-1-yl)-1,1,3,3-tetramethyluronium hexafluorophos-phate, CAS [148893-10-1]), (29.4 g, 77.4 mmol) was added, followed by diisopro-pylethylamine (33 mL, 194 mmol). The resulting reaction mixture was stirred at room temperature overnight. To the reaction mixture water and sodium bicarbonate solution were added. The reaction mixture was extracted with ethyl acetate, washed with water, dried (sodium sulfate) and the solvent was evaporated under reduced pressure. The crude product was purified by column chromatography using ethyl acetate as solvent yielding ethyl 5-[(3,5-dichlorophenyl)carbamoyl]-hydrofuran-5-carboxylate (Cpd 1.1) as a yellow solid (21 g, 99%). ¹H NMR (400 MHz, Chloroform-d) δ 8.32 (br s, 1H), 7.56 (d, J=1.8 Hz, 2H), 7.14 (m, 1H), 6.20 (m, 1H), 6.01 (m, 1H), 4.89-4.86 (m, 1H), 4.81 (s, 1H), 4.28 (m, 4H), 1.32 (t, 3H).

### Example 2

### Synthesis of 5-[(3,5-dichlorophenyl)carbamoyl]-hydrofuran-5-carboxylic acid (Cpd 1.2)

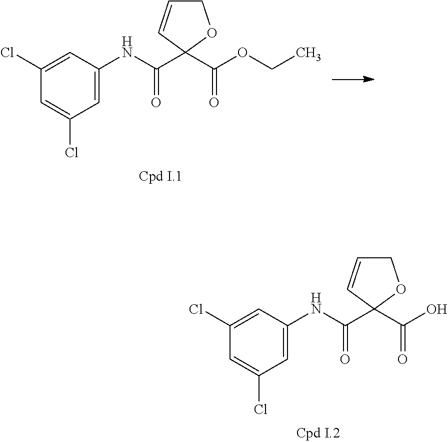 [SMILES: CCOC(=O)C1(C(=O)Nc2cc(Cl)cc(Cl)c2)C=CCO1 ; O=C(O)C1(C(=O)Nc2cc(Cl)cc(Cl)c2)C=CCO1]

To a solution of ethyl 5-[(3,5-dichlorophenyl)carbamoyl]-hydrofuran-5-carboxylate (Cpd 1.1) (1.33 g, 4.03 mmol) in EtOH/H₂O (40/20 mL) was added KOH (452 mg, 8.06 mmol) at 20° C. in portions. The mixture was stirred at 20° C. for 16 h. The mixture was quenched with H₂O, adjusted to pH=3 with 6N HCl, and extracted with EtOAc. The combined organics were washed with brine, dried and concentrated to give 5-[(3,5-dichlorophenyl)carbamoyl]-hydrofuran-5-carboxylic acid (Cpd 1.2) (950 mg, 78%) as yellow oil. ¹H NMR (400 MHz, Chloroform-d) δ 8.72 (s, 1H), 7.54 (m, 2H), 7.20 (m, 1H), 6.26 (m, 1H), 6.10 (m, 1H), 5.15 (m, 1H), 5.06 (m, 1H).

### Example 3

### Synthesis of ethyl 5-[(3,5-difluorophenyl)carbamoyl]-2H-furan-5-carboxylate (Cpd 1.20)

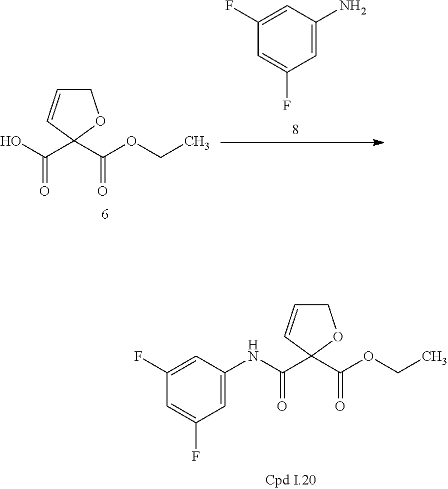 [SMILES: CCOC(=O)C1(C(=O)O)C=CCO1 ; Nc1cc(F)cc(F)c1 ; CCOC(=O)C1(C(=O)Nc2cc(F)cc(F)c2)C=CCO1]

According to example 2, to a solution of 2-ethoxycarbonylhydrofuran-2-carboxylic acid (6) (7.1 g, 38 mmol) in dimethylformamide (DMF) (50 mL, 0.76 M) aniline 8 (4.9 g, 38 mmol) was added. To the resulting solution HATU (2-(7-aza-1 H-benzotriazole-1-yl)-1,1,3,3-tetramethyluronium hexafluorophosphate, CAS [148893-10-1]), (17.4 g, 45.8 mmol) was added, followed by diisopropylethylamine (19.5 mL, 114 mmol). The result-ing reaction mixture was stirred at room temperature overnight. To the reaction mixture water and sodium bicarbonate solution were added. The reaction mixture was extract-ed with ethyl acetate, washed with water, dried (sodium sulfate) and the solvent was evaporated under reduced pressure. The crude product was purified by column chro-matography using ethyl acetate as solvent yielding ethyl 5-[(3,5-dichlorophenyl)carbamoyl]-hydrofuran-5-carboxylate (Cpd 1.20) as a yellow to brown oil (8.4 g, 74%). ¹H NMR (400 MHz, Chloroform-d) δ 8.61 (s, 1H), 7.25-7.14 (m, 2H), 6.58 (tt, J=8.9, 2.3 Hz, 1H), 6.26-6.11 (m, 2H), 4.94 (dd, J=2.2, 1.3 Hz, 2H), 4.27 (q, J=7.1 Hz, 2H), 1.31 (t, J=7.1 Hz, 3H).

### Example 4

### Synthesis of 5-[(3,5-difluorophenyl)carbamoyl]-hydrofuran-5-carboxylic acid (Cpd 1.7)

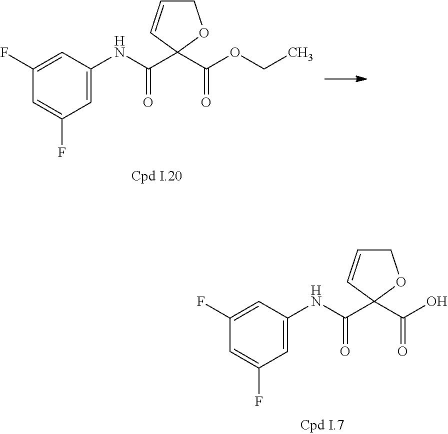 [SMILES: CCOC(=O)C1(C(=O)Nc2cc(F)cc(F)c2)C=CCO1 ; O=C(O)C1(C(=O)Nc2cc(F)cc(F)c2)C=CCO1]

To a solution of ethyl 5-[(3,5-difluorophenyl)carbamoyl]-hydrofuran-5-carboxylate (Cpd 1.20) (8.4 g, 28 mmol) in a 1:1 mixture of THE and water (50 mL) was added LiOH (1.35 g, 56.5 mmol) at 20° C. in portions. The mixture was stirred at room temperature overnight. The mixture was quenched with H₂O, adjusted to pH=3 with 6N HCl, and extracted with EtOAc. The combined organics were washed with brine, dried and concentrated to give 5-[(3,5-difluorophenyl)carbamoyl]-hydrofuran-5-carboxylic acid (Cpd 1.7) (7 g, 92%) as colorless liquid. ¹H NMR (400 MHz, Chloroform-d) δ 8.75 (s, 1H), 7.18 (dd, J=8.3, 2.2 Hz, 2H), 6.75-6.59 (m, 1H), 6.26 (dt, J=6.1, 1.6 Hz, 1H), 6.09 (dt, J=6.0, 2.4 Hz, 1H), 5.23-5.12 (m, 1H), 5.05 (dt, J=13.5, 2.0 Hz, 1H).

### Example 5

### Synthesis of cyclopropylmethyl 5-[(3,5-dichlorophenyl)carbamoyl]-2H-furan-5-carbox late (Cpd 1.18)

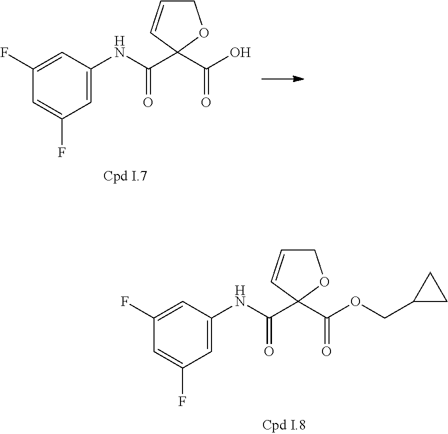 [SMILES: O=C(O)C1(C(=O)Nc2cc(F)cc(F)c2)C=CCO1 ; O=C(Nc1cc(F)cc(F)c1)C1(C(=O)OCC2CC2)C=CCO1]

To a solution of 5-[(3,5-dichlorophenyl)carbamoyl]-hydrofuran-5-carboxylic acid (0.10 mg, 0.37 mmol) in dichloromethane (3 mL, 0.1 M) DMAP (45 mg, 0.37 mmol), N-(3-dimethylaminopropyl)-N′-ethylcarbodiimide hydrochloride (214 mg, 1.11 mmol) and cyclopropylmethanol (27 mg, 0.37 mmol) were added subsequently. After stirring for 18 h, the reaction was quenched with 1 N HCl (1 mL). The organic layer was separated and washed with 1 N HCl (2 x) before drying over sodium sulfate. The filtrate was con-centrated providing Cpd 1.18 as a colorless viscous oil (71 mg, 59%). ¹H NMR (400 MHz, Chloroform-d) δ 8.59 (s, 1H), 7.25-7.14 (m, 2H), 6.59 (tt, J=8.9, 2.3 Hz, 1H), 6.26-6.14 (m, 2H), 4.95 (dt, J=2.3, 1.6 Hz, 2H), 4.05 (dd, J=7.3, 0.9 Hz, 2H), 1.24-1.10 (m, 1H), 0.64-0.49 (m, 2H), 0.35-0.26 (m, 2H).

### Example 6

### Synthesis of ethyl 2-[(3,5-difluorophenyl)carbamoyl]-3H-furan-2-carboxylate (Cpd 1.25)

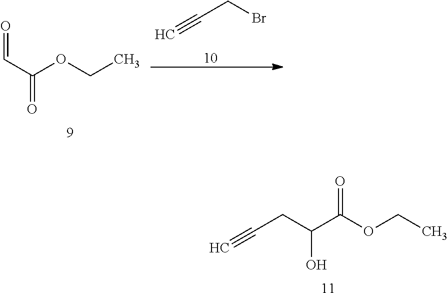

To a solution of ethyl glyoxylate (9) (50 g, 490 mmol) and propargyl bromide (10) (116 g, 980 mmol) in THE (200 mL) was added Zn (78.4 g, 1225 mmol) at 20° C. The mixture was stirred at initially at room temperature and heated to 80° C. in a period of 1 h. After cooling to room temperature, the mixture was filtered. The filtrate was quenched with HCl (2N, 300 mL) and extracted with EtOAc (100 mL×3). The combined organic were washed with bine, dried and concentrated, and purified by column chromatography (hexane/EtOAc=100:0 to 0:100) to give ethyl 2-hydroxypent-4-ynoate (11) (100 g, 72.2% yield) as yellow oil. ¹H-NMR (400 MHz, CDCl₃): δ=4.40 (t, J=4.9 Hz, 1H), 4.37-4.26 (m, 2H), 2.80-2.65 (m, 2H), 2.07 (t, J=2.6 Hz, 1H), 1.33 (t, J=7.1 Hz, 3H).

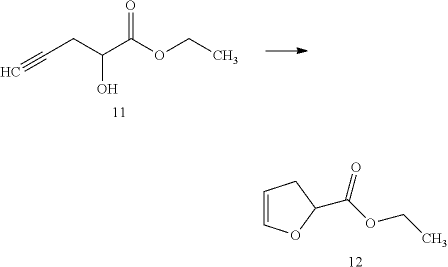

To a mixture of ethyl 2-hydroxypent-4-ynoate (55 g, 387 mmol) in acetone (1100 ml) was added Ag₂O (44.5 g, 193 mmol) and triethylamine (39.1 g, 387 mmol) at room temperature. After stirring the reaction at 50° C. for 2 h, the suspension was filtered and the filtrate was quenched with water (1 L). The aqueous layer was extracted with methyl tert-butylether (3×500 mL). The combined ethers were washed with brine, dried and concentrated. The crude was purified by flash column chromatography (methyl tert-butylether) and distilled at 75° C. at 20 Torr to give the ethyl 2,3-dihydrofuran-2-carboxylate (12) (15.8 g, 29%) as a yellow oil. ¹H-NMR (400 MHz, CDCl₃): δ=6.38 (q, J=2.5 Hz, 1H), 4.99-4.93 (m, 1H), 4.26 (q, J=7.1 Hz, 2H), 3.04-2.94 (m, 1H), 2.79 (tdd, J=2.4, 7.3, 15.6 Hz, 1H), 1.31 (t, J=7.1 Hz, 3H).

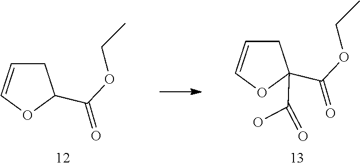

To a solution of LDA (29 ml, 59.1 mmol) in THE (60 mL) was added ethyl 2,3-dihydrofuran-2-carboxylate (12) (6.0 g, 42 mmol) in THE (60 ml) at −78° C. over 5 min and stirred at −78° C. for 10 min. CO2 (dry ice) was added and stirred at −78° C. for 1 h. The mixture was quenched with HCl (1 N, 150 ml) and extracted with ethyl acetate (100 mL×2), The combined organic were washed with bine, dried and concentrated to give 2-ethoxycarbonyl-3H-furan-2-carboxylic acid (13) (8 g, 100%) as a yellow oil.

Based on instability, the crude product was used in the next step without further purification.

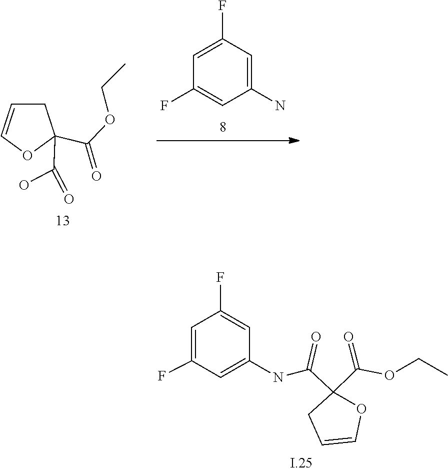

To a solution of 2-ethoxycarbonyl-3H-furan-2-carboxylic acid (13) (8 g, 43 mmol), aniline 8 (8.32 g, 64.5 mmol) and triethylamine (17.43 g, 172 mmol) in THE (20 mL) was added T₃P (41.0 g, 64.5 mmol) dropwise at 0° C. After stirring for 16 h, the mixture was quenched with water (50 mL) and extracted with ethyl acetate (100 mL×3), The combined organic layers were washed with bine (200 mL), dried and concentrated to give the crude product, which was purified by column chromatography (hexane/ethyl acetate=100:0 to 7:3) to give ethyl 2-[(3,5-difluorophenyl)carbamoyl]-3H-furan-2-carboxylate (Cpd 1.25) (6 g, 47% yield) as yellow oil. ¹H-NMR (400 MHz, CDC₃): δ=8.49 (br s, 1H), 7.26-7.19 (m, 2H), 6.62 (tt, J=2.3, 8.9 Hz, 1H), 6.39 (q, J=2.5 Hz, 1H), 5.12 (q, J=2.6 Hz, 1H), 4.42-4.21 (m, 2H), 3.49 (td, J=2.5, 16.6 Hz, 1H), 3.23 (td, J=2.4, 16.7 Hz, 1H), 1.33 (t, J=7.2 Hz, 3H).

### Example 7

### Synthesis of 2-[(3,5-difluorophenyl)carbamoyl]-3H-furan-2-carboxylate (Cpd 1.26)

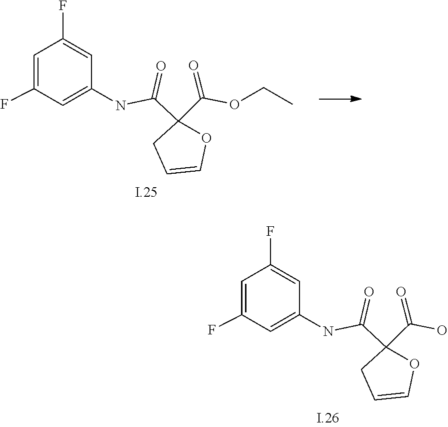

To a solution of compound 1.25 (4.0 g, 14 mmol) in THE (40 mL) was added LiOH—H₂O (0.84 g, 21 mmol) in water (8 mL) dropwise at 0° C. After stirring for 3 h at room temperate, the mixture was poured into water (100 mL) and extracted with ethyl acetate (100 mL). The aqueous phase was adjusted to pH=3 with 6N HCl, and extracted with ethyl acetate (50 mL×3). The combined organic layers were washed with brine (100 mL), dried over sodium sulfate, filtered, and concentrated to give the crude product (2.7 g, 75%). For analytic data 600 mg of the crude product was purified by prep-HPLC (NH₄HCO₃, MeCN—H₂O) to get 2-[(3,5-difluorophenyl)carbamoyl]-3H-furan-2-carboxylate (Cpd 1.26) (337 mg): ¹H-NMR (400 MHz, CDCl₃): δ=7.63-7.45 (m, 2H), 6.91-6.79 (m, 1H), 6.39 (q, J=2.3 Hz, 1H), 4.86 (q, J=2.4 Hz, 1H), 3.11-2.90 (m, 2H).

### Example 8

### Synthesis of methyl 3-[(3,5-difluorophenyl)carbamoyl]-2H-furan-3-carboxylate (Cpd. 1.27)

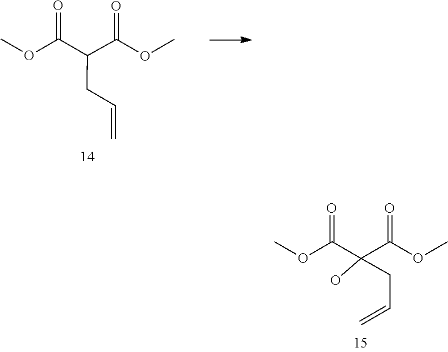

To a solution of dimethyl 2-allylpropanedioate (40 g, 232.56 mmol) in ethanol (160 mL) and water (80 mL) was added NaHCO₃ (1 0.95 g, 23.26 mmol) and formaldehyde (37% in water) (20.7 g, 256 mmol) at 0° C. and stirred at 15° C. for 16 h. The reaction mixture was poured into ice water (200 mL) and extracted with EtOAc (200 mL×3). The organic phase was washed with brine, dried over sodium sulfate, concentrated and purified by column chromatography (hexane/ethyl acetate=100:0 to 6:4) to give dimethyl 2-allyl-2-hydroxy-propanedioate (39 g, 83%) as yellow oil. ¹H-NMR (400 MHz, CDCl₃): δ=5.81-5.66 (m, 1H), 5.21-5.10 (m, 2H), 3.95 (d, J=6.8 Hz, 2H), 3.78 (s, 6H), 2.70 (d, J=7.4 Hz, 2H), 2.54 (t, J=6.9 Hz, 1H).

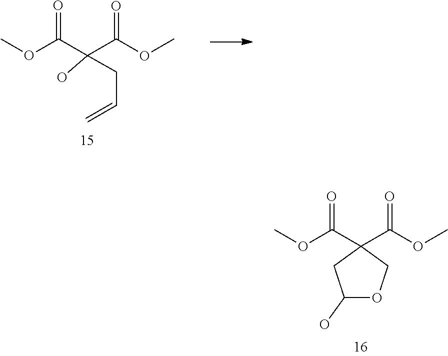

Ozone was bubbled through a solution of dimethyl 2-allyl-2-hydroxy-propanedioate (39 g, 193 mmol) in dichloromethane (390 mL) and methanol (39 mL) at −78° C. for 3 h. After addition of dimethyl sulfide, the reaction mixture was stirred at 15° C. for 16 h. The reaction mixture was concentrated and purified by column chromatography (hexane/ethyl acetate=100:0 to 60:40) to give dimethyl 5-hydroxytetrahydrofuran-3,3-dicarboxylate (16) (35 g, 88%) as a yellow oil. ¹H-NMR (400 MHz, CDCl₃): δ=5.57 (dt, J=1.4, 5.5 Hz, 1H), 4.48 (d, J=9.4 Hz, 1H), 4.31 (d, J=9.3 Hz, 1H), 3.80 (s, 3H), 3.77 (s, 3H), 3.51 (d, J=5.9 Hz, 1H), 2.70-2.62 (m, 1H), 2.56-2.49 (m, 1H).

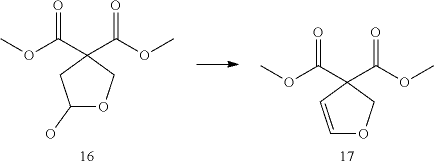

To a solution of dimethyl 5-hydroxytetrahydrofuran-3,3-dicarboxylate (16) (10 g, 49 mmol) in dichloromethane (100 mL) was added triethylamine (14.8 g, 147 mmol) and mesyl chloride [CAS: 124-63-0](8.38 g, 73.53 mmol) dropwise at 0° C. After stirring for 3 h at the same temperature, the mixture was stirred at 70° C. for 16 h. The reaction mixture was poured into ice water (100 mL) and extracted with ethyl acetate (100 mL×3). The organic phase was washed with brine, dried over sodium sulfate, concentrated and purified by column chromatography (hexane/ethyl acetate=100:0 to 60:40) to give dimethyl 2H-furan-3,3-dicarboxylate (17) (5.84 g, 64%) as a yellow oil. ¹H-NMR (400 MHz, CDCl₃): δ=6.47 (d, J=2.6 Hz, 1H), 5.19 (d, J=2.6 Hz, 1H), 4.75 (s, 2H), 3.77 (s, 6H).

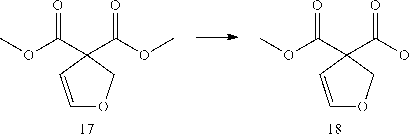

According to example 3, to a solution of dimethyl 2H-furan-3,3-dicarboxylate (17) (3.7 g, 19.9 mmol) in methanol (20 mL) was added LiOH (14.82 g) in water (20 mL) dropwise at 0° C. After stirring for 16 h at 15° C., the reaction mixture was lyophilized to give 3-methoxycarbonyl-2H-furan-3-carboxylic acid (3.7 g, 100%) as a white amorphous solid. The crude production was used without further purification. ¹H-NMR (400 MHz, CDCl₃): δ=6.37 (d, J=2.6 Hz, 1H), 5.21 (d, J=2.6 Hz, 1H), 4.72 (d, J=9.4 Hz, 1H), 4.61 (d, J=9.4 Hz, 1H), 3.69 (s, 3H).

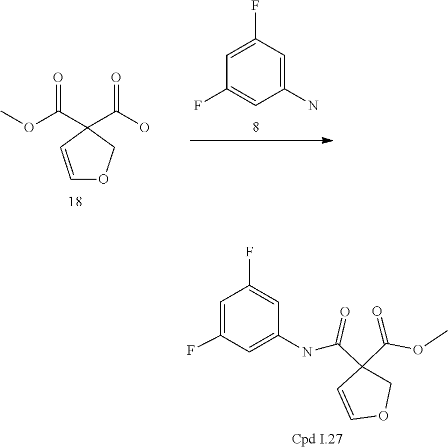

According to example 1, to a solution of 3-methoxycarbonyl-2H-furan-3-carboxylic acid (3.7 g, 22 mmol) in dimethylformamide (DMF) aniline 8 (40 mL, 0.55 M) was added. To the resulting solution HATU (2-(7-aza-1 H-benzotriazole-1-yl)-1,1,3,3-tetramethyluronium hexafluorophosphate, CAS [148893-10-1]), (16 g, 43 mmol) was added, followed by triethylamine (10.9 g, 108 mmol). The resulting reaction mixture was stirred at room temperature overnight. The reaction mixture was poured into ice water (100 mL) and extracted with ethyl acetate (100 mL×3). The organic phase was washed with brine, dried over sodium sulfate and the solvent was evaporated under reduced pressure. The crude product was purified by column chromatography (hex-ane/ethyl acetate=100:0 to 60:40) yielding methyl 3-[(3,5-difluorophenyl)carbamoyl]-2H-furan-3-carboxylate (Cpd 1.27) as a yellow oil (6.8 g, quantitative crude yield). ¹H NMR (400 MHz, Chloroform-d) δ=8.18 (br s, 1H), 7.20-7.12 (m, 2H), 6.67 (d, J=2.6 Hz, 1H), 6.60 (tt, J=2.3, 8.9 Hz, 1H), 5.24 (d, J=2.6 Hz, 1H), 5.07 (d, J=10.3 Hz, 1H), 4.83 (d, J=10.3 Hz, 1H), 3.84 (s, 3H).

### Example 9

### Synthesis of 3-[(3,5-difluorophenyl)carbamoyl]-2H-furan-3-carboxylate (Cpd. 1.28)

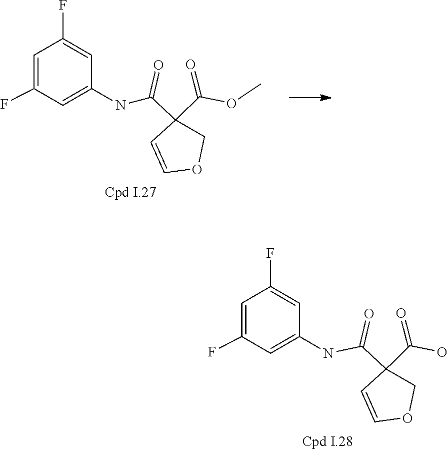

According to 2, to a solution of methyl 3-[(3,5-difluorophenyl)carbamoyl]-2H-furan-3-carboxylate (Cpd 1.27) (1.0 g, 3.5 mmol) in methanol (6 mL) was added LiOH (223 mg) in water (6 mL) dropwise at 0° C. After stirring for 16 h at 15° C., the reaction mixture was purified by prep-HPLC (NH₃′H₂O) to give 3-methoxycarbonyl-2H-furan-3-carboxylic acid (200 mg, 21%) as a white amorphous solid. ¹H NMR (400 MHz, Methanol-d) δ=7.33-7.23 (m, 2H), 6.62 (tt, J=2.4, 9.1 Hz, 1H), 6.42 (d, J=2.6 Hz, 1H), 5.33 (d, J=2.6 Hz, 1H), 4.93-4.90 (m, 1H), 4.83-4.80 (m, 1H).

### Example 10

### Synthesis of ethyl 2-[(3,5-dichlorophenyl)carbamoyl]oxetane-2-carboxylic acid (Cpd 11.1)

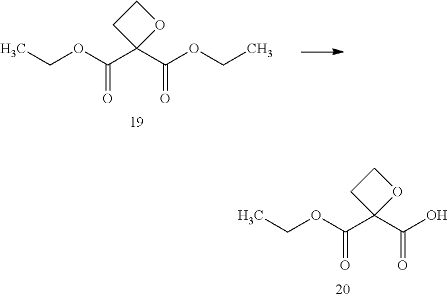

A solution of lithium hydroxide (118 mg, 4.95 mmol) in water was added dropwise to mixture of 2,2-diethoxyoxetane-2,2-dicarboxylat (19) (CAS [1384465-73-9]) (1000 mg, 4.95 mmol), tetrahydrofuran (THF) (50 ml) and water (50 ml) and the reaction mixture was stirred at room temperature overnight. THE was evaporated in vacuo and the re-mainder washed with methyl t-butyl ether. The aqueous solution was concentrated in vacuo and the remainder dried to give the product (20) (740 mg, 86% yield). ¹H NMR (500 MHz, Deuterium Oxide) δ=4.55 (t, 2H), 4.28 (m, 2H), 3.13 (m, 1H), 2.91 (m, 1H), 1.29 (t, 3H).

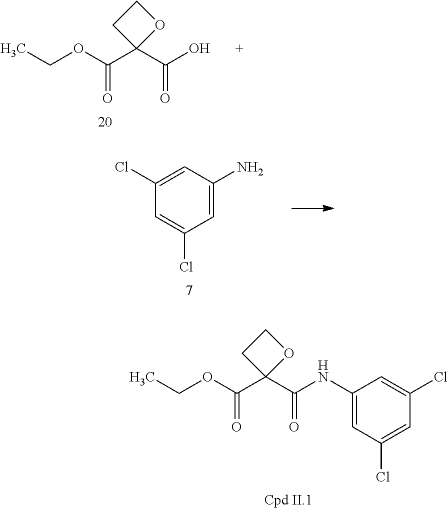 [SMILES: CCOC(=O)C1(C(=O)O)CCO1 ; Nc1cc(Cl)cc(Cl)c1 ; CCOC(=O)C1(C(=O)Nc2cc(Cl)cc(Cl)c2)CCO1]

To a solution of ethyl 2-[(3,5-dichlorophenyl)carbamoyl]oxetane-2-carboxylate (20) (3.52 g, 19.6 mmol) in dimethylformamide (DMF) aniline 7 (3.17 g, 19.6 mmol) was added. To the resulting solution was added HATU (2-(7-aza-1 H-benzotriazole-1-yl)-1,1,3,3-tetramethyluronium hexafluorophosphate, CAS [148893-10-1]), (8.18 g, 21.5 mmol) and then diisopropylethylamine (16.6 mL). The resulting reaction mixture was stirred at room temperature overnight. To the reaction mixture water and sodium bicar-bonate solution were added. The reaction mixture was extracted with ethyl acetate, washed with water, dried (sodium sulfate) and the solvent was evaporated under re-duced pressure. The crude product was purified by column chromatography using ethyl acetate as solvent yielding ethyl 2-[(3,5-dichlorophenyl)carbamoyl]oxetane-2-carboxylate (Cpd 11.1) (1.6 g, 26%). ¹H NMR (500 MHz, Chloroform-d) δ=8.71 (s, 1H), 7.61 (d, 2H), 7.16 (d, 1H), 4.74 (dt, 1H), 4.66 (m, 1H), 4.31 (q, 2H), 3.42 (ddd, 1H), 2.95 (ddd, 1H), 1.32 (t, 3H).

### Example 11

### Synthesis of 2-[(3,5-dichlorophenyl)carbamoyl]oxetane-2-carboxylic acid (Cpd 11.18)

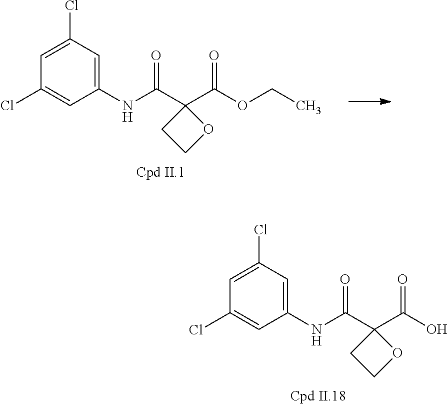 [SMILES: CCOC(=O)C1(C(=O)Nc2cc(Cl)cc(Cl)c2)CCO1 ; O=C(O)C1(C(=O)Nc2cc(Cl)cc(Cl)c2)CCO1]

A solution of lithium hydroxide (23 mg, 3.8 mmol) in water was added dropwise to mix-ture of ethyl 2-[(3,5-dichlorophenyl)carbamoyl]oxetane-2-carboxylate (Cpd 11.1) (150 mg, 0.472 mmol), tetrahydrofuran (THF) (10 ml) and water (10 ml) and the reaction mixture was stirred at room temperature overnight. THE was evaporated in vacuo and the remainder washed with methyl t-butyl ether (MTBE). The aqueous solution was concentrated in vacuo and the remainder dried to give 2-[(3,5-dichlorophenyl)carbamoyl]oxetane-2-carboxylic acid (Cpd 11.18) (130 mg, 95% yield). ¹H NMR (500 MHz, Methanol-d4) δ=7.76 (d, 2H), 7.21 (t, 1H), 6.56 (m, 1H), 4.67 (t, 2H), 3.31 (m, 1H), 2.94 (dt, 1H).

### Example 12

### Synthesis of methyl 3-[(3,5-difluorophenyl)carbamoyl]oxetane-3-carboxylic acid (Cpd 11.19)

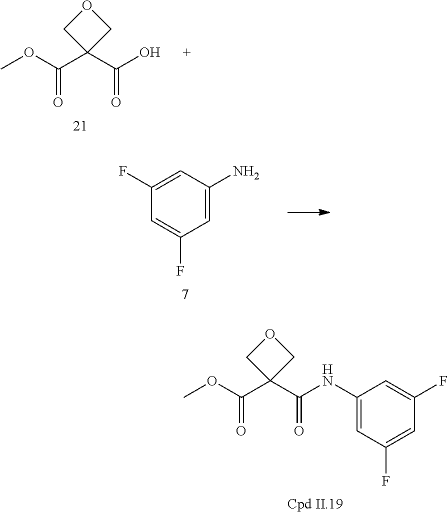 [SMILES: COC(=O)C1(C(=O)O)COC1 ; Nc1cc(F)cc(F)c1 ; COC(=O)C1(C(=O)Nc2cc(F)cc(F)c2)COC1]

According to example 6, to a solution of 3-methoxycarbonyloxetane-3-carboxylic acid (21) [CAS: 1395668-39-9](400 mg, 2.50 mmol), aniline 7 (322 g, 2.50 mmol) and triethylamine (1.04 mL, 7.5 mmol) in THE (5 mL, 0.5 M) was added T₃P (50% in DMF, 2.4 mL, 4.0 mmol) dropwise at 0° C. After stirring for 3 h at room temperature, the mixture was quenched with brine (10 mL) and extracted with ethyl acetate (10 mL×2), The combined organic layers were concentrated and purified by prep HPLC (water/acetonitrile) to give methyl 3-[(3,5-difluorophenyl)carbamoyl]oxetane-3-carboxylate (Cpd 11.19) (590 mg, 87%) as a yellow oil. ¹H-NMR (400 MHz, CDCl₃): δ=8.77 (s, 1H), 7.24-7.13 (m, 2H), 6.60 (tt, J=8.9, 2.4 Hz, 1H), 5.13 (d, J=6.2 Hz, 2H), 4.98 (d, J=6.2 Hz, 2H), 3.95 (s, 3H).

### Example 13

### Synthesis of 3-[(3,5-difluorophenyl)carbamoyl]oxetane-3-carboxylic acid (Cpd 11.20)

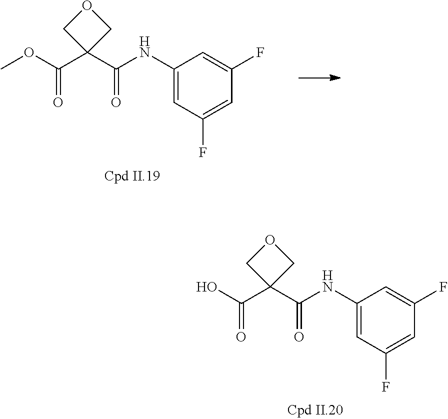 [SMILES: COC(=O)C1(C(=O)Nc2cc(F)cc(F)c2)COC1 ; O=C(O)C1(C(=O)Nc2cc(F)cc(F)c2)COC1]

According to example 3, to a solution of methyl 3-[(3,5-difluorophenyl)carbamoyl]-oxetane-3-carboxylic acid (Cpd 11.19) (0.55 mg, 2.0 mmol) in a 1:1 mixture of THE and 5 water (30 mL) was added LiOH (97 mg, 4.1 mmol). The mixture was stirred at room temperature over 2 h. After concentrating the reaction mixture under reduced pressure, the residue was washed with ethyl acetate. After adjusting the pH-value of the aueous residue to 3 with 6N HCl, the aqueous layer was extracted with ethyl acetate.The combined organic layers were concentrated to give the crude 3-[(3,5-difluorophenyl)carbamoyl]oxetane-3-carboxylic acid (Cpd 11.20) (450 mg, 88%) as colorless amorphous solid. ¹H NMR (400 MHz, THF-d) δ=9.45 (s, 1H), 7.35-7.27 (m, 2H), 6.65 (tt, J=9.1, 2.3 Hz, 1H), 4.95 (d, J=6.0 Hz, 2H), 4.87 (d, J=6.0 Hz, 2H).

High Performance Liquid Chromatography: HPLC-column KinetexXB C18 1,7μ (50×2.1 mm); eluent: acetonitrile/water+0.1% trifluoroacetic acid (gradient from 5:95 to 100: 0 in 1.5 min at 60° C., flow gradient from 0.8 to 1.0 ml/min in 1.5 min).

In analogy to the examples described above, the following compounds of formula (1) were prepared, wherein R¹ is hydrogen, and W is formed by R⁷ and R⁸ together with the carbon atom to which they are bound, starting from commercially available diesters and using commercially available amines:

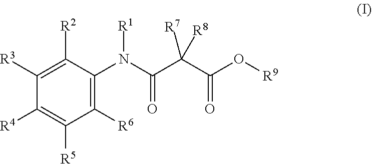

TABLE 2
HPLC/MS = MassChargeRatio

| Cpd. | R² | R³ | R⁴ | R⁵ | R⁶ | W | R⁹ | HPLC/MS |
|---|---|---|---|---|---|---|---|---|
| I.1 | H | Cl | H | Cl | H | 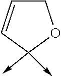 | CH₂CH₃ | 330.1 |
| I.2 | H | Cl | H | Cl | H | 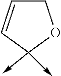 | H | 301.7 |
| I.3 | H | Cl | H | Cl | H | 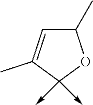 | H | 329.9 |
| I.4 | H | Cl | H | Cl | H | 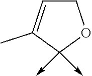 | CH₂CH₃ | 344 |
| I.5 | H | Cl | H | Cl | H | 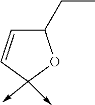 | H | 330 |
| I.6 | H | Cl | H | Cl | H | 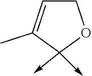 | H | 316 |
| I.7 | H | F | H | F | H | 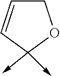 | H | 270.1 |
| I.8 | H | F | H | F | H | 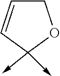 | 2-methoxyethyl | 328 |
| I.9 | H | F | H | F | H | 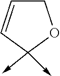 | 2-methylsulfanylethyl | 365.8 |
| I.10 | H | F | H | F | H | 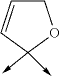 | 2-methylsulfonylethyl | 375.9 |
| I.11 | H | F | H | F | H | 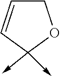 | 2-phenylsulfanylethyl | 427.8 |
| I.12 | H | F | H | F | H | 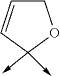 | 2-chloroethyl | 331.8 |
| I.13 | H | F | H | F | H | 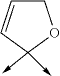 | 2-fluoroethyl | 315.8 |
| I.14 | H | F | H | F | H | 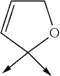 | 2,2-difluoroethyl | 333.8 |
| I.15 | H | F | H | F | H | 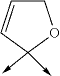 | 2,2,2-trifluoroethyl | 351.8 |
| I.16 | H | F | H | F | H | 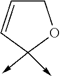 | 2-furylmethyl | 349.9 |
| I.17 | H | F | H | F | H | 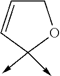 | benzyl | 359.9 |
| I.18 | H | F | H | F | H | 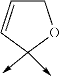 | cyclopropylmethyl | 323.9 |
| I.19 | H | F | H | F | H | 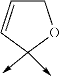 | cyclobutyl | 324 |
| I.20 | H | F | H | F | H | 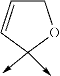 | CH₂CH₃ | 298.1 |
| I.21 | H | Cl | Cl | Cl | H | 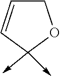 | CH₂CH₃ | 365.7 |
| I.22 | H | Cl | Cl | Cl | H | 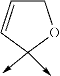 | H | 335.7 |
| I.23 | H | OCF₃ | H | H | H | 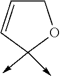 | CH₂CH₃ | 346 |
| I.24 | H | OCF₃ | H | H | H | 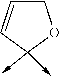 | H | 317.8 |
| I.25 | H | F | H | F | H | 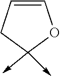 | CH₂CH₃ | 298.1 |
| I.26 | H | F | H | F | H | 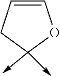 | H | 270 |
| I.27 | H | F | H | F | H | 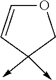 | CH₃ | 284 |
| I.28 | H | F | H | F | H | 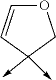 | H | 270.1 |

TABLE 3
HPLC/MS = MassChargeRatio

| Cpd. | R² | R³ | R⁴ | R⁵ | R⁶ | W | R⁹ | HPLC/MS |
|---|---|---|---|---|---|---|---|---|
| II.1 | H | Cl | H | Cl | H | 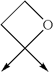 | CH₂CH₃ | 317.6 |
| II.2* | H | Cl | H | Cl | H | 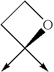 | CH₂CH₃ | 317.6 |
| II.3 | H | Cl | H | Cl | H | 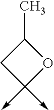 | H | 303.8 |
| II.4 | H | Cl | H | Cl | H | 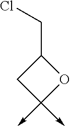 | H | 338.0 |
| II.5 | H | F | H | F | H | 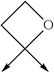 | H | 257.8 |
| II.6 | H | F | H | F | H | 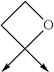 | 2-methoxyethyl | 315.8 |
| II.7 | H | F | H | F | H | 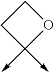 | 2-methylsulfanylethyl | 353.8 |
| II.8 | H | F | H | F | H | 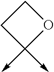 | 2-methylsulfonylethyl | 363.8 |
| II.9 | H | F | H | F | H | 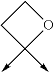 | 2-phenylsulfanylethyl | 416.1 |
| II.10 | H | F | H | F | H | 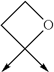 | 2-chloroethyl | 319.8 |
| II.11 | H | F | H | F | H | 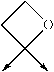 | 2-fluoroethyl | 303.8 |
| II.12 | H | F | H | F | H | 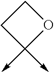 | 2,2-difluoroethyl | 321.8 |
| II.13 | H | F | H | F | H | 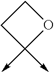 | 2,2,2-trifluoroethyl | 339.8 |
| II.14 | H | F | H | F | H | 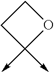 | 2-furylmethyl | 337.9 |
| II.15 | H | F | H | F | H | 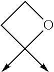 | benzyl | 347.9 |
| II.16 | H | F | H | F | H | 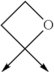 | cyclopropylmethyl | 311.9 |
| II.17 | H | F | H | F | H | 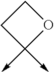 | cyclobutyl | 311.9 |
| II.18 | H | Cl | H | Cl | H | 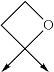 | H | 289.7 |
| II.19 | H | F | H | F | H | 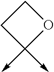 | CH₃ | 271.1 |
| II.20 | H | F | H | F | H | 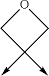 | H | 257.7 |

TABLE 4
HPLC/MS = MassChargeRatio

| Cpd. | R₂ | R₃ | R₄ | R₅ | R₆ | W | R₉ | HPLC/MS |
|---|---|---|---|---|---|---|---|---|
| III.1 | H | Cl | H | Cl | H | 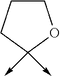 | CH₃ | 318 |
| III.2 | H | Cl | H | Cl | H | 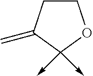 | CH₂CH₃ | 344 |
| III.3 | H | Cl | H | Cl | H | 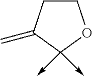 | H | 315.9 |

TABLE 5
HPLC/MS = MassChargeRatio

| Cpd. | R₂ | R₃ | R₄ | R₅ | R₆ | W | R₉ | HPLC/MS |
|---|---|---|---|---|---|---|---|---|
| IV.1 | H | Cl | H | Cl | H | 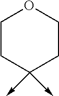 | CH₃ | 331.9 |
| IV.2 | H | Cl | H | Cl | H | 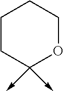 | CH₂CH₃ | 345.7 |
| IV.3 | H | Cl | H | Cl | H | 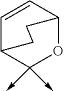 | H | 341.8 |
| IV.4 | H | Cl | H | Cl | H | 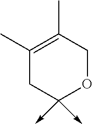 | H | 344.1 |

TABLE 6
HPLC/MS = MassChargeRatio

| Cpd. | R₂ | R₃ | R₄ | R₅ | R₆ | W | R₉ | HPLC/MS |
|---|---|---|---|---|---|---|---|---|
| V.1 | H | Cl | H | Cl | H | 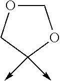 | CH₂CH₃ | 334 |
| V.2 | H | Cl | H | Cl | H | 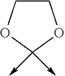 | CH₂CH₃ | 331.9 |
| V.3 | H | Cl | H | Cl | H | 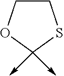 | CH₂CH₃ | 349.9 |
| V.4 | H | Cl | H | Cl | H | 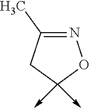 | CH₂CH₃ | 344.9 |
| V.5 | H | Cl | H | Cl | H | 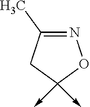 | CH₃ | 330.9 |
| V.6 | H | Cl | H | Cl | H | 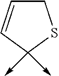 | CH₃ | 332 |
| V.7 | H | Cl | H | Cl | H | 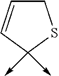 | H | 272 |

### B Use examples

The herbicidal activity of the compounds of formula (1) was demonstrated by the following greenhouse experiments:

The culture containers used were plastic flowerpots containing loamy sand with approximately 3.0% of humus as the substrate. The seeds of the test plants were sown separately for each species.

For the pre-emergence treatment, the active ingredients, which had been suspended or emulsified in water, were applied directly after sowing by means of finely distributing nozzles. The containers were irrigated gently to promote germination and growth and subsequently covered with transparent plastic hoods until the test plants had rooted.

This cover caused uniform germination of the test plants, unless this had been impaired by the active ingredients.

For the post-emergence treatment, the test plants were first grown to a height of 3 to 15 cm, depending on the plant habit, and only then treated with the active ingredients which had been suspended or emulsified in water. For this purpose, the test plants were either sown directly and grown in the same containers, or they were first grown separately as seedlings and transplanted into the test containers a few days prior to treatment.

Depending on the species, the test plants were kept at 10-25° C. or 20-35° C., respectively.

The test period extended over 2 to 4 weeks. During this time, the test plants were tended, and their response to the individual treatments was evaluated.

Evaluation was carried out using a scale from 0 to 100. 100 means no emergence of the test plants, or complete destruction of at least the aerial moieties, and 0 means no damage, or normal course of growth. A good herbicidal activity is given at values of 70 to <90 and a very good herbicidal activity is given at values of 90 to 100.

The test plants used in the greenhouse experiments were of the following species:

| Bayer code | Scientific name |
|---|---|
| ALOMY | Alopercurus myosuroides |
| AMARE | Amaranthus retroflexus |
| APESV | Apera spica-venti |
| AVEFA | Avena fatua |
| DIGSA | Digitaria sanguinalis |
| ECHCG | Echinocloa crus-galli |
| LOLMU | Lolium multiflorum |
| SETVI | Setaria viridis |
| SETFA | Setaria faberi |

At an application rate of 0.125 kg/ha, applied by the pre-emergence method:
compound 1.6 showed good herbicidal activity against AMARE
compound 1.6 showed good herbicidal activity against APESV

At an application rate of 0.250 kg/ha, applied by the pre-emergence method:
compound 11.8 showed good herbicidal activity against AMARE
compounds 1.1, 1.2, 1.5, 11.5 showed good herbicidal activity against APESV
compounds 1.10, 1.25 showed good herbicidal activity against LOLMU

At an application rate of 0.500 kg/ha, applied by the pre-emergence method:
compounds 1.8, 1.14, 1.16 showed good herbicidal activity against AMARE
compound 1.7 showed very good herbicidal activity against APESV
compound 1.7 showed good herbicidal activity against ECHCG
compounds 1.8, 1.9, 1.12, 1.13, 1.18, 1.19 showed very good herbicidal activity against LOLMU
compounds 1.11, 1.14, 1.15, 1.16, 1.17 showed good herbicidal activity against LOLMU
compound 1.7 showed good herbicidal activity against SETFA
compound 1.9 showed very good herbicidal activity against SETVI
compounds 1.14, 1.18 showed good herbicidal activity against SETVI

At an application rate of 1.000 kg/ha, applied by the pre-emergence method:
compounds 1.26, 11.1 showed very good herbicidal activity against AMARE
compound 11.1 showed good herbicidal activity against APESV
compound 1.26 showed very good herbicidal activity against DIGSA
compound 11.1 showed good herbicidal activity against ECHCG
compound 1.26 showed very good herbicidal activity against LOLMU

At an application rate of 0.250 kg/ha, applied by the post-emergence method:
compound 1.25 showed very good herbicidal activity against ALOMY
compounds 1.1, 1.10, 11.5 showed good herbicidal activity against ALOMY
compounds 1.25, 11.10, showed very good herbicidal activity against AMARE
compounds 1.4, 11.4, 11.6, 11.7, 11.8, 11.9, 11.11, 11.12, 11.15, 11.16, 11.17 showed good herbicidal activity against AMARE
compounds 1.25, 11.5, 11.6, 11.7, 11.9, 11.10, 11.11, 11.12, 11.13, 11.16, 11.17 showed very good herbicidal activity against AVEFA
compounds 1.1, 1.2, 1.10, 11.8, 11.14, 11.15 showed good herbicidal activity against AVEFA
compounds 1.25, 11.7, 11.8, 11.10, 11.11, 11.12, 11.13, 11.14, 11.15, 11.16, 11.17 showed very good herbicidal activity against ECHCG
compounds 1.10, 11.6, 11.9 showed good herbicidal activity against ECHCG
compound 11.5 showed very good herbicidal activity against SETVI

At an application rate of 0.500 kg/ha, applied by the post-emergence method:
compound 1.7 showed very good herbicidal activity against ALOMY
compounds 1.13, 1.16, 1.17, 1.19 showed good herbicidal activity against ALOMY
compounds 1.8, 1.12, 1.14, 11.20 showed good herbicidal activity against AMARE
compounds 1.7, 1.9, 1.11, 1.12, 1.13, 1.15, 1.16, 1.18 showed very good herbicidal activity against AVEFA
compounds 1.8, 1.14, 1.17, 1.19 showed good herbicidal activity against AVEFA
compounds 1.7, 1.14, 1.18 showed very good herbicidal activity against ECHCG
compounds 1.8, 1.9, 1.11, 1.12, 1.15, 1.17, 1.19, 11.20 showed good herbicidal activity against ECHCG

At an application rate of 1.000 kg/ha, applied by the post-emergence method:
compounds 11.1, 11.2 showed very good herbicidal activity against AMARE
compound 1.26 showed good herbicidal activity against AMARE
compound 1.26 showed very good herbicidal activity against AVEFA
compounds 1.26, 11.1, 11.2 showed very good herbicidal activity against ECHCG
compounds 11.1, 11.2 showed very good herbicidal activity against SETVI

1. A method for combatting undesired vegetation comprising applying a compound of the formula (I), or an agriculturally acceptable salt, a stereoisomer or a tautomer thereof to plants, their seeds and/or their habitat 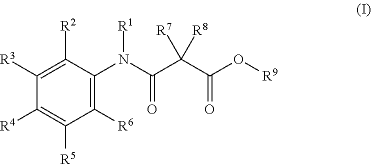
wherein
R¹ is hydrogen, (C₁-C₃)-alkyl, (C₁-C₃)-haloalkyl, (C₃-C₄)-cycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy-(C₁-C₃)-alkyl, (C₁-C₃)-alkoxy or (C₁-C₃)-haloalkoxy;
R² is hydrogen, halogen, hydroxyl, cyano, (C₁-C₃)-alkyl, (C₁-C₃)-haloalkyl, (C₁-C₃)-alkoxy or (C₁-C₃)-haloalkoxy;
R³ is hydrogen, halogen, nitro, hydroxyl, cyano, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy, (C₁-C₃)-haloalkoxy, (C₁-C₃)-alkoxycarbonyl, (C₁-C₃)-alkylthio, (C₁-C₃)-alkylsulfinyl or (C₁-C₃)-alkylsulfonyl;
R⁴ is hydrogen, halogen, hydroxyl, cyano, (C₁-C₃)-alkyl, (C₁-C₃)-haloalkyl, (C₃-C₄)-cycloalkyl, (C₃-C₄)-halocycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy or (C₁-C₃)-haloalkoxy;
R⁵ is hydrogen, halogen, nitro, hydroxyl, cyano, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₂-C₃)-alkenyl, (C₂-C₃)-haloalkenyl, (C₂-C₃)-alkynyl, (C₂-C₃)-haloalkynyl, (C₁-C₃)-alkoxy, (C₁-C₃)-haloalkoxy, (C₁-C₃)-alkoxycarbonyl, (C₁-C₃)-alkylthio, (C₁-C₃)-alkylsulfinyl or (C₁-C₃)-alkylsulfonyl;
R⁶ is hydrogen, halogen, hydroxyl, cyano, (C₁-C₃)-alkyl, (C₁-C₃)-haloalkyl, (C₁-C₃)-alkoxy or (C₁-C₃)-haloalkoxy;
R⁷ and R⁸ form, together with the carbon atom to which they are bound, a saturated or partially unsaturated 4-, 5-, 6-, 7- or 8-membered monocyclic or bicyclic heterocyclic ring W, containing, in addition to this carbon atom, q carbon atoms, u oxygen atoms, v nitrogen atoms, and w sulfur atoms as ring members, where one carbon ring atom bears p oxo groups, and where the ring is substituted by n radicals R^{b};
R⁹ is hydrogen, (C₁-C₆)-alkyl, (C₂-C₄)-alkenyl, (C₂-C₄)-alkynyl, (C₃-C₆)-cycloalkyl, (C₃-C₆)-cycloalkyl-(C₁-C₃)-alkyl or phenyl-(C₁-C₃)-alkyl, where the six last-mentioned radicals are each substituted by m radicals selected from the group consisting of fluorine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members;
R^{a} is (C₁-C₆)-alkyl, (C₂-C₄)-alkynyl or (C₃-C₆)-cycloalkyl, each of which is substituted by m radicals selected from the group consisting of fluorine, chlorine, bromine, iodine, cyano, hydroxyl, and (C₁-C₃)-alkoxy;
each R^{b} is independently halogen, nitro, hydroxyl, cyano, (C₁-C₃)-alkyl, (C₁-C₃)-haloalkyl, hydroxy-(C₁-C₃)-alkyl, (C₃-C₅)-cycloalkyl, (C₃-C₅)-halocycloalkyl, hydroxy-(C₃-C₅)-cycloalkyl, (C₁-C₃)-alkoxy, (C₁-C₃)-haloalkoxy, (C₁-C₃)-alkoxycarbonyl, (C₂-C₃)-alkenyl, (C₂-C₃)-haloalkenyl, (C₂-C₃)-alkynyl, (C₂-C₃)-haloalkynyl, (C₁-C₃)-alkylthio, (C₁-C₃)-alkylsulfinyl or (C₁-C₃)-alkylsulfonyl; or
two R^{b}, bound on the same carbon atom, form together a methylene group (═CH₂);
each m is independently 0, 1, 2, 3, 4 or 5;
each n is independently 0, 1 or 2;
p is 0 or 1;
q is 1, 2, 3, 4, 5 or 6;
u is 0, 1 or 2;
v is 0, 1, 2, or 3;
w is 0, 1 or 2;
with the proviso that at least one of u, v and w is not 0.

2. The method of claim 1, wherein one, two, three or all four of the following conditions a), b), c), d) apply:
a) R¹ is hydrogen or (C₁-C₃)-alkyl;
b) R² is hydrogen, halogen, or (C₁-C₃)-alkyl, and R⁶ is hydrogen, halogen, or (C₁-C₃)-alkyl;
c) R³ is hydrogen, halogen, cyano, (C₁-C₃)-alkyl, (C₁-C₃)-haloalkyl, (C₁-C₃)-alkoxy or (C₁-C₃)-haloalkoxy, and R⁵ is hydrogen, halogen, cyano, (C₁-C₃)-alkyl, (C₁-C₃)-haloalkyl, (C₁-C₃)-alkoxy or (C₁-C₃)-haloalkoxy;
d) R⁴ is hydrogen or halogen.

3. The method of claim 2, wherein one, two,
three or all four of the following conditions a), b), c), d) apply:
a) R¹ is hydrogen;
b) R² is hydrogen, and R⁶ is hydrogen;
c) R³ is halogen or (C₁-C₃)-haloalkoxy; and R⁵ is hydrogen or halogen,
d) R⁴ is hydrogen.

4. The method of claim 1, wherein
R⁷ and R⁸ form, together with the carbon atom to which they are bound, a saturated or partially unsaturated 4-, 5- or 6-membered monocyclic heterocyclic ring W or a saturated or partially unsaturated 7- or 8-membered bicyclic heterocyclic ring W, where ring W contains, in addition to this carbon atom, q carbon atoms, u oxygen atoms, v nitrogen atoms, and w sulfur atoms as ring members, where the sum of u, v and w is 1 or 2, and where ring W is substituted by n radicals R^{b}.

5. The method of claim 1, wherein
u is 1 or 2, v is 0 and w is 0; or
u is 1, v is 1 and w is 0; or
u is 1, v is 0 and w is 1; or
u is 0, v is 0 and w is 1.

6. The method of claim 1, wherein
R⁷ and R⁸ form, together with the carbon atom to which they are bound, a saturated or partially unsaturated 4-, 5- or 6-membered monocyclic heterocyclic ring W containing 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or
R⁷ and R⁸ form, together with the carbon atom to which they are bound, a saturated or partially unsaturated 7- or 8-membered bicyclic heterocyclic ring W containing 1 oxygen atom as ring members, the remaining ring members being carbon atoms, and where the ring is substituted by n radicals R^{b}, where n is 0, 1 or 2;
where R⁷ and R⁸ form, together with the carbon atom to which they are bound, a saturated or partially unsaturated 4- or 5-membered monocyclic heterocyclic ring W containing 1 oxygen atom as ring member, the remaining ring members being carbon atoms, and where the ring is substituted by n radicals R^{b}, where n is 0 or 1.

7. The method of claim 1, where each R^{b} is independently (C₁-C₃)-alkyl or (C₁-C₃)-haloalkyl; or two R^{b}, bound on the same carbon atom, form a methylene group (═CH₂).

8. The method of claim 1, where R⁹ is hydrogen, (C₁-C₆)-alkyl, (C₃-C₆)-cycloalkyl, (C₃-C₆)-cycloalkyl-(C₁-C₃)-alkyl, phenyl-(C₁-C₃)-alkyl or (C₁-C₄)-alkyl substituted by m radicals selected from the group consisting of fluorine, chlorine, bromine, cyano, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5- or 6-membered heteroaromatic ring containing 1, 2 or 3 heteroatoms selected from N, O and S as ring members; where m is 1, 2 or 3.

9. The method of claim 8, where R⁹ is hydro-gen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members.

10. The method of claim 1, where
R¹ is hydrogen or (C₁-C₃)-alkyl;
R² is hydrogen, halogen or (C₁-C₃)-alkyl;
R³ is hydrogen, halogen, cyano, (C₁-C₃)-alkyl, (C₁-C₃)-haloalkyl, (C₁-C₃)-alkoxy or (C₁-C₃)-haloalkoxy;
R⁴ is hydrogen or halogen;
R⁶ is hydrogen, halogen, cyano, (C₁-C₃)-alkyl, (C₁-C₃)-haloalkyl, (C₁-C₃)-alkoxy or (C₁-C₃)-haloalkoxy;
R⁶ is hydrogen, halogen or (C₁-C₃)-alkyl;
R⁷ and R⁸ form, together with the carbon atom to which they are bound, a saturated or partially unsaturated 4-, 5- or 6-membered monocyclic heterocyclic ring W or a saturated or partially unsaturated 7- or 8-membered bicyclic heterocyclic ring W, where ring W contains, in addition to this carbon atom, q carbon atoms, u oxygen atoms, v nitrogen atoms, and w sulfur atoms as ring members, where the sum of u, v and w is 1 or 2, and where ring W is substituted by n radicals R^{b};
R⁹ is hydrogen, (C₁-C₆)-alkyl, (C₃-C₆)-cycloalkyl, (C₃-C₆)-cycloalkyl-(C₁-C₃)-alkyl, phenyl-(C₁-C₃)-alkyl or (C₁-C₄)-alkyl substituted by m radicals selected from the group consisting of fluorine, chlorine, bromine, cyano, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5- or 6-membered heteroaromatic ring containing 1, 2 or 3 heteroatoms selected from N, O and S as ring members;
where m is 1, 2 or 3.

11. The method of claim 10, where:
R¹ is hydrogen;
R² is hydrogen;
R³ is halogen or (C₁-C₃)-haloalkoxy;
R⁴ is hydrogen;
R⁵ is hydrogen or halogen;
R⁶ is hydrogen;
R⁷ and R⁸ form, together with the carbon atom to which they are bound, a saturated or partially unsaturated 4-, 5- or 6-membered monocyclic heterocyclic ring W containing 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or
R⁷ and R⁸ form, together with the carbon atom to which they are bound, a saturated or partially unsaturated 7- or 8-membered bicyclic heterocyclic ring W containing 1 oxygen atom as ring member, the remaining ring members being carbon atoms, and where the ring is substituted by n radicals R^{b}, where n is 0, 1 or 2; where
each R^{b} is independently (C₁-C₃)-alkyl or (C₁-C₃)-haloalkyl; or two R^{b}, bound on the same carbon atom, form a methylene group (═CH₂); and
R⁹ is hydrogen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlo-rine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members, where R⁹ is preferably hydrogen, (C₁-C₃)-alkyl, (C₃-C₄)-cycloalkyl, (C₃-C₄)-cycloalkyl-(C₁-C₂)-alkyl, phenyl-(C₁-C₂)-alkyl or (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl.

12. The method of claim 11, where
R¹ is hydrogen;
R² is hydrogen;
R³ is halogen;
R⁴ is hydrogen;
R⁶ is halogen;
R⁶ is hydrogen;
R⁷ and R⁸ form, together with the carbon atom to which they are bound, a saturated or partially unsaturated 4- or 5-membered monocyclic heterocyclic ring W containing 1 oxygen atom as ring member, the remaining ring members being carbon atoms, and where the ring is substituted by n radicals R^{b}, where n is 0 or 1; where each R^{b} is independently (C₁-C₃)-alkyl or (C₁-C₃)-haloalkyl; and
R⁹ is hydrogen, (C₁-C₄)-alkyl, (C₃-C₆)-cycloalkyl, (C₃-C₆)-cycloalkyl-(C₁-C₂)-alkyl, phenyl-(C₁-C₂)-alkyl or (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, and a 5-membered heteroaromatic ring containing 1, 2 or 3 heteroatoms selected from N, O and S as ring members, where R⁹ is preferably hydrogen, (C₁-C₃)-alkyl, (C₃-C₄)-cycloalkyl, (C₃-C₄)-cycloalkyl-(C₁-C₂)-alkyl, phenyl-(C₁-C₂)-alkyl or (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl.

13. A herbicidal composition comprising at least one compound of the formula (I) as defined in claim 1, an agriculturally acceptable salt thereof, a stereoisomer thereof or a tautomer thereof, and at least one auxiliary except for compositions comprising simultaneously 3-[(4-fluorophenyl)carbamoyl]-oxetane-3-carboxylic acid as compound of the formula (I) and one or more of the following solvents: acetonitrile, ethyl acetate, water, methanol, tetrahydrofuran; preferably except for following compositions:
compositions comprising 3-[(4-fluorophenyl)carbamoyl]oxetane-3-carboxylic acid;
compositions comprising ethyl 2-[(4-bromo-2-methyl-phenyl)carbamoyl]-1,3-dithiolane-2-carboxylate.

14. The composition of claim 13, where the auxiliary comprises a liquid carrier and/or a solid carrier, where the liquid carrier is selected from the group consisting of water, organic solvents and mixtures thereof, where the organic solvents are selected from the group consisting of mineral oil fractions, kerosene or diesel oil; oils of vegetable or animal origin; paraffin, tetrahydronaphthalene, alkylated naphthalenes; alcohols, ethanol, propanol, butanol, benzylalcohol, cyclohexanol or glycols; DMSO; ketones, cyclohexanone; esters different from ethyl acetate, lactates, carbonates, fatty acid esters, gamma-butyrolactone; fatty acids; phosphonates; amines; amides, N-methylpyrrolidone, fatty acid dimethylamides; and mixtures thereof; and where the solid carriers are selected from the group consisting of silicates, silica gels, talc, kaolins, limestone, lime, chalk, clays, dolomite, diatomaceous earth, bentonite, calcium sulfate, magnesium sulfate, magnesium oxide; polysaccharides, cellulose, starch; fertilizers, ammonium sulfate, ammonium phosphate, ammonium nitrate, ureas; products of vegetable origin, cereal meal, tree bark meal, wood meal, nutshell meal, and mixtures thereof;
where in case that the auxiliary comprises water, the composition preferably also comprises a surface-active compound, where the surface-active compound is preferably selected from the group consisting of anionic, cationic, nonionic and amphoteric surfactants, block polymers, polyelectrolytes, and mixtures thereof.

15. A herbicidal composition comprising at least one compound of the formula (I) as defined in claim 1, an agriculturally acceptable salt thereof, a stereoisomer thereof or a tautomer thereof, at least one auxiliary which is customary for formulating crop protection compounds, and further comprising a herbicide which is different from the compounds of the formula (I).

16. A compound of the formula (I), an agriculturally acceptable salt thereof, a stereoisomer thereof or a tautomer thereof 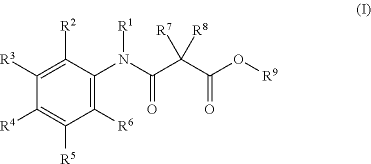
wherein R¹ to R⁹ are as defined in claim 1, except for compounds (I), wherein:
R¹, R², R⁴ and R⁶ are hydrogen, R³ and R⁵ are C₁, R⁷ and R⁸ form together with the carbon atom they are bound to oxetan-2,2-diyl (i.e. R⁷ and R⁸ form together a bridging group —CH₂—CH₂—O—), 2,5-dihydrofuran-2,2-diyl (i.e. R⁷ and R⁸ form together a bridging group —CH═CH—CH₂—O—), 3,5-dimethyl-2,5-dihydrofuran-2,2-diyl (i.e. R¹ and R⁸ form together a bridging group —C(CH₃)═CH—CH(CH₃)—O—), oxathiolan-2,2-diyl (i.e. R⁷ and R⁸ form together a bridging group —S—CH₂—CH₂-0-), 1,3-dioxolan-5,5-diyl (i.e. R⁷ and R⁸ form together a bridging group —CH₂—O—CH₂—O—), 3-methyl-4,5-dihydroisoxazol-5,5-diyl (i.e. R⁷ and R⁸ form together a bridging group —CH₂—C(CH₃)=N—O—), or 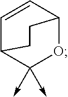
and R⁹ is hydrogen or ethyl;
R¹, R², R⁴ and R⁶ are hydrogen, R³ and R⁵ are Cl , R¹ and R⁸ form together with the carbon atom they are bound to 1-tert-butoxycarbonyl-pyrrolidin-2,2-diyl (i.e. R⁷ and R⁸ form together a bridging group —CH₂—CH₂—CH₂—N(—C(O)—O—C(CH₃)₃)—), and R⁹ is ethyl;
R¹, R², R⁴ and R⁶ are hydrogen, R³ and R⁵ are F or C₁, R⁷ and R⁸ form together with the carbon atom they are bound to tetrahydrofuran-2,2-diyl (i.e. R¹ and R⁸ form together a bridging group —CH₂—CH₂—CH₂—O—) or 2,5-dihydrothiophen-2,2-diyl (i.e. R⁷ and R⁸ form together a bridging group —CH═CH—CH₂—S—), and R⁹ is hydrogen or methyl;
R¹, R², R⁴ and R⁶ are hydrogen, R³ and R⁵ are F, R⁷ and R⁸ form together with the carbon atom they are bound to oxetan-2,2-diyl (i.e. R⁷ and R⁸ form together a bridging group —CH₂—CH₂—O—), and R⁹ is hydrogen or ethyl;
R⁷ and R⁸ form together with the carbon atom they are bound to tetrahydrofuran-2,2-diyl (i.e. R⁷ and R⁸ form together a bridging group —CH₂—CH₂—CH₂—O—), and R⁹ is tert-butyl;
R¹ is hydrogen or methyl, R⁷ and R⁸ form together with the carbon atom they are bound to oxetan-3,3-diyl (i.e. R⁷ and R⁸ form together a bridging group —CH₂—O—CH₂—), and R⁹ is hydrogen or methyl; and
R⁷ and R⁸ form together with the carbon atom they are bound to tetrahydropyran-4,4-diyl (i.e. R⁷ and R⁸ form together a bridging group —CH₂—CH₂—O—CH₂—CH₂), and R⁹ is hydrogen or ethyl;
and except for following compounds (I):
2-[(3-fluoro-5-methylphenyl)carbamoyl]oxolane-2-carboxylic acid;
2-[(3-bromophenyl)carbamoyl]oxolane-2-carboxylic acid;
2-[(4-tert-butylphenyl)carbamoyl]oxolane-2-carboxylic acid;
2-[(2,3-dimethylphenyl)carbamoyl]oxolane-2-carboxylic acid;
2-[(3-bromo-2-methylphenyl)carbamoyl]oxolane-2-carboxylic acid;
2-[(5-chloro-2-methylphenyl)carbamoyl]oxolane-2-carboxylic acid;
2-[(4-difluoromethoxylphenyl)carbamoyl]oxolane-2-carboxylic acid;
2-[(4-ethyl-3-fluorophenyl)carbamoyl]oxolane-2-carboxylic acid;
2-[(3,5-difluoro-4-methoxyphenyl)carbamoyl]oxolane-2-carboxylic acid;
2-[(3-chloro-4-(2-methylpropoxy)phenyl)carbamoyl]oxolane-2-carboxylic acid;
2-[(4-hydroxy-2-methyl-5-(1-methylethyl)phenyl)carbamoyl]oxolane-2-carboxylic acid;
2-[(4-hydroxy-2,3,5-trimethylphenyl)carbamoyl]oxolane-2-carboxylic acid;
2-[(3-hydroxy-2,4-dimethylphenyl)carbamoyl]oxolane-2-carboxylic acid;
2-[(5-ethyl-2-hydroxyphenyl)carbamoyl]oxolane-2-carboxylic acid;
3-[(4-fluorophenyl)carbamoyl]oxetane-3-carboxylic acid; and
ethyl 2-[(4-bromo-2-methyl-phenyl)carbamoyl]-1,3-dithiolane-2-carboxylate.

17. The compound as claimed in claim 16, and wherein
R⁹ is n-propyl, isopropyl, n-butyl, 2-butyl, isobutyl, (C₅-C₆)-alkyl, (C₂-C₄)-alkenyl, (C₂-C₄)-alkynyl, (C₃-C₆)-cycloalkyl, (C₃-C₆)-cycloalkyl-(C₁-C₃)-alkyl or phenyl (C₁-C₃)-alkyl, where the six last-mentioned radicals are each substituted by m radicals selected from the group consisting of fluorine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members; or
R⁹ is (C₁-C₂)-alkyl substituted by m1 radicals selected from the group consisting of fluorine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, 0 and S as ring members;
R^{a} is (C₁-C₆)-alkyl, (C₂-C₄)-alkynyl or (C₃-C₆)-cycloalkyl, each of which is substituted by m radicals selected from the group consisting of fluorine, chlorine, bromine, iodine, cyano, hydroxy, and (C₁-C₃)-alkoxy;
each m is independently 0, 1, 2, 3, 4 or 5; and
ml is 1, 2, 3, 4 or 5;
where in particular
R⁹ is (C₁-C₆)-alkyl substituted by m1 radicals R^{9a} ; (C₂-C₄)-alkenyl, (C₂-C₄)-alkynyl, (C₃-C₆)-cycloalkyl or (C₃-C₆)-cycloalkyl-(C₁-C₃)-alkyl, where the four last-mentioned radicals are each substituted by m radicals R^{9a};
each R^{9a} is independently selected from the group consisting of fluorine, chlorine, bromine, cyano, COOR^{a}, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl, where the aliphatic or aromatic moieties in the seven last-mentioned radicals are each substituted with m radicals selected from the group consisting of fluorine, chlorine and bromine; and a 5- or 6-membered heteroaromatic ring containing 1, 2 or 3 heteroatoms selected from N, O and S as ring members;
R^{a} is (C₁-C₆)-alkyl, (C₂-C₄)-alkynyl or (C₃-C₆)-cycloalkyl, each of which is substituted by m radicals selected from the group consisting of fluorine, chlorine, bromine, iodine, cyano, hydroxy, and (C₁-C₃)-alkoxy;
each m is independently 0, 1, 2, 3, 4 or 5; and
ml is 1, 2, 3, 4 or 5;
where specifically
R⁹ is (C₁-C₄)-alkyl substituted by m1 radicals R^{9a}; (C₃-C₆)-cycloalkyl or (C₃-C₆)-cycloalkyl-(C₁-C₃)-alkyl; and
each R^{1a} is independently selected from the group consisting of fluorine, chlorine, (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl and a 5-membered heteroaromatic ring containing 1, 2 or 3 heteroatoms selected from N, O and S as ring members
where more specifically R⁹ is (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl and a 5-membered heteroaromatic ring containing 1, 2 or 3 heteroatoms selected from N, O and S as ring members; or R⁹ is (C₃-C₆)-cycloalkyl or (C₃-C₆)-cycloalkyl-(C₁-C₃)-alkyl;
where even more specifically R⁹ is (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio, and furanyl; or R⁹ is (C₃-C₄)-cycloalkyl or (C₃-C₄)-cycloalkyl-(C₁-C₂)-alkyl.

18. The compound claim 16, where
R¹ is hydrogen;
R² is hydrogen;
R³ is halogen;
R⁴ is hydrogen;
R⁵ is halogen;
R⁶ is hydrogen;
R⁷ and R⁸ form, together with the carbon atom to which they are bound, a saturated or partially unsaturated 4-, 5- or 6-membered monocyclic heterocyclic ring W containing 1 or 2 oxygen atoms as ring members, or 1 oxygen atom and 1 nitrogen atom as ring members, or 1 oxygen atom and 1 sulfur atom as ring members, or 1 sulfur atom as ring member, the remaining ring members being carbon atoms, and where the ring is substituted by n radicals R^{b}, where n is 0, 1 or 2; or
R⁷ and R⁸ form, together with the carbon atom to which they are bound, a saturated or partially unsaturated 7- or 8-membered bicyclic heterocyclic ring W containing 1 oxygen atom as ring members, the remaining ring members being carbon atoms, and where the ring is substituted by n radicals R^{b}, where n is 0, 1 or 2; where
each R^{b} is independently (C₁-C₃)-alkyl or (C₁-C₃)-haloalkyl; or two R^{b}, bound on the same carbon atom, form a methylene group (═CH₂); and
R⁹ is as defined in claim 16;
where in particular R⁹ is (C₁-C₄)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfinyl, (C₁-C₃)-alkylsulfonyl, phenylthio, phenylsulfinyl, phenylsulfonyl and a 5-membered heteroaromatic ring containing 1, 2 or 3 heteroatoms selected from N, O and S as ring members, or R⁹ is (C₃-C₆)-cycloalkyl or (C₃-C₆)-cycloalkyl-(C₁-C₃)-alkyl.

19. The compound of claim 18, where
R¹ is hydrogen;
R² is hydrogen;
R³ is halogen;
R⁴ is hydrogen;
R⁶ is halogen;
R⁶ is hydrogen;
R⁷ and R⁸ form, together with the carbon atom to which they are bound, a saturated or partially unsaturated 4- or 5-membered monocyclic heterocyclic ring W containing 1 oxygen atom as ring member, the remaining ring members being carbon atoms, and where the ring is substituted by n radicals R^{b}, where n is 0 or 1; where each R^{b} is independently (C₁-C₃)-alkyl or (C₁-C₃)-haloalkyl; and
R⁹ is (C₁-C₃)-alkyl substituted by 1, 2 or 3 fluorine or chlorine atoms or by 1 radical selected from the group consisting of (C₁-C₃)-alkoxy, (C₁-C₃)-alkylthio, (C₁-C₃)-alkylsulfonyl, phenylthio and furanyl; or R⁹ is (C₃-C₄)-cycloalkyl or (C₃-C₄)-cycloalkyl-(C₁-C₂)-alkyl.

20. The compound of claim 16, wherein
R⁷ and R⁸ form, together with the carbon atom to which they are bound, a saturated or partially unsaturated 4-, 5-, 6-, 7- or 8-membered monocyclic or bicyclic heterocyclic ring W, containing, in addition to this carbon atom, q carbon atoms, u oxygen atoms, v nitrogen atoms, and w sulfur atoms as ring members, where one carbon ring atom bears p oxo groups, and where the ring is substituted by a methylene group (═CH₂);
where
p is 0 or 1;
q is 1, 2, 3, 4, 5 or 6;
u is 0, 1 or 2;
v is 0, 1, 2, or 3;
w is 0, 1 or 2;
with the proviso that at least one of u, v and w is not 0;
where R⁷ and R⁸ form, together with the carbon atom to which they are bound, a saturated 5- or 6-membered, monocyclic heterocyclic ring W, containing, in addition to this carbon atom, 3 or 4 carbon atoms and 1 oxygen atom as ring members, and where the ring is substituted by a methylene group (═CH₂).

21. A method for controlling undesired vegetation, which method comprises allowing a herbicidally effective amount of at least one compound of formula (I) as defined in claim 1, an agriculturally acceptable salt thereof, a stereoisomer thereof or a tautomer thereof to act on plants, their seeds and/or their habitat.
